(19) United States
(12) Patent Application Publication
(10) Pub. No.: US 2024/0309672 A1
(43) Pub. Date: Sep. 19, 2024

(54) MULTIFUNCTIONAL GAZEBO

(71) Applicant: ZHEJIANG ZHENGTE CO., LTD., Linhai (CN)

(72) Inventor: Dee Volin, Gresham, OR (US)

(21) Appl. No.: 18/612,391

(22) Filed: Mar. 21, 2024

Related U.S. Application Data
(63) Continuation of application No. PCT/US2021/059294, filed on Nov. 14, 2021.
Application No. PCT/US2021/059294 is a continuation of application No. 17/480,767, filed on Sep. 21, 2021, now Pat. No. 11,293,196.

(51) Int. Cl. E04H 15/02; A01G 9/16; A01K 1/00; A01K 1/02; A01K 15/02; A47B 47/00; E04F 10/02; E04H 15/50; F16B 25/10; G09F 15/00

(52) U.S. Cl. CPC E04H 15/02; A01G 9/16; A01K 1/0035; A01K 1/02; A01K 15/027; A47B 47/00; E04F 10/02; E04H 15/50; F16B 25/10; G09F 15/0012

(57) ABSTRACT

Disclosed are example embodiments of a multifunctional gazebo. In some implementations, the multifunctional gazebo may include a foldable truss, including at least one of a top truss, a corner truss, and a side truss. The foldable truss supports the adjustable canopy. Additionally, the device may include a plurality of posts, including an upper post and a lower post. The lower post and the upper post are configured to be slidably coupled to allow for height adjustment. The lower post and the upper post are coupled to the foldable truss.

### CROSS-REFERENCE TO RELATED APPLICATIONS

The present application is a continuation of International Patent Application No. PCT/US21/59294, filed Nov. 14, 2021, which claims priority to U.S. patent application Ser. No. 17/480,767, both of which are incorporated by reference herein.

### FIELD OF THE INVENTION

The present invention relates to a collapsible popup, which is cheap to produce, is easy to ship as one unit, requires no assembly, and can be quickly and easily be unfolded. Particularly, the present invention relates to a six-device-in-one robot-assembled arthritic-assisting noise-canceling friction-reducing dog-run-adaptable anti-wobbling gazebo, which comprises:
1) Robot-assembled arthritic-assisting noise-canceling friction-reducing dog-run-adaptable anti-wobbling gazebo system,
2) Robot-assembled automatically-making-rivet-tail-flare noise-canceling injury-preventing top-connector system,
3) Robot-assembled heat-expandable cold-contractable interlocking anti-wobbling spiral-saw screw system,
4) Robot-assembled injury-preventing cone-shielding central intersector system,
5) Robot-assembled injury-preventing cone-shielding upper intersector system,
6) Robot-assembled arthritic-assisting injury-preventing cone-shielding lower intersector system,
7) Robot-assembled arthritic-assisting injury-preventing post-centering tick-preventing water-discharging sleeve system,
8) Robot-assembled noise-canceling injury-preventing rust-preventing truss-centering cover-cushion system,
9) Robot-assembled arthritic-assisting noise-canceling injury-preventing rust-preventing truss-centering cup-cushion system,
10) Robot-assembled arthritic-assisting noise-canceling circular-cushion system, and
11) Robot-assembled injury-preventing rust-preventing caterpillar-cover system.

### DESCRIPTION OF THE PRIOR ART

A number of collapsible popups have been introduced.

U.S. Pat. No. 3,085,586, issued 1963 Apr. 16, to Elon D. McDonough, refers to a portable structure of the type employing a foldable frame and a flexible covering for the frame. An object of this invention is to provide a foldable structure which is adapted to form an enclosure for large areas, which structure is of economical and light weight construction and which can be readily collapsed and disassembled for compact storage and transportation.

U.S. Pat. No. 3,199,518, issued 1965 Aug. 10, to Herman A. Glidewell, describes a collapsible and foldable frame which may be employed as a shelter when suitable covering material is placed thereover. The device is primarily intended as a collapsible frame over which camouflage material can be placed to provide a hunting blind, but could, of course, be employed as a frame over which any desired covering material (such as tarpaulin) could be placed to provide protection against the weather.

U.S. Pat. No. 4,885,891, issued 1989 Dec. 12, to James P. Lynch, relates to an extendible scissors truss such as may be utilized in a collapsible canopy structure wherein the extendible scissors truss has members pivotally connected to form truss cells. The reinforcement member has first and second end portions joined by a linking portion to form a Z-like configuration.

U.S. Pat. No. 4,947,884, issued 1990 Aug. 14, to James P. Lynch, relates to a canopy shelter which has a plurality of corner support forming legs that may be positioned on a support surface. Scissor assemblies interconnect adjacent ones of the corner supports and are each pivotally connected at one portion to the top ends of the respective corner supports and are each pivotally connected at another portion to slide brackets slideably mounted on each of the respective corner supports. Roof support members are pivotally connected to a respective slide bracket on a corner support. Thus, the framework may be collapsed in a stored state yet expanded to an expanded state by spreading the corner members apart from one another.

U.S. Pat. No. 5,035,253, issued 1991 Jul. 30, to Allan D. Bortles, demonstrates a rain runoff awning for collecting runoff from a tent canopy. Fabric is stretched between and secured to outwardly extending arms which are attached to the canopy frame. The fabric forms a gutter or trough along an edge of the canopy for receiving runoff from the canopy and directing the runoff away from entrance and exit areas of the canopy.

U.S. Pat. No. 5,511,572, issued 1996 Apr. 30, to Mark C. Carter, describes a collapsible shelter including a truss and canopy framework that permits a flexible, collapsible canopy to be moved between a raised position and a lowered position. The collapsible shelter includes at least three legs supporting flexible poles removably mounted to the tops of the legs and forming the framework of the canopy. X-shaped truss pairs of link members are connected to each of the legs on each side of the shelter between adjacent legs.

U.S. Pat. No. 5,244,001, issued 1993 Sep. 14, to James P. Lynch, describes an expandable framework structure which can be folded for storage and expanded for use, especially as a canopy when a covering is placed on top of the framework. The framework includes a plurality of upright supports and a plurality of edge scissor assemblies that interconnect adjacent ones of the upright supports.

U.S. Pat. No. 5,511,572, issued 1996 Apr. 30, to Mark C. Carter, describes a collapsible shelter which includes a truss and canopy framework that permits a flexible, collapsible canopy to be moved between a raised position and a lowered position. The collapsible shelter includes at least three legs supporting flexible poles removably mounted to the tops of the legs and forming the framework of the canopy. X-shaped truss pairs of link members are connected to each of the legs on each side of the shelter between adjacent legs.

U.S. Pat. No. 6,141,934, issued 2000 Nov. 7, to Theodore R. Zeigler, depicts a folding frame system which includes a roof assembly including at least three pivotably attached strut pairs, adjacent pairs of the at least three pivotably attached strut pairs defining at least three corners of the roof assembly. The roof assembly is movable between a roof assembly closed position in which struts of the at least three strut pairs are disposed parallel to each other and a roof assembly open position in which struts of the at least three strut pairs are locked in non-parallel positions and ends of the struts of each strut pair of the at least three strut pairs define a rectangle.

U.S. Pat. No. 6,283,136, issued 2001 Sep. 4, to Fengchun Chen, refers to a collapsible tent which comprises top connecting means at the top of the tent; a plurality of upright legs; a slider slideably received on each upright leg; upper roof support bars pivotally connected to the top connecting means; lower roof support bars which each are connected at one end to its respective upper roof support bar and at the other end to a top of its respective upright leg.

U.S. Pat. No. 6,470,902, issued 2002 Oct. 29, to Mark C. Carter, discloses a quickly erectable canopy shelters include a plurality of legs connected together by an extendible perimeter assembly of link members. The roof structure is formed by a pole members pivotally mounted to the upper ends of the legs so as to extend across the shelter, and movable between a lowered position and a raised, upwardly arching position. The pole members are pivotally coupled to a central hub, and each of the pole members is formed of pole sections hinged to permit downward folding and upward unfolding until they are fully extended.

U.S. Pat. No. 6,502,597, issued 2003 Jan. 7, to Mark C. Carter, describes a lightweight erectable canopy shelters include a plurality of legs connected together by an extendible perimeter assembly of link members. In one embodiment, the roof structure is formed by a pole members pivotally mounted to the upper ends of the legs so as to extend across the shelter, and movable between a lowered position and a raised, upwardly arching position. The pole members are pivotally coupled to a central hub, and each of the pole members comprises pole sections hinged to permit downward folding and upward unfolding until they are fully extended.

U.S. Pat. No. 7,178,542, issued 2007 Feb. 20, to Mark C. Carter, demonstrates a lightweight erectable canopy shelters which include a plurality of legs connected together by an extendible perimeter assembly of link members. In one embodiment, the roof structure is formed by a pole members pivotally mounted to the upper ends of the legs so as to extend across the shelter, and movable between a lowered position and a raised, upwardly arching position.

U.S. Pat. No. 7,775,229, issued 2010 Aug. 17, to Ron Sy-Facunda, relates to technology of the present application which provides a collapsible canopy shelter having one or more side awnings that are pivotally coupled to the canopy frame. The canopy shelter for this has reinforced eaves for additional structural integrity, as well as at least one collapsible ventilation flap in the canopy cover that is capable of moving between a closed position and an open position to ventilate air from beneath the canopy cover as desired. Further, the collapsible canopy shelter comprises a canopy frame with a robust, spring-loaded pull latch, allowing the user to quickly and easily assemble and, collapse the shelter without risking injury.

U.S. Pat. No. 7,836,907, issued 2010 Nov. 23, to Mark C. Carter, refers to a quickly erectable dome shelter which includes an extendible perimeter truss assembly with link members connected between adjacent legs, a central truss assembly of link members, and a roof framework, including pairs of curved upper and lower peak truss members, that is movable between a lowered, collapsed configuration and a raised, upwardly arching position.

U.S. Pat. No. 7,836,908, issued 2010 Nov. 23, to Ron Sy-Facunda, relates to technology of the present application which provides a canopy with an automatic roof structure having improved structural stability. The canopy comprises a plurality of vertical support posts connected by trusses. A plurality of roof support rods extend from the vertical support posts to a central hub. At least one of the roof support rods has a cantilever support extending from the associated slide or thereabouts to a pivot on the roof support rod. The canopy also comprises central truss supports and stubs extending from the connection of the lateral trusses to the central hub. The canopy has an expanded, open configuration and a collapsed, closed configuration.

U.S. Pat. No. 8,215,326, issued 2012 Jul. 10, to Bumjun Park, outlines a collapsible shelter assembly which includes plurality of legs with each of the legs having an upper, a lower end and an axis. A truss system links each pair of legs together and defines a perimeter. Rods are adapted for supporting a cover and brackets are adapted for attaching the rods to the legs. Each of the brackets has a base adapted for attachment to the upper end one of the legs and a coupler mounted to the base for attaching one of the rods. Each bracket is configured so that at least one of the base and the coupler is rotatable relative to the leg axis.

U.S. Pat. No. 8,220,477, issued 2012 Jul. 17, to Lindy Park, refers to a collapsible canopy frame having an improved roof and support structure. A collapsible canopy frame according to one embodiment includes a plurality of side poles; a plurality of edge scissor assemblies coupling adjacent side poles of the plurality of side poles to one another; a center pole for supporting a covering; a plurality of center pole ribs each coupling the center pole to a respective side pole of the plurality of side poles; and a plurality of center scissor assemblies coupling the plurality of edge scissor assemblies to the center pole.

U.S. Pat. No. 8,418,711, issued 2013 Apr. 16, to Bumjun Park, demonstrates a collapsible canopy support which includes beams for supporting a canopy with each beam having a plurality of elongated beam segments coupled together to form the beam. A segment coupler provides for pivotally coupling a first beam segment to a second beam segment. A segment locking assembly is adapted for selectively securing the first beam segment relative to the second beam segment.

U.S. Pat. No. 8,544,489, issued 2013 Oct. 1, to Kwan Jun Choi, refers to a collapsible tent structure which includes a plurality of poles coupled with a plurality of linkages. The tent structure also includes a plurality of rods where each rod is pivotally coupled to each pole on one end and pivotally coupled to a hub on an opposite end. A plurality of struts are further included in the tent structure and each strut is pivotally coupled to each rod on one end and pivotally coupled to each pole on an opposite end, and a locking mechanism is coupled to each of the rods.

U.S. Pat. No. 8,616,226, issued 2013 Dec. 31, to Oliver Ma, refers to a shelter that includes a slider and a strut mechanism mounted on support posts of the shelter that automatically actuate and extend from the side of the support posts when the shelter is expanded from its collapsed state. The strut mechanism provides support for an eave that extends outside from all or a portion of the perimeter of the shelter defined by the corners of the support posts. An automatic hard-stop mechanism is incorporated into the support posts that prevent the eave sliders and strut mechanisms from becoming over-extended.

U.S. Pat. No. 8,701,692, issued 2014 Apr. 22, to Allen Holland, demonstrates a collapsible shelter which includes an improved attachment of the roof poles to the legs. A shelter frame has a leg at each corner. Each leg may have an angled top edge or surface. A scissor assembly attaches adjacent legs to each other. An offset link pivotally attaches the roof poles to the legs, adjacent to the top of each leg. The roof poles can be rigidly attached to the offset link. Extension poles are attached to the roof poles with a bungee or similar elastic element.

U.S. Pat. No. 8,776,815, issued 2014 Jul. 15, to Bumjun Park, relates to a collapsible shelter assembly which includes legs, a truss system, a cover, cover supporting rods and mounting brackets. Each of the legs has an upper and a lower end. The truss system is configured to link each pair of legs together and define a base perimeter.

U.S. Pat. No. 8,978,680, issued 2015 Mar. 17, to Matt Kayser, demonstrates an erectable canopy framework comprising a base frame and a roof frame. The roof frame is operative to support a canopy above the base frame and is removably mountable to the base frame. The base frame includes a plurality of upright support members, a plurality of cross members, each interconnecting adjacent upright support members, and a plurality of mounts disposed on the upright support members.

U.S. Pat. No. 9,103,138, issued 2015 Aug. 11, to Jack B. Lovley, II, demonstrates a collapsible canopy structure includes one or more eaves, one or more fixed eave mounts, one or more sliding eave mounts and one or more vertical poles. Each of the vertical poles has a top end and a bottom end. Each of the vertical poles is connected by at least one of the one or more eaves.

U.S. Pat. No. 9,528,292, issued 2016 Dec. 27, to Jack B. Lovley, II, refers to a canopy which includes a frame assembly having a perimeter frame portion, a central frame portion and multiple legs. The frame assembly also includes one or more overhang frame portions, each of which can include a main overhang frame member and a strut. Each overhang frame portion can extend diagonally from the associated corner of the frame assembly.

U.S. Pat. No. 9,556,639, issued 2017 Jan. 31, to David Lewis Hunt, refers to a portable shelter framing system which is disclosed herein. The portable shelter framing system includes a plurality of corner support members; a plurality of crossbeam members, each of the crossbeam members configured to be connected between a pair of the plurality of corner support members without the use of tools.

U.S. Pat. No. 9,995,056, issued 2018 Jun. 12, to Shanghai Yang, refers to a collapsible canopy frame which includes a plurality of side and central supports and a plurality of telescopic legs. A single activation feature provides for the extension and retraction, and the locking and unlocking of the canopy frame. A fixed bracket and a sliding bracket located at the upper end of each telescopic leg provide the connection of the telescopic legs to the side and central supports and to each other. The single activation feature includes an upper and a lower hub and when they joined together facilitate the extension and locking of canopy frame; as the lower hub is disengaged from the upper hub, the gazebo frame becomes unlocked and capable of being retracted. Each telescopic leg includes a plurality of telescopic sections that extend and retract through a cable system or a tape-driven system connected to the sliding bracket and which links the telescopic sections to each other.

U.S. Pat. No. 10,344,494, issued 2019 Jul. 9, to Dee Volin, refers to an 11-device-in-one system (which can be used as 360-degree-rotatable rollable portable lockable collapsible expandable carport, green house, gazebo, storage, attic, awnings, tent, workshop, outdoor tables, booth, and RV port) comprises: round bars; square bars releasably attached to the round bars; 360-degree rotatable lockable wheels rotatably attached to the round bars; canvas roof panels; canvas side panels; canvas end panels; canvas gap-covering panels; panel-lifting VELCRO (hook and loop fasteners) sewn to the side and gap-covering panels; panel-sealing zippers sewn to the end panels (for forming doors); panel-sealing grommets attached to the roof, side, and end panels; bungee cords and balls inserted through the grommets (for attaching the roof, side, and end panels together); first telescopic arms foldably and releasably attached to the round bars; second telescopic arms foldably attached to the first telescopic arms; feet welded to the second telescopic arms (for attaching to each other over the roof panels to form the frames for booth signs); and toes welded to the round bars (for releasably locking the feet thereon to form the frames for awnings and tables).

U.S. Pat. No. 11,002,037, issued 2021 Mar. 11, to Mark C. Carter, refers to a portable room which includes multiples sides and a roof attached to the multiple sides. The protavel room also includes a flexible strap attached to the roof. The flexible strap includes a fastener to attach to a peak structure of a portable shelter.

U.S. Pat. No. 11,072,942, issued 2021 Jul. 27, to Martin Dotterweich, refers to a novel canopy frame hub, or bracket, that features insert openings on all four sides as well as leg adjustments. The frame hub encompasses a leg of a traditional canopy frame and may be adjusted vertically to a desired height by sliding the bracket along the frame leg. The hub may then be fixated at the desired height via the twisting of the fixed screw inserted through an opening in one side of the hub.

U.S. Pat. No. D365,884, issued 1996 Jan. 2, to Ronald N. Dennis, depicts an ornamental design for a cloth-covered canopy.

U.S. Pat. No. D445,916, issued 2001 Jul. 31, to Nicholas Mark Reginald Pritchard, depicts an ornamental design for a portable shelter structure.

U.S. Pat. No. D670003, issued 2012 Oct. 30, to Jack B Lovley, II, depicts an ornamental design for a canopy.

U.S. Pat. No. D785201, issued 2017 Apr. 25, to Ellen Hassman, depicts an ornamental design for a gazebo canopy.

U.S. Publication No. 20060266401, published 2006 Nov. 30, to Weidan Wu, relates to a tarpaulin shelter with collapsible doorframes, including doorframes, the lower end of which is connected to the base and the upper end is connected with corner joint and cross beam, characterized in that the doorframe includes at least three upright poles, in which at least a set of x-scissor member are arranged between the middle upright pole and each side upright pole, said scissor is composed of two cross rods of which the middle portions are mutually hinged together.

U.S. Publication No. 20070240748, published 2007 Oct. 18, by Sang-Jin Bae, reveals a canopy includes a plurality of height-adjustable support frames including upper and lower frames; a bottom fixture inserted/fixed in each lower frame; a fixed two-point connection member fixed to each upper frame; a height-adjustable movable two-point connection member installed to each upper frame; three-point connection members positioned between the upper frames respectively; upper and lower four-point connection members positioned in the middle of the support frames respectively and having a vertically-installed anti-drooping frame; and pivoting frames whose both ends are connected to each connection member and whose center portion is hinged pivotally.

U.S. Publication No. 20110308559, published 2011 Dec. 22, to Oliver Ma, relates to a shelter that includes a slider and a strut mechanism mounted on support posts of the shelter that automatically actuate and extend from the side of the support posts when the shelter is expanded from its collapsed state. The strut mechanism provides support for an eave that extends outside from all or a portion of the perimeter of the shelter defined by the corners of the support posts.

U.S. Publication No. 20160168874, published 2016 Jun. 16, by Jack B. Lovley, II, reveals a collapsible canopy has a collapsible frame and a canopy cover supported by the collapsible frame. In some configurations, the frame includes telescopic legs having three or more stages. An automatic lock release is carried by one of the legs and automatically releases a lock between two other of the legs. A relative inner leg can include a cap having a resilient portion that contacts an inner surface of a relative outer leg to increase a lateral rigidity of the leg assembly. At least one of the eave cross members can have an end portion having an abutting extension that contacts an adjacent cross member to limit lateral deflection of the eave. The abutting extension can be positioned between eave cross members that incorporate a bracket for supporting a center support that extends from the eave toward a center or interior of the canopy.

### DISADVANTAGES OF THE PRIOR ART

The prior art have failed to solve many problems associated with collapsible popup, as follows:
1) No prior art mention or disclose any collapsible popup, having
   adjustable canopy 102.
   Therefore, the prior art of collapsible popup:
      a) Is not capable of protecting occupants and property users from weather elements;
      b) Is not capable of functioning as a greenhouse (see FIG. 3, FIG. 4, FIG. 138, and FIG. 139);
      c) Is not capable of functioning as a cover for a dog-run
         in the direction of arrow 169 (see FIG. 5, FIG. 6, FIG. 140, and FIG. 141);
      d) Is not capable of functioning as a surface for an advertisement sign (see FIG. 7, FIG. 8, FIG. 129, and FIG. 130);
      e) Is not capable of functioning as an awning cover (see FIG. 9, FIG. 10, FIG. 131, and FIG. 132); and
      f) Is not capable of functioning as ceiling-mounted overhead storage (see FIG. 11, FIG. 12, FIG. 133, and FIG. 134).
2) No prior art mention or disclose any collapsible popup, having
   dog-run-adaptable anti-wobbling foldable lower posts 107.
   Therefore, the prior art of collapsible popup:
      a) Is not capable of foldably and slidably raising and lowering to increase and decrease the height of the six-device-in-one robot-assembled arthritic-assisting noise-canceling friction-reducing dog-run-adaptable anti-wobbling gazebo; and
      b) Is not capable of supporting sidewalls of dog-run.
3) No prior art mention or disclose any collapsible popup, having
   top robot-assembled automatically-flaring-and-shielding-rivet-tail injury-preventing hammer-shields 114.
   Therefore, the prior art of collapsible popup:
      a) Is not capable of providing a limiting surface for robot-assembled heat-expandable cold-contractable anti-wobbling screws 117 to stop in the directions of arrows 171a, 171f, 171g, 171h, 171i, and 171j (see FIG. 145, FIG. 149, FIG. 150, and FIG. 153); and
      b) Is not capable of preventing injury by covering the robot-assembled heat-expandable cold-contractable interlocking cones 120.
4) No prior art mention or disclose any collapsible popup, having
   robot-assembled heat-expandable cold-contractable anti-wobbling screws 117.
   Therefore, the prior art of collapsible popup:
      a) Is not capable of saving manufacturing time by eliminating the need for nuts and bolts (see FIG. 146 (Prior Art), FIG. 155 (Prior Art), FIG. 162 (Prior Art), and FIG. 169 (Prior Art));
      b) Is not capable of saving manufacturing man-hours by robotically manufacturing
         in the directions of arrows 172a, 172b, 172c, and 172d (see FIG. 154, FIG. 158, FIG. 168, and FIG. 177);
      c) Is not capable of saving end-consumer assembly time by robotically pre-installing robot-assembled heat-expandable cold-contractable anti-wobbling screws 117, at the factory
         in the directions of arrows 172a, 172b, 172c, and 172d (see FIG. 154, FIG. 158, FIG. 168, and FIG. 177); and
      d) Is not capable of increasing overall production output of the six-device-in-one robot-assembled arthritic-assisting noise-canceling friction-reducing dog-run-adaptable anti-wobbling gazebo by robotically decreasing per-unit production time.
5) No prior art mention or disclose any collapsible popup, having
   robot-assembled heat-expandable cold-contractable spirally-threading spiral saws 118.
   Therefore, the prior art of collapsible popup:
      Is not capable of robotically and heatingly expanding and tapping threads into top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144).
6) No prior art mention or disclose any collapsible popup, having
   robot-assembled heat-expandable cold-contractable spiral-teeth 119.
   Therefore, the prior art of collapsible popup:
      Is not capable of robotically and speedily cutting through plastic connector material
         to decrease production time, and
         to increase production output
      in the directions of arrows 171a, 173a, and 173b (see FIG. 144).
7) No prior art mention or disclose any collapsible popup, having
   robot-assembled heat-expandable cold-contractable interlocking cones 120.
   Therefore, the prior art of collapsible popup:
      a) Is not capable of robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144);
      b) Is not capable of expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133 in the directions of arrows 171a, 173c, 173d, and 173e (see FIG. 145); and
      c) Is not capable of eliminating the need for the usage of nuts and bolts
         to robotically lessen the assembly time, and
         to robotically lessen assembly cost (see FIG. 146 (Prior Art), FIG. 155 (Prior Art), FIG. 162 (Prior Art), and FIG. 169 (Prior Art)).
8) No prior art mention or disclose any collapsible popup, having
   robot-assembled heat-expandable cold-contractable interlocking spiral locks 121.
   Therefore, the prior art of collapsible popup:
      a) Is not capable of robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144); and
      b) Is not capable of expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133 in the directions of arrows 171a, 173c, 173d, and 173e (see FIG. 145).
9) No prior art mention or disclose any collapsible popup, having
   central robot-assembled automatically-flaring-and-shielding-cone-head injury-preventing hammer-shields 125.
   Therefore, the prior art of collapsible popup:
      a) Is not capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place
         in the directions of arrows 174a, 174f, 174g, 174h, 174i, and 174j (see FIG. 156, FIG. 157, FIG. 159, FIG. 160, and FIG. 161); and
      b) Is not capable of preventing injury by coving the robot-assembled heat-expandable cold-contractable interlocking cones 120.
10) No prior art mention or disclose any collapsible popup, having
   upper robot-assembled automatically-flaring-and-shielding-cone-head injury-preventing hammer-shields 129.
   Therefore, the prior art of collapsible popup:
      a) Is not capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place; and
      b) Is not capable of preventing injury by coving the robot-assembled heat-expandable cold-contractable interlocking cones 120
         in the directions of arrows 175a, 175f, 175g, 175h, 175i, and 175j (see FIG. 163, FIG. 164, FIG. 165, FIG. 166, and FIG. 167).
11) No prior art mention or disclose any collapsible popup, having
   lower robot-assembled cone-shielding injury-preventing hammer-shields 133.
   Therefore, the prior art of collapsible popup:
      a) Is not capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place, and
      b) Is not capable of preventing injury by coving the robot-assembled heat-expandable cold-contractable interlocking cones 120
         in the directions of arrows 176a, 176f, 176g, 176h, 176i, and 176j (see FIG. 170, FIG. 171, FIG. 172, FIG. 173, FIG. 174, FIG. 175, and FIG. 176).
12) No prior art mention or disclose any collapsible popup, having
   lower robot-assembled arthritic-assisting height-adjusting dog-run-panel-rope hooks 134.
   Therefore, the prior art of collapsible popup:
      a) Is not capable of allowing an arthritic to deploy and retract the six-device-in-one robot-assembled arthritic-assisting noise-canceling friction-reducing dog-run-adaptable anti-wobbling gazebo without the need to close the hand
         in the directions of arrows 177a, 177b, 177c, 177d, 177e, and 177f (see FIG. 178, FIG. 179, and FIG. 180); and
      b) Is not capable of attaching a rope or strap to support a dog run in the direction of arrow 178 (see FIG. 181).
13) No prior art mention or disclose any collapsible popup, having
   sleeve robot-assembled post-centering clamps 143.
   Therefore, the prior art of collapsible popup:
      Is not capable of centering dog-run-adaptable anti-wobbling foldable lower posts 107 within dog-run-adaptable anti-wobbling foldable upper posts 106.
14) No prior art mention or disclose any collapsible popup, having
   sleeve robot-assembled tick-preventing downward teeth 144.
   Therefore, the prior art of collapsible popup:
      Is not capable of preventing ticks from getting inside dog-run-adaptable anti-wobbling foldable upper posts 106.
15) No prior art mention or disclose any collapsible popup, having
   sleeve robot-assembled water-discharging grooves 145.
   Therefore, the prior art of collapsible popup:
      Is not capable of allowing water to discharge out of dog-run-adaptable anti-wobbling foldable upper posts 106
      in the directions of arrows 181a and 181b (see FIG. 188).
16) No prior art mention or disclose any collapsible popup, having
   sleeve robot-assembled arthritic-assisting height-adjusting dog-run-panel-rope hooks 146.
   Therefore, the prior art of collapsible popup:
      a) Is not capable of allowing an arthritic to deploy and retract the six-device-in-one robot-assembled arthritic-assisting noise-canceling friction-reducing dog-run-adaptable anti-wobbling gazebo without bending the fingers (see FIG. 191); and
      b) Is not capable of attaching a rope or strap to support a dog run in the direction of arrow 182 (see FIG. 193).
17) No prior art mention or disclose any collapsible popup, having
   robot-assembled rust-preventing truss-end covers 154.
   Therefore, the prior art of collapsible popup:
      a) Is not capable of eliminating the need for nuts and bolts
         to save manufacturing cost,
         to save manufacturing time,
         to save end-user assembly time, and
         to increase overall production output;
      b) Is not capable of eliminating the need for washers
         to save manufacturing cost,
         to save manufacturing time,
         to save end-user assembly time, and
         to increase overall production output;
      c) Is not capable of eliminating the need for 50 truss-end-plugs, from prior art
         to save manufacturing cost,
         to save manufacturing time,
         to save end-user assembly time, and
         to increase overall production output;
      d) Is not capable of preventing water and insects from entering into dog-run-adaptable anti-wobbling foldable corner trusses 104; and
      e) Is not capable of preventing injury by covering sharp metal edges.
18) No prior art mention or disclose any collapsible popup, having
   robot-assembled heat-expandable cold-contractable double-tail cover-cushion rivets 157.
   Therefore, the prior art of collapsible popup:
      a) Is not capable of decreasing assembly man hours by being robotically factory-installed;
      b) Is not capable of decreasing end-user assembly time by being robotically factory-installed;
      c) Is not capable of eliminating need for washers;
      d) Is not capable of creating a locking ridge when robotically heat-stamped eliminating need for nuts and bolts
         in the directions of arrows 185a, 185b, 185c, and 185d (see FIG. 197, FIG. 198, and FIG. 199); and
      e) Is not capable of creating a locking ridge when robotically heat-stamped securely and pivotably locking two dog-run-adaptable anti-wobbling foldable side trusses 105 together
         in the directions of arrows 185a, 185b, 185c, and 185d (see FIG. 197, FIG. 198, and FIG. 199).
19) No prior art mention or disclose any collapsible popup, having
   robot-assembled noise-canceling cup-cushion 159.
   Therefore, the prior art of collapsible popup:
      a) Is not capable of eliminating the need for nuts and bolts
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      b) Is not capable of eliminating the need for washers
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      c) Is not capable of eliminating the need for 50 truss-end-plugs, from prior art
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      d) Is not capable of preventing water and insects from entering into dog-run-adaptable anti-wobbling foldable corner trusses 104; and
      e) Is not capable of preventing injury by covering sharp metal edges.
20) No prior art mention or disclose any collapsible popup, having
   robot-assembled noise-canceling circular-cushion 162.
   Therefore, the prior art of collapsible popup:
      a) Is not capable of providing a washer between two dog-run-adaptable anti-wobbling foldable side trusses 105;
      b) Is not capable of pivotably connecting two dog-run-adaptable anti-wobbling foldable side trusses 105 together;
      c) Is not capable of eliminating the need for nuts and bolts
         to save manufacturing cost,
         to save manufacturing time,
         to save end-user assembly time, and
         to increase overall production output
         in the directions of arrows 187a, 187b, 187c, 187d, 187e, and 186f (see FIG. 207, FIG. 208, FIG. 209, and FIG. 210); and
      d) Is not capable of eliminating the need for washers
         to save manufacturing cost,
         to save manufacturing time,
         to save end-user assembly time, and
         to increase overall production output
         in the directions of arrows 187a, 187b, 187c, 187d, 187e, and 186f (see FIG. 207, FIG. 208, FIG. 209, and FIG. 210).
21) No prior art mention or disclose any collapsible popup, having
   robot-assembled double-tail built-in circular-cushion rivets 163.
   Therefore, the prior art of collapsible popup:
      a) Is not capable of pivotably connecting two dog-run-adaptable anti-wobbling foldable side trusses 105 together;
      b) Is not capable of being robotically installed to lessen the assembly man hours
         in the directions of arrows 187a, 187b, 187c, 187d, 187e, and 186f (see FIG. 207, FIG. 208, FIG. 209, and FIG. 210);
      c) Is not capable of being robotically installed to lessen end-user assembly time
         in the directions of arrows 187a, 187b, 187c, 187d, 187e, and 186f (see FIG. 207, FIG. 208, FIG. 209, and FIG. 210); and
      d) Is not capable of being robotically heat-stamped automatically creating a locking ridge eliminating the need for nuts
         in the directions of arrows 187a, 187b, 187c, 187d, 187e, and 186f (see FIG. 207, FIG. 208, FIG. 209, and FIG. 210).

### Objects and Advantages of the Invention

The present invention substantially departs from the conventional concepts and designs of the prior art. In doing so, the present invention provides the six-device-in-one robot-assembled arthritic-assisting noise-canceling friction-reducing dog-run-adaptable anti-wobbling gazebo, having many unique and significant features, functions, and advantages, which overcome all the disadvantages of the prior art, as follows:
1) It is an object of the new invention to provide a six-device-in-one robot-assembled arthritic-assisting noise-canceling friction-reducing dog-run-adaptable anti-wobbling gazebo, having
   adjustable canopy 102.
   Therefore, the six-device-in-one robot-assembled arthritic-assisting noise-canceling friction-reducing dog-run-adaptable anti-wobbling gazebo:
      a) Is capable of protecting occupants and property users from weather elements;
      b) Is capable of functioning as a greenhouse (see FIG. 3, FIG. 4, FIG. 138, and FIG. 139);
      c) Is capable of functioning as a cover for a dog-run in the direction of arrow 169 (see FIG. 5, FIG. 6, FIG. 140, and FIG. 141);
      d) Is capable of functioning as a surface for an advertisement sign (see FIG. 7, FIG. 8, FIG. 129, and FIG. 130);
      e) Is capable of functioning as an awning cover (see FIG. 9, FIG. 10, FIG. 131, and FIG. 132); and
      f) Is capable of functioning as ceiling-mounted overhead storage (see FIG. 11, FIG. 12, FIG. 133, and FIG. 134).
2) It is another object of the new invention to provide a six-device-in-one robot-assembled arthritic-assisting noise-canceling friction-reducing dog-run-adaptable anti-wobbling gazebo, having
   dog-run-adaptable anti-wobbling foldable lower posts 107.
   Therefore, the six-device-in-one robot-assembled arthritic-assisting noise-canceling friction-reducing dog-run-adaptable anti-wobbling gazebo:
      a) Is capable of foldably and slidably raising and lowering to increase and decrease the height of the six-device-in-one robot-assembled arthritic-assisting noise-canceling friction-reducing dog-run-adaptable anti-wobbling gazebo; and
      b) Is capable of supporting sidewalls of dog-run.
3) It is another object of the new invention to provide a six-device-in-one robot-assembled arthritic-assisting noise-canceling friction-reducing dog-run-adaptable anti-wobbling gazebo, having
   top robot-assembled automatically-flaring-and-shielding-rivet-tail injury-preventing hammer-shields 114.
   Therefore, the six-device-in-one robot-assembled arthritic-assisting noise-canceling friction-reducing dog-run-adaptable anti-wobbling gazebo:
      a) Is capable of providing a limiting surface for robot-assembled heat-expandable cold-contractable anti-wobbling screws 117 to stop in the directions of arrows 171a, 171f, 171g, 171h, 171i, and 171j (see FIG. 145, FIG. 149, FIG. 150, and FIG. 153); and
      b) Is capable of preventing injury by covering the robot-assembled heat-expandable cold-contractable interlocking cones 120.
4) It is a further object of the new invention to provide a six-device-in-one robot-assembled arthritic-assisting noise-canceling friction-reducing dog-run-adaptable anti-wobbling gazebo, having
   robot-assembled heat-expandable cold-contractable anti-wobbling screws 117.
   Therefore, the six-device-in-one robot-assembled arthritic-assisting noise-canceling friction-reducing dog-run-adaptable anti-wobbling gazebo:
      a) Is capable of saving manufacturing time by eliminating the need for nuts and bolts (see FIG. 146 (Prior Art), FIG. 155 (Prior Art), FIG. 162 (Prior Art), and FIG. 169 (Prior Art));
      b) Is capable of saving manufacturing man-hours by robotically manufacturing
         in the directions of arrows 172a, 172b, 172c, and 172d (see FIG. 154, FIG. 158, FIG. 168, and FIG. 177);
      c) Is capable of saving end-consumer assembly time by robotically pre-installing robot-assembled heat-expandable cold-contractable anti-wobbling screws 117, at the factory
         in the directions of arrows 172a, 172b, 172c, and 172d (see FIG. 154, FIG. 158, FIG. 168, and FIG. 177); and
      d) Is capable of increasing overall production output of the six-device-in-one robot-assembled arthritic-assisting noise-canceling friction-reducing dog-run-adaptable anti-wobbling gazebo by robotically decreasing per-unit production time.
5) It is an even further object of the new invention to provide a six-device-in-one robot-assembled arthritic-assisting noise-canceling friction-reducing dog-run-adaptable anti-wobbling gazebo, having
   robot-assembled heat-expandable cold-contractable spirally-threading spiral saws 118.
   Therefore, the six-device-in-one robot-assembled arthritic-assisting noise-canceling friction-reducing dog-run-adaptable anti-wobbling gazebo:
      Is capable of robotically and heatingly expanding and tapping threads into top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144).
6) It is another object of the new invention to provide a six-device-in-one robot-assembled arthritic-assisting noise-canceling friction-reducing dog-run-adaptable anti-wobbling gazebo, having
   robot-assembled heat-expandable cold-contractable spiral-teeth 119.
   Therefore, the six-device-in-one robot-assembled arthritic-assisting noise-canceling friction-reducing dog-run-adaptable anti-wobbling gazebo:
      Is capable of robotically and speedily cutting through plastic connector material
         to decrease production time, and
         to increase production output
      in the directions of arrows 171a, 173a, and 173b (see FIG. 144).
7) It is yet another object of the new invention to provide a six-device-in-one robot-assembled arthritic-assisting noise-canceling friction-reducing dog-run-adaptable anti-wobbling gazebo, having
   robot-assembled heat-expandable cold-contractable interlocking cones 120.
   Therefore, the six-device-in-one robot-assembled arthritic-assisting noise-canceling friction-reducing dog-run-adaptable anti-wobbling gazebo:
      a) Is capable of robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144);
      b) Is capable of expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133 in the directions of arrows 171a, 173c, 173d, and 173e (see FIG. 145); and
      c) Is capable of eliminating the need for the usage of nuts and bolts
         to robotically lessen the assembly time, and
         to robotically lessen assembly cost (see FIG. 146 (Prior Art), FIG. 155 (Prior Art), FIG. 162 (Prior Art), and FIG. 169 (Prior Art)).
8) It is still yet another object of the new invention to provide a six-device-in-one robot-assembled arthritic-assisting noise-canceling friction-reducing dog-run-adaptable anti-wobbling gazebo, having
   robot-assembled heat-expandable cold-contractable interlocking spiral locks 121.
   Therefore, the six-device-in-one robot-assembled arthritic-assisting noise-canceling friction-reducing dog-run-adaptable anti-wobbling gazebo:
      a) Is capable of robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132
         in the directions of arrows 171a, 173a, and 173b (see FIG. 144); and
      b) Is capable of expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133
         in the directions of arrows 171a, 173c, 173d, and 173e (see FIG. 145).
9) It is still yet an even further object of the new invention to provide a six-device-in-one robot-assembled arthritic-assisting noise-canceling friction-reducing dog-run-adaptable anti-wobbling gazebo, having
   central robot-assembled automatically-flaring-and-shielding-cone-head injury-preventing hammer-shields 125.
   Therefore, the six-device-in-one robot-assembled arthritic-assisting noise-canceling friction-reducing dog-run-adaptable anti-wobbling gazebo:
      a) Is capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place
         in the directions of arrows 174a, 174f, 174g, 174h, 174i, and 174j (see FIG. 156, FIG. 157, FIG. 159, FIG. 160, and FIG. 161); and
      b) Is capable of preventing injury by coving the robot-assembled heat-expandable cold-contractable interlocking cones 120.
10) It is still yet an even further object of the new invention to provide a six-device-in-one robot-assembled arthritic-assisting noise-canceling friction-reducing dog-run-adaptable anti-wobbling gazebo, having
   upper robot-assembled automatically-flaring-and-shielding-cone-head injury-preventing hammer-shields 129.
   Therefore, the six-device-in-one robot-assembled arthritic-assisting noise-canceling friction-reducing dog-run-adaptable anti-wobbling gazebo:
      a) Is capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place; and
      b) Is capable of preventing injury by coving the robot-assembled heat-expandable cold-contractable interlocking cones 120 in the directions of arrows 175a, 175f, 175g, 175h, 175i, and 175j (see FIG. 163, FIG. 164, FIG. 165, FIG. 166, and FIG. 167).
11) It is still yet an even further object of the new invention to provide a six-device-in-one robot-assembled arthritic-assisting noise-canceling friction-reducing dog-run-adaptable anti-wobbling gazebo, having
   lower robot-assembled cone-shielding injury-preventing hammer-shields 133.
   Therefore, the six-device-in-one robot-assembled arthritic-assisting noise-canceling friction-reducing dog-run-adaptable anti-wobbling gazebo:
      a) Is capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place, and
      b) Is capable of preventing injury by coving the robot-assembled heat-expandable cold-contractable interlocking cones 120
         in the directions of arrows 176a, 176f, 176g, 176h, 176i, and 176j (see FIG. 170, FIG. 171, FIG. 172, FIG. 173, FIG. 174, FIG. 175, and FIG. 176).
12) It is still yet an even further object of the new invention to provide a six-device-in-one robot-assembled arthritic-assisting noise-canceling friction-reducing dog-run-adaptable anti-wobbling gazebo, having
   lower robot-assembled arthritic-assisting height-adjusting dog-run-panel-rope hooks 134.
   Therefore, the six-device-in-one robot-assembled arthritic-assisting noise-canceling friction-reducing dog-run-adaptable anti-wobbling gazebo:
      a) Is capable of allowing an arthritic to deploy and retract the six-device-in-one robot-assembled arthritic-assisting noise-canceling friction-reducing dog-run-adaptable anti-wobbling gazebo without the need to close the hand
         in the directions of arrows 177a, 177b, 177c, 177d, 177e, and 177f (see FIG. 178, FIG. 179, and FIG. 180); and
      b) Is capable of attaching a rope or strap to support a dog run
         in the direction of arrow 178 (see FIG. 181).
13) It is still yet an even further object of the new invention to provide a six-device-in-one robot-assembled arthritic-assisting noise-canceling friction-reducing dog-run-adaptable anti-wobbling gazebo, having
   sleeve robot-assembled post-centering clamps 143.
   Therefore, the six-device-in-one robot-assembled arthritic-assisting noise-canceling friction-reducing dog-run-adaptable anti-wobbling gazebo:
      Is capable of centering dog-run-adaptable anti-wobbling foldable lower posts 107 within dog-run-adaptable anti-wobbling foldable upper posts 106.
14) It is still yet an even further object of the new invention to provide a six-device-in-one robot-assembled arthritic-assisting noise-canceling friction-reducing dog-run-adaptable anti-wobbling gazebo, having
   sleeve robot-assembled tick-preventing downward teeth 144.
   Therefore, the six-device-in-one robot-assembled arthritic-assisting noise-canceling friction-reducing dog-run-adaptable anti-wobbling gazebo:
      Is capable of preventing ticks from getting inside dog-run-adaptable anti-wobbling foldable upper posts 106.
15) It is still yet an even further object of the new invention to provide a six-device-in-one robot-assembled arthritic-assisting noise-canceling friction-reducing dog-run-adaptable anti-wobbling gazebo, having
   sleeve robot-assembled water-discharging grooves 145.
   Therefore, the six-device-in-one robot-assembled arthritic-assisting noise-canceling friction-reducing dog-run-adaptable anti-wobbling gazebo:
      Is capable of allowing water to discharge out of dog-run-adaptable anti-wobbling foldable upper posts 106
         in the directions of arrows 181a and 181b (see FIG. 188).
16) It is still yet an even further object of the new invention to provide a six-device-in-one robot-assembled arthritic-assisting noise-canceling friction-reducing dog-run-adaptable anti-wobbling gazebo, having
   sleeve robot-assembled arthritic-assisting height-adjusting dog-run-panel-rope hooks 146.
   Therefore, the six-device-in-one robot-assembled arthritic-assisting noise-canceling friction-reducing dog-run-adaptable anti-wobbling gazebo:
      a) Is capable of allowing an arthritic to deploy and retract the six-device-in-one robot-assembled arthritic-assisting noise-canceling friction-reducing dog-run-adaptable anti-wobbling gazebo without bending the fingers (see FIG. 191); and
      b) Is capable of attaching a rope or strap to support a dog run in the direction of arrow 182 (see FIG. 193).
17) It is still yet an even further object of the new invention to provide a six-device-in-one robot-assembled arthritic-assisting noise-canceling friction-reducing dog-run-adaptable anti-wobbling gazebo, having
   robot-assembled rust-preventing truss-end covers 154.
   Therefore, the six-device-in-one robot-assembled arthritic-assisting noise-canceling friction-reducing dog-run-adaptable anti-wobbling gazebo:
      a) Is capable of eliminating the need for nuts and bolts
         to save manufacturing cost,
         to save manufacturing time,
         to save end-user assembly time, and
         to increase overall production output;
      b) Is capable of eliminating the need for washers
         to save manufacturing cost,
         to save manufacturing time,
         to save end-user assembly time, and
         to increase overall production output;
      c) Is capable of eliminating the need for 50 truss-end-plugs, from prior art to save manufacturing cost, to save manufacturing time, to save end-user assembly time, and to increase overall production output;
      d) Is capable of preventing water and insects from entering into dog-run-adaptable anti-wobbling foldable corner trusses 104; and
      e) Is capable of preventing injury by covering sharp metal edges.
18) It is still yet an even further object of the new invention to provide a six-device-in-one robot-assembled arthritic-assisting noise-canceling friction-reducing dog-run-adaptable anti-wobbling gazebo, having
   robot-assembled heat-expandable cold-contractable double-tail cover-cushion rivets 157.
   Therefore, the six-device-in-one robot-assembled arthritic-assisting noise-canceling friction-reducing dog-run-adaptable anti-wobbling gazebo:
      a) Is capable of decreasing assembly man hours by being robotically factory-installed;
      b) Is capable of decreasing end-user assembly time by being robotically factory-installed;
      c) Is capable of eliminating need for washers;
      d) Is capable of creating a locking ridge when robotically heat-stamped eliminating need for nuts and bolts
         in the directions of arrows 185a, 185b, 185c, and 185d (see FIG. 197, FIG. 198, and FIG. 199); and
      e) Is capable of creating a locking ridge when robotically heat-stamped securely and pivotably locking two dog-run-adaptable anti-wobbling foldable side trusses 105 together
         in the directions of arrows 185a, 185b, 185c, and 185d (see FIG. 197, FIG. 198, and FIG. 199).
19) It is still yet an even further object of the new invention to provide a six-device-in-one robot-assembled arthritic-assisting noise-canceling friction-reducing dog-run-adaptable anti-wobbling gazebo, having
   robot-assembled noise-canceling cup-cushion 159.
   Therefore, the six-device-in-one robot-assembled arthritic-assisting noise-canceling friction-reducing dog-run-adaptable anti-wobbling gazebo:
      a) Is capable of eliminating the need for nuts and bolts
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      b) Is capable of eliminating the need for washers
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      c) Is capable of eliminating the need for 50 truss-end-plugs, from prior art to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      d) Is capable of preventing water and insects from entering into dog-run-adaptable anti-wobbling foldable corner trusses 104; and
      e) Is capable of preventing injury by covering sharp metal edges.
20) It is still yet an even further object of the new invention to provide a six-device-in-one robot-assembled arthritic-assisting noise-canceling friction-reducing dog-run-adaptable anti-wobbling gazebo, having
   robot-assembled noise-canceling circular-cushion 162.
   Therefore, the six-device-in-one robot-assembled arthritic-assisting noise-canceling friction-reducing dog-run-adaptable anti-wobbling gazebo:
      a) Is capable of providing a washer between two dog-run-adaptable anti-wobbling foldable side trusses 105;
      b) Is capable of pivotably connecting two dog-run-adaptable anti-wobbling foldable side trusses 105 together;
      c) Is capable of eliminating the need for nuts and bolts
         to save manufacturing cost,
         to save manufacturing time,
         to save end-user assembly time, and
         to increase overall production output
         in the directions of arrows 187a, 187b, 187c, 187d, 187e, and 186f (see FIG. 207, FIG. 208, FIG. 209, and FIG. 210); and
      d) Is capable of eliminating the need for washers
         to save manufacturing cost,
         to save manufacturing time,
         to save end-user assembly time, and
         to increase overall production output
         in the directions of arrows 187a, 187b, 187c, 187d, 187e, and 186f (see FIG. 207, FIG. 208, FIG. 209, and FIG. 210).
21) It is still yet an even further object of the new invention to provide a six-device-in-one robot-assembled arthritic-assisting noise-canceling friction-reducing dog-run-adaptable anti-wobbling gazebo, having
   robot-assembled double-tail built-in circular-cushion rivets 163.
   Therefore, the six-device-in-one robot-assembled arthritic-assisting noise-canceling friction-reducing dog-run-adaptable anti-wobbling gazebo:
      a) Is capable of pivotably connecting two dog-run-adaptable anti-wobbling foldable side trusses 105 together;
      b) Is capable of being robotically installed to lessen the assembly man hours in the directions of arrows 187a, 187b, 187c, 187d, 187e, and 186f (see FIG. 207, FIG. 208, FIG. 209, and FIG. 210);
      c) Is capable of being robotically installed to lessen end-user assembly time
         in the directions of arrows 187a, 187b, 187c, 187d, 187e, and 186f (see FIG. 207, FIG. 208, FIG. 209, and FIG. 210); and
      d) Is capable of being robotically heat-stamped automatically creating a locking ridge eliminating the need for nuts
         in the directions of arrows 187a, 187b, 187c, 187d, 187e, and 186f (see FIG. 207, FIG. 208, FIG. 209, and FIG. 210).

Other objects and advantages of the present invention will become apparent from a consideration of the accompanying drawings and ensuing description.

### SUMMARY OF THE INVENTION

A six-device-in-one robot-assembled arthritic-assisting noise-canceling friction-reducing dog-run-adaptable anti-wobbling gazebo comprises:
an adjustable canopy for protecting occupants and property users from weather elements and functioning as a greenhouse and a cover for a dog-run and a surface for an advertisement sign and an awning cover and ceiling-mounted overhead storage, foldable top trusses, foldable corner trusses robotically attached to the foldable top trusses, foldable side trusses, foldable upper posts, foldable lower posts slidably inserted within the foldable upper posts for supporting sidewalls of a dog-run, feet robotically welded to the foldable lower posts, foot holes robotically drilled into the feet, truss holes robotically drilled into the foldable top trusses, the foldable corner trusses, and the foldable side trusses, robot-assembled screws robotically inserted into top robot-assembled holes and central robot-assembled holes and upper robot-assembled holes and lower robot-assembled holes for saving manufacturing time by eliminating need for nuts and bolts and manufacturing man-hours by robotically manufacturing and end-consumer assembly time by robotically pre-installing the screws at factories and increasing overall production output of the gazebo, robot-assembled spiral saws formed to the robot-assembled screws, robot-assembled spiral-teeth formed to the robot-assembled spiral saws, robot-assembled interlocking cones formed to the robot-assembled screws, robot-assembled interlocking locks formed to the robot-assembled interlocking cones, top robot-assembled connectors robotically heated up to expand and robotically heat-riveted to the foldable top trusses, top robot-assembled holes robotically heated up to expand and robotically molded in the top robot-assembled connectors, top robot-assembled hammer-shields robotically heated up to expand and robotically molded on the top robot-assembled connectors covering at least one of the top robot-assembled holes, top robot-assembled double-tail rivets robotically heated up to expand and robotically heat-hammered through the robot-assembled holes against the robot-assembled hammer-shields such that the hammer-shields automatically bend the top double-tail rivets to secure the top robot-assembled connectors to the top trusses and automatically shield the top double-tail rivets, at least one central robot-assembled intersector robotically heated up to expand and robotically heat-screwed to the foldable top trusses, central robot-assembled holes robotically heated up to expand and robotically molded in the central robot-assembled intersector and the robot-assembled screws robotically heated up to expand and inserted into the central robot-assembled holes, central robot-assembled hammer-shields robotically heated up to expand and robotically molded on the central robot-assembled intersectors to cover at least one of the central robot-assembled holes for automatically stopping the robot-assembled screws allowing the robot-assembled interlocking cones and the robot-assembled interlocking locks to expand and lock into place and preventing injury by coving said robot-assembled interlocking cones, upper robot-assembled intersectors robotically heated up to expand and robotically heat-screwed to the foldable top trusses, the foldable side trusses, and robotically assembled to the foldable upper posts, upper robot-assembled holes robotically heated up to expand and robotically molded in the upper robot-assembled intersectors, the robot-assembled screws robotically heated up to expand and inserted into the upper robot-assembled holes, upper robot-assembled hammer-shields robotically heated up to expand and robotically molded on the upper robot-assembled intersectors to cover at least one of the upper robot-assembled holes robot-assembled interlocking cones and said robot-assembled heat-expandable cold-contractable interlocking spiral locks for robotically and heatingly boring through the top robot-assembled heat-expandable cold-contractable holes and expanding and locking when impacted by the top robot-assembled hammer-shields and eliminating need for nuts and bolts to robotically lessen manufacturing time and assembly cost, lower robot-assembled intersectors robotically heated up to expand and robotically heat-screwed to the foldable corner trusses, the foldable side trusses, and robotically and slidably attached to the foldable upper posts, lower robot-assembled holes robotically heated up to expand and robotically molded in the lower robot-assembled intersectors, to cover at least one of the lower robot-assembled holes, the robot-assembled screws robotically heated up to expand and inserted into the lower robot-assembled holes, lower robot-assembled hammer-shields robotically heated up to expand and robotically molded on the lower robot-assembled intersectors to cover at least one of the lower robot-assembled holes for automatically stopping the robot-assembled screws allowing the robot-assembled interlocking cones and the robot-assembled interlocking locks to expand and lock into place and preventing injury by coving said robot-assembled interlocking cones, lower robot-assembled height-adjusting hooks robotically and pivotably secured to the lower robot-assembled intersectors, lower robot-assembled height-adjusting nipples robotically and pivotably secured to the lower robot-assembled height-adjusting hooks, lower robot-assembled nipple tips robotically inserted within the lower robot-assembled height-adjusting nipples, lower robot-assembled nipple-securing pins robotically heated up to expand and robotically heat-pressed through the lower robot-assembled height-adjusting hooks and through the lower robot-assembled height-adjusting nipples, lower robot-assembled hook-securing pins robotically heated up to expand and robotically heat-pressed into the lower robot-assembled intersectors and through the lower robot-assembled height-adjusting hooks, a lower robot-assembled hook spring robotically springingly inserted between the lower robot-assembled intersectors and the lower robot-assembled height-adjusting hooks, lower robot-assembled tunnels robotically molded into the lower robot-assembled intersectors, robot-assembled sleeves robotically assembled to the foldable upper posts, sleeve robot-assembled clamps robotically molded to the robot-assembled sleeves, sleeve robot-assembled downward teeth robotically molded to the sleeve robot-assembled clamps, sleeve robot-assembled grooves robotically molded into the sleeve robot-assembled clamps, sleeve robot-assembled height-adjusting hooks robotically and pivotably secured to the robot-assembled sleeves, sleeve robot-assembled jacks robotically assembled to the sleeve robot-assembled height-adjusting hooks, sleeve robot-assembled grooved nipples robotically formed to the sleeve robot-assembled jacks, sleeve robot-assembled jack-securing pins robotically heated up to expand and robotically heat-pressed through the sleeve robot-assembled height-adjusting hooks and through the sleeve robot-assembled jacks, sleeve robot-assembled hook-securing pins robotically heated up to expand and robotically heat-pressed into the robot-assembled sleeves and through the sleeve robot-assembled height-adjusting hooks, a sleeve robot-assembled hook spring robotically springingly inserted between the robot-assembled sleeves and the robot-assembled height-adjusting hooks, sleeve robot-assembled flower-shaped nipple-centering holes robotically molded into the robot-assembled sleeves, robot-assembled truss-end covers and a robot-assembled cup-cushion each robotically assembled to the foldable corner trusses for eliminating need for nuts and bolts to save manufacturing cost and manufacturing time and end-user assembly time and increase overall production output, and eliminating need for washers to save manufacturing cost and end-user assembly time and increase overall production output, and eliminating need for 50 truss-end plugs from prior art gazebos save manufacturing cost and time and end-user assembly time and increase overall production output, and preventing water and insects from entering into the foldable corner trusses and for preventing injury by covering sharp metal edges, a robot-assembled cover-cushion robotically formed to the robot-assembled truss-end covers, robot-assembled cover-cushion edges robotically formed to the robot-assembled cover-cushion, robot-assembled double-tail cover-cushion rivets robotically heated up to expand and robotically heat-hammered through the robot-assembled truss-end covers automatically bend the robot-assembled double-tail cover-cushion rivets to secure the robot-assembled double-tail cover-cushion rivets to the foldable corner trusses, and automatically shield the robot-assembled double-tail cover-cushion rivets for decreasing assembly man hours by being robotically factory-installed and end-user assembly time by being robotically factory-installed and eliminating need for washers and creating locking ridge when robotically heat-stamped eliminating need for nuts and bolts and locking two foldable side trusses together, cup-cushion edges robotically formed into the robot-assembled cup-cushion, a robot-assembled circular-cushion robotically assembled to the foldable side trusses, and robot-assembled circular-cushion rivets robotically formed into the robot-assembled circular-cushion for pivotably connecting two foldable side trusses together and being robotically installed to lessen assembly man hours and end-user assembly time and being robotically heat-stamped to automatically create a locking ridge eliminating need for nuts and bolts.

### BRIEF DESCRIPTION OF THE DRAWINGS

FIG. 1, FIG. 2, FIG. 3, FIG. 4, FIG. 5, FIG. 6A, FIG. 6B, FIG. 7, FIG. 8, FIG. 9, FIG. 10, FIG. 11, and FIG. 12 illustrate perspective, side, top views of various assemblies and functions of the six-device-in-one robot-assembled arthritic-assisting noise-canceling friction-reducing dog-run-adaptable anti-wobbling gazebo.

FIG. 13 and FIG. 14 illustrate perspective views of robot-assembled heat-expandable cold-contractable anti-wobbling screws.

FIG. 15, FIG. 16, FIG. 17, FIG. 18, FIG. 19, and FIG. 20 illustrate perspective view of robot-assembled automatically-making-rivet-tail-flare noise-canceling injury-preventing top-connector system and its components.

FIG. 21 (Prior Art) illustrates a perspective view of prior art of robot-assembled automatically-making-rivet-tail-flare noise-canceling injury-preventing top-connector system.

FIG. 22, FIG. 23, FIG. 24, FIG. 25, FIG. 26, and FIG. 27 illustrate cross-sectional views of robot-assembled automatically-making-rivet-tail-flare noise-canceling injury-preventing top-connector system demonstrating how robot-assembled heat-expandable cold-contractable anti-wobbling screws are inserted therein.

FIG. 22 illustrates a perspective view of how robot-assembled automatically-making-rivet-tail-flare noise-canceling injury-preventing top-connector system is robotically manufactured.

FIG. 28, FIG. 29, and FIG. 30 illustrate perspective views of dog-run-adaptable anti-wobbling foldable corner trusses 104.

FIG. 31, FIG. 32, FIG. 33, FIG. 34, FIG. 35, FIG. 36, and FIG. 37 illustrate perspective views of robot-assembled injury-preventing cone-shielding central intersector system.

FIG. 38 (Prior Art) illustrates a perspective view of prior art of robot-assembled injury-preventing cone-shielding central intersector system.

FIG. 39 illustrates a perspective view of robot-assembled injury-preventing cone-shielding central intersector system 122 demonstrating how robot-assembled heat-expandable cold-contractable anti-wobbling screws are inserted therein.

FIG. 40, FIG. 41, and FIG. 42 illustrate cross-sectional views of robot-assembled injury-preventing cone-shielding central intersector system demonstrating how robot-assembled heat-expandable cold-contractable anti-wobbling screws are inserted therein.

FIG. 43 illustrates a perspective view of how robot-assembled injury-preventing cone-shielding central intersector system is robotically manufactured.

FIG. 44, and FIG. 45 illustrate perspective views of robot-assembled injury-preventing cone-shielding central intersector system.

FIG. 46, FIG. 47, FIG. 48, FIG. 49, FIG. 50, and FIG. 51 illustrate perspective views of robot-assembled injury-preventing cone-shielding upper intersector system.

FIG. 52 (Prior Art) illustrates a perspective view of prior art of robot-assembled injury-preventing cone-shielding upper intersector system.

FIG. 53, FIG. 54, FIG. 55, FIG. 56, FIG. 57, FIG. 58, and FIG. 59 illustrate cross-sectional views of robot-assembled injury-preventing cone-shielding upper intersector system demonstrating how robot-assembled heat-expandable cold-contractable anti-wobbling screws are inserted therein.

FIG. 60 illustrates a perspective view of how robot-assembled injury-preventing cone-shielding upper intersector system is robotically manufactured.

FIG. 61 illustrates a perspective view of robot-assembled arthritic-assisting injury-preventing cone-shielding lower intersector system.

FIG. 62, and FIG. 63 illustrate perspective views of lower robot-assembled hook spring.

FIG. 64, and FIG. 65 illustrate perspective views of lower robot-assembled self-securing nipple-securing pins and lower robot-assembled self-securing hook-securing pins, respectively.

FIG. 66 illustrates a cross-sectional view of robot-assembled arthritic-assisting injury-preventing cone-shielding lower intersector system.

FIG. 67 (Prior Art) illustrates a perspective view of prior art of robot-assembled arthritic-assisting injury-preventing cone-shielding lower intersector system.

FIG. 68, FIG. 69, FIG. 70, FIG. 71, and FIG. 72 illustrate cross-sectional views of robot-assembled arthritic-assisting injury-preventing cone-shielding lower intersector system demonstrating how robot-assembled heat-expandable cold-contractable anti-wobbling screws are inserted therein.

FIG. 73 illustrates a perspective view of how robot-assembled arthritic-assisting injury-preventing cone-shielding lower intersector system is robotically manufactured.

FIG. 74 illustrates a perspective view demonstrating how an arthritic can operate lower robot-assembled arthritic-assisting height-adjusting dog-run-panel-rope hooks without the need to close the hand.

FIG. 75, FIG. 76, FIG. 77, FIG. 78, FIG. 79, FIG. 80, and FIG. 81 illustrate perspective views demonstrating components of robot-assembled arthritic-assisting injury-preventing post-centering tick-preventing water-discharging sleeve system.

FIG. 82 and FIG. 83 illustrate perspective views demonstrating the assembly of robot-assembled arthritic-assisting injury-preventing post-centering tick-preventing water-discharging sleeve system.

FIG. 84 and FIG. 85 illustrate front and side views of sleeve robot-assembled arthritic-assisting height-adjusting dog-run-panel-rope hooks.

FIG. 86 and FIG. 87 illustrate cross-sectional views demonstrating sleeve robot-assembled post-centering clamps, sleeve robot-assembled tick-preventing downward teeth, and sleeve robot-assembled water-discharging grooves.

FIG. 88 and FIG. 89 illustrate perspective views demonstrating the assembly of robot-assembled arthritic-assisting injury-preventing post-centering tick-preventing water-discharging sleeve system.

FIG. 90 illustrates a perspective view demonstrating how an arthritic can operate sleeve robot-assembled arthritic-assisting height-adjusting dog-run-panel-rope hooks without the need to close the hand.

FIG. 91, FIG. 92, FIG. 93, and FIG. 94 illustrate perspective views of top robot-assembled heat-expandable cold-contractable double-tail rivets and robot-assembled heat-expandable cold-contractable double-tail cover-cushion rivets, respectively.

FIG. 95, FIG. 96, and FIG. 97 illustrate perspective views of robot-assembled noise-canceling injury-preventing rust-preventing truss-centering cover-cushion system.

FIG. 98 illustrates a cross-sectional view of robot-assembled noise-canceling injury-preventing rust-preventing truss-centering cover-cushion system.

FIG. 99 and FIG. 100 illustrate cross-sectional and perspective views of how robot-assembled noise-canceling injury-preventing rust-preventing truss-centering cover-cushion system is robotically installed.

FIG. 101 and FIG. 102 illustrate perspective views of robot-assembled arthritic-assisting noise-canceling injury-preventing rust-preventing truss-centering cup-cushion system.

FIG. 103 (Prior Art) illustrates a perspective view of prior art demonstrating how screws, washers and nuts are used for assembly.

FIG. 104, FIG. 105, FIG. 106, FIG. 107, and FIG. 108 illustrate perspective views of robot-assembled arthritic-assisting noise-canceling injury-preventing rust-preventing truss-centering cup-cushion system, its components and assembly.

FIG. 109 illustrates a perspective view of how robot-assembled arthritic-assisting injury-preventing cone-shielding lower intersector system is robotically manufactured.

FIG. 110 and FIG. 111 illustrate cross-sectional views demonstrating how a manufacturing robot is used to heat-press robot-assembled heat-expandable cold-contractable double-tail cover-cushion rivets to lock them in place.

FIG. 112, FIG. 113, FIG. 114, and FIG. 115 illustrate perspective views demonstrating the various components of robot-assembled arthritic-assisting noise-canceling circular-cushion system and the assembly thereof.

FIG. 116 and FIG. 117 illustrate cross-sectional views demonstrating how a manufacturing robot is used to heat-press robot-assembled double-tail built-in circular-cushion rivets to lock them in place.

FIG. 118 illustrates a perspective view of how Robot-assembled arthritic-assisting noise-canceling circular-cushion system is robotically manufactured.

FIG. 119, FIG. 120, FIG. 121, FIG. 122, FIG. 123, and FIG. 124 illustrate perspective views of dog-run-adaptable anti-wobbling foldable top trusses, dog-run-adaptable anti-wobbling foldable corner trusses, and dog-run-adaptable anti-wobbling foldable side trusses, respectively.

FIG. 125, FIG. 126, FIG. 127, and FIG. 128 illustrate perspective views of dog-run-adaptable anti-wobbling foldable upper posts, dog-run-adaptable anti-wobbling foldable lower posts, dog-run-adaptable anti-wobbling arthritic-assisting feet, and dog-run-adaptable anti-wobbling arthritic-assisting foot holes, respectively.

FIG. 129 and FIG. 130 illustrate perspective and cross-sectional views demonstrating how the six-device-in-one robot-assembled arthritic-assisting noise-canceling friction-reducing dog-run-adaptable anti-wobbling gazebo can function as a sign.

FIG. 131 and FIG. 132 illustrate perspective and cross-sectional views demonstrating how the six-device-in-one robot-assembled arthritic-assisting noise-canceling friction-reducing dog-run-adaptable anti-wobbling gazebo can function as an awning.

FIG. 133 and FIG. 134 illustrate perspective and cross-sectional views demonstrating how the six-device-in-one robot-assembled arthritic-assisting noise-canceling friction-reducing dog-run-adaptable anti-wobbling gazebo can function as ceiling-mounted overhead storage.

FIG. 135 and FIG. 136 illustrate perspective and cross-sectional views demonstrating how the six-device-in-one robot-assembled arthritic-assisting noise-canceling friction-reducing dog-run-adaptable anti-wobbling gazebo can function as a greenhouse.

FIG. 137 and FIG. 138 illustrate perspective and cross-sectional views demonstrating how the six-device-in-one robot-assembled arthritic-assisting noise-canceling friction-reducing dog-run-adaptable anti-wobbling gazebo can function as a dog-run.

FIG. 139 and FIG. 140 illustrate perspective views demonstrating how a rope can be tied to dog-run-adaptable anti-wobbling arthritic-assisting foot holes to support a dog run.

FIG. 141 illustrates a perspective view demonstrating how a rope can be tied to lower robot-assembled arthritic-assisting height-adjusting dog-run-panel-rope hooks to support a dog run.

FIG. 142 and FIG. 143 illustrate perspective views of robot-assembled heat-expandable cold-contractable anti-wobbling screws.

FIG. 144 illustrates a cross-sectional view demonstrating how robotically heated robot-assembled heat-expandable cold-contractable anti-wobbling screws are inserted they automatically form threads in the connector holes and then the plastic contracts as it cools.

FIG. 145 illustrates a cross-sectional view demonstrating how robot-assembled heat-expandable cold-contractable interlocking cones and robot-assembled heat-expandable cold-contractable interlocking spiral locks expand when they are stopped by hammer-shields.

FIG. 146 (Prior Art) illustrates a perspective view of prior art of robot-assembled automatically-making-rivet-tail-flare noise-canceling injury-preventing top-connector system.

FIG. 147, FIG. 148, FIG. 149, FIG. 150, FIG. 151, FIG. 152, and FIG. 153 illustrate cross-sectional views demonstrating how robot-assembled heat-expandable cold-contractable anti-wobbling screws are inserted into robot-assembled automatically-making-rivet-tail-flare noise-canceling injury-preventing top-connector system.

FIG. 154 illustrates a perspective view of how robot-assembled automatically-making-rivet-tail-flare noise-canceling injury-preventing top-connector system is robotically manufactured.

FIG. 155 (Prior Art) illustrates a perspective view of prior art of robot-assembled injury-preventing cone-shielding central intersector system.

FIG. 156, FIG. 157, FIG. 158, FIG. 159, and FIG. 160 illustrate cross-sectional views demonstrating how robot-assembled heat-expandable cold-contractable anti-wobbling screws are inserted into robot-assembled injury-preventing cone-shielding central intersector system.

FIG. 161 illustrates a perspective view of how robot-assembled injury-preventing cone-shielding central intersector system is robotically manufactured.

FIG. 162 (Prior Art) illustrates a perspective view of prior art of robot-assembled injury-preventing cone-shielding upper intersector system.

FIG. 163, FIG. 164, FIG. 165, FIG. 166, and FIG. 167 illustrate cross-sectional views how robot-assembled heat-expandable cold-contractable anti-wobbling screws are inserted into robot-assembled injury-preventing cone-shielding upper intersector system.

FIG. 168 illustrates a perspective view of how robot-assembled injury-preventing cone-shielding upper intersector system is robotically manufactured.

FIG. 169 (Prior Art) illustrates a perspective view of prior art of robot-assembled arthritic-assisting injury-preventing cone-shielding lower intersector system.

FIG. 170, FIG. 171, FIG. 172, FIG. 173, FIG. 174, FIG. 175, and FIG. 176 illustrate perspective and cross-sectional views demonstrating how robot-assembled heat-expandable cold-contractable anti-wobbling screws are inserted into robot-assembled arthritic-assisting injury-preventing cone-shielding lower intersector system.

FIG. 177 illustrates a perspective view of how robot-assembled arthritic-assisting injury-preventing cone-shielding lower intersector system is robotically manufactured.

FIG. 178 illustrates a perspective view demonstrating how an arthritic can operate lower robot-assembled arthritic-assisting height-adjusting dog-run-panel-rope hooks without the need to close the hand.

FIG. 179 and FIG. 180 illustrate cross-sectional views demonstrating how lower robot-assembled arthritic-assisting height-adjusting dog-run-panel-rope hooks engage and disengage the lower robot-assembled noise-canceling friction-reducing height-adjusting nipples to deploy and retract the six-device-in-one robot-assembled arthritic-assisting noise-canceling friction-reducing dog-run-adaptable anti-wobbling gazebo.

FIG. 181 illustrates a perspective view demonstrating how a rope can be tied to lower robot-assembled arthritic-assisting height-adjusting dog-run-panel-rope hooks to support a dog run.

FIG. 182, FIG. 183, FIG. 184, FIG. 185, and FIG. 186 illustrate perspective views demonstrating various components of robot-assembled arthritic-assisting injury-preventing post-centering tick-preventing water-discharging sleeve system, and the assembly thereof.

FIG. 187, FIG. 188, FIG. 189, and FIG. 190 illustrate cross-sectional and perspective views demonstrating sleeve robot-assembled post-centering clamps, sleeve robot-assembled tick-preventing downward teeth, and sleeve robot-assembled water-discharging grooves.

FIG. 191 illustrates a perspective view demonstrating how an arthritic can operate sleeve robot-assembled arthritic-assisting height-adjusting dog-run-panel-rope hooks without the need to close the hand.

FIG. 192 and FIG. 193 illustrate perspective views demonstrating how a rope can be tied to sleeve robot-assembled arthritic-assisting height-adjusting dog-run-panel-rope hooks to support a dog run.

FIG. 194 (Prior Art) illustrates a perspective view of prior art demonstrating how screws, washers and nuts are used for assembly.

FIG. 195 and FIG. 196 illustrate perspective views of robot-assembled noise-canceling injury-preventing rust-preventing truss-centering cover-cushion system.

FIG. 197, FIG. 198, and FIG. 199 illustrate cross-sectional views demonstrating how robot-assembled heat-expandable cold-contractable double-tail cover-cushion rivets are inserted through robot-assembled noise-canceling injury-preventing rust-preventing truss-centering cover-cushion system and dog-run-adaptable anti-wobbling foldable top trusses to connect the components together.

FIG. 200, FIG. 201, and FIG. 202 illustrate cross-sectional and perspective views demonstrating how robot-assembled noise-canceling injury-preventing rust-preventing truss-centering cover-cushion system is robotically installed, heat-pressing the robot-assembled heat-expandable cold-contractable double-tail cover-cushion rivets to lock them in place without the need for nuts, bolts, or washers.

FIG. 203, FIG. 204, FIG. 205, and FIG. 206 illustrate perspective and cross-sectional views demonstrating the robotic assembly of robot-assembled arthritic-assisting noise-canceling injury-preventing rust-preventing truss-centering cup-cushion system.

FIG. 207, FIG. 208, FIG. 209, and FIG. 210 illustrate perspective and cross-sectional views demonstrating the robotic assembly of robot-assembled arthritic-assisting noise-canceling circular-cushion system.

FIG. 211, FIG. 212, FIG. 213, FIG. 214, FIG. 215, FIG. 216, FIG. 217, FIG. 218, and FIG. 219 illustrate perspective and cross-sectional views of equivalent variations of robot-assembled arthritic-assisting injury-preventing cone-shielding lower intersector system as well as perspective views of equivalent variations of robot-assembled automatically-making-rivet-tail-flare noise-canceling injury-preventing top-connector system.

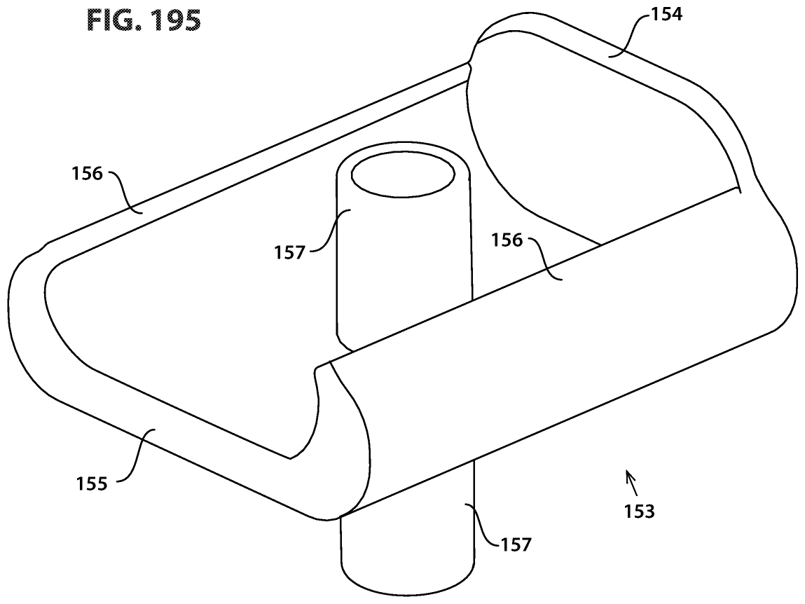

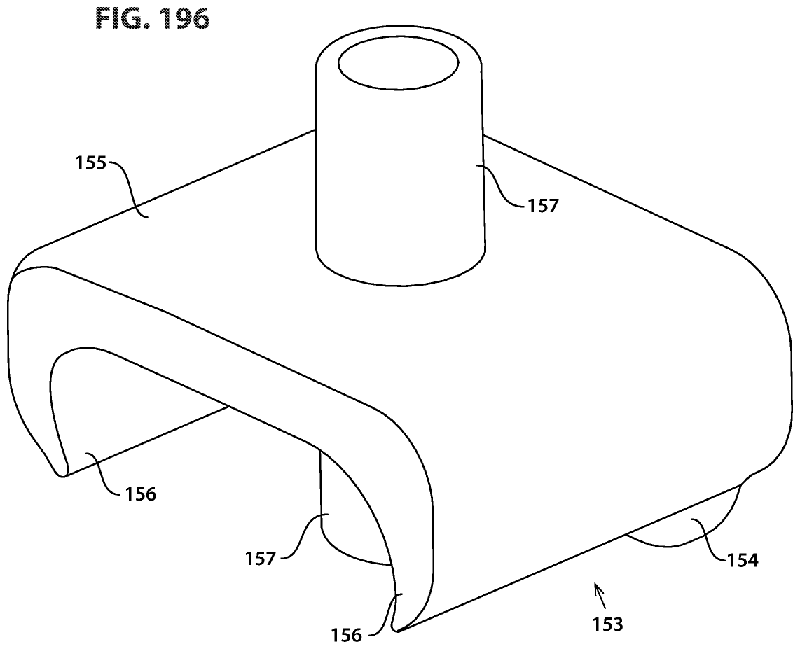

FIG. 195 and FIG. 196 illustrate perspective views of equivalent variations of robot-assembled automatically-making-rivet-tail-flare noise-canceling injury-preventing top-connector system.

FIG. 220, FIG. 221, FIG. 222, FIG. 223, and FIG. 224 illustrate perspective views of equivalent variations of robot-assembled noise-canceling injury-preventing rust-preventing truss-centering cover-cushion system.

FIG. 225 and FIG. 226 illustrate perspective views of equivalent variations of robot-assembled heat-expandable cold-contractable anti-wobbling screws.

FIG. 227, FIG. 228, FIG. 229, FIG. 230, FIG. 231, FIG. 232, FIG. 233, FIG. 234, FIG. 235, and FIG. 236 illustrate perspective views of equivalent variations of various components of robot-assembled arthritic-assisting injury-preventing post-centering tick-preventing water-discharging sleeve system.

FIG. 237, FIG. 238, FIG. 239, and FIG. 240 illustrate cross-section views of equivalent variations of robot-assembled automatically-making-rivet-tail-flare noise-canceling injury-preventing top-connector system, robot-assembled injury-preventing cone-shielding central intersector system, robot-assembled injury-preventing cone-shielding upper intersector system, and robot-assembled arthritic-assisting injury-preventing cone-shielding lower intersector system and the installation of robot-assembled heat-expandable cold-contractable interlocking anti-wobbling spiral-saw screw system, respectively, therein.

FIG. 241, FIG. 242, FIG. 243, and FIG. 244 illustrate perspective views of equivalent variations of robot-assembled automatically-making-rivet-tail-flare noise-canceling injury-preventing top-connector system.

FIG. 245, FIG. 246, FIG. 247, FIG. 248, FIG. 249, FIG. 250, FIG. 251, and FIG. 252 illustrate perspective views of equivalent variations of lower robot-assembled arthritic-assisting height-adjusting dog-run-panel-rope hooks and sleeve robot-assembled arthritic-assisting height-adjusting dog-run-panel-rope hooks.

FIG. 253, FIG. 254, and FIG. 255 illustrate perspective views of equivalent variations of the six-device-in-one robot-assembled arthritic-assisting noise-canceling friction-reducing dog-run-adaptable anti-wobbling gazebo in its folded position.

### DETAILED DESCRIPTION OF THE INVENTION

The six-device-in-one robot-assembled arthritic-assisting noise-canceling friction-reducing dog-run-adaptable anti-wobbling gazebo comprises: COMPONENT

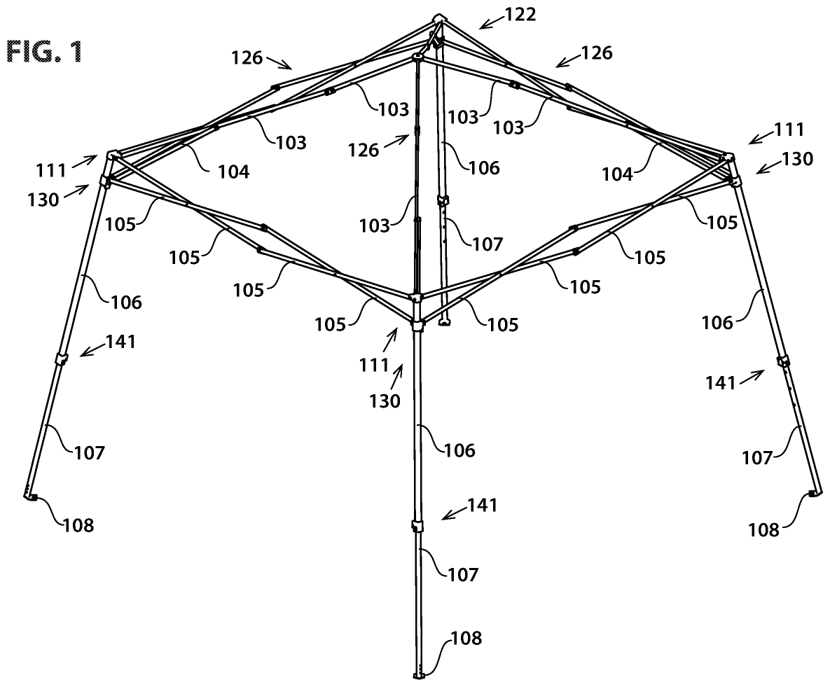

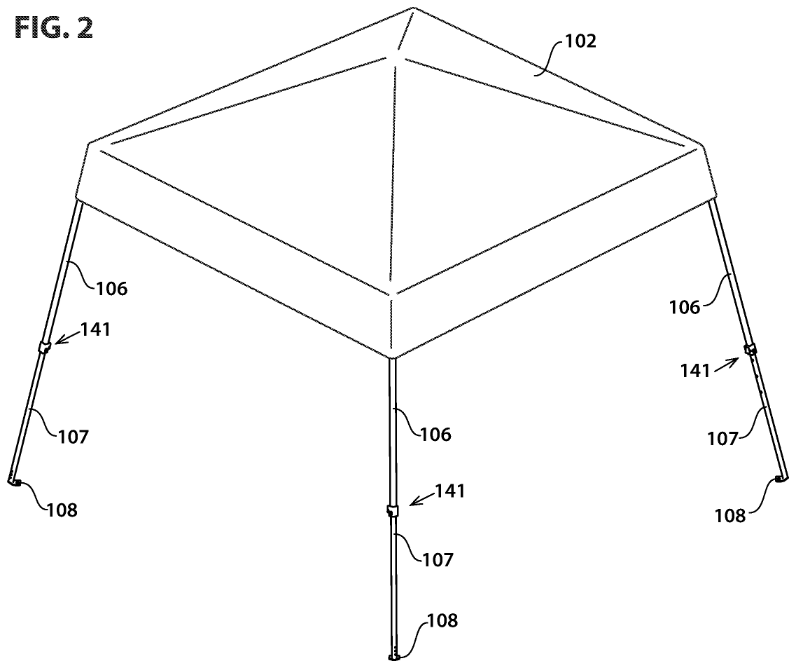

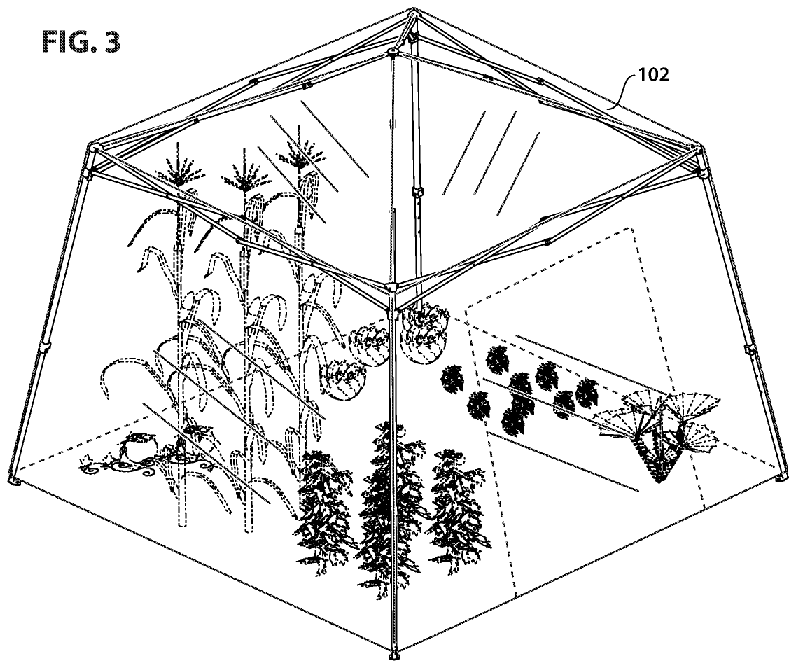

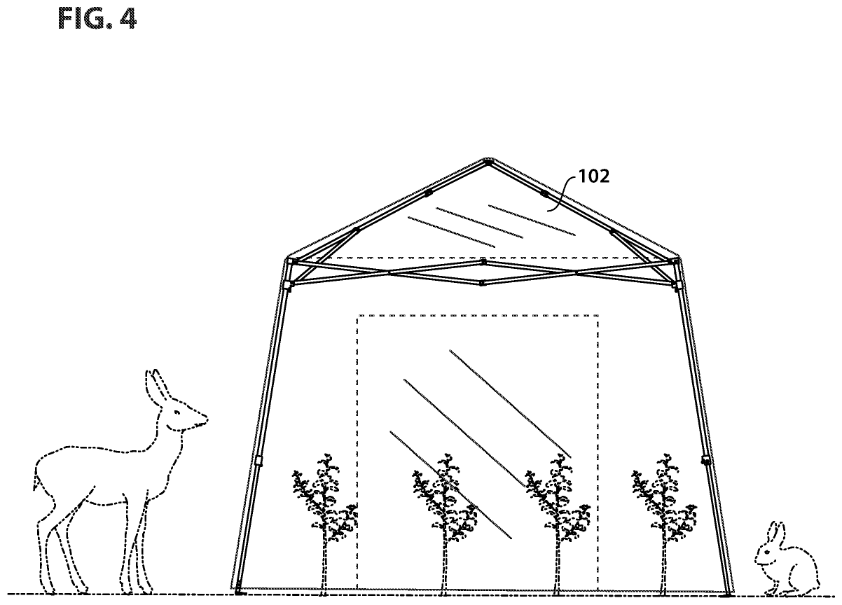

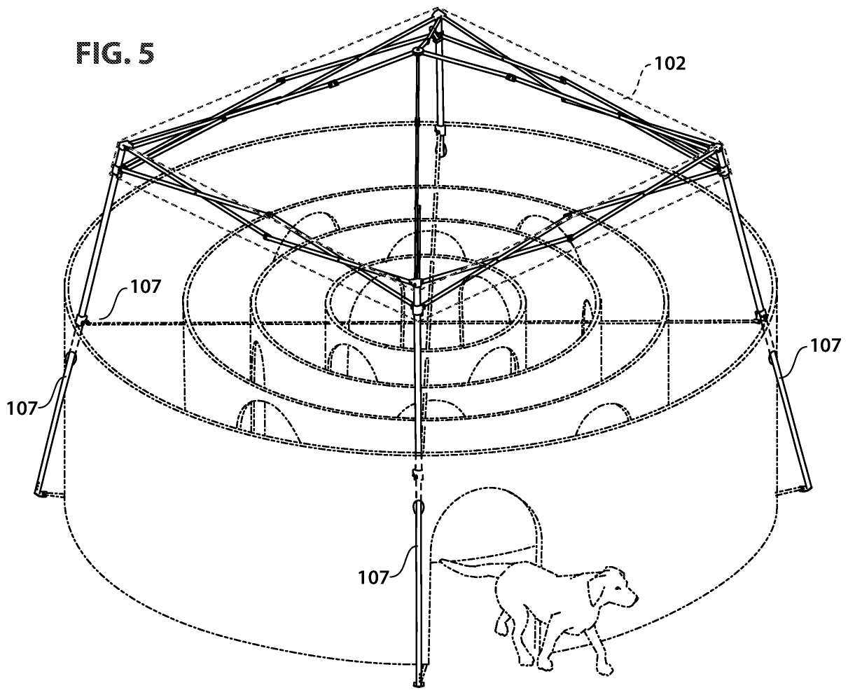

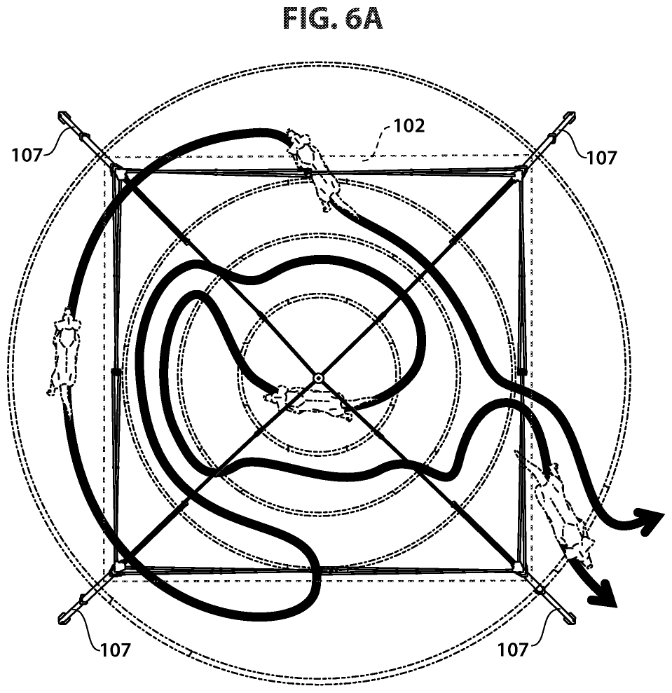

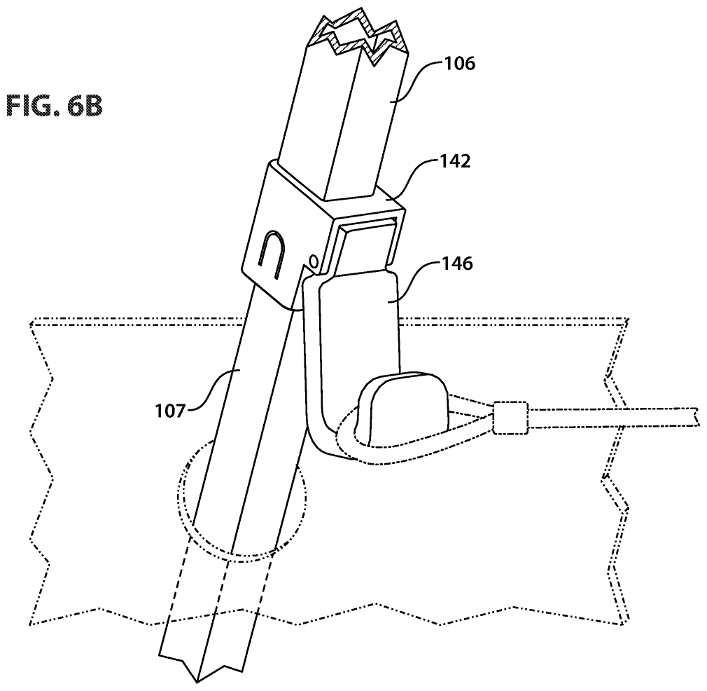

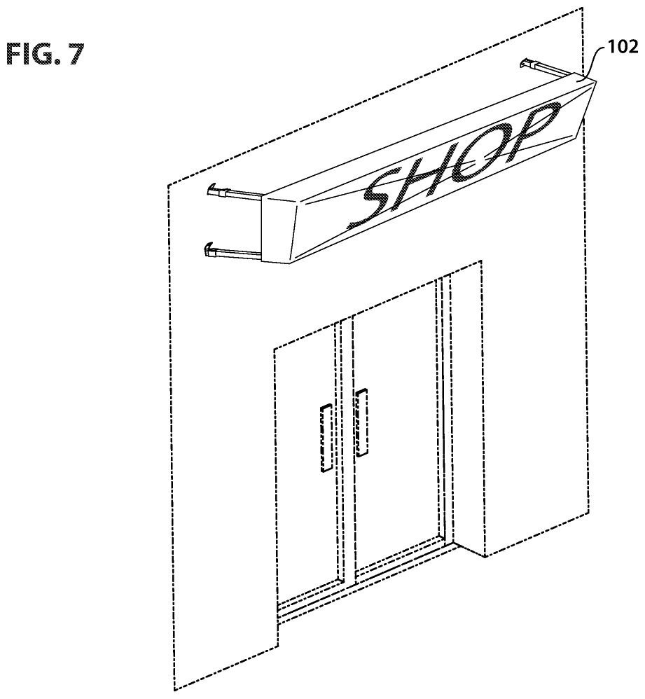

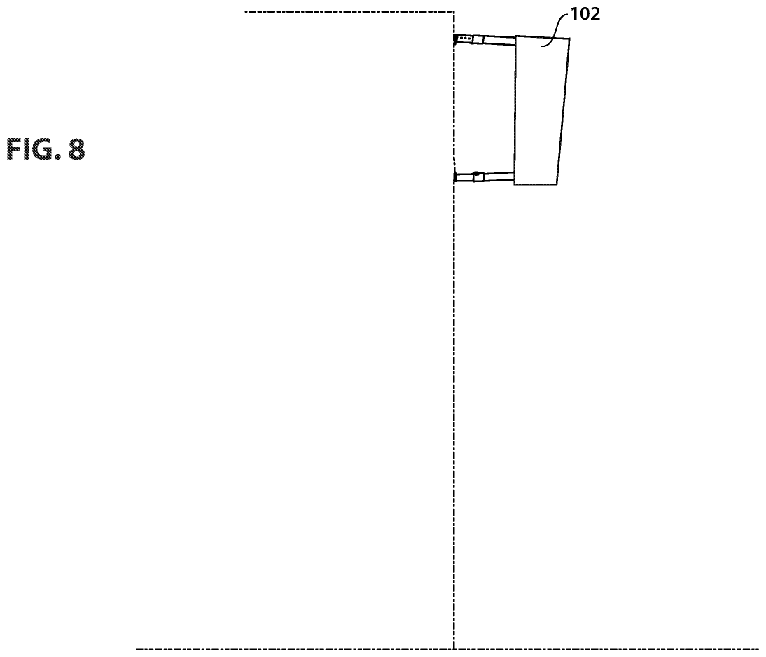

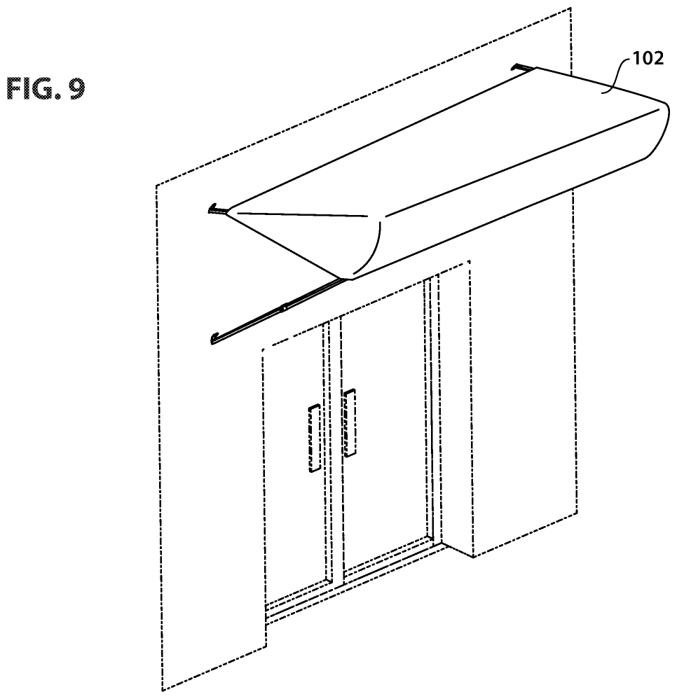

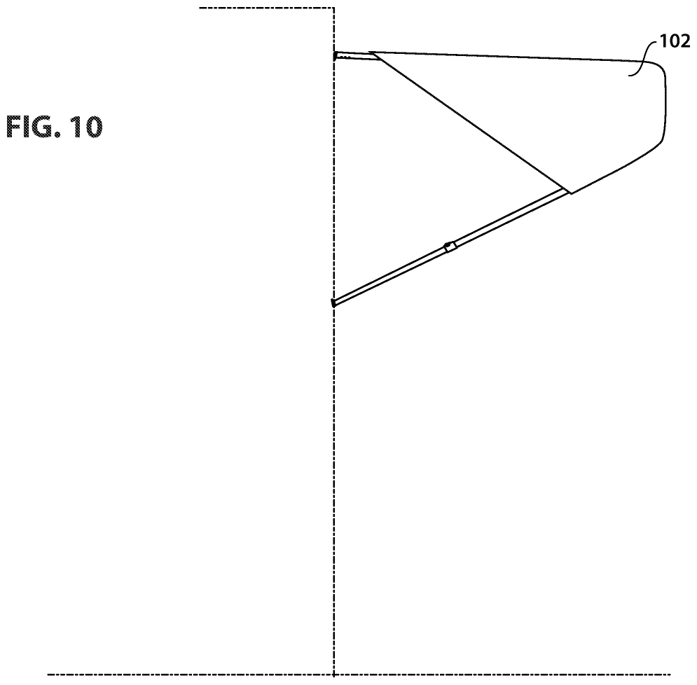

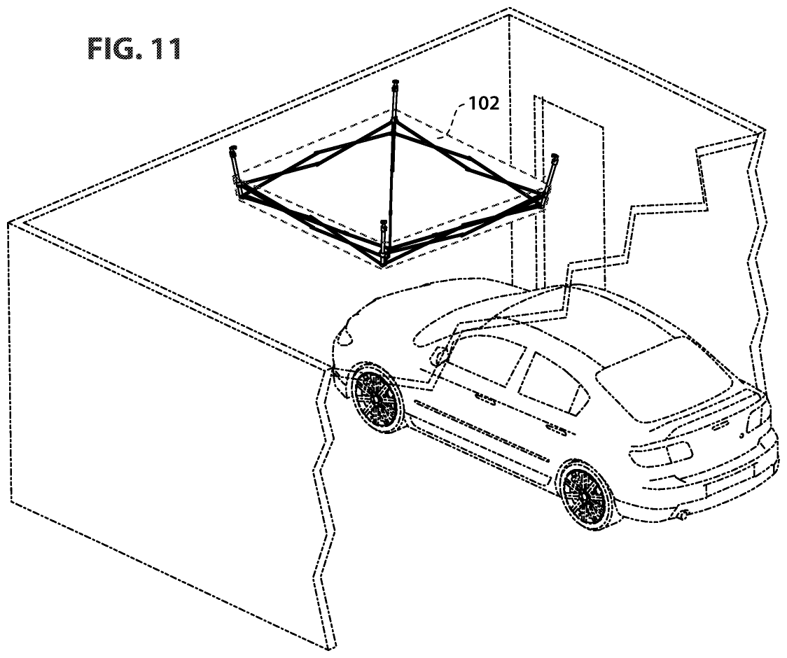

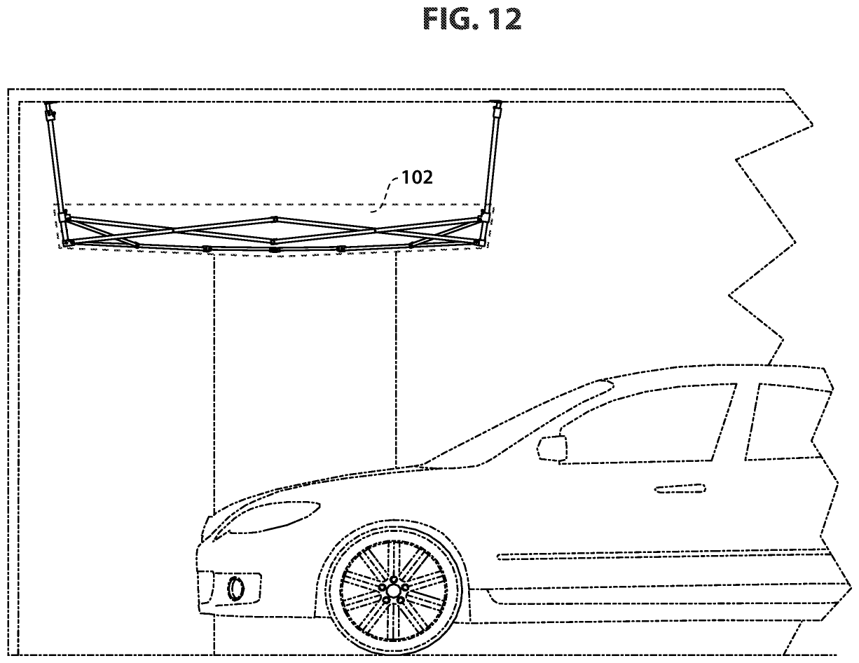

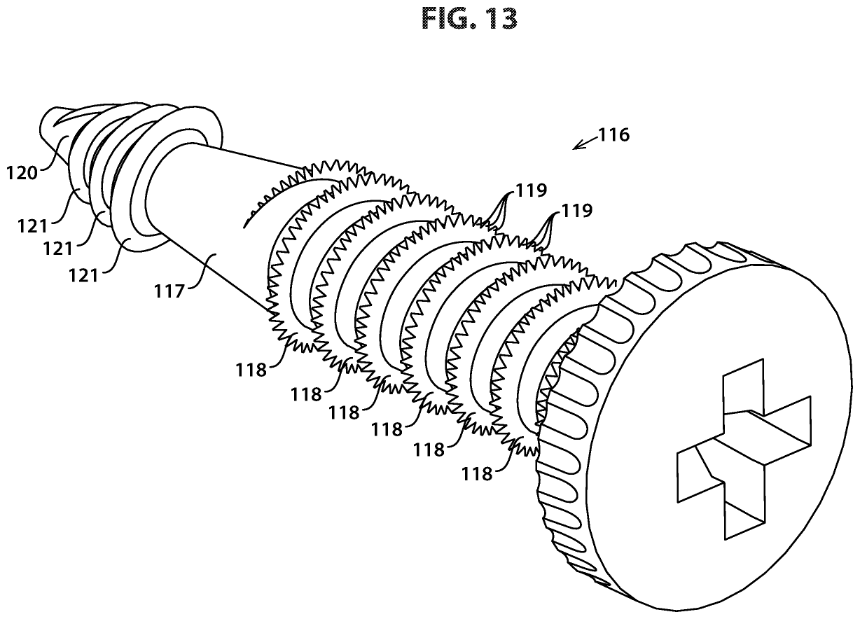

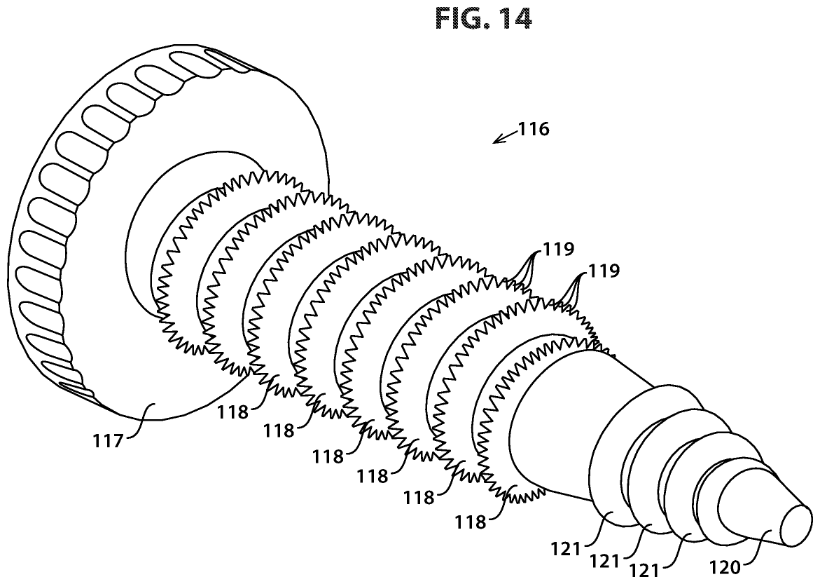

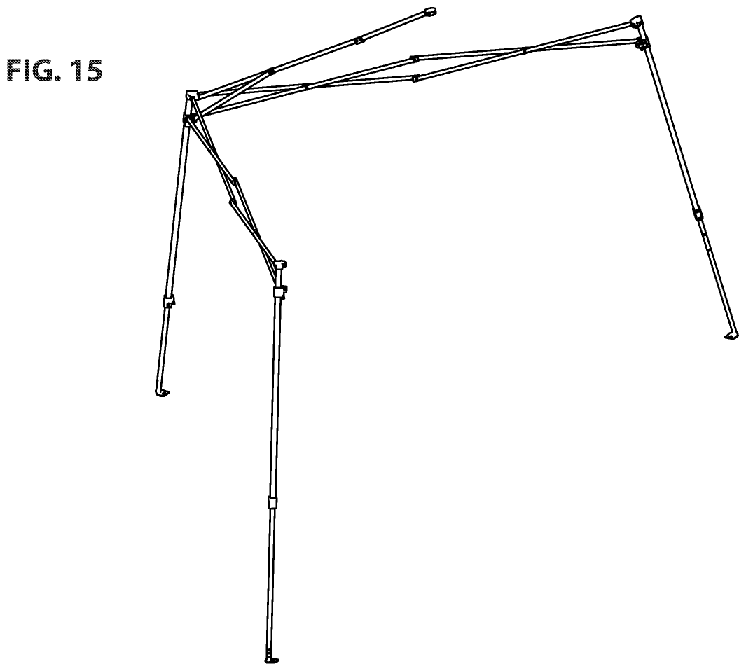

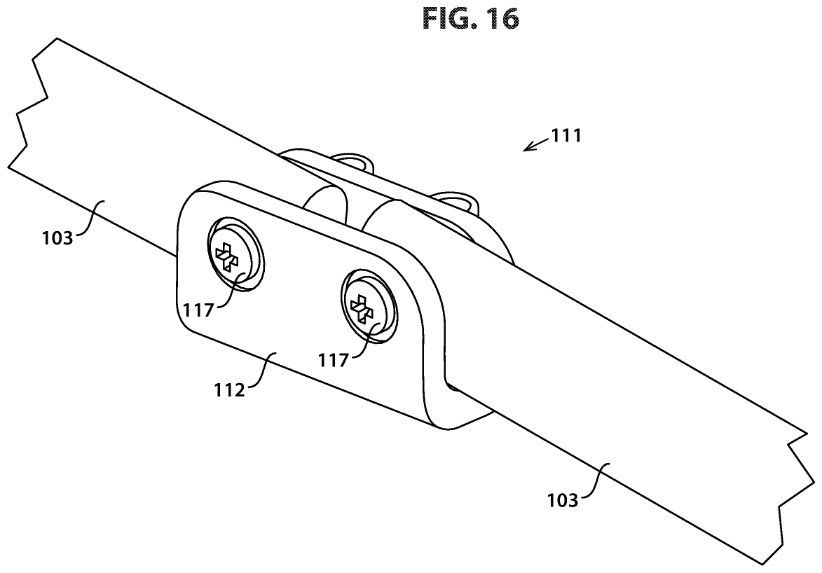

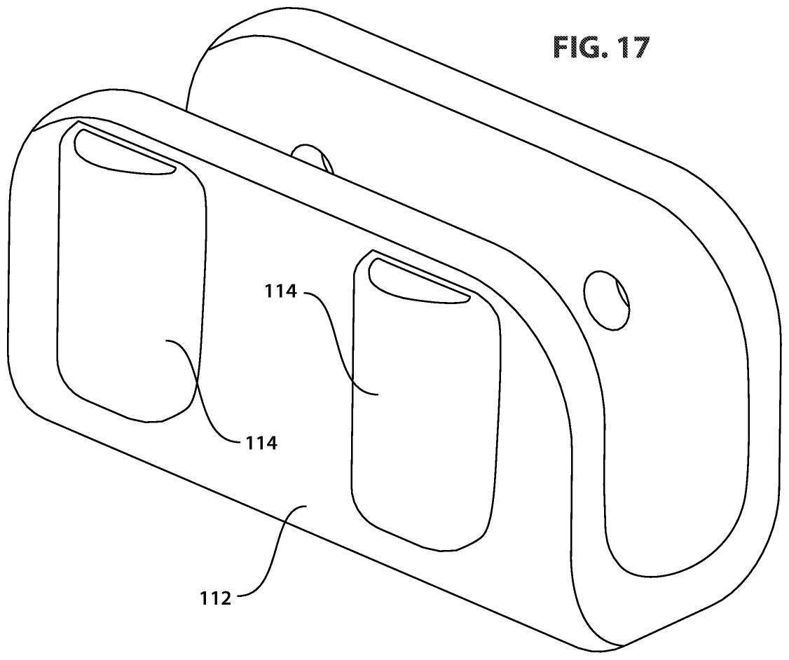

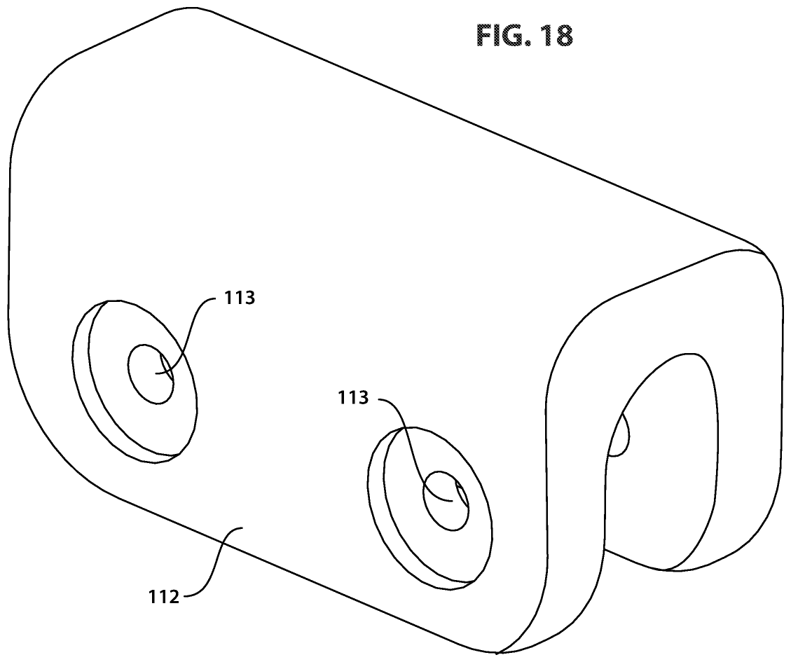

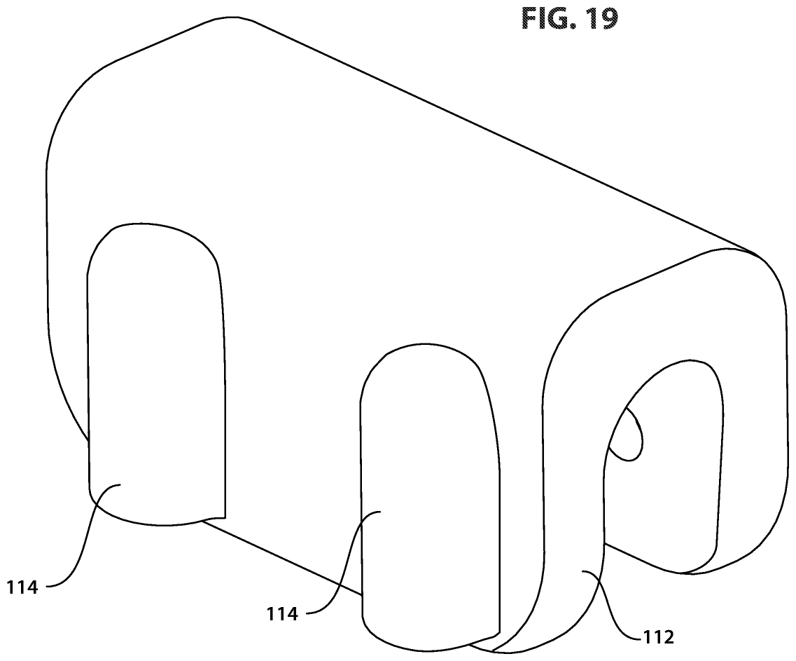

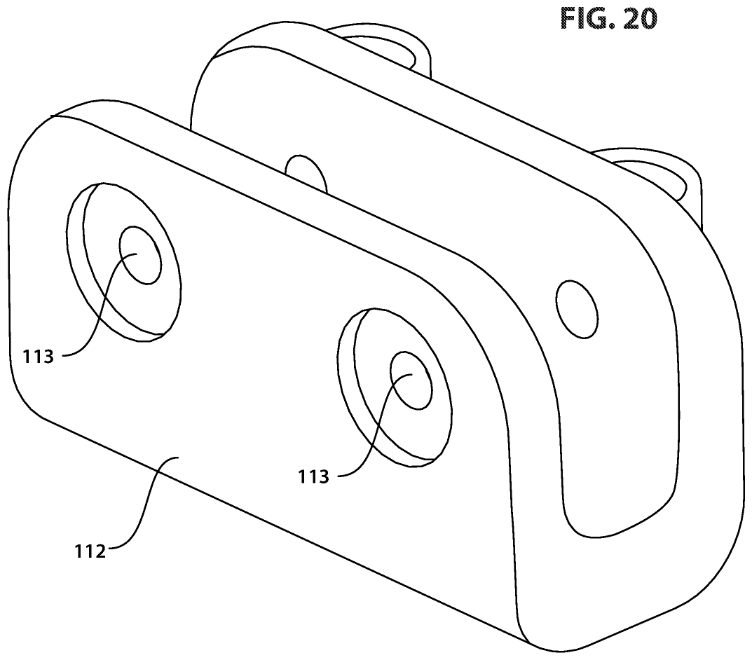

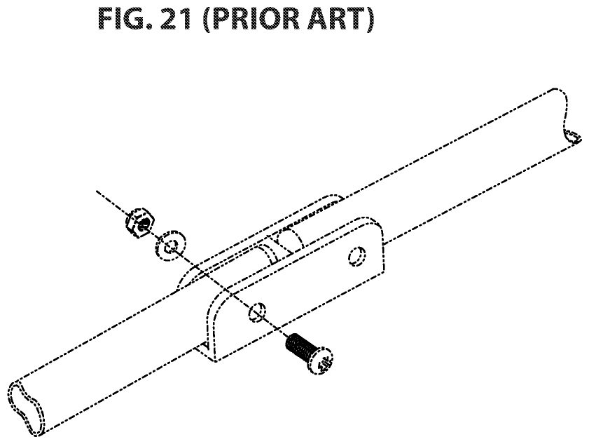

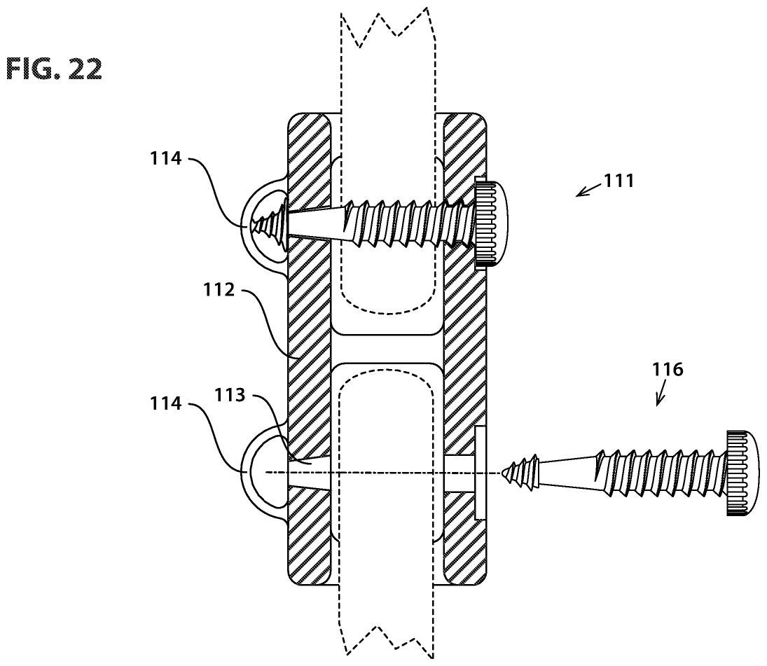

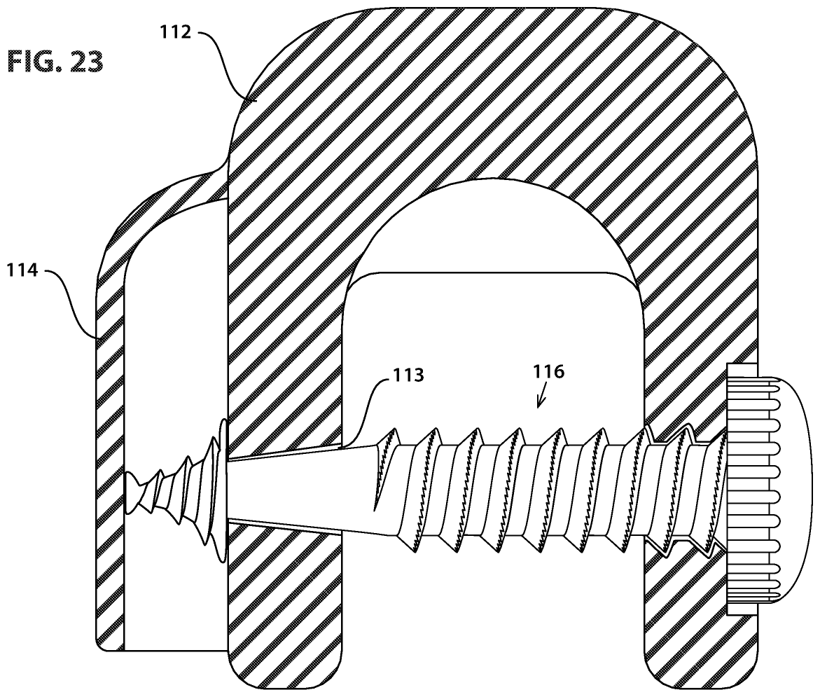

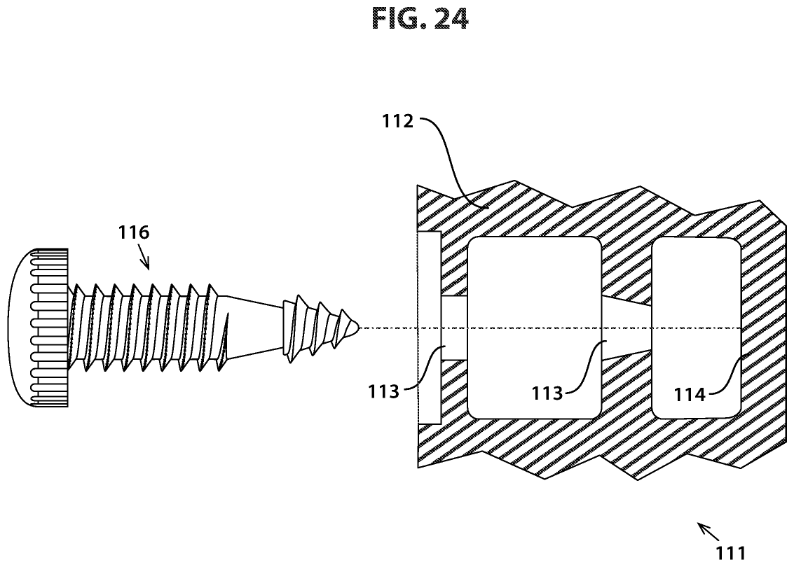

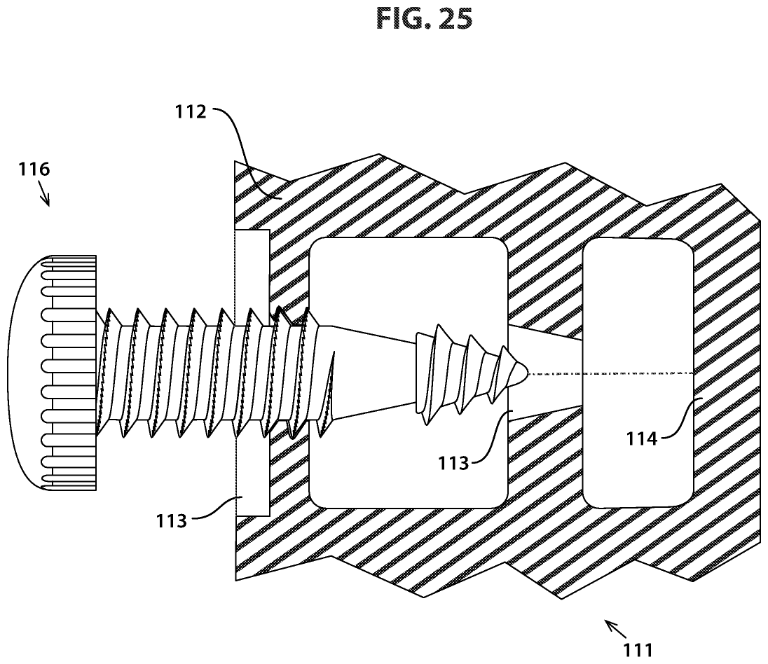

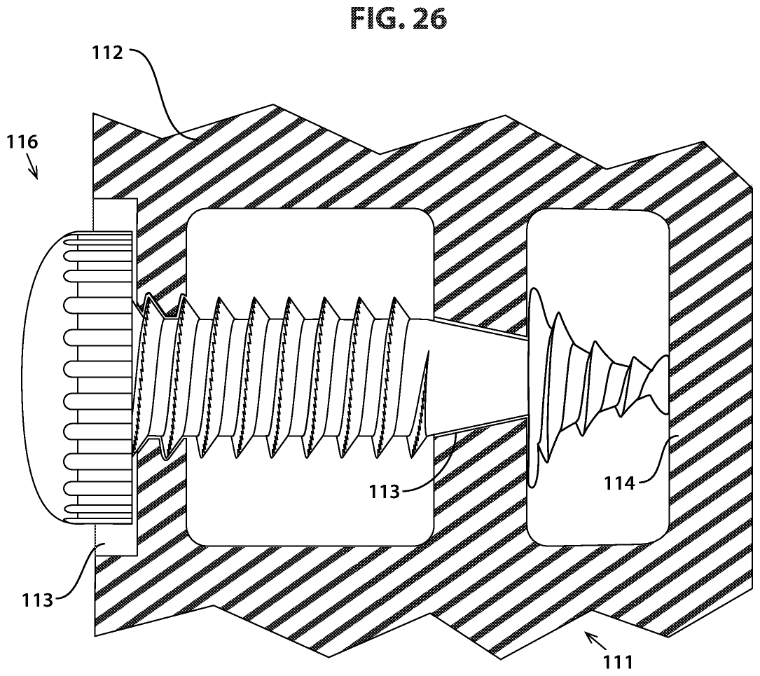

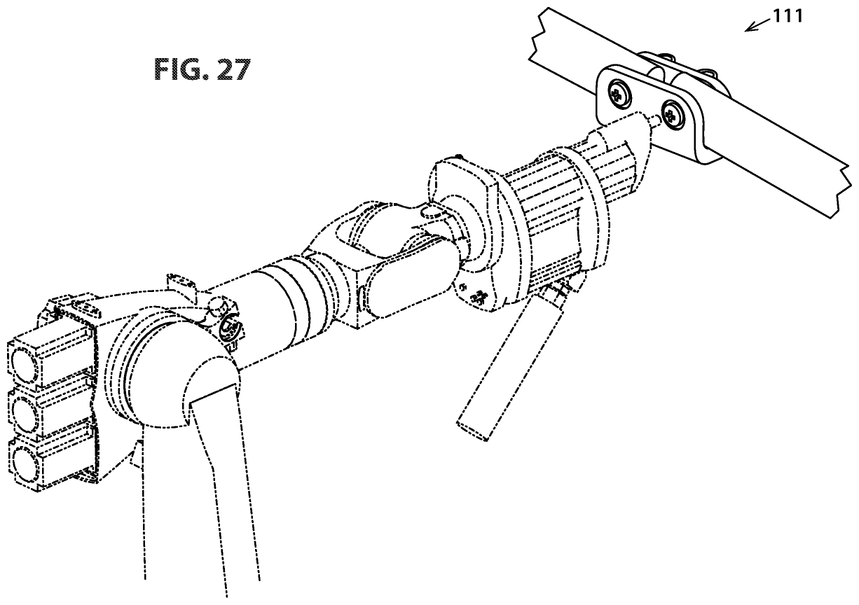

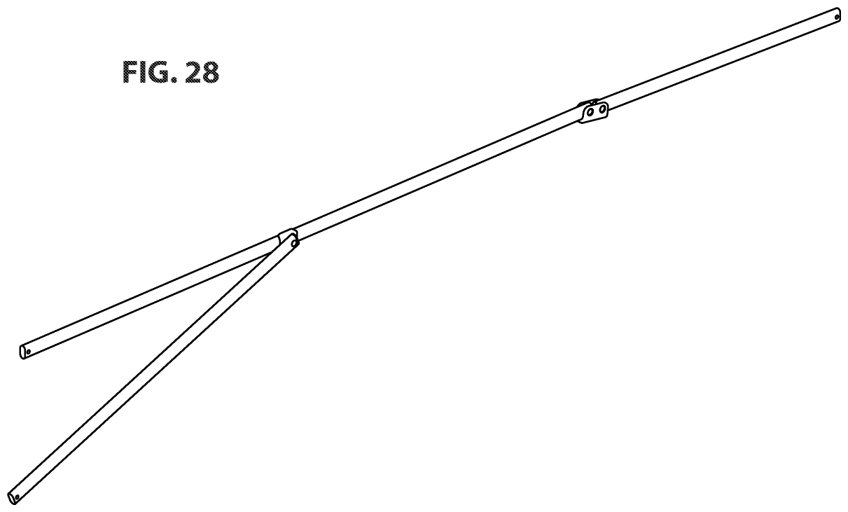

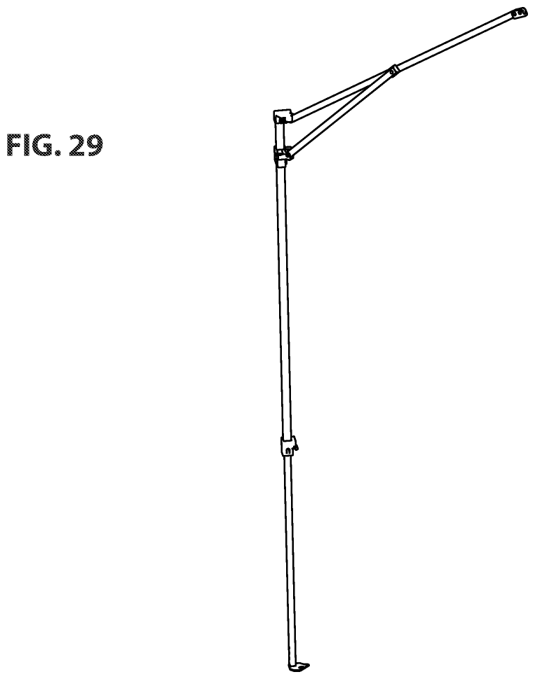

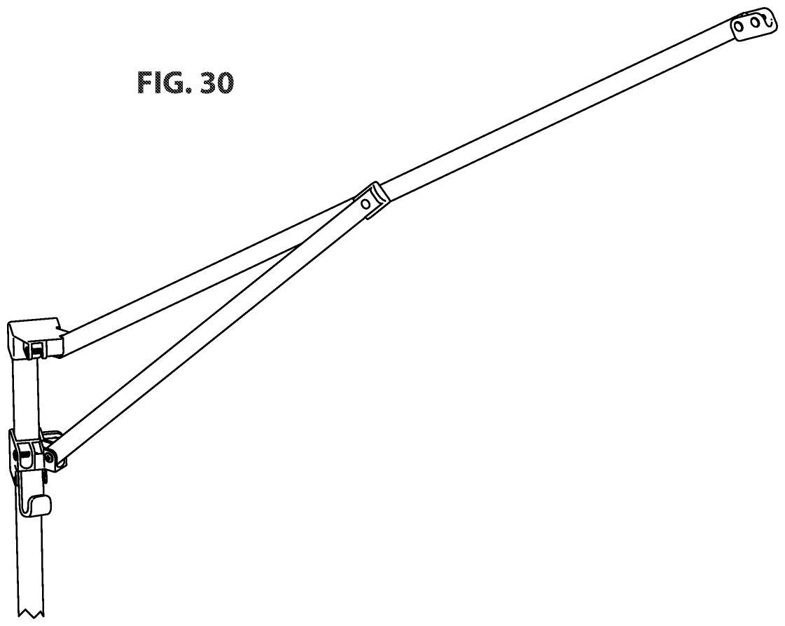

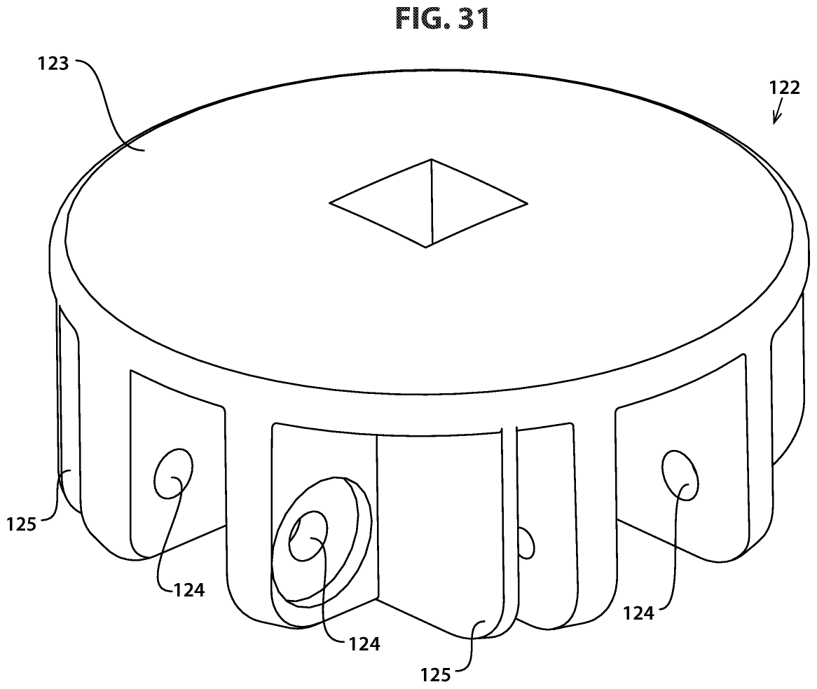

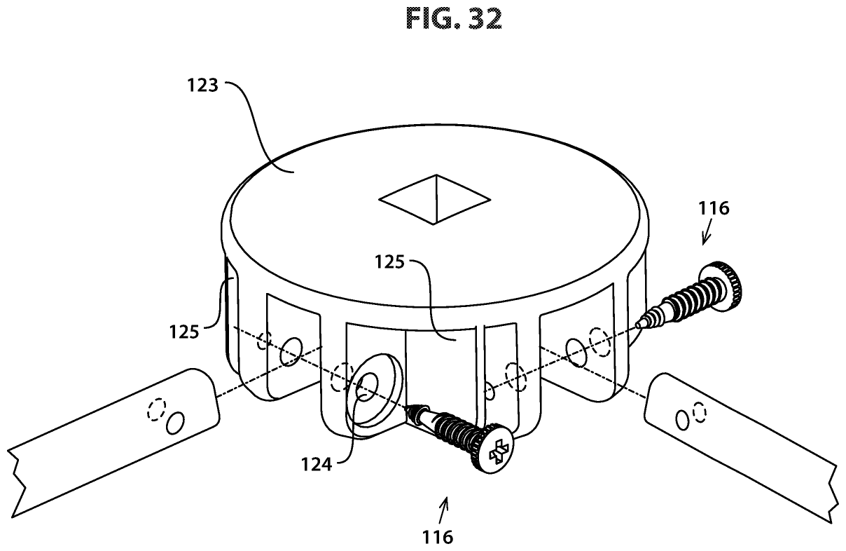

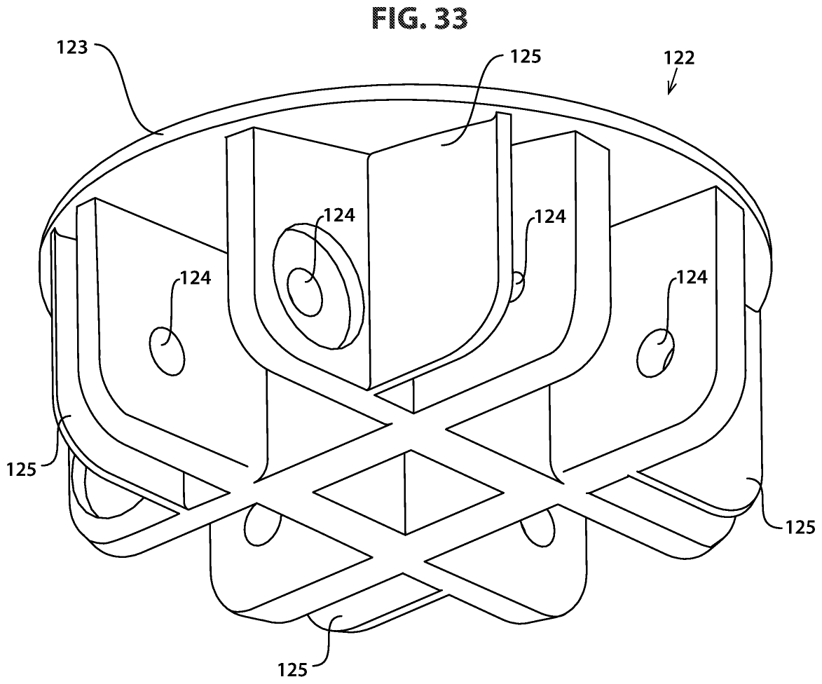

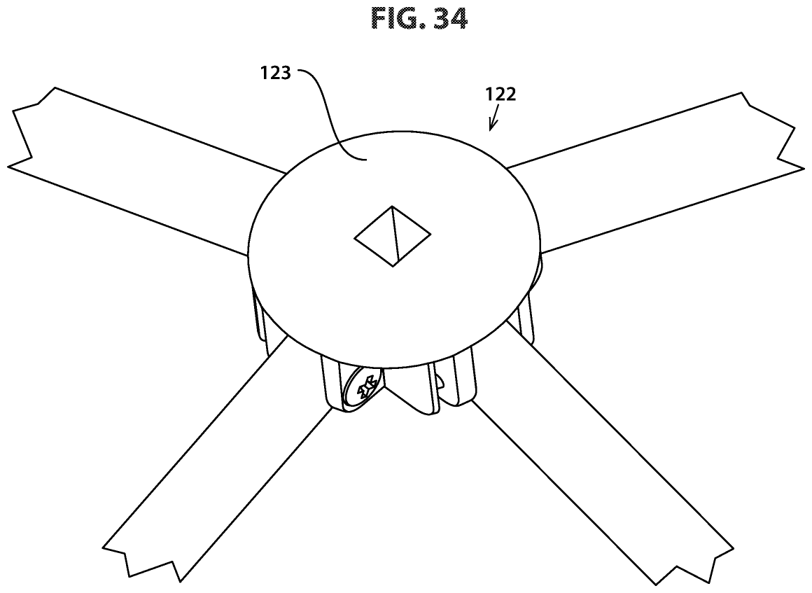

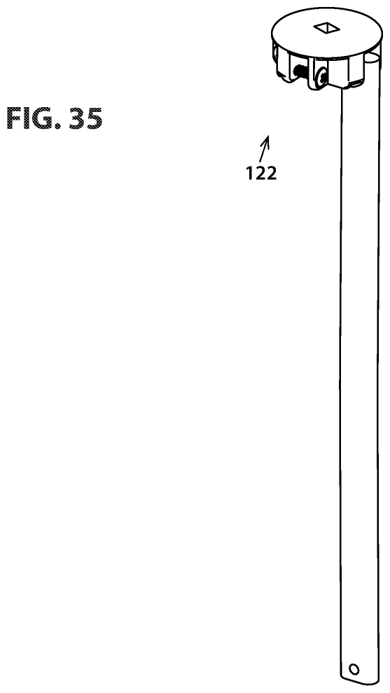

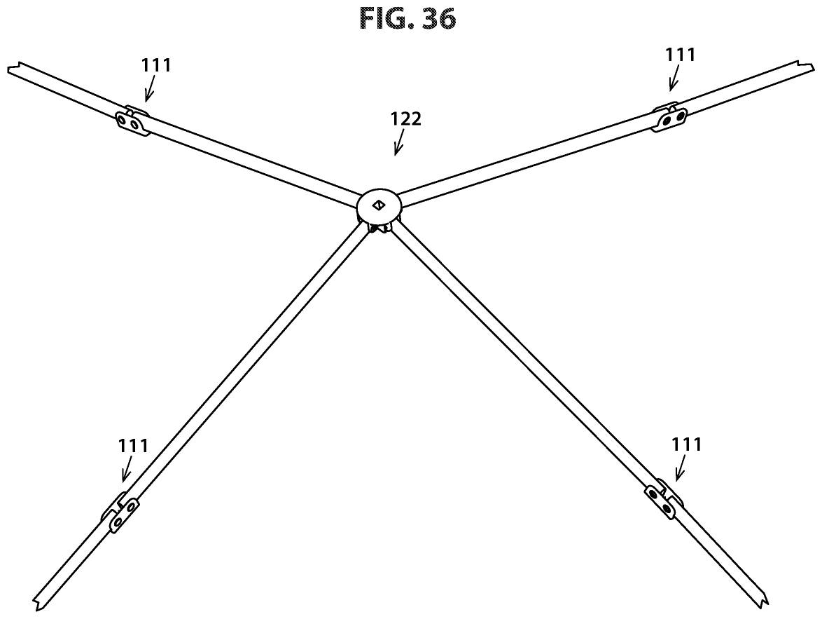

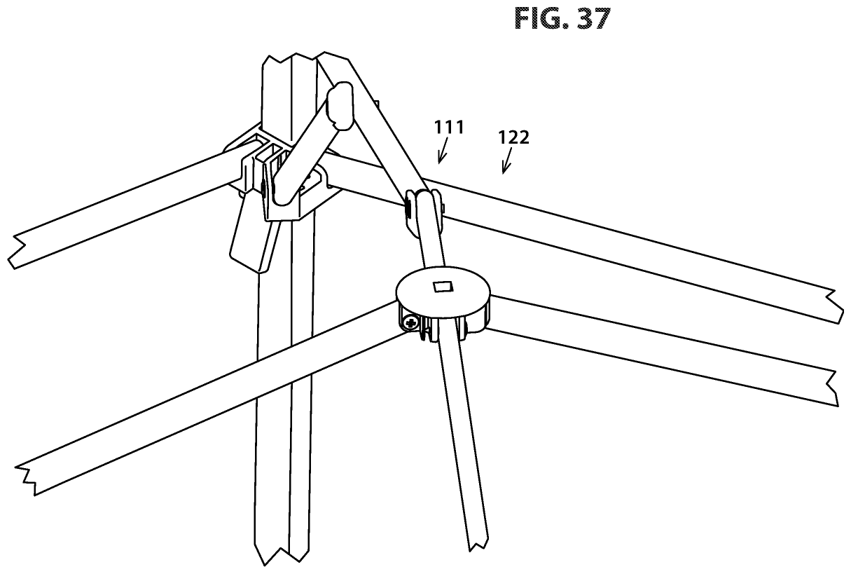

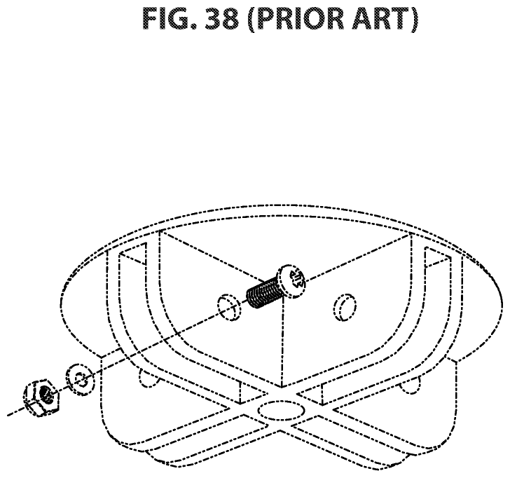

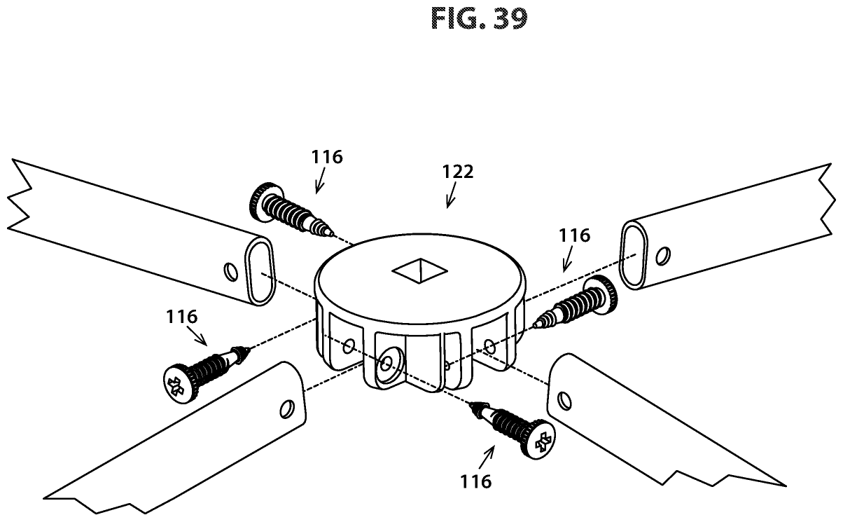

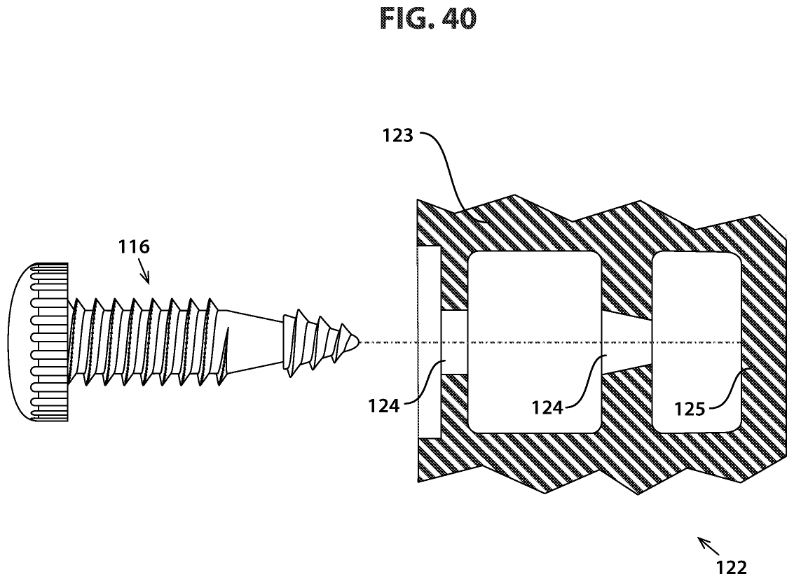

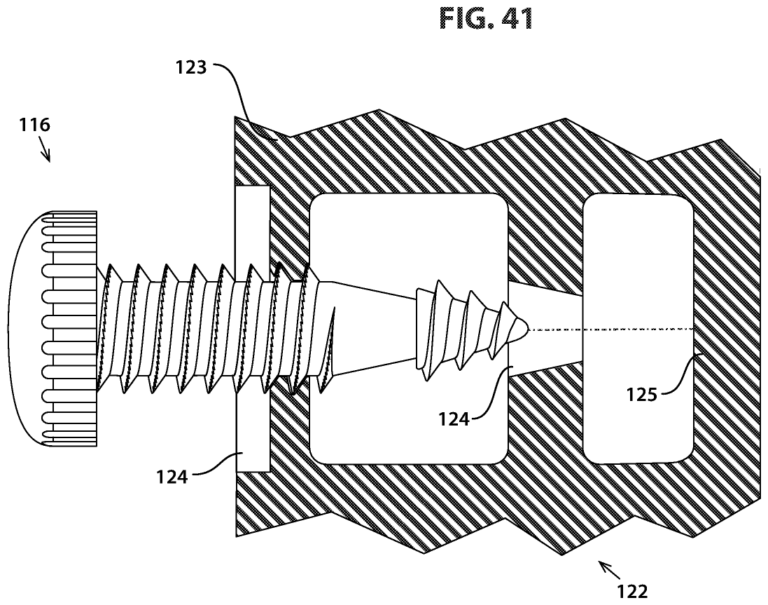

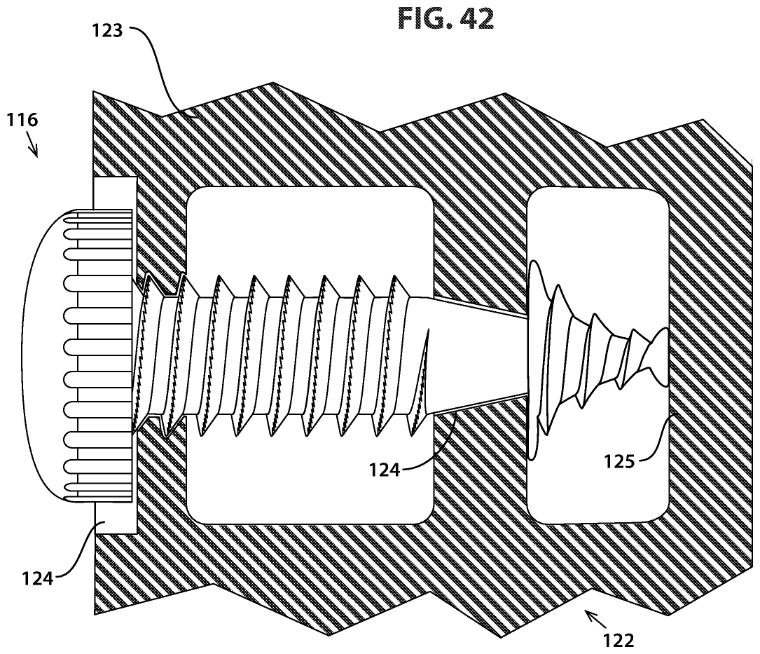

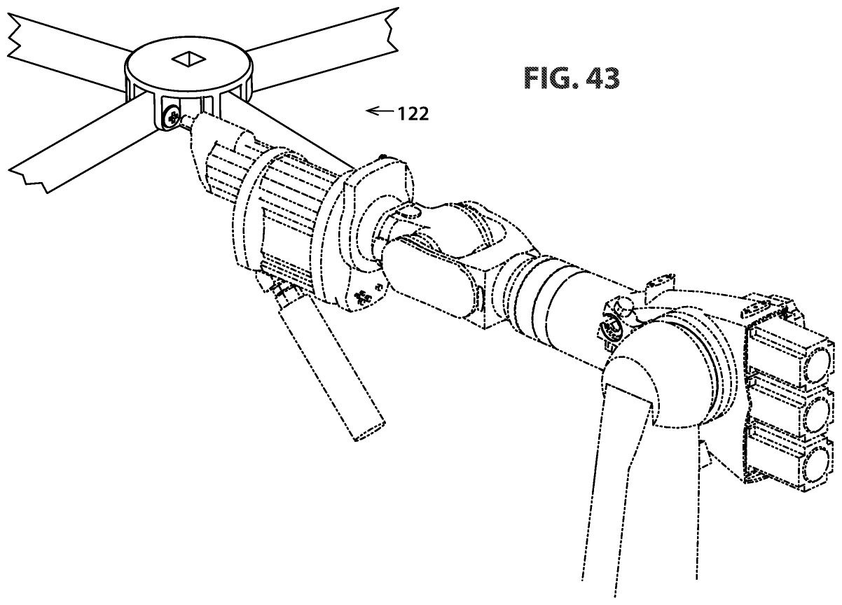

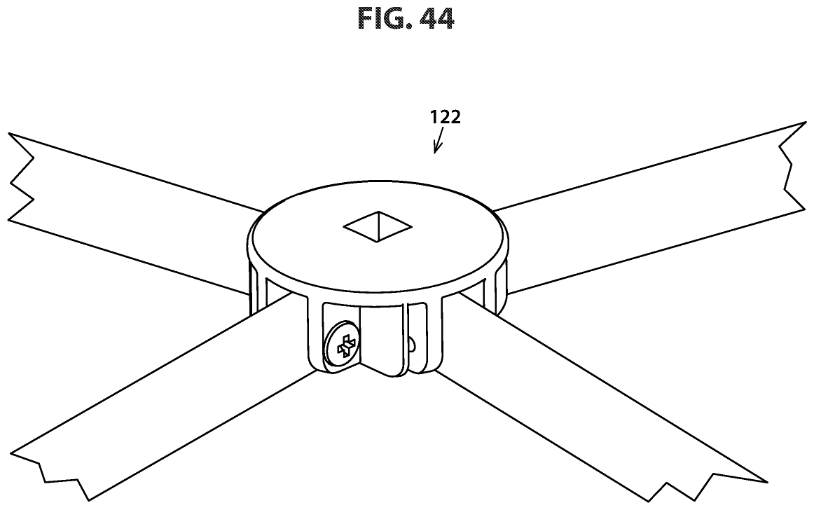

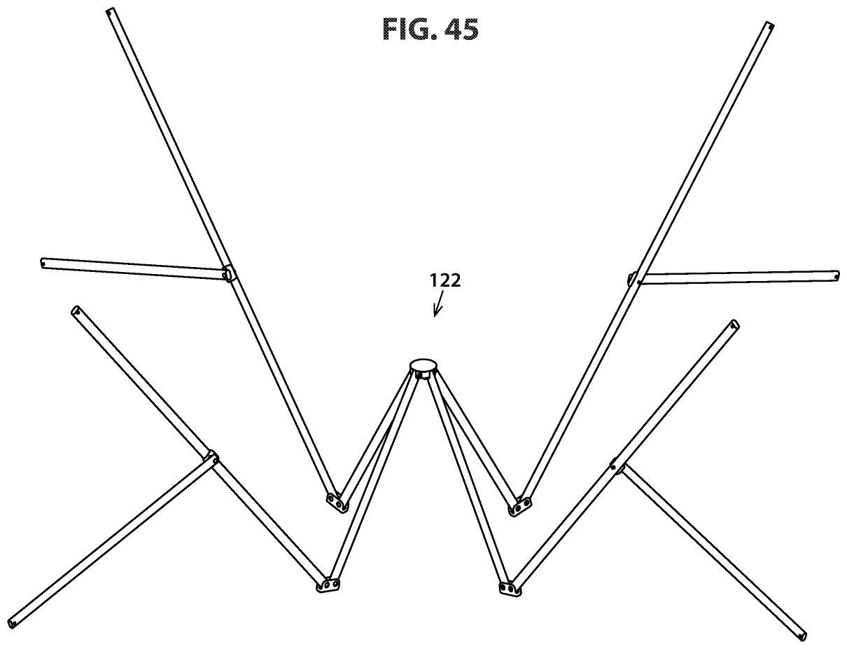

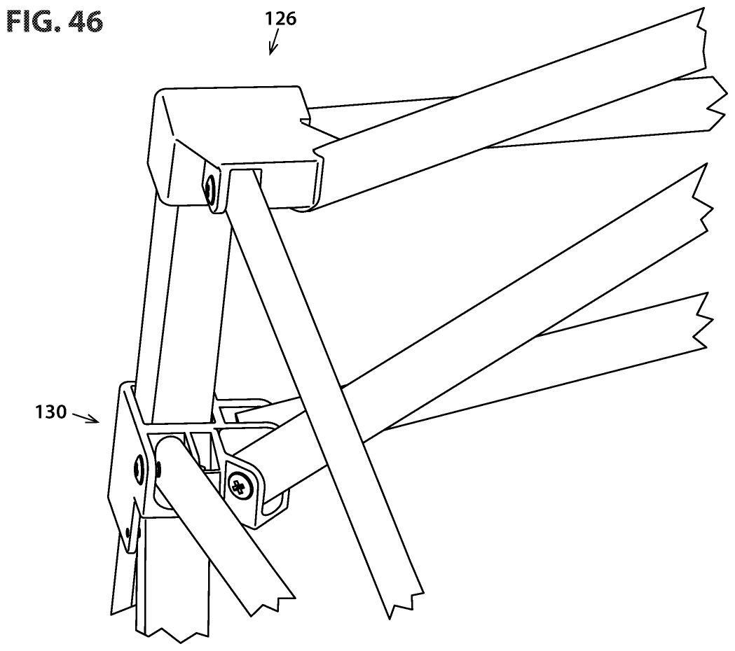

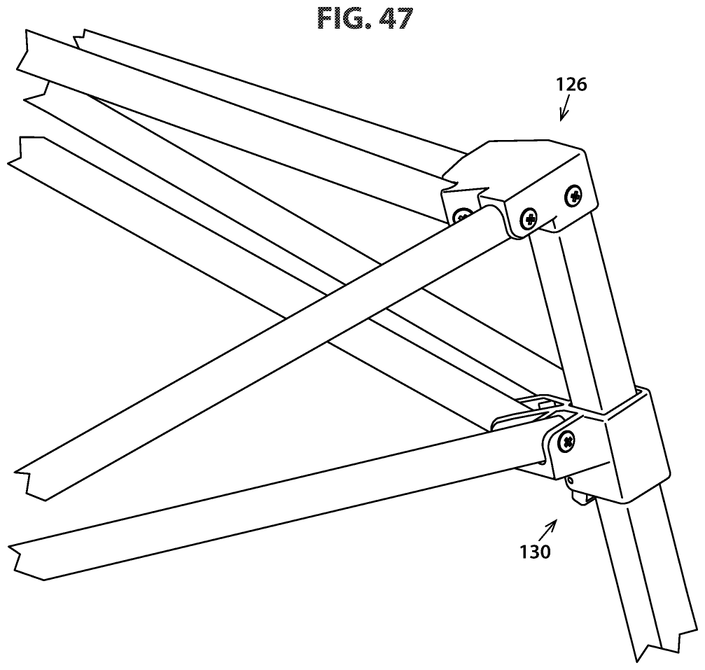

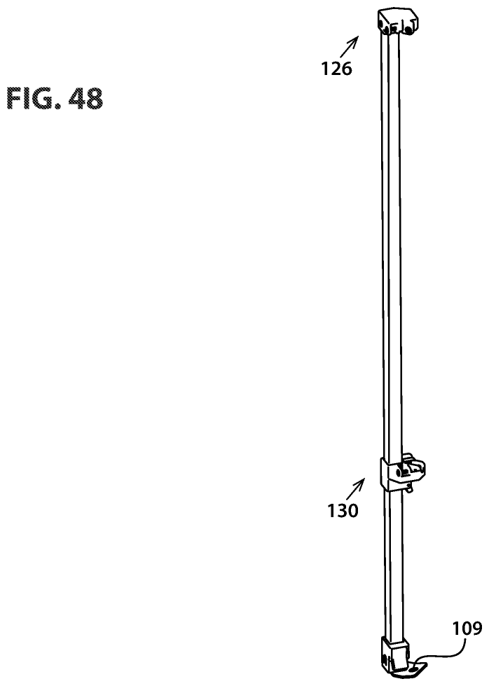

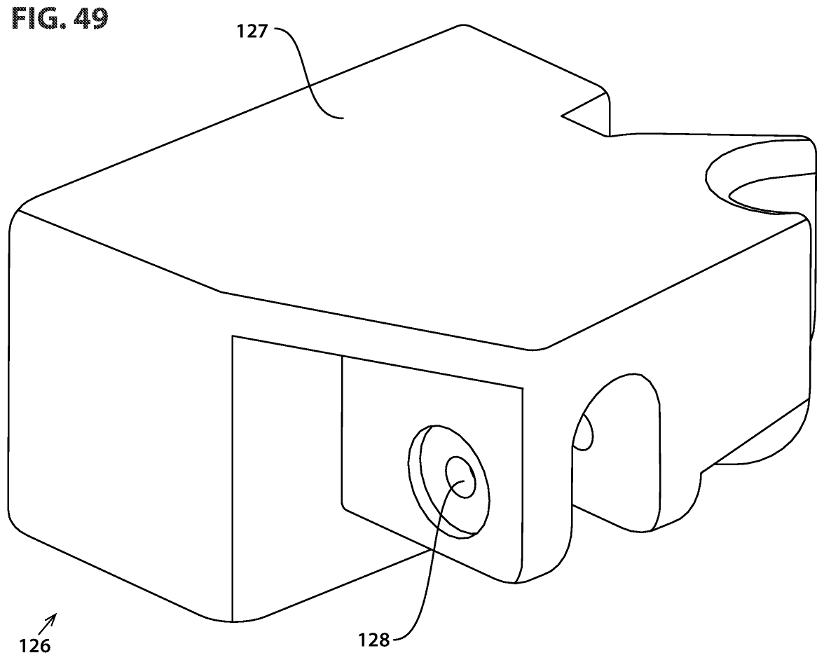

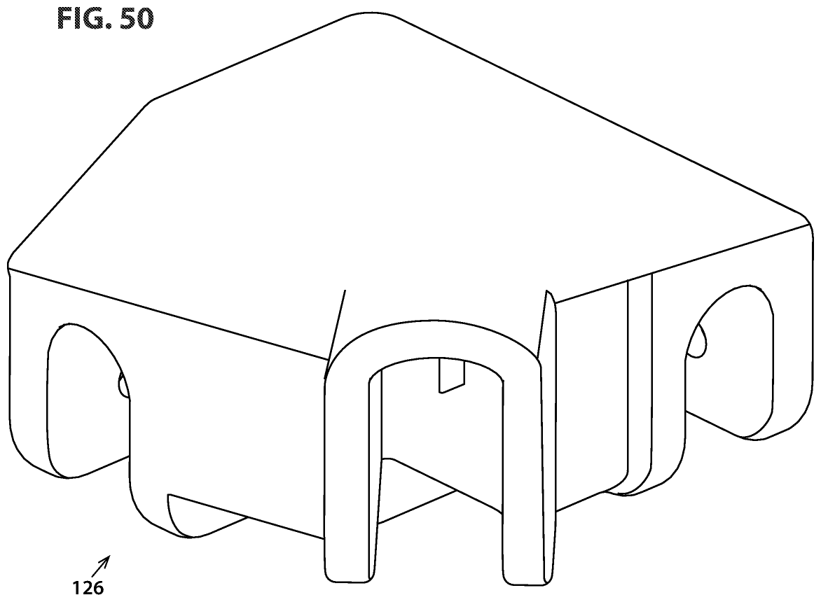

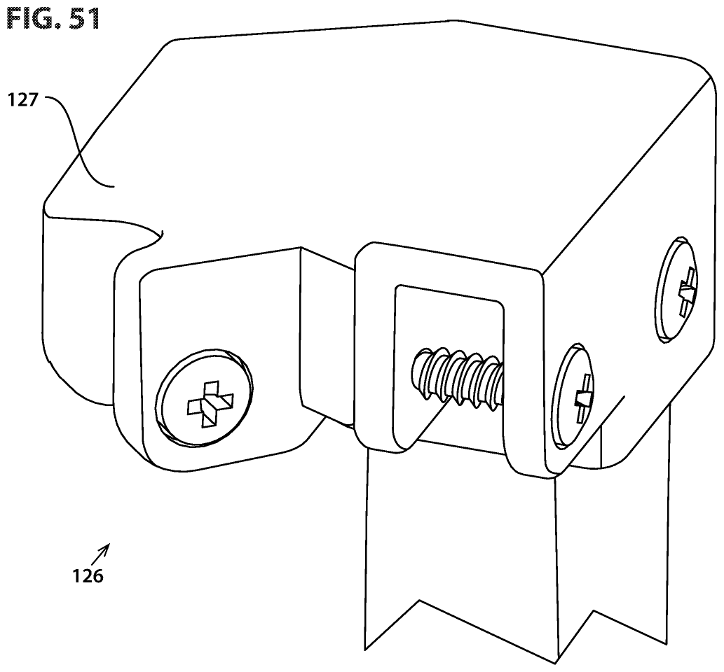

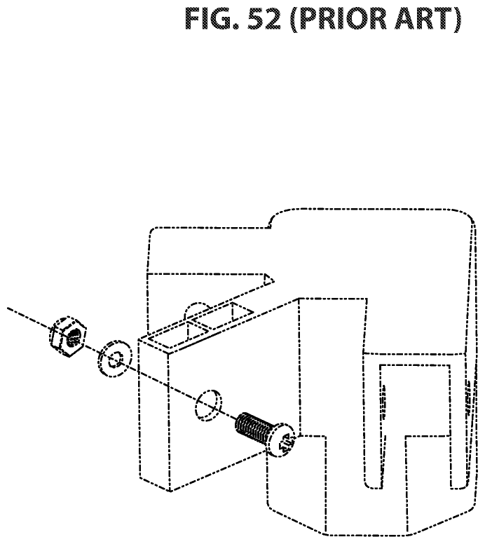

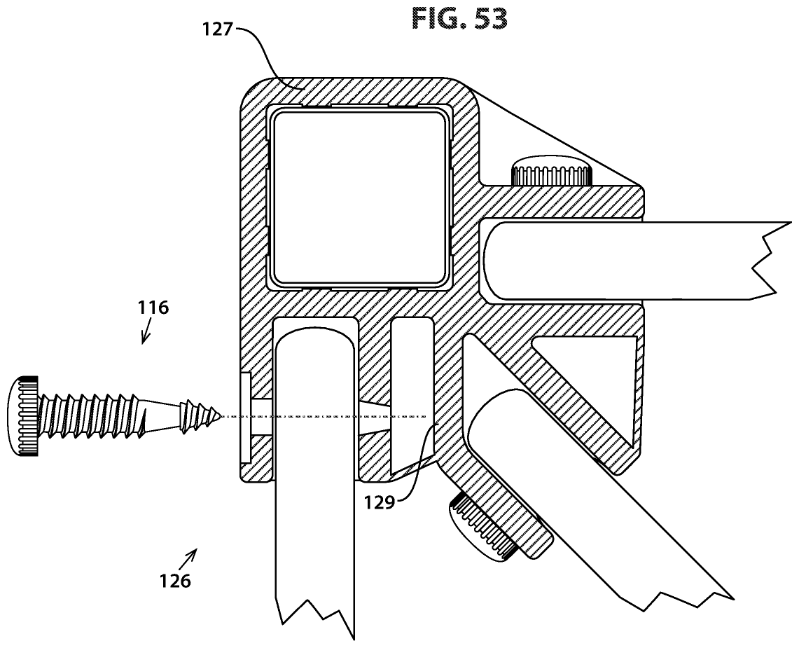

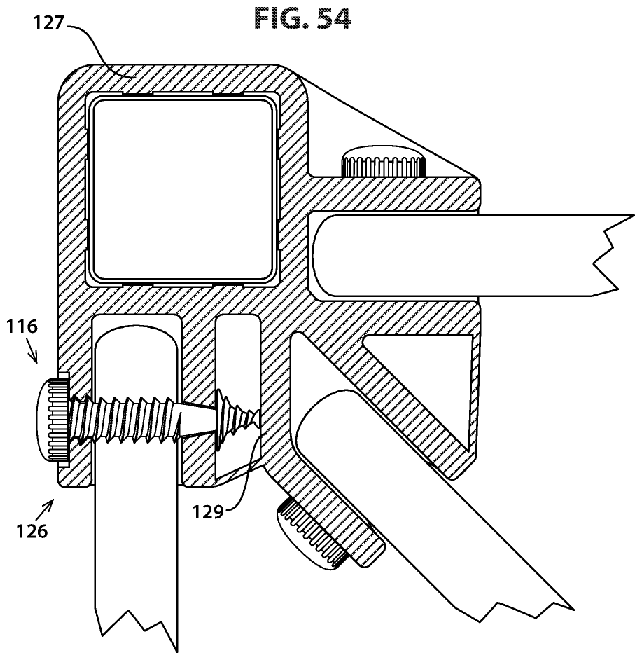

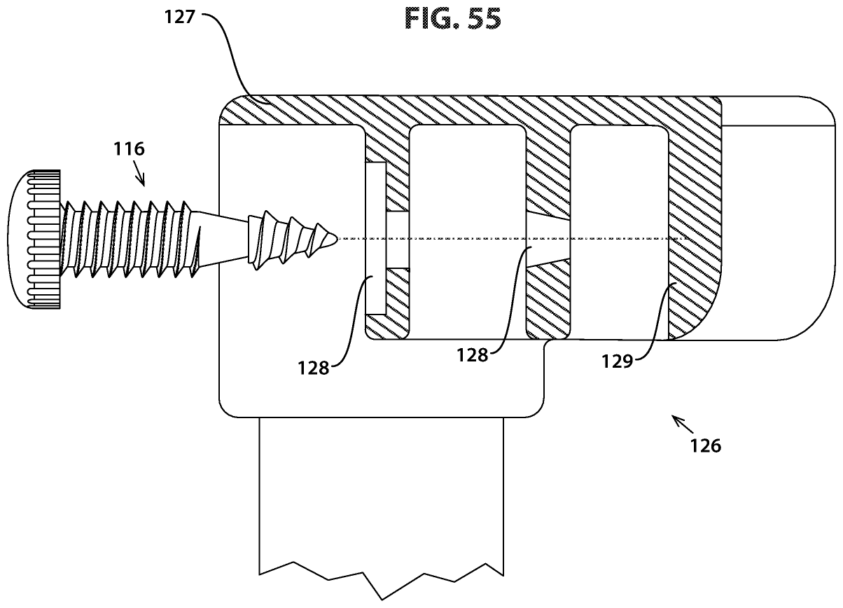

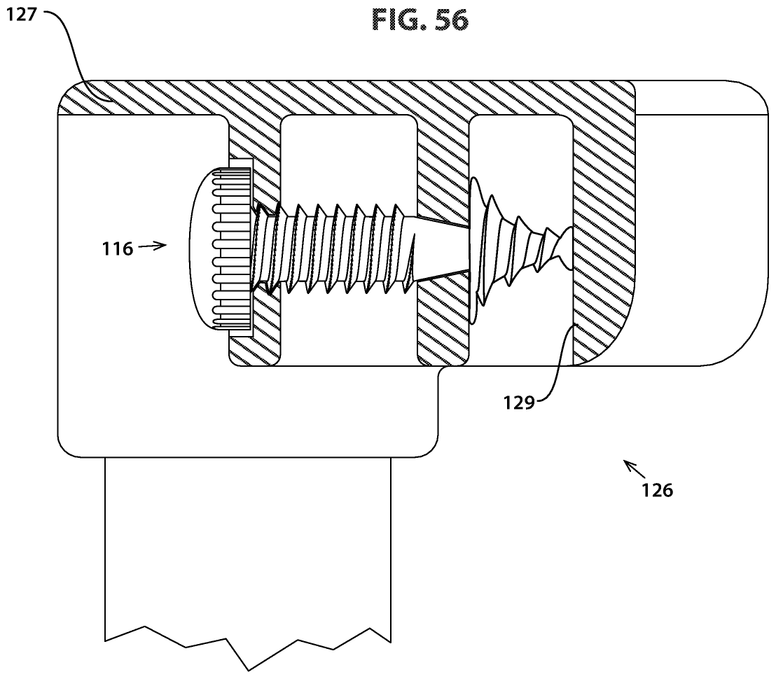

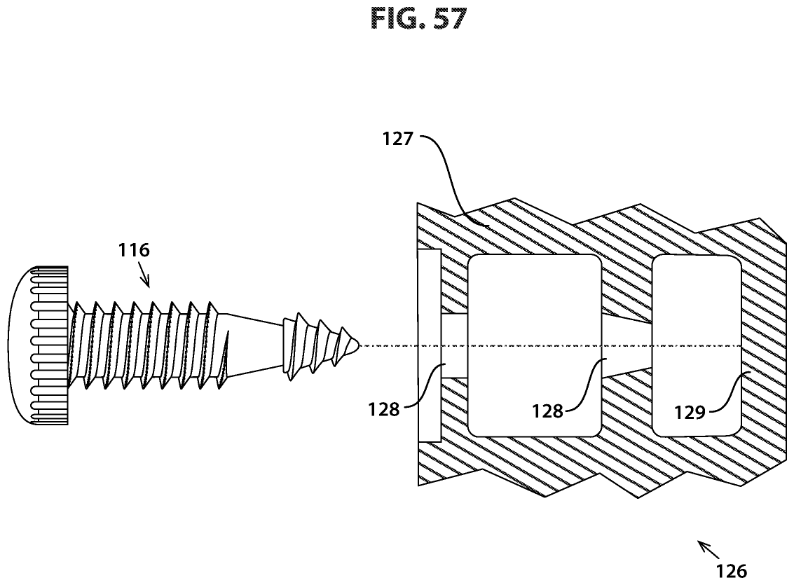

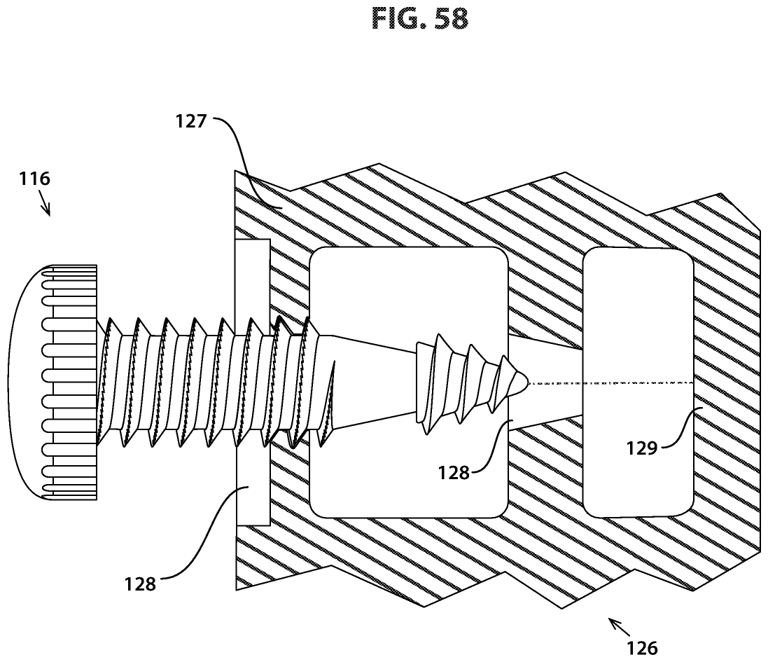

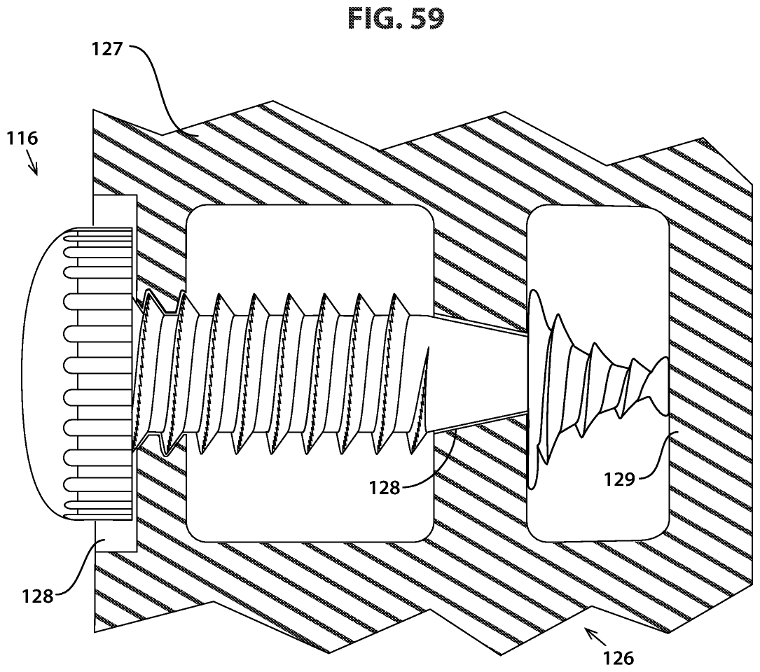

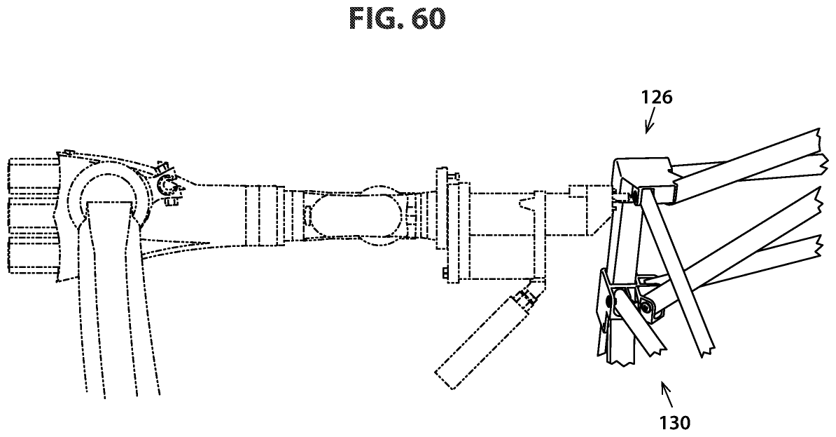

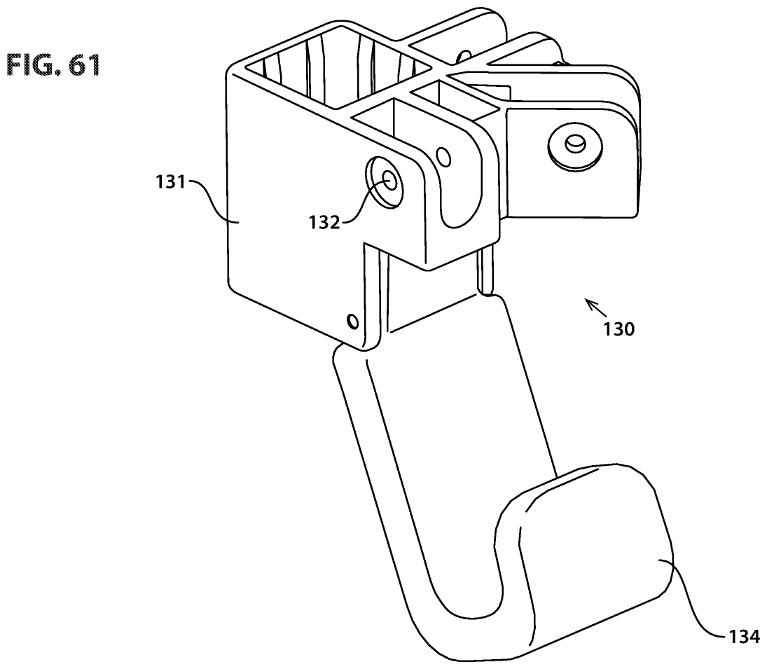

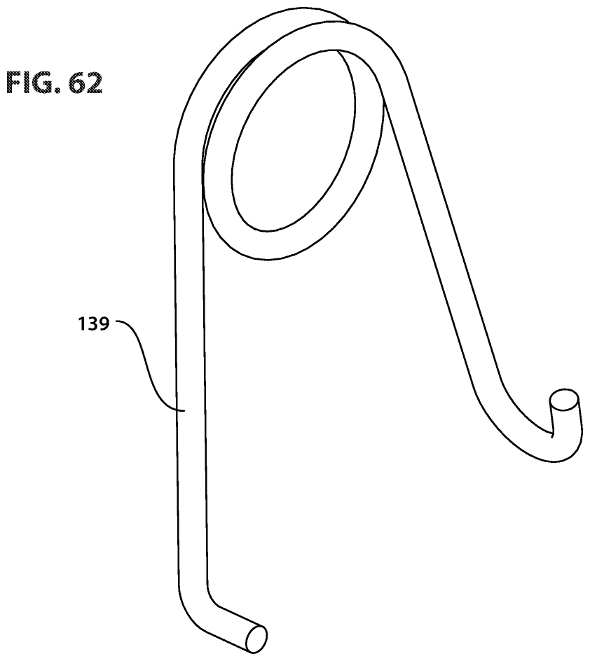

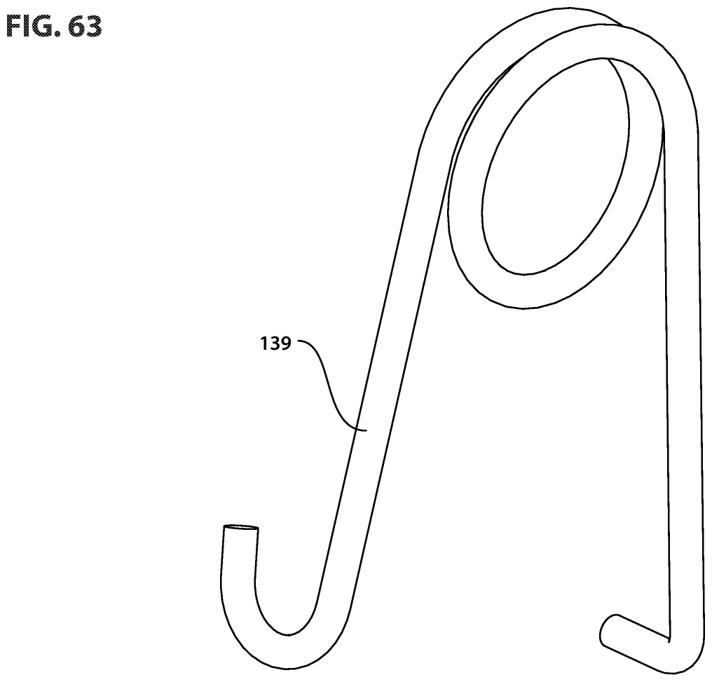

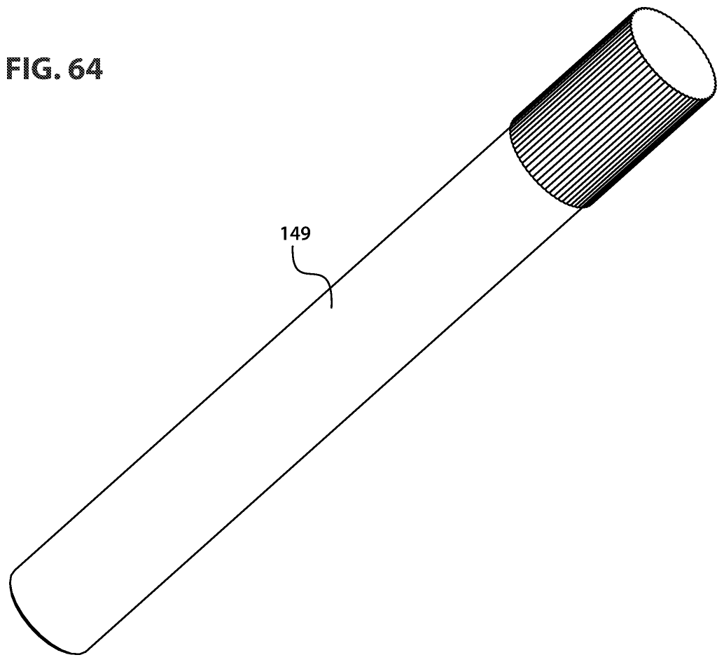

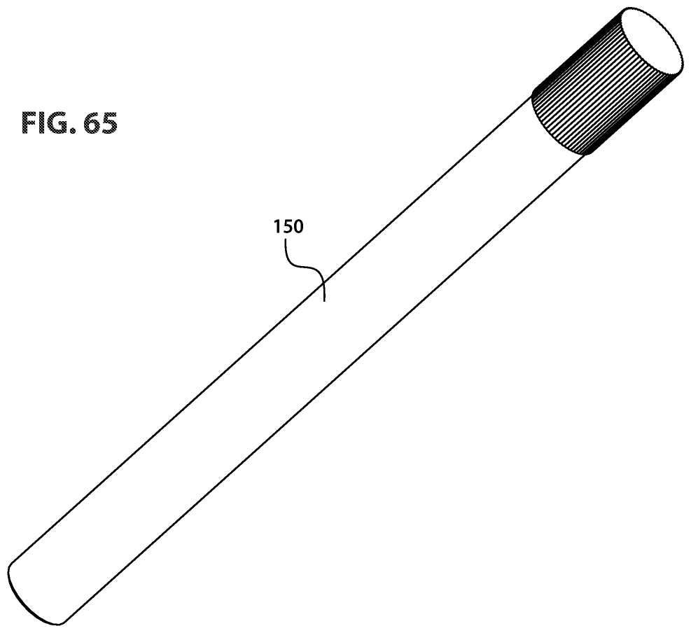

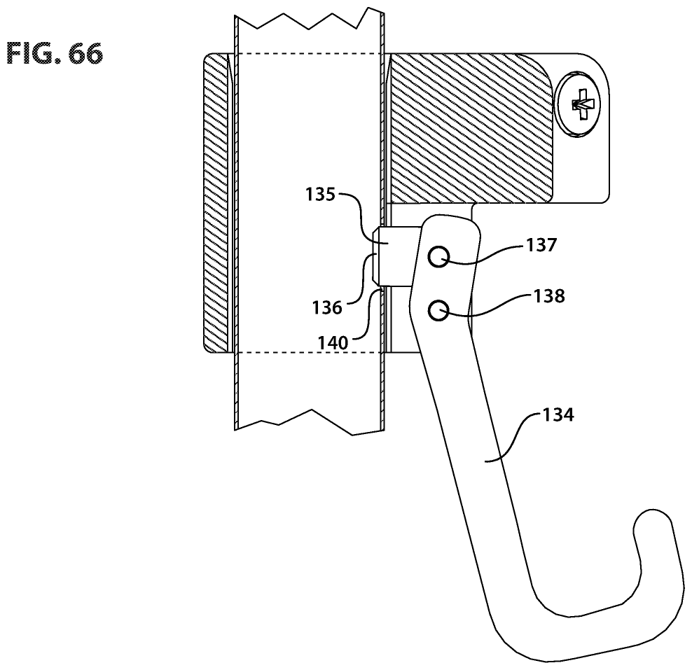

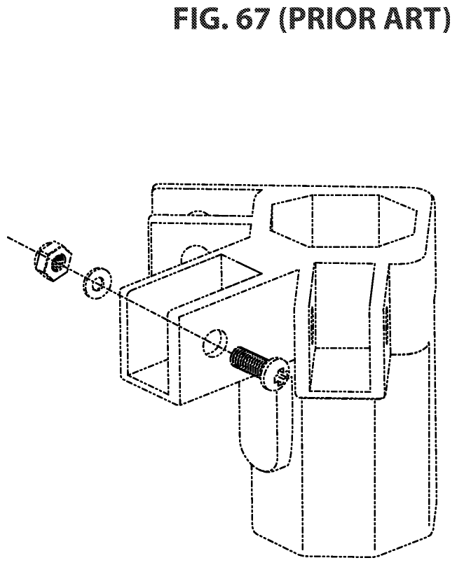

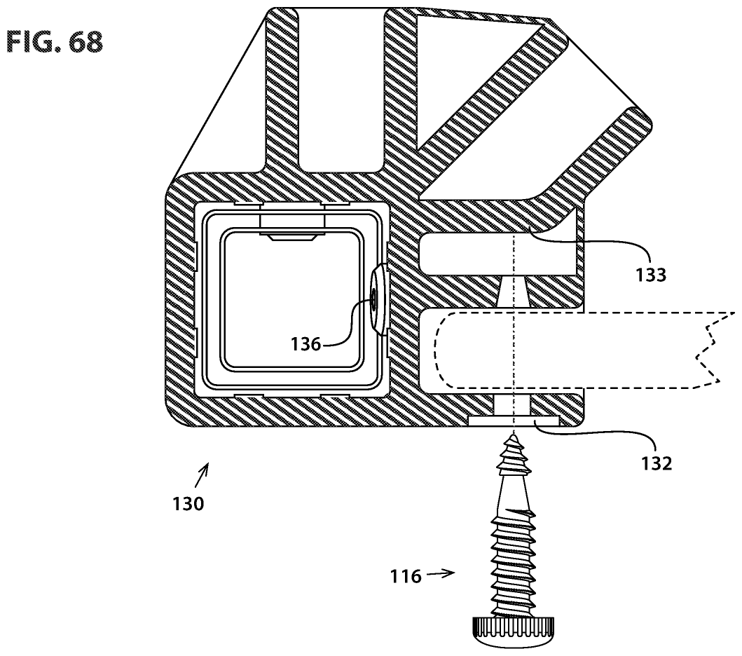

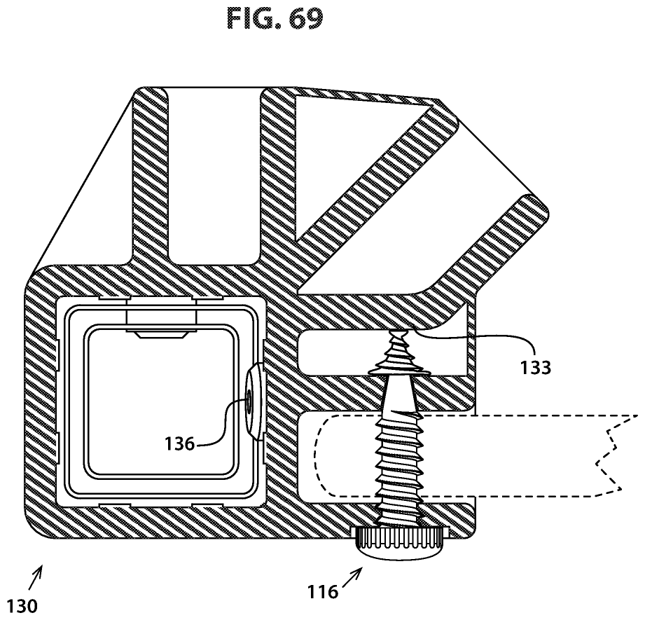

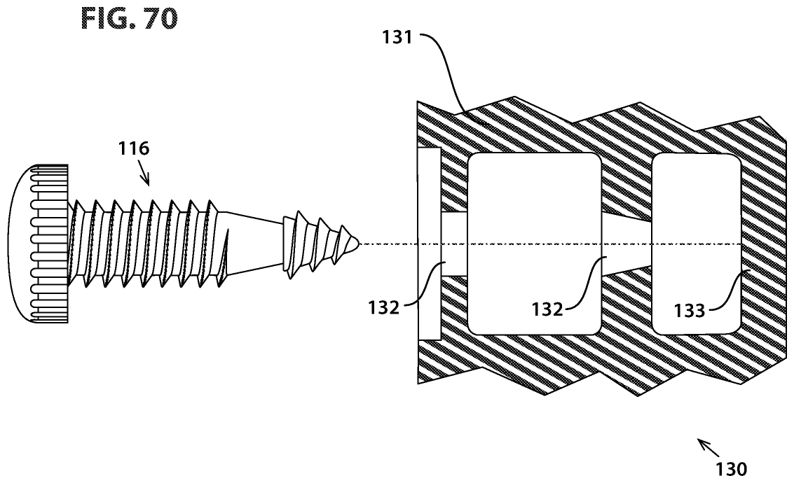

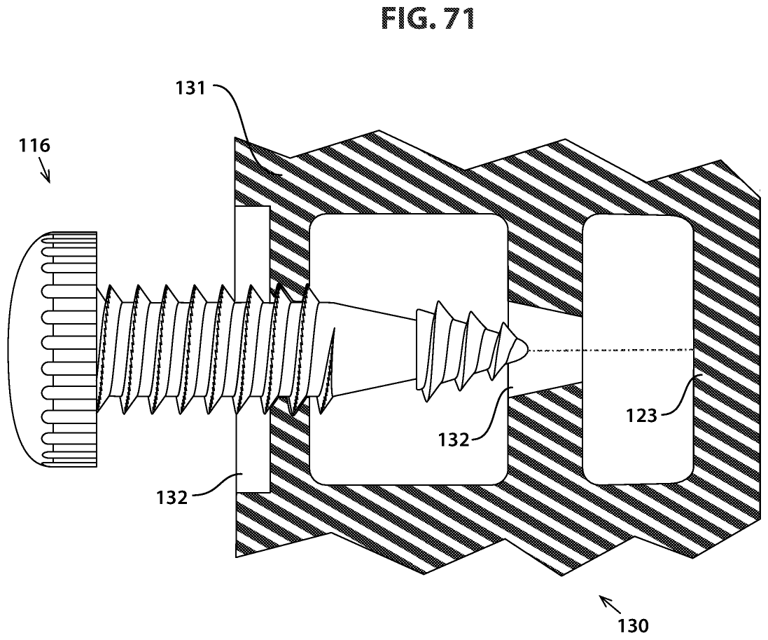

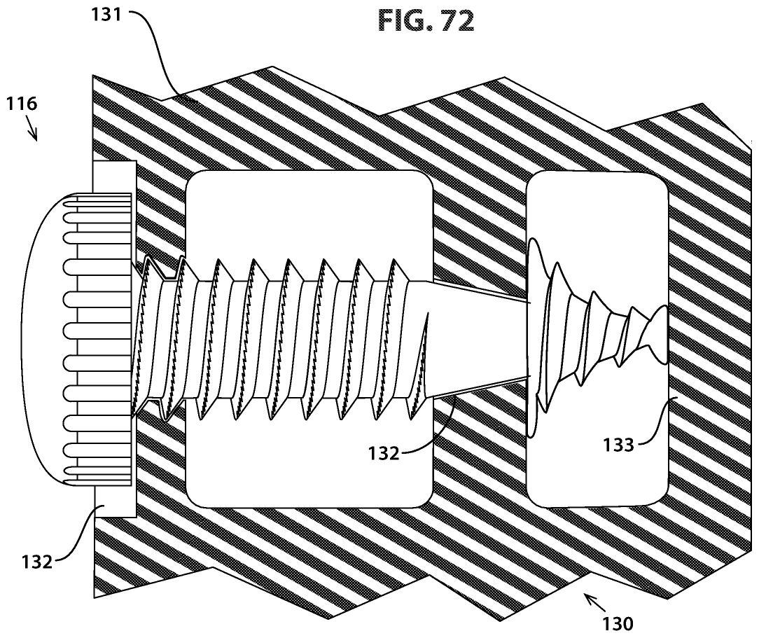

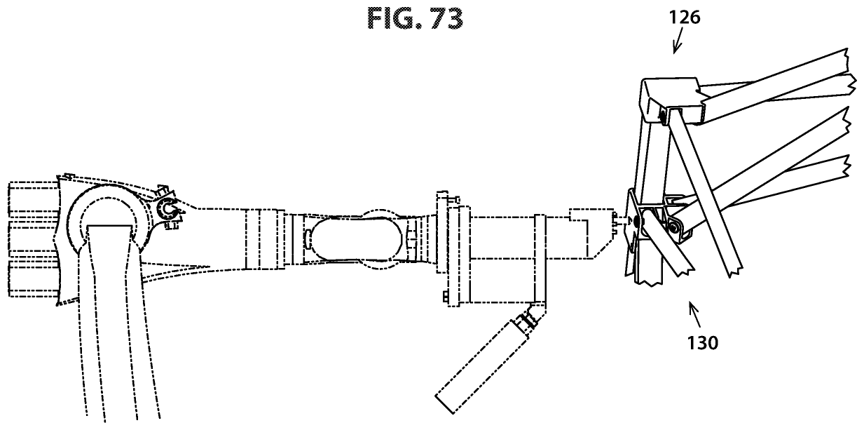

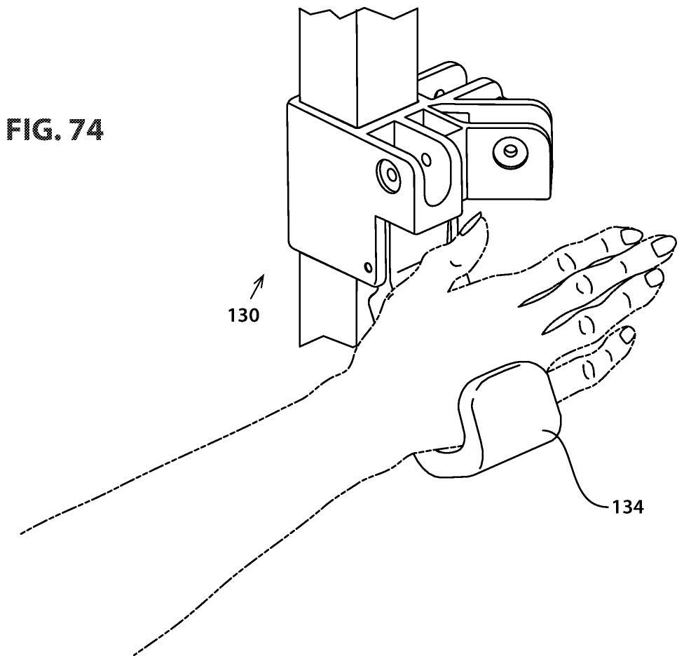

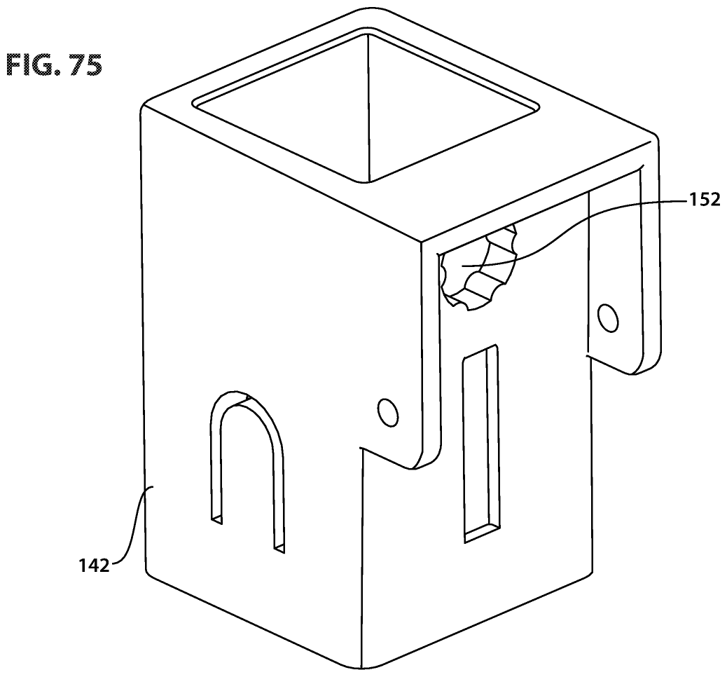

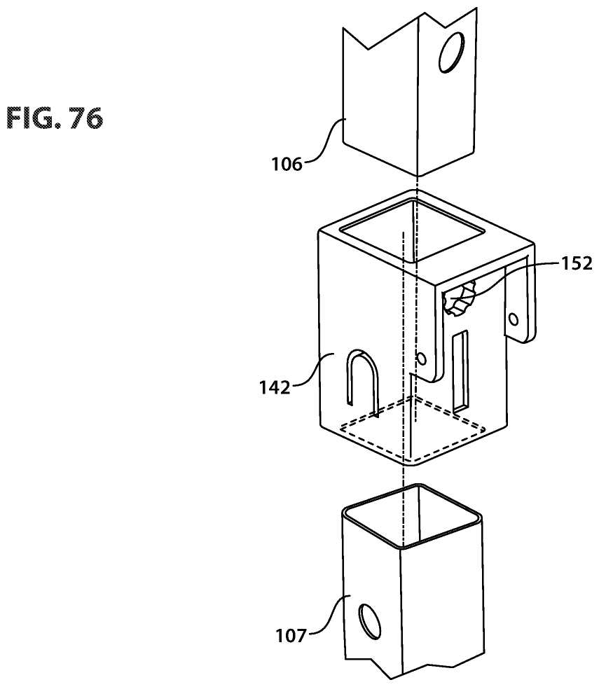

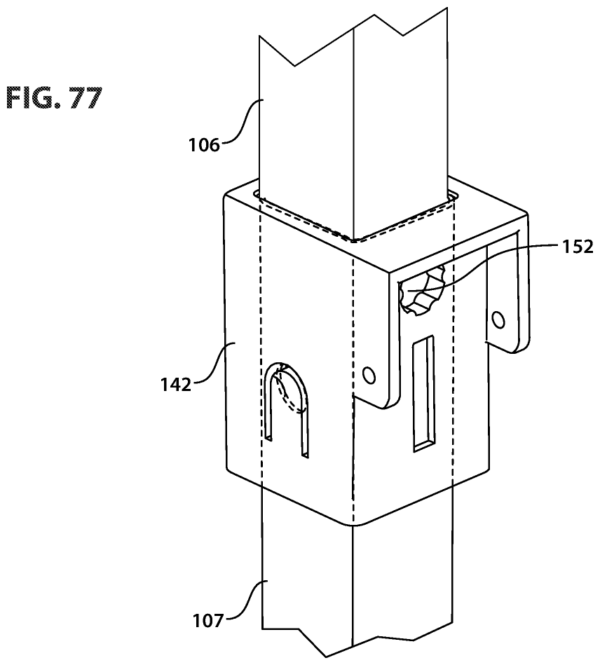

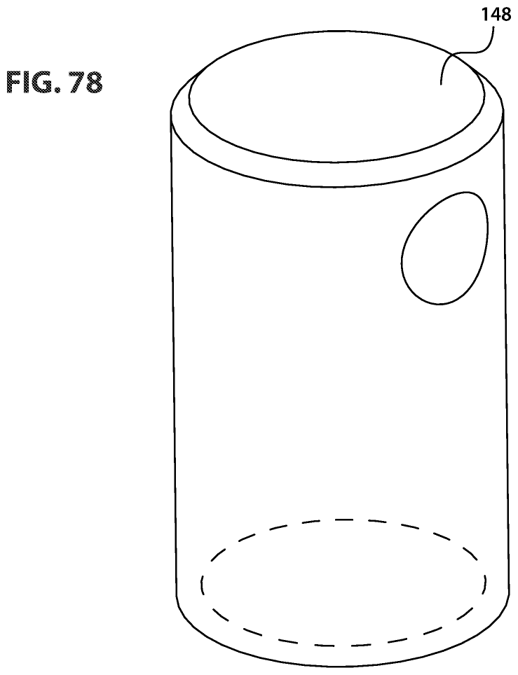

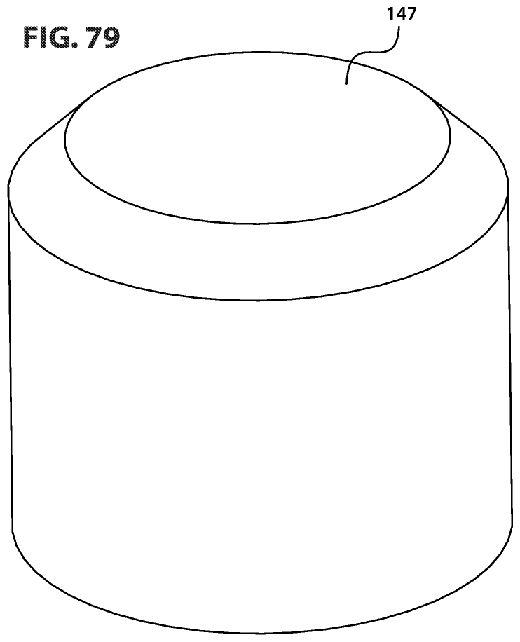

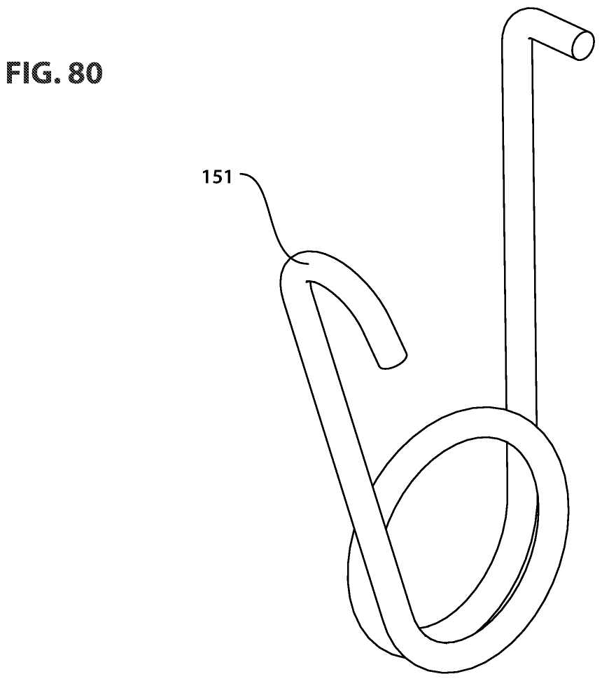

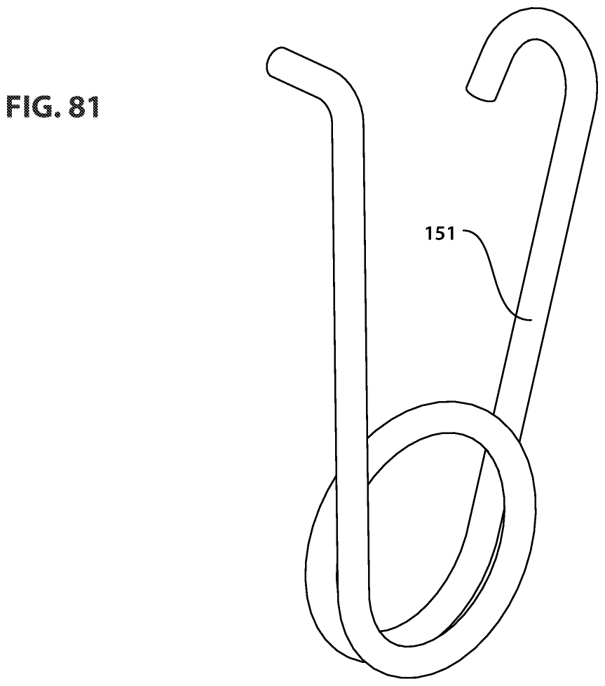

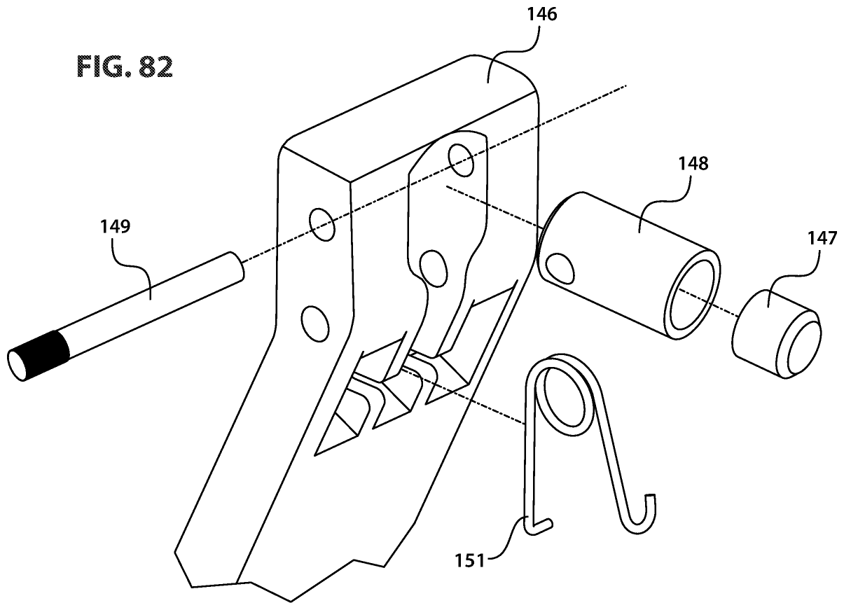

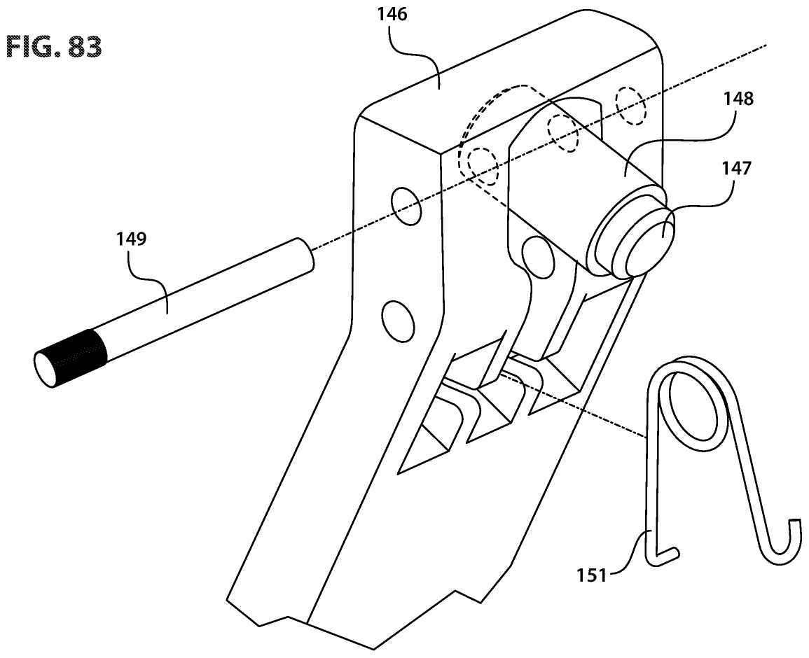

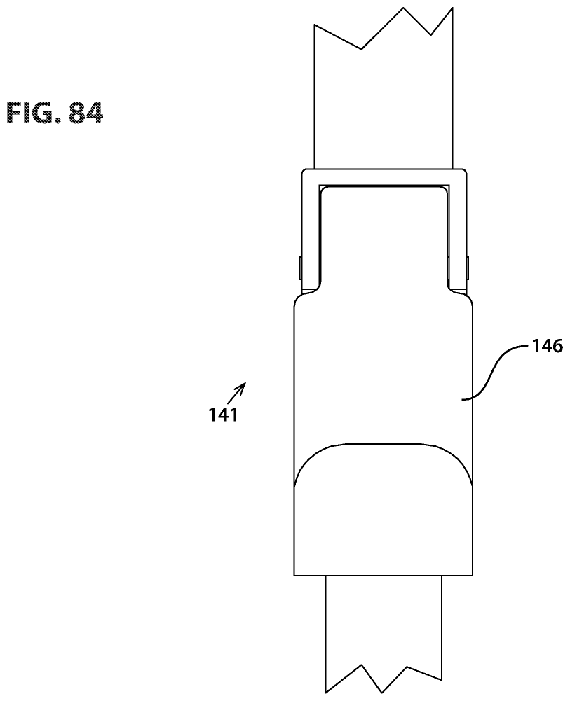

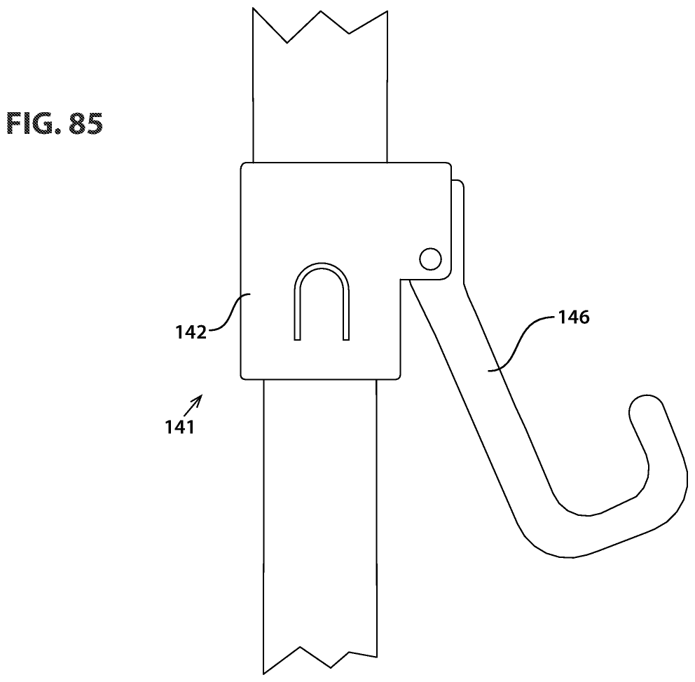

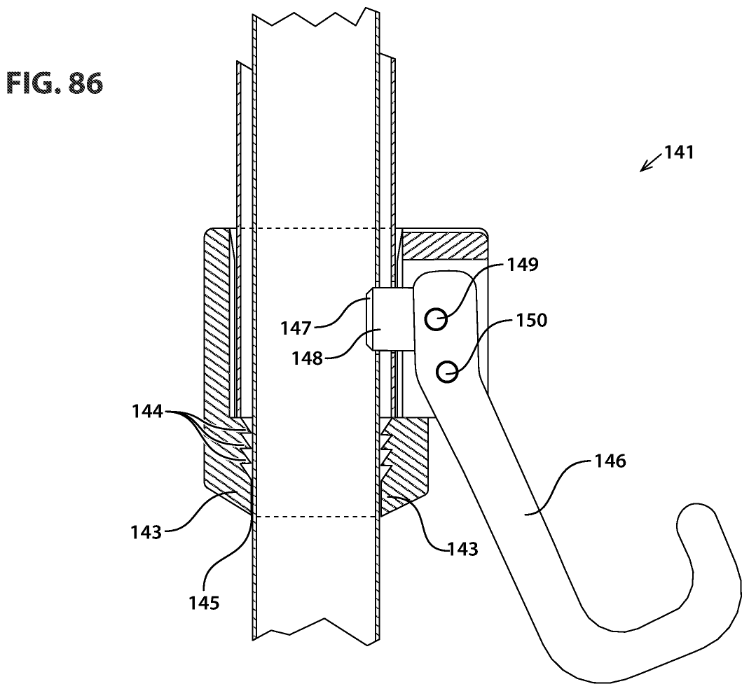

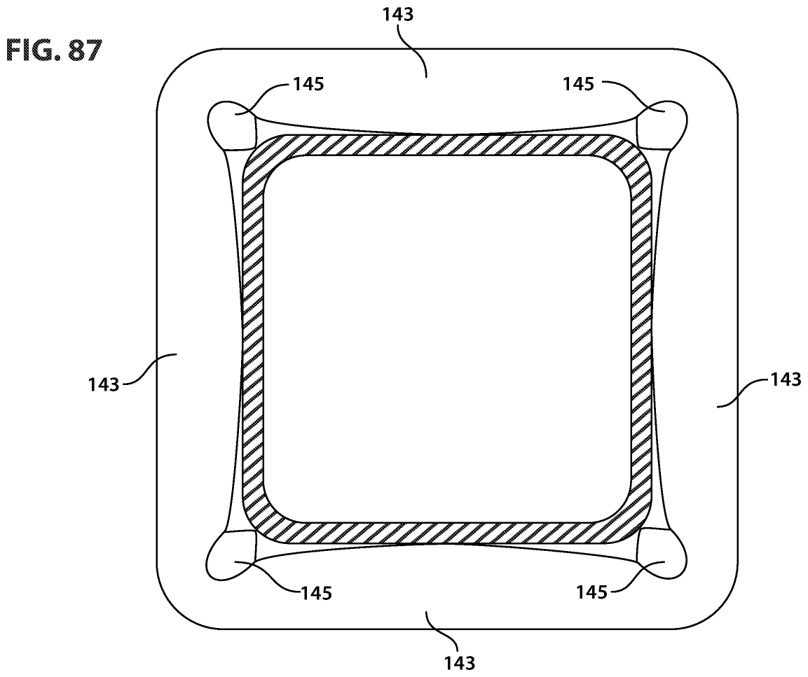

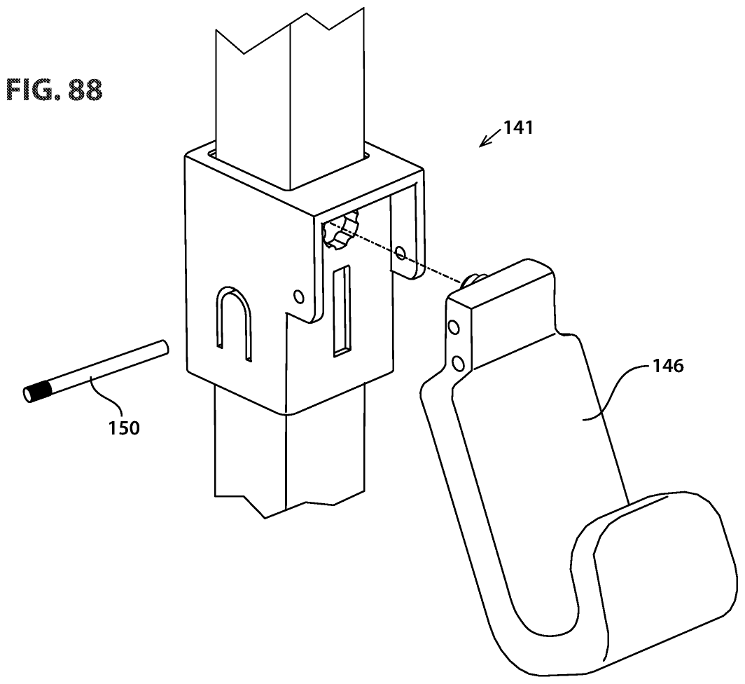

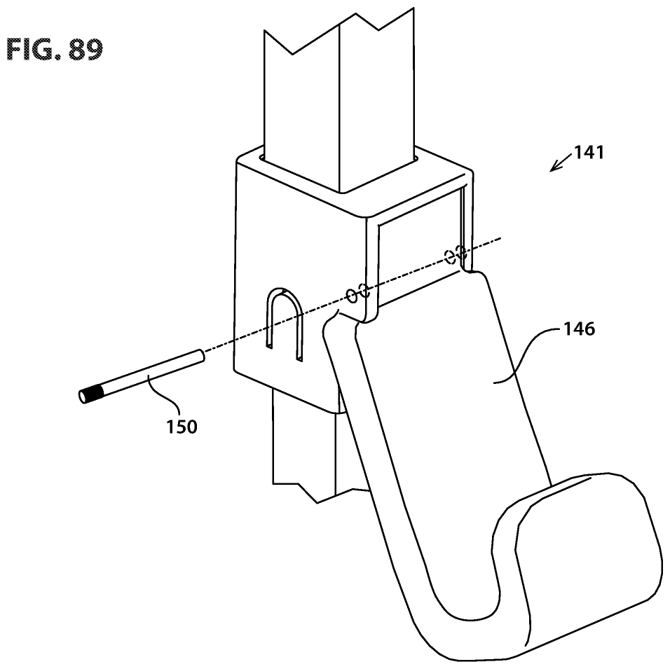

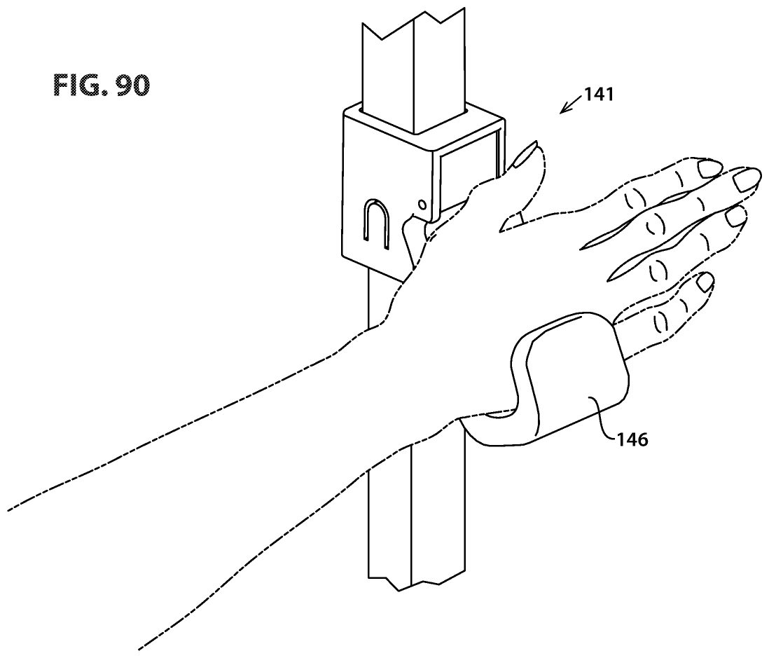

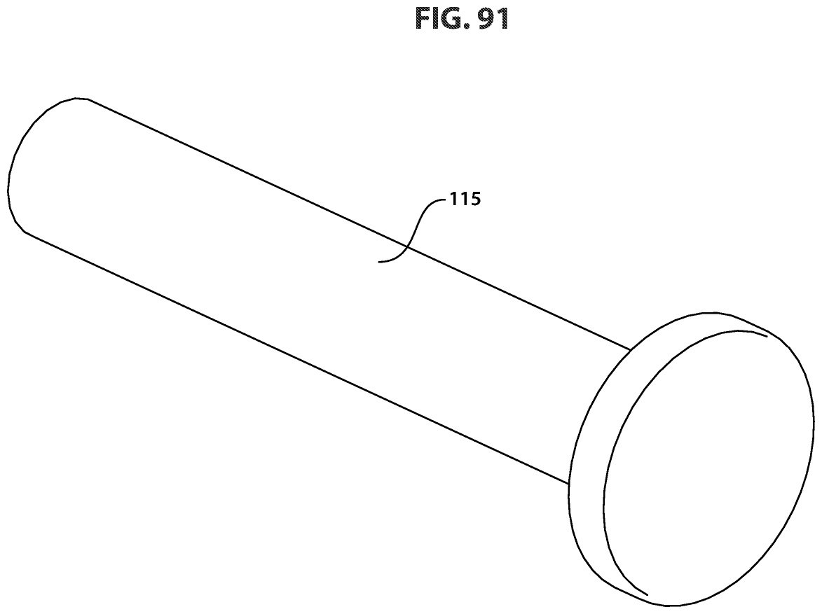

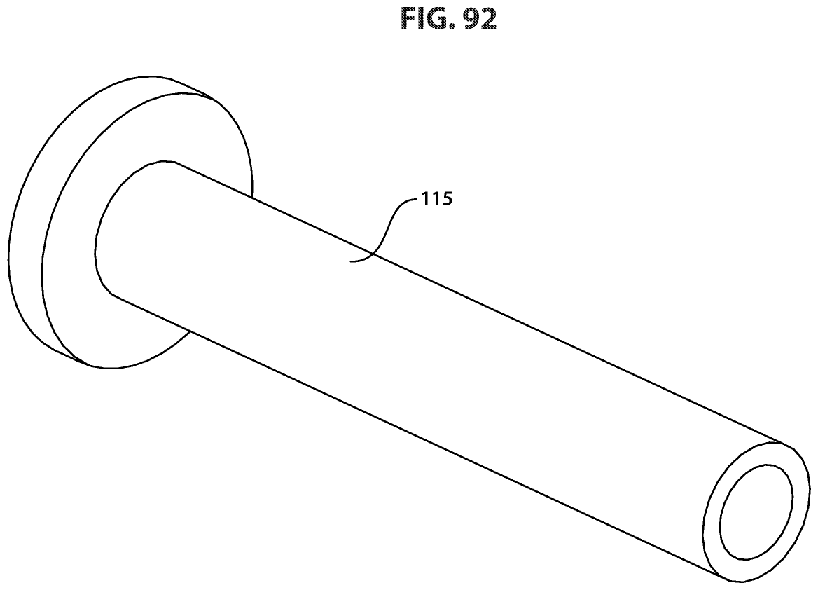

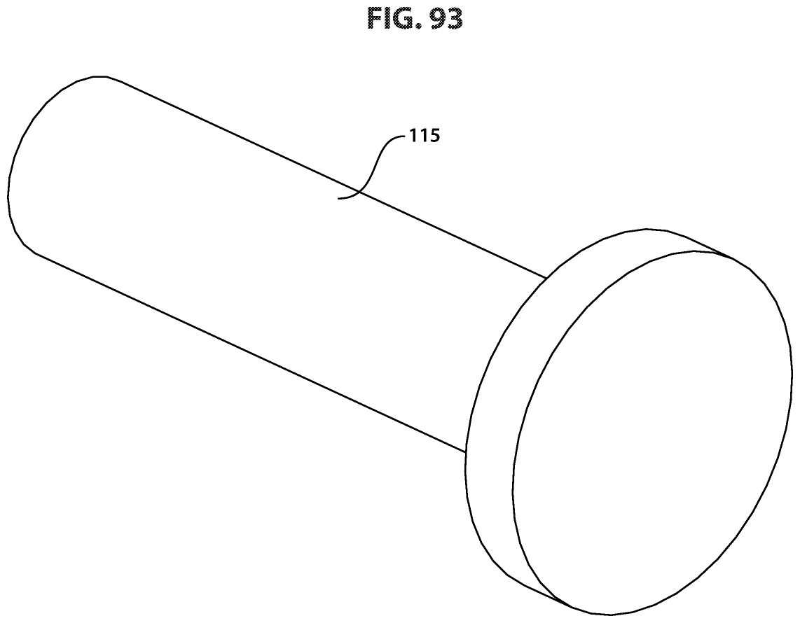

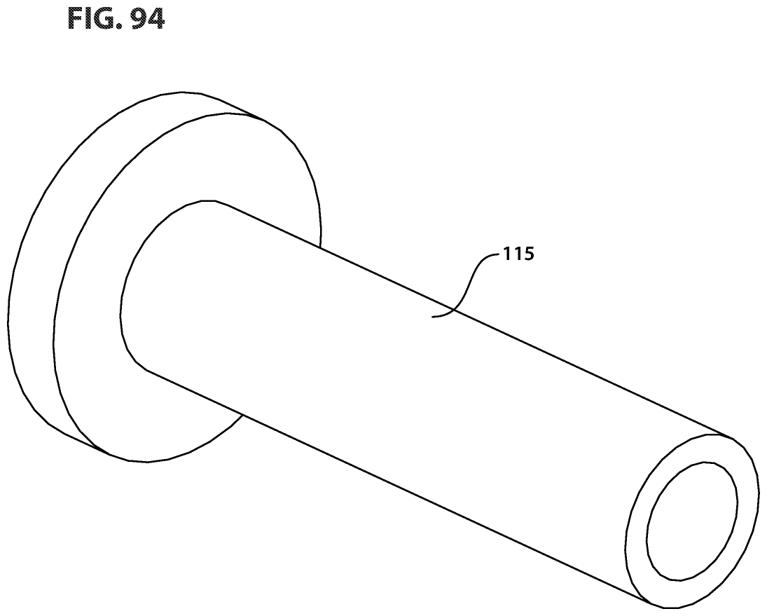

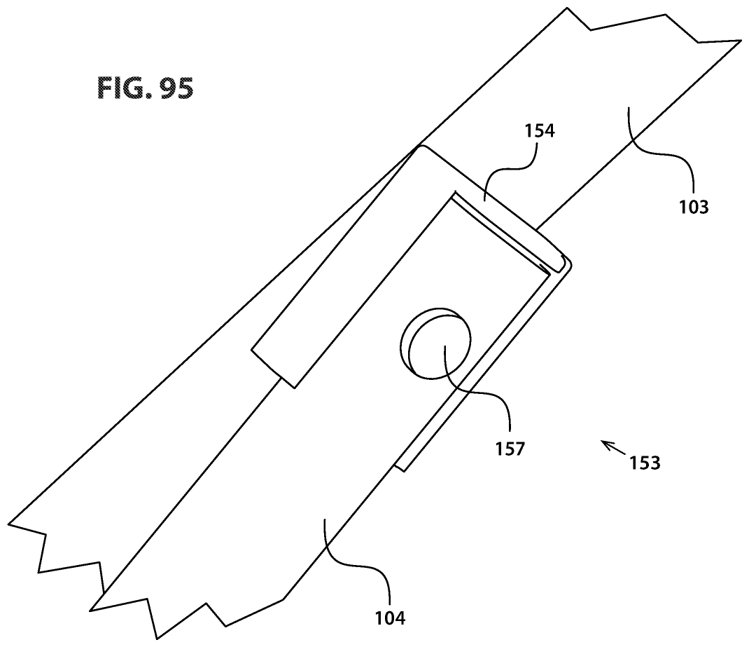

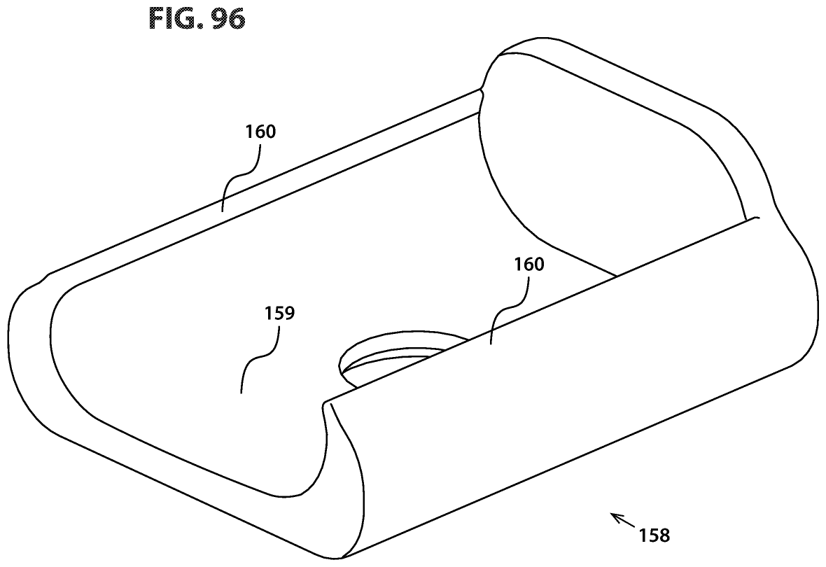

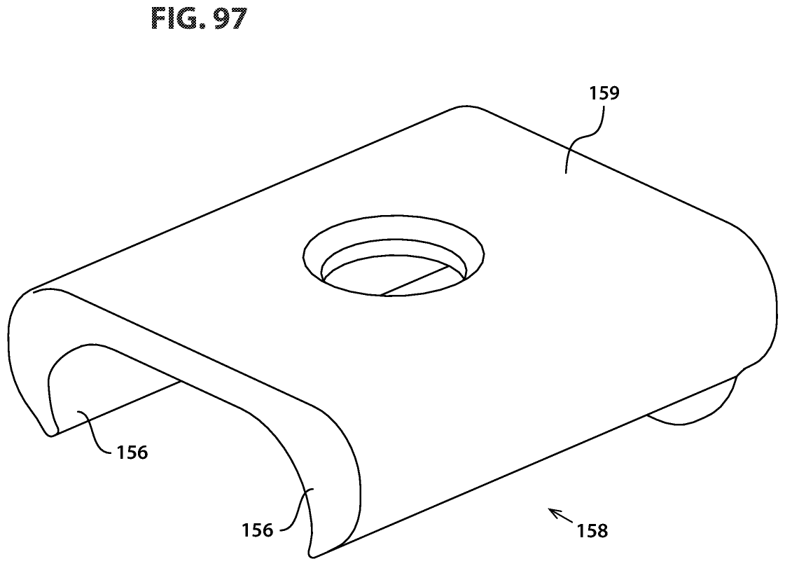

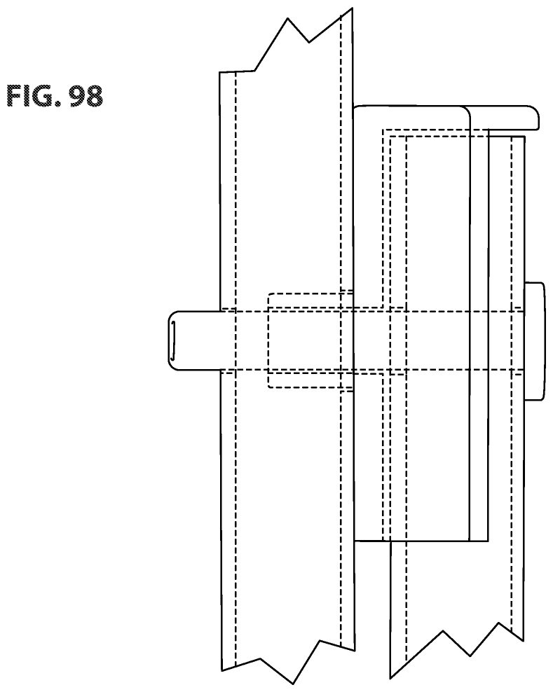

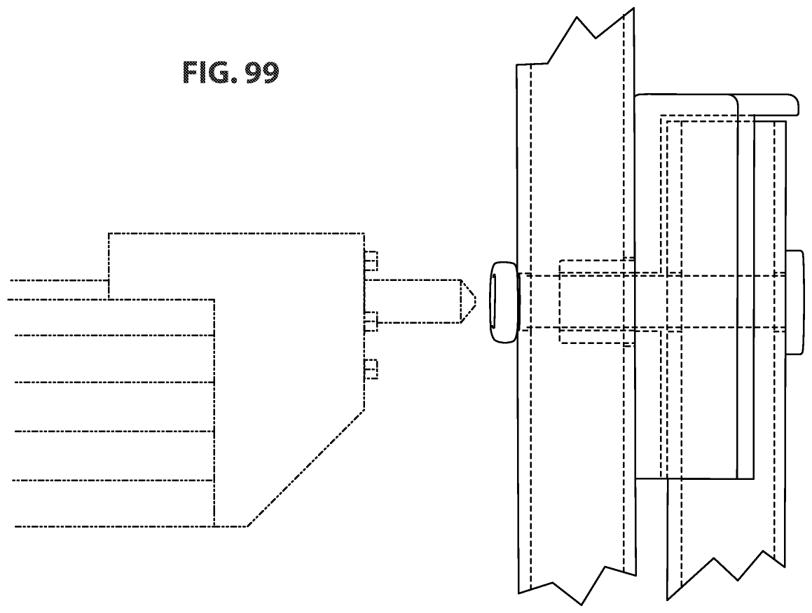

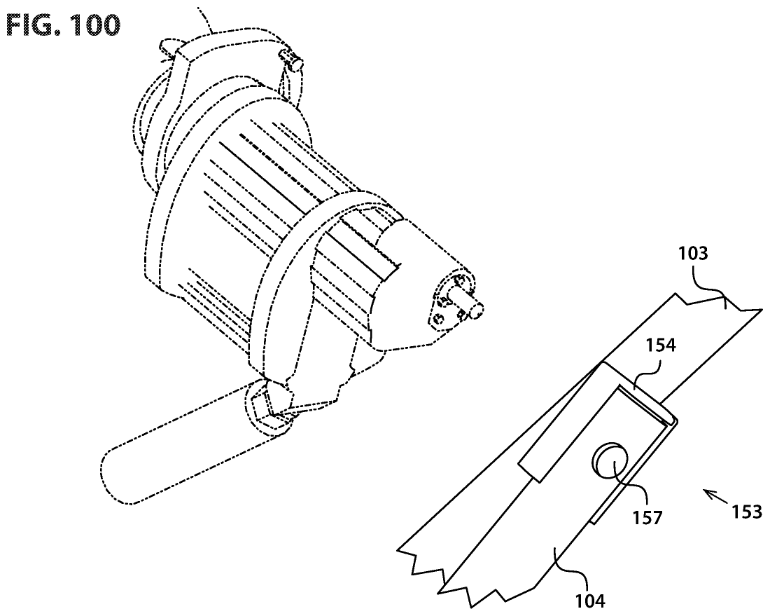

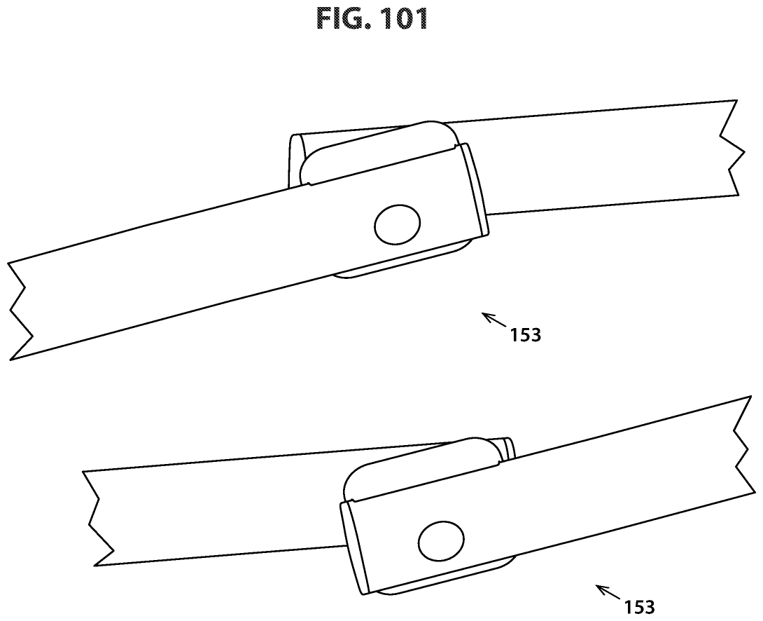

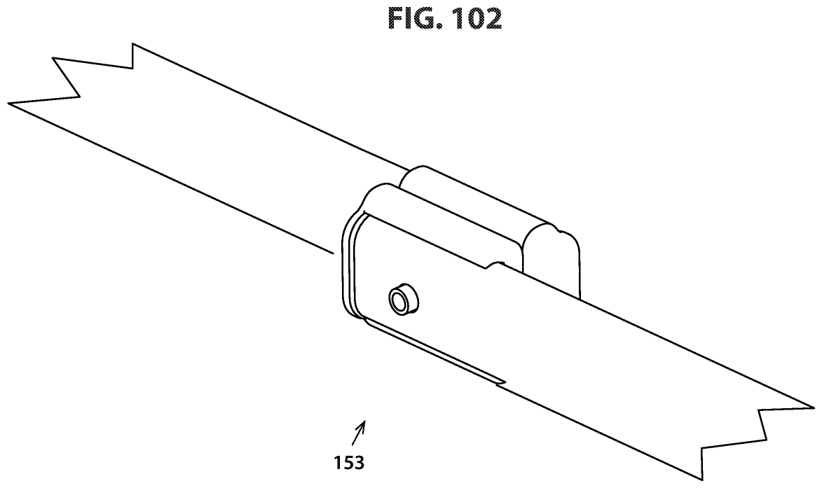

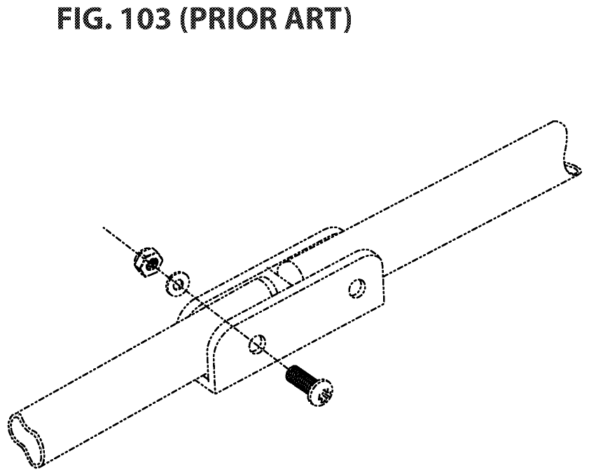

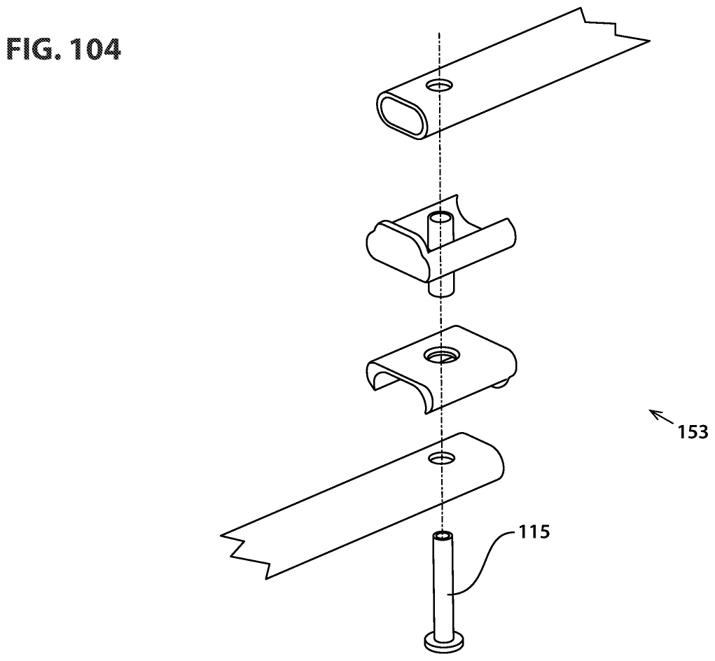

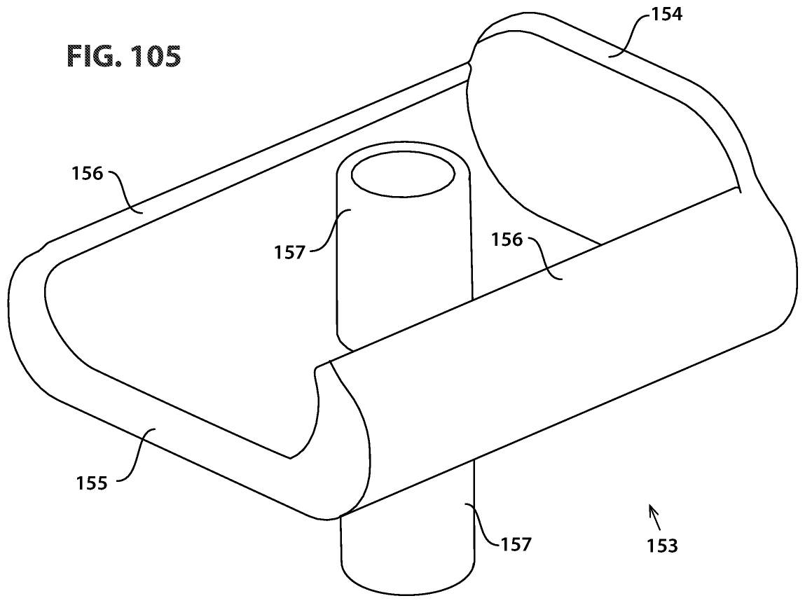

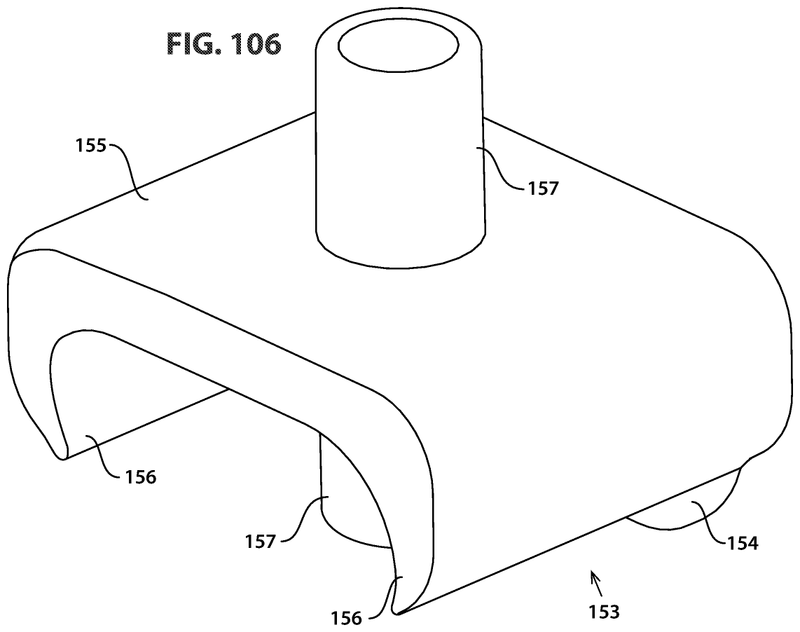

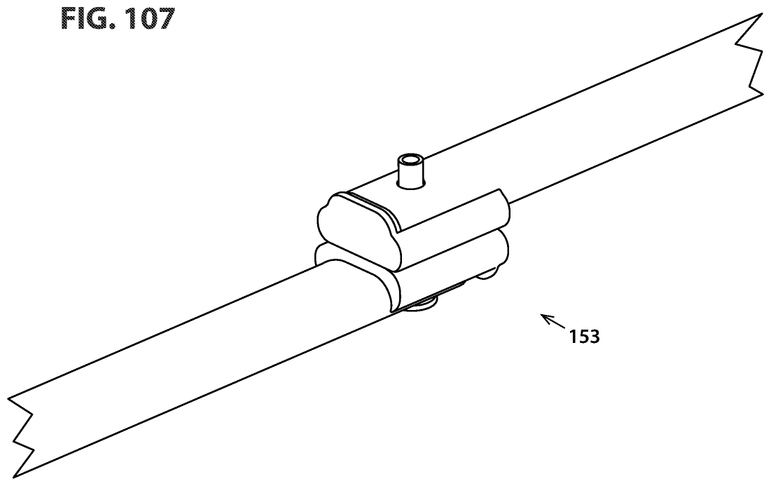

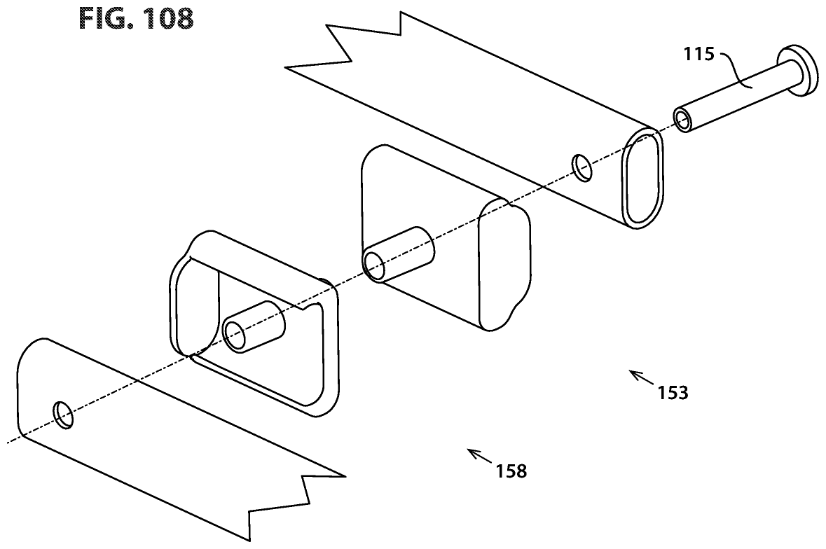

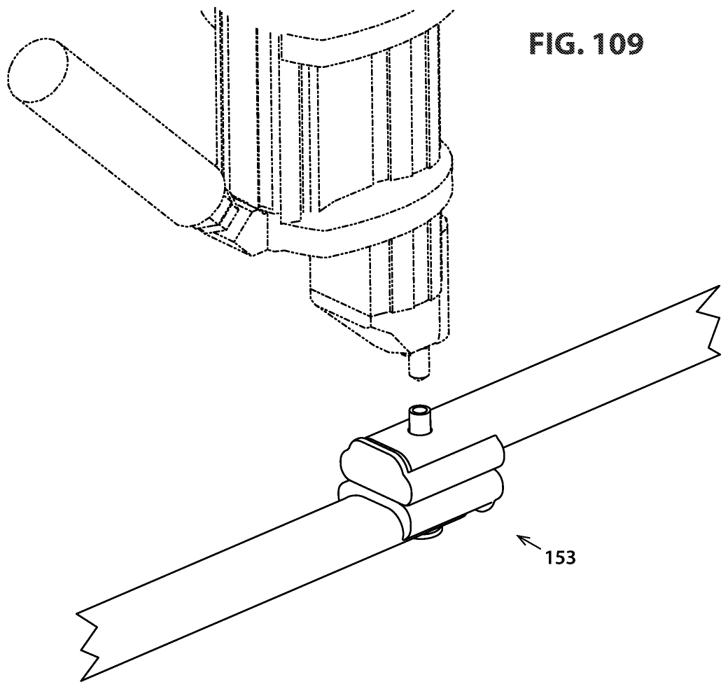

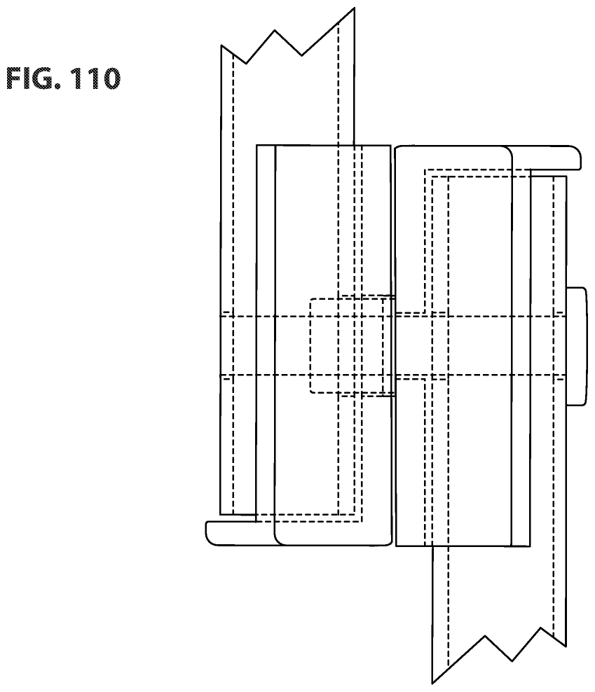

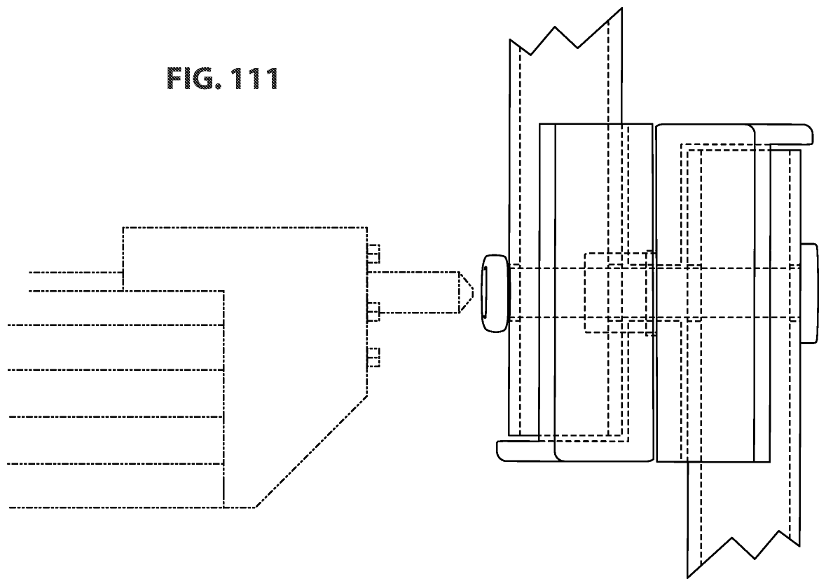

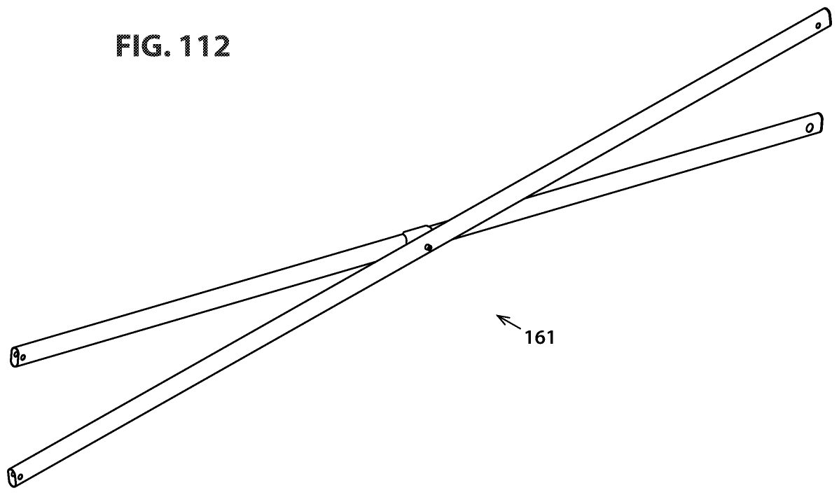

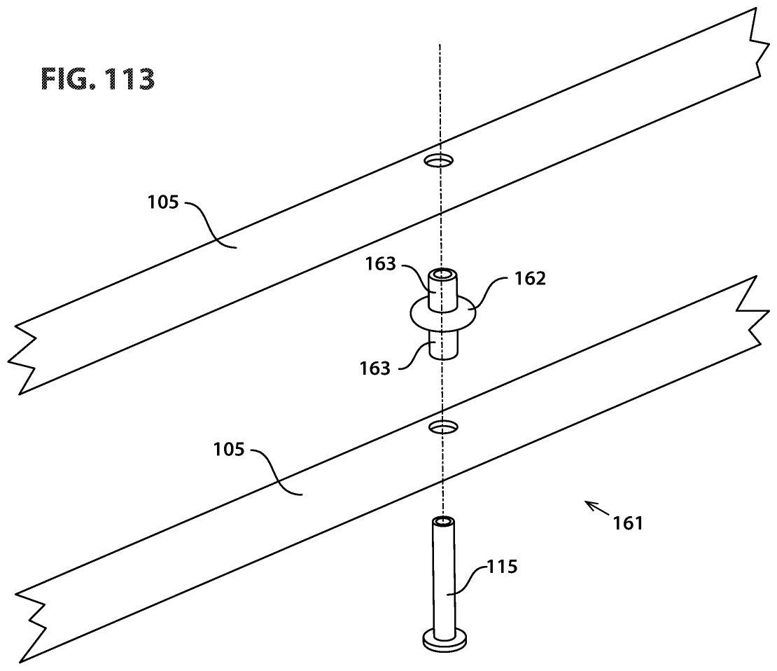

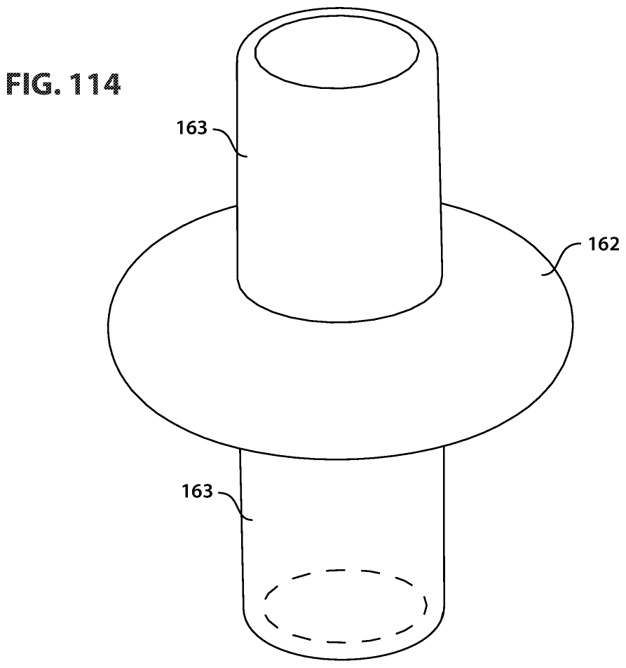

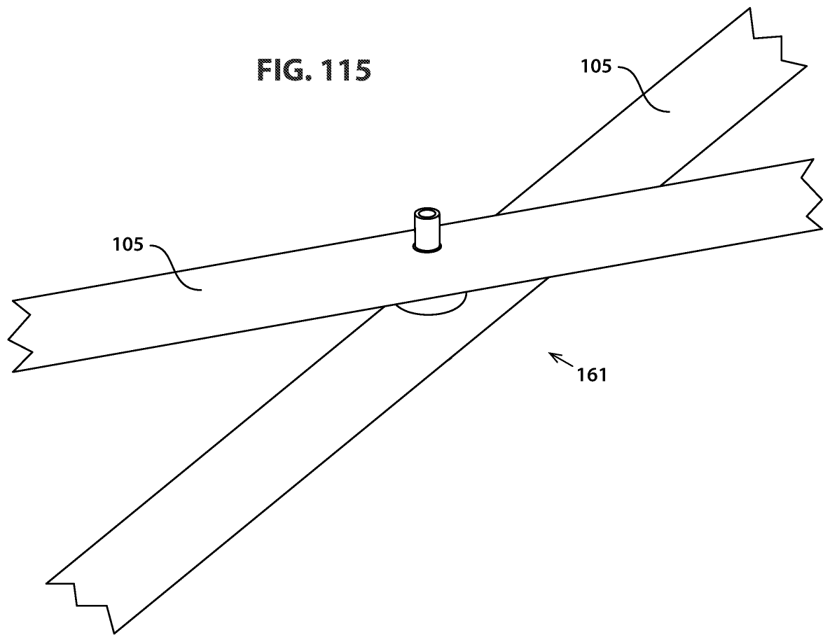

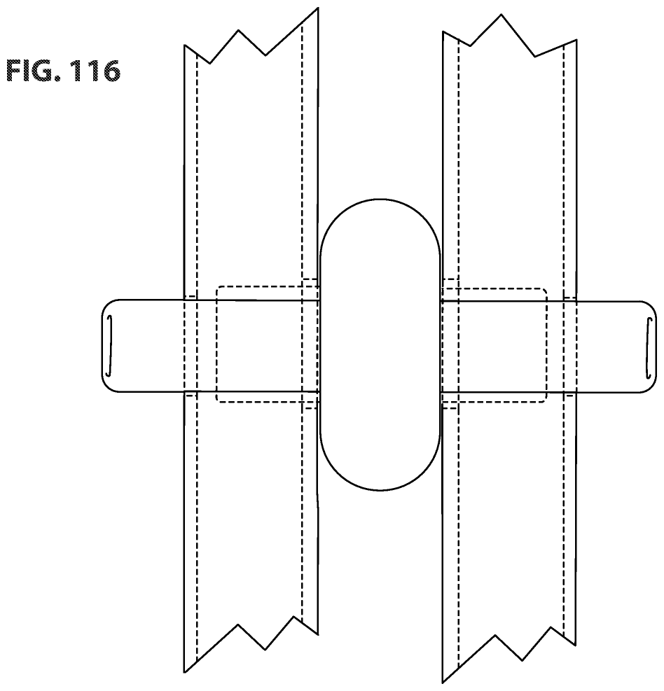

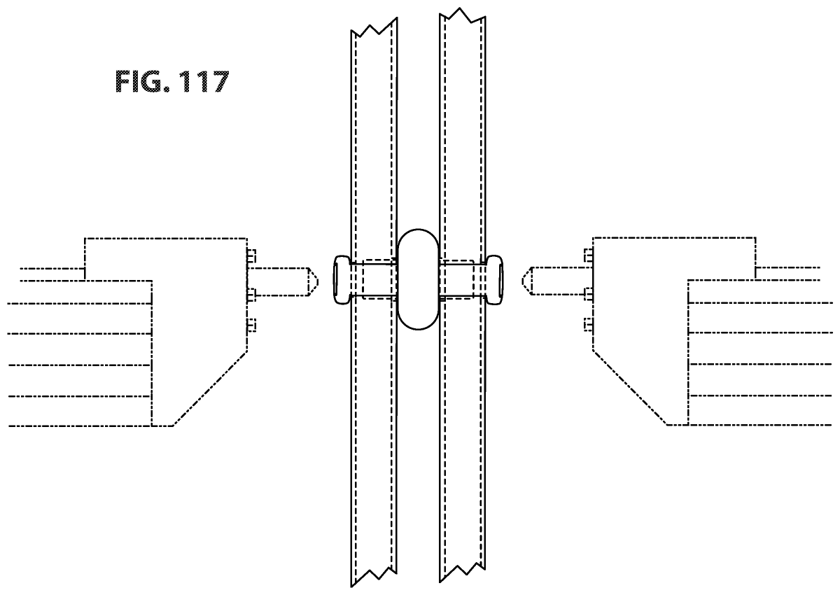

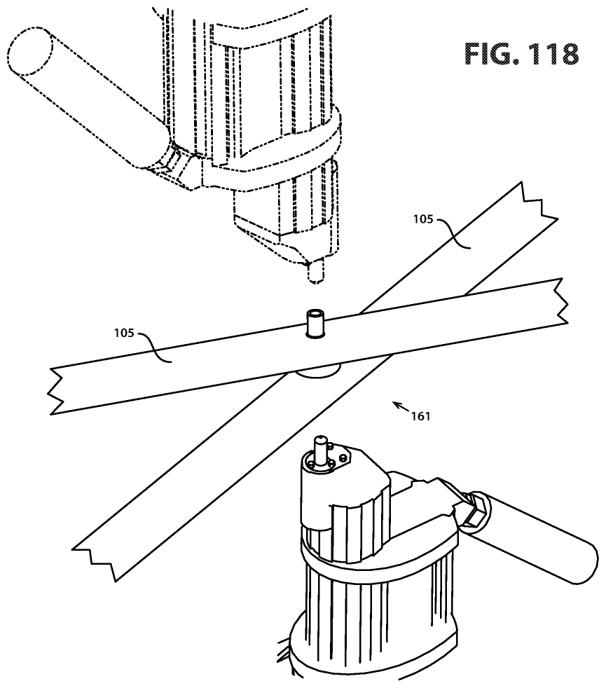

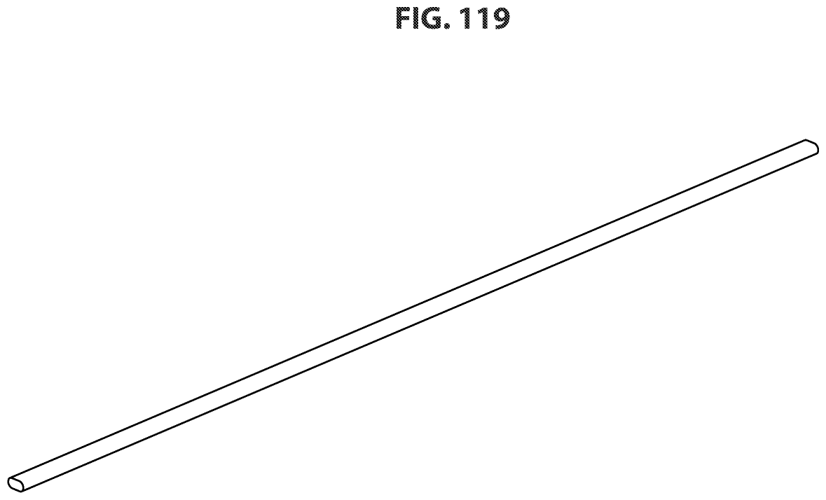

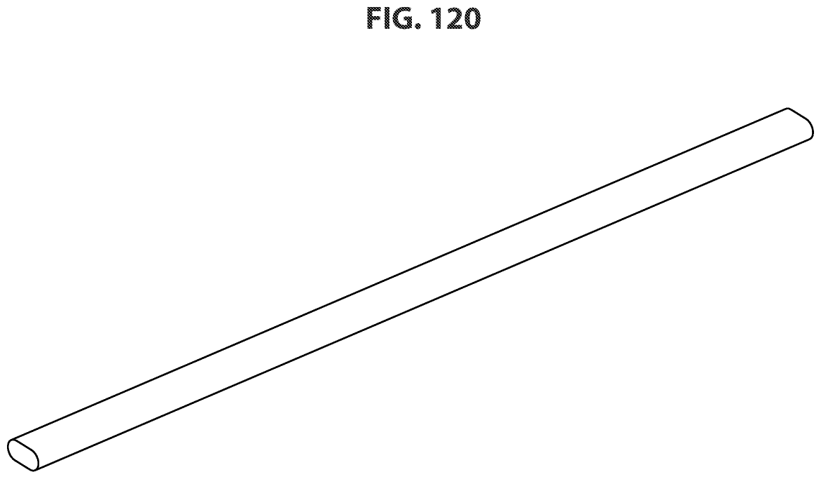

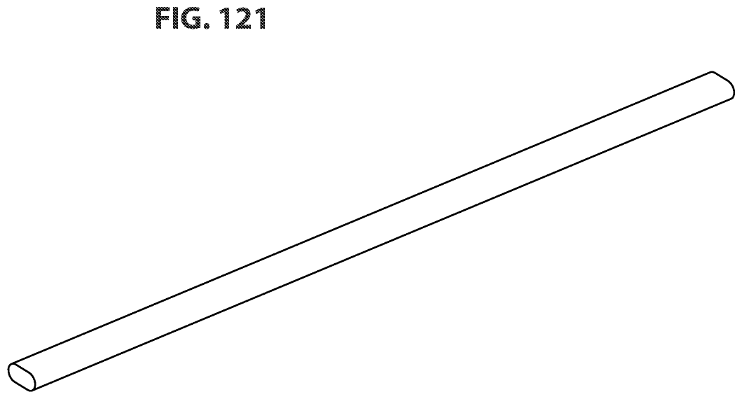

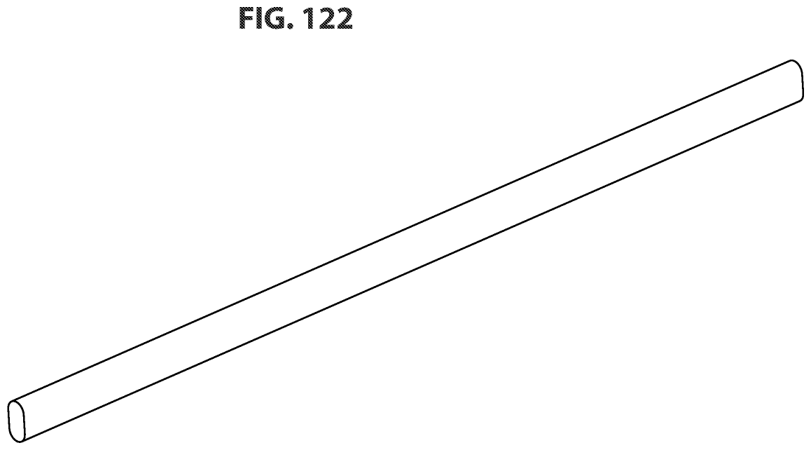

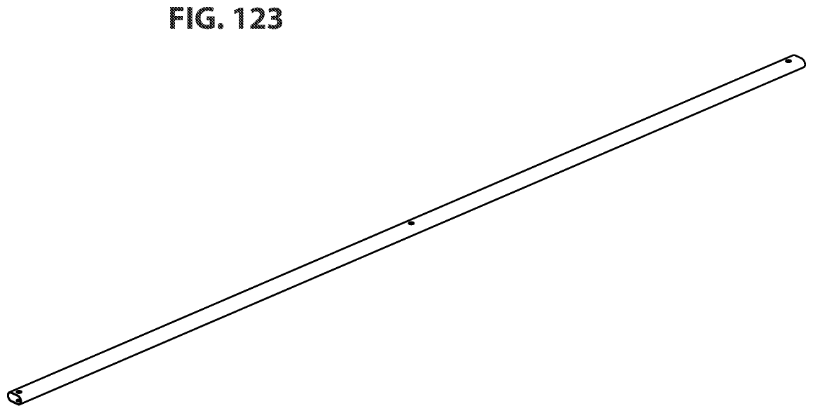

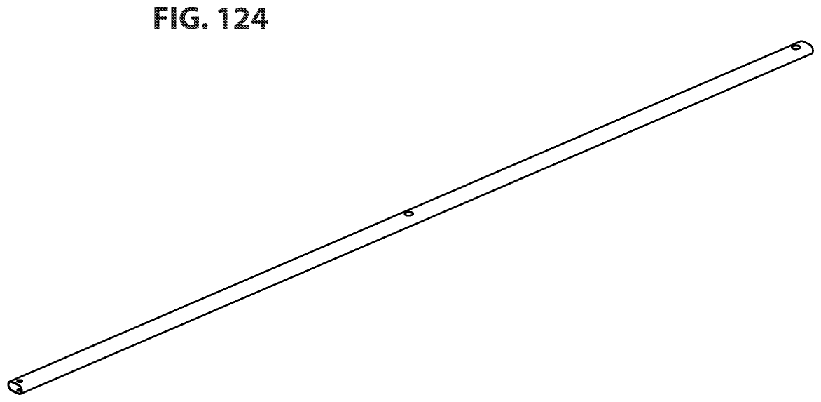

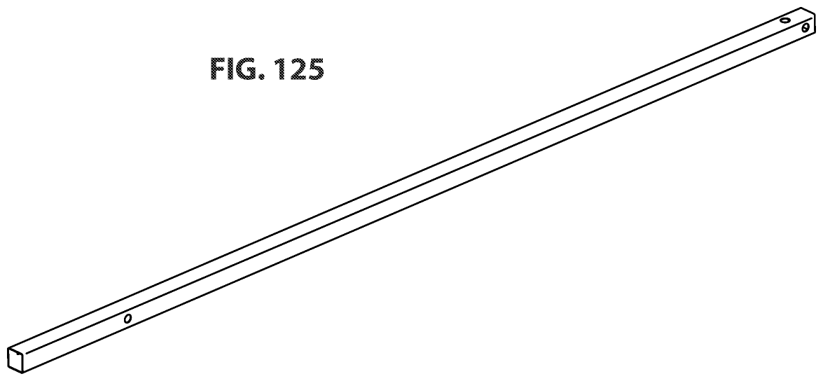

Referring to FIG. 1, FIG. 2, FIG. 3, FIG. 4, FIG. 5, FIG. 6A, FIG. 6B, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, FIG. 42, FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, FIG. 75, FIG. 76, FIG. 77, FIG. 78, FIG. 79, FIG. 80, FIG. 81, FIG. 82, FIG. 83, FIG. 84, FIG. 85, FIG. 86, FIG. 87, FIG. 88, FIG. 89, FIG. 90, FIG. 91, FIG. 92, FIG. 93, FIG. 94, FIG. 95, FIG. 96, FIG. 97, FIG. 98, FIG. 99, FIG. 100, FIG. 101, FIG. 102, FIG. 103, FIG. 104, FIG. 105, FIG. 106, FIG. 107, FIG. 108, FIG. 109, FIG. 110, FIG. 111, FIG. 112, FIG. 113, FIG. 114, FIG. 115, FIG. 116, FIG. 117, FIG. 118, FIG. 119, FIG. 120, FIG. 121, FIG. 122, FIG. 123, FIG. 124, FIG. 125, FIG. 126, FIG. 127, and FIG. 128, the six-device-in-one robot-assembled arthritic-assisting noise-canceling friction-reducing dog-run-adaptable anti-wobbling gazebo comprises:
1) Robot-assembled arthritic-assisting noise-canceling friction-reducing dog-run-adaptable anti-wobbling gazebo system 101, comprising:
2) Adjustable canopy 102,
3) Dog-run-adaptable anti-wobbling foldable top trusses 103,
4) Dog-run-adaptable anti-wobbling foldable corner trusses 104,
5) Dog-run-adaptable anti-wobbling foldable side trusses 105,
6) Dog-run-adaptable anti-wobbling foldable upper posts 106,
7) Dog-run-adaptable anti-wobbling foldable lower posts 107,
8) Dog-run-adaptable anti-wobbling arthritic-assisting feet 108,
9) Dog-run-adaptable anti-wobbling arthritic-assisting foot holes 109,
10) Truss holes 110;
11) Robot-assembled automatically-making-rivet-tail-flare noise-canceling injury-preventing top-connector system 111, comprising:
12) Top robot-assembled connectors 112,
13) Top robot-assembled heat-expandable cold-contractable holes 113,
14) Top robot-assembled automatically-flaring-and-shielding-rivet-tail injury-preventing hammer-shields 114,
15) Top robot-assembled heat-expandable cold-contractable double-tail rivets 115; 16) Robot-assembled heat-expandable cold-contractable interlocking anti-wobbling spiral-saw screw system 116, comprising:
17) Robot-assembled heat-expandable cold-contractable anti-wobbling screws 117,
18) Robot-assembled heat-expandable cold-contractable spirally-threading spiral saws 118,
19) Robot-assembled heat-expandable cold-contractable spiral-teeth 119,
20) Robot-assembled heat-expandable cold-contractable interlocking cones 120,
21) Robot-assembled heat-expandable cold-contractable interlocking spiral locks 121;
22) Robot-assembled injury-preventing cone-shielding central intersector system 122, comprising:
23) Central robot-assembled intersectors 123,
24) Central robot-assembled heat-expandable cold-contractable holes 124,
25) Central robot-assembled automatically-flaring-and-shielding-cone-head injury-preventing hammer-shields 125;
26) Robot-assembled injury-preventing cone-shielding upper intersector system 126, comprising:
27) Upper robot-assembled intersectors 127,
28) Upper robot-assembled heat-expandable cold-contractable holes 128,
29) Upper robot-assembled automatically-flaring-and-shielding-cone-head injury-preventing hammer-shields 129;
30) Robot-assembled arthritic-assisting injury-preventing cone-shielding lower intersector system 130, comprising:
31) Lower robot-assembled intersectors 131,
32) Lower robot-assembled heat-expandable cold-contractable holes 132,
33) Lower robot-assembled cone-shielding injury-preventing hammer-shields 133,
34) Lower robot-assembled arthritic-assisting height-adjusting dog-run-panel-rope hooks 134,
35) Lower robot-assembled noise-canceling friction-reducing height-adjusting nipples 135,
36) Lower robot-assembled noise-canceling friction-reducing lead-in nipple tips 136,
37) Lower robot-assembled self-securing nipple-securing pins 137,
38) Lower robot-assembled self-securing hook-securing pins 138,
39) Lower robot-assembled hook spring 139,
40) Lower robot-assembled noise-canceling friction-reducing nipple-centering tunnels 140;
41) Robot-assembled arthritic-assisting injury-preventing post-centering tick-preventing water-discharging sleeve system 141, comprising:
42) Robot-assembled sleeves 142,
43) Sleeve robot-assembled post-centering clamps 143,
44) Sleeve robot-assembled tick-preventing downward teeth 144,
45) Sleeve robot-assembled water-discharging grooves 145,
46) Sleeve robot-assembled arthritic-assisting height-adjusting dog-run-panel-rope hooks 146,
47) Sleeve robot-assembled noise-canceling friction-reducing post-height-adjusting grooved nipples 147,
48) Sleeve robot-assembled noise-canceling friction-reducing hook-jacking jacks 148,
49) Sleeve robot-assembled self-securing jack-securing pins 149,
50) Sleeve robot-assembled self-securing hook-securing pins 150,
51) Sleeve robot-assembled hook spring 151,
52) Sleeve robot-assembled noise-canceling friction-reducing flower-shaped nipple-centering holes 152;
53) Robot-assembled noise-canceling injury-preventing rust-preventing truss-centering cover-cushion system 153, comprising:
54) Robot-assembled rust-preventing truss-end covers 154,
55) Robot-assembled noise-canceling cover-cushion 155,
56) Robot-assembled injury-preventing inward-curved cover-cushion edges 156,
57) Robot-assembled heat-expandable cold-contractable double-tail cover-cushion rivets 157;
58) Robot-assembled arthritic-assisting noise-canceling injury-preventing rust-preventing truss-centering cup-cushion system 158, comprising:
59) Robot-assembled noise-canceling cup-cushion 159,
60) Robot-assembled injury-preventing inward-curved cup-cushion edges 160;
61) Robot-assembled arthritic-assisting noise-canceling circular-cushion system 161, comprising:
62) Robot-assembled noise-canceling circular-cushion 162,
63) Robot-assembled double-tail built-in circular-cushion rivets 163; and

### Material

Referring to FIG. 1, FIG. 2, FIG. 3, FIG. 4, FIG. 5, FIG. 6A, FIG. 6B, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, FIG. 42, FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, FIG. 75, FIG. 76, FIG. 77, FIG. 78, FIG. 79, FIG. 80, FIG. 81, FIG. 82, FIG. 83, FIG. 84, FIG. 85, FIG. 86, FIG. 87, FIG. 88, FIG. 89, FIG. 90, FIG. 91, FIG. 92, FIG. 93, FIG. 94, FIG. 95, FIG. 96, FIG. 97, FIG. 98, FIG. 99, FIG. 100, FIG. 101, FIG. 102, FIG. 103, FIG. 104, FIG. 105, FIG. 106, FIG. 107, FIG. 108, FIG. 109, FIG. 110, FIG. 111, FIG. 112, FIG. 113, FIG. 114, FIG. 115, FIG. 116, FIG. 117, FIG. 118, FIG. 119, FIG. 120, FIG. 121, FIG. 122, FIG. 123, FIG. 124, FIG. 125, FIG. 126, FIG. 127, and FIG. 128:
1) Robot-assembled arthritic-assisting noise-canceling friction-reducing dog-run-adaptable anti-wobbling-gazebo system 101 is (or are each) made of the combined materials of its components.
2) Adjustable canopy 102.
3) Dog-run-adaptable anti-wobbling foldable top trusses 103 is (or are each) made of the material of metal.
4) Dog-run-adaptable anti-wobbling foldable corner trusses 104 is (or are each) made of the material of metal.
5) Dog-run-adaptable anti-wobbling foldable side trusses 105 is (or are each) made of the material of metal.
6) Dog-run-adaptable anti-wobbling foldable upper posts 106 is (or are each) made of the material of metal.
7) Dog-run-adaptable anti-wobbling foldable lower posts 107 is (or are each) made of the material of metal.
8) Dog-run-adaptable anti-wobbling arthritic-assisting feet 108 is (or are each) made of the material of metal.
9) Dog-run-adaptable anti-wobbling arthritic-assisting foot holes 109 is (or are each) made of the material of empty space.
10) Truss holes 110 is (or are each) made of the material of empty space.
11) Robot-assembled automatically-making-rivet-tail-flare noise-canceling injury-preventing top-connector system 111 is (or are each) made of the combined materials of its components.
12) Top robot-assembled connectors 112 is (or are each) made of the material of plastic.
13) Top robot-assembled heat-expandable cold-contractable holes 113 is (or are each) made of the material of empty space.
14) Top robot-assembled automatically-flaring-and-shielding-rivet-tail injury-preventing hammer-shields 114 is (or are each) made of the material of plastic.
15) Top robot-assembled heat-expandable cold-contractable double-tail rivets 115 is (or are each) made of the material of plastic or metal.
16) Robot-assembled heat-expandable cold-contractable interlocking anti-wobbling spiral-saw screw system 116 is (or are each) connected by the combined connections of its components.
17) Robot-assembled heat-expandable cold-contractable anti-wobbling screws 117 is (or are each) made of the material of metal or plastic.
18) Robot-assembled heat-expandable cold-contractable spirally-threading spiral saws 118 is (or are each) made of the material of metal or plastic.
19) Robot-assembled heat-expandable cold-contractable spiral-teeth 119 is (or are each) made of the material of metal or plastic.
20) Robot-assembled heat-expandable cold-contractable interlocking cones 120 is (or are each) made of the material of metal or plastic.
21) Robot-assembled heat-expandable cold-contractable interlocking spiral locks 121 is (or are each) made of the material of metal or plastic.
22) Robot-assembled injury-preventing cone-shielding central intersector system 122 is (or are each) made of the combined materials of its components.
23) Central robot-assembled intersectors 123 is (or are each) made of the material of plastic.
24) Central robot-assembled heat-expandable cold-contractable holes 124 is (or are each) made of the material of empty space.
25) Central robot-assembled automatically-flaring-and-shielding-cone-head injury-preventing hammer-shields 125 is (or are each) made of the material of plastic.
26) Robot-assembled injury-preventing cone-shielding upper intersector system 126 is (or are each) made of the combined materials of its components.
27) Upper robot-assembled intersectors 127 is (or are each) made of the material of plastic.
28) Upper robot-assembled heat-expandable cold-contractable holes 128 is (or are each) made of the material of empty space.
29) Upper robot-assembled automatically-flaring-and-shielding-cone-head injury-preventing hammer-shields 129 is (or are each) made of the material of plastic.
30) Robot-assembled arthritic-assisting injury-preventing cone-shielding lower intersector system 130 is (or are each) made of the combined materials of its components.
31) Lower robot-assembled intersectors 131 is (or are each) made of the material of plastic.
32) Lower robot-assembled heat-expandable cold-contractable holes 132 is (or are each) made of the material of empty space.
33) Lower robot-assembled cone-shielding injury-preventing hammer-shields 133 is (or are each) made of the material of plastic.
34) Lower robot-assembled arthritic-assisting height-adjusting dog-run-panel-rope hooks 134 is (or are each) made of the material of plastic.
35) Lower robot-assembled noise-canceling friction-reducing height-adjusting nipples 135 is (or are each) made of the material of metal.
36) Lower robot-assembled noise-canceling friction-reducing lead-in nipple tips 136 is (or are each) made of the material of metal.
37) Lower robot-assembled self-securing nipple-securing pins 137 is (or are each) made of the material of metal.
38) Lower robot-assembled self-securing hook-securing pins 138 is (or are each) made of the material of metal.
39) Lower robot-assembled hook spring 139 is (or are each) made of the material of metal.
40) Lower robot-assembled noise-canceling friction-reducing nipple-centering tunnels 140 is (or are each) made of the material of empty space.
41) Robot-assembled arthritic-assisting injury-preventing post-centering tick-preventing water discharging sleeve system 141 is (or are each) made of the combined materials of its components.
42) Robot-assembled sleeves 142 is (or are each) made of the material of plastic.
43) Sleeve robot-assembled post-centering clamps 143 is (or are each) made of the material of plastic.
44) Sleeve robot-assembled tick-preventing downward teeth 144 is (or are each) made of the material of plastic.
45) Sleeve robot-assembled water-discharging grooves 145 is (or are each) made of the material of empty space.
46) Sleeve robot-assembled arthritic-assisting height-adjusting dog-run-panel-rope hooks 146 is (or are each) made of the material of plastic.
47) Sleeve robot-assembled noise-canceling friction-reducing post-height-adjusting grooved nipples 147 is (or are each) made of the material of metal.
48) Sleeve robot-assembled noise-canceling friction-reducing hook-jacking jacks 148 is (or are each) made of the material of plastic.
49) Sleeve robot-assembled self-securing jack-securing pins 149 is (or are each) made of the material of metal.
50) Sleeve robot-assembled self-securing hook-securing pins 150 is (or are each) made of the material of metal.
51) Sleeve robot-assembled hook spring 151 is (or are each) made of the material of metal.
52) Sleeve robot-assembled noise-canceling friction-reducing flower-shaped nipple-centering holes 152 is (or are each) made of the material of empty space.
53) Robot-assembled noise-canceling injury-preventing rust-preventing truss-centering cover cushion system 153 is (or are each) made of the combined materials of its components.
54) Robot-assembled rust-preventing truss-end covers 154 is (or are each) made of the material of plastic.
55) Robot-assembled noise-canceling cover-cushion 155 is (or are each) made of the material of plastic.
56) Robot-assembled injury-preventing inward-curved cover-cushion edges 156 is (or are each) made of the material of plastic.
57) Robot-assembled heat-expandable cold-contractable double-tail cover-cushion rivets 157 is (or are each) made of the material of plastic.
58) Robot-assembled arthritic-assisting noise-canceling injury-preventing rust-preventing truss-centering cup-cushion system 158 is (or are each) made of the combined materials of its components.
59) Robot-assembled noise-canceling cup-cushion 159 is (or are each) made of the material of plastic.
60) Robot-assembled injury-preventing inward-curved cup-cushion edges 160 is (or are each) made of the material of plastic.
61) Robot-assembled arthritic-assisting noise-canceling circular-cushion system 161 is (or are each) made of the combined materials of its components.
62) Robot-assembled noise-canceling circular-cushion 162 is (or are each) made of the material of plastic.
63) Robot-assembled double-tail built-in circular-cushion rivets 163 is (or are each) made of the material of plastic or metal.

### Shape

Referring to FIG. 1, FIG. 2, FIG. 3, FIG. 4, FIG. 5, FIG. 6A, FIG. 6B, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, FIG. 42, FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, FIG. 75, FIG. 76, FIG. 77, FIG. 78, FIG. 79, FIG. 80, FIG. 81, FIG. 82, FIG. 83, FIG. 84, FIG. 85, FIG. 86, FIG. 87, FIG. 88, FIG. 89, FIG. 90, FIG. 91, FIG. 92, FIG. 93, FIG. 94, FIG. 95, FIG. 96, FIG. 97, FIG. 98, FIG. 99, FIG. 100, FIG. 101, FIG. 102, FIG. 103, FIG. 104, FIG. 105, FIG. 106, FIG. 107, FIG. 108, FIG. 109, FIG. 110, FIG. 111, FIG. 112, FIG. 113, FIG. 114, FIG. 115, FIG. 116, FIG. 117, FIG. 118, FIG. 119, FIG. 120, FIG. 121, FIG. 122, FIG. 123, FIG. 124, FIG. 125, FIG. 126, FIG. 127, and FIG. 128:
1) Robot-assembled arthritic-assisting noise-canceling friction-reducing dog-run-adaptable anti-wobbling-gazebo system 101 is (or are each) formed into the combined shapes of its components.
2) Adjustable canopy 102 is (or are each) formed into the shape of (a or an) square.
3) Dog-run-adaptable anti-wobbling foldable top trusses 103 is (or are each) formed into the shape of (a or an) tube.
4) Dog-run-adaptable anti-wobbling foldable corner trusses 104 is (or are each) formed into the shape of (a or an) tube.
5) Dog-run-adaptable anti-wobbling foldable side trusses 105 is (or are each) formed into the shape of (a or an) tube.
6) Dog-run-adaptable anti-wobbling foldable upper posts 106 is (or are each) formed into the shape of (a or an) tube with a square cross-section.
7) Dog-run-adaptable anti-wobbling foldable lower posts 107 is (or are each) formed into the shape of (a or an) tube with a square cross-section.
8) Dog-run-adaptable anti-wobbling arthritic-assisting feet 108 is (or are each) formed into the shape of (a or an) rectangle plate.
9) Dog-run-adaptable anti-wobbling arthritic-assisting foot holes 109.
10) Truss holes 110 is (or are each) formed into the shape of (a or an) circle.
11) Robot-assembled automatically-making-rivet-tail-flare noise-canceling injury-preventing top-connector system 111 is (or are each) formed into the combined shapes of its components.
12) Top robot-assembled connectors 112 is (or are each) formed into the shape of (a or an) U-shaped box with at least one receiving cavity or protrusion.
13) Top robot-assembled heat-expandable cold-contractable holes 113 is (or are each) formed into the shape of (a or an) circle.
14) Top robot-assembled automatically-flaring-and-shielding-rivet-tail injury-preventing hammer-shields 114 is (or are each) formed into the shape of (a or an) rectangle.
15) Top robot-assembled heat-expandable cold-contractable double-tail rivets 115 is (or are each) formed into the shape of (a or an) tube with a circular head.
16) Robot-assembled heat-expandable cold-contractable interlocking anti-wobbling spiral-saw screw system 116 is (or are each) formed into the combined shapes of its components.
17) Robot-assembled heat-expandable cold-contractable anti-wobbling screws 117 is (or are each) formed into the shape of (a or an) cylinder.
18) Robot-assembled heat-expandable cold-contractable spirally-threading spiral saws 118 is (or are each) formed into the shape of (a or an) jagged teeth.
19) Robot-assembled heat-expandable cold-contractable spiral-teeth 119 is (or are each) formed into the shape of (a or an) angled triangle.
20) Robot-assembled heat-expandable cold-contractable interlocking cones 120 is (or are each) formed into the shape of (a or an) cone.
21) Robot-assembled heat-expandable cold-contractable interlocking spiral locks 121 is (or are each) formed into the shape of (a or an) spiral.
22) Robot-assembled injury-preventing cone-shielding central intersector system 122 is (or are each) formed into the combined shapes of its components.
23) Central robot-assembled intersectors 123 is (or are each) formed into the shape of (a or an) cylinder with at least one receiving cavity or protrusion.
24) Central robot-assembled heat-expandable cold-contractable holes 124 is (or are each) formed into the shape of (a or an) circle.
25) Central robot-assembled automatically-flaring-and-shielding-cone-head injury-preventing hammer-shields 125 is (or are each) formed into the shape of (a or an) rectangle.
26) Robot-assembled injury-preventing cone-shielding upper intersector system 126 is (or are each) formed into the combined shapes of its components.
27) Upper robot-assembled intersectors 127 is (or are each) formed into the shape of (a or an) box with at least one receiving cavity or protrusion.
28) Upper robot-assembled heat-expandable cold-contractable holes 128 is (or are each) formed into the shape of (a or an) circle.
29) Upper robot-assembled automatically-flaring-and-shielding-cone-head injury-preventing hammer-shields 129 is (or are each) formed into the shape of (a or an) rectangle.
30) Robot-assembled arthritic-assisting injury-preventing cone-shielding lower intersector system 130 is (or are each) formed into the combined shapes of its components.
31) Lower robot-assembled intersectors 131 is (or are each) formed into the shape of (a or an) box with at least one receiving cavity or protrusion.
32) Lower robot-assembled heat-expandable cold-contractable holes 132 is (or are each) formed into the shape of (a or an) circle.
33) Lower robot-assembled cone-shielding injury-preventing hammer-shields 133 is (or are each) formed into the shape of (a or an) rectangle.
34) Lower robot-assembled arthritic-assisting height-adjusting dog-run-panel-rope hooks 134 is (or are each) formed into the shape of (a or an) hook.
35) Lower robot-assembled noise-canceling friction-reducing height-adjusting nipples 135 is (or are each) formed into the shape of (a or an) cylinder.
36) Lower robot-assembled noise-canceling friction-reducing lead-in nipple tips 136 is (or are each) formed into the shape of (a or an) cylinder.
37) Lower robot-assembled self-securing nipple-securing pins 137 is (or are each) formed into the shape of (a or an) cylinder.
38) Lower robot-assembled self-securing hook-securing pins 138 is (or are each) formed into the shape of (a or an) cylinder.
39) Lower robot-assembled hook spring 139 is (or are each) formed into the shape of (a or an) spring with at least one hook end.
40) Lower robot-assembled noise-canceling friction-reducing nipple-centering tunnels 140 is (or are each) formed into the shape of (a or an) circle.
41) Robot-assembled arthritic-assisting injury-preventing post-centering tick-preventing water-discharging sleeve system 141 is (or are each) formed into the combined shapes of its components.
42) Robot-assembled sleeves 142 is (or are each) formed into the shape of (a or an) box.
43) Sleeve robot-assembled post-centering clamps 143 is (or are each) formed into the shape of (a or an) rectangle.
44) Sleeve robot-assembled tick-preventing downward teeth 144 is (or are each) formed into the shape of (a or an) triangle.
45) Sleeve robot-assembled water-discharging grooves 145 is (or are each) formed into the shape of (a or an) trough.
46) Sleeve robot-assembled arthritic-assisting height-adjusting dog-run-panel-rope hooks 146 is (or are each) formed into the shape of (a or an) hook.
47) Sleeve robot-assembled noise-canceling friction-reducing post-height-adjusting grooved nipples 147.
48) Sleeve robot-assembled noise-canceling friction-reducing hook-jacking jacks 148 is (or are each) formed into the shape of (a or an) cylinder.
49) Sleeve robot-assembled self-securing jack-securing pins 149 is (or are each) formed into the shape of (a or an) cylinder.
50) Sleeve robot-assembled self-securing hook-securing pins 150 is (or are each) formed into the shape of (a or an) cylinder.
51) Sleeve robot-assembled hook spring 151 is (or are each) formed into the shape of (a or an) spring with at least one hook end.
52) Sleeve robot-assembled noise-canceling friction-reducing flower-shaped nipple-centering holes 152 is (or are each) formed into the shape of (a or an) flower.
53) Robot-assembled noise-canceling injury-preventing rust-preventing truss-centering cover-cushion system 153 is (or are each) formed into the combined shapes of its components.
54) Robot-assembled rust-preventing truss-end covers 154 is (or are each) formed into the shape of (a or an) open-top box.
55) Robot-assembled noise-canceling cover-cushion 155 is (or are each) formed into the shape of (a or an) rounded rectangle.
56) Robot-assembled injury-preventing inward-curved cover-cushion edges 156 is (or are each) formed into the shape of (a or an) inward curve.
57) Robot-assembled heat-expandable cold-contractable double-tail cover-cushion rivets 157 is (or are each) formed into the shape of (a or an) tube.
58) Robot-assembled arthritic-assisting noise-canceling injury-preventing rust-preventing truss-centering cup-cushion system 158 is (or are each) formed into the combined shapes of its components.
59) Robot-assembled noise-canceling cup-cushion 159 is (or are each) formed into the shape of (a or an) open-top box.
60) Robot-assembled injury-preventing inward-curved cup-cushion edges 160 is (or are each) formed into the shape of (a or an) inward curve.
61) Robot-assembled arthritic-assisting noise-canceling circular-cushion system 161 is (or are each) formed into the combined shapes of its components.
62) Robot-assembled noise-canceling circular-cushion 162 is (or are each) formed into the shape of (a or an) squashed sphere.
63) Robot-assembled double-tail built-in circular-cushion rivets 163 is (or are each) formed into the shape of (a or an) tube.

### Connection

Referring to FIG. 1, FIG. 2, FIG. 3, FIG. 4, FIG. 5, FIG. 6A, FIG. 6B, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, FIG. 42, FIG. 43, FIG. 44, FIG. 45, FIG. 46, FIG. 47, FIG. 48, FIG. 49, FIG. 50, FIG. 51, FIG. 52, FIG. 53, FIG. 54, FIG. 55, FIG. 56, FIG. 57, FIG. 58, FIG. 59, FIG. 60, FIG. 61, FIG. 62, FIG. 63, FIG. 64, FIG. 65, FIG. 66, FIG. 67, FIG. 68, FIG. 69, FIG. 70, FIG. 71, FIG. 72, FIG. 73, FIG. 74, FIG. 75, FIG. 76, FIG. 77, FIG. 78, FIG. 79, FIG. 80, FIG. 81, FIG. 82, FIG. 83, FIG. 84, FIG. 85, FIG. 86, FIG. 87, FIG. 88, FIG. 89, FIG. 90, FIG. 91, FIG. 92, FIG. 93, FIG. 94, FIG. 95, FIG. 96, FIG. 97, FIG. 98, FIG. 99, FIG. 100, FIG. 101, FIG. 102, FIG. 103, FIG. 104, FIG. 105, FIG. 106, FIG. 107, FIG. 108, FIG. 109, FIG. 110, FIG. 111, FIG. 112, FIG. 113, FIG. 114, FIG. 115, FIG. 116, FIG. 117, FIG. 118, FIG. 119, FIG. 120, FIG. 121, FIG. 122, FIG. 123, FIG. 124, FIG. 125, FIG. 126, FIG. 127, and FIG. 128:
1) Robot-assembled arthritic-assisting noise-canceling friction-reducing dog-run-adaptable anti-wobbling-gazebo system 101 is (or are each) connected by the combined connections of its components.
2) Adjustable canopy 102
   is (or are each)
   secured over dog-run-adaptable anti-wobbling foldable top trusses 103.
3) Dog-run-adaptable anti-wobbling foldable top trusses 103
   is (or are each)
   robotically attached to top robot-assembled connectors 112.
4) Dog-run-adaptable anti-wobbling foldable corner trusses 104
   is (or are each)
   robotically pivotably attached to dog-run-adaptable anti-wobbling foldable top trusses 103.
5) Dog-run-adaptable anti-wobbling foldable side trusses 105
   is (or are each)
   robotically pivotably attached to upper robot-assembled intersectors 127 and lower robot-assembled intersectors 131.
6) Dog-run-adaptable anti-wobbling foldable upper posts 106
   is (or are each)
   robotically inserted within upper robot-assembled intersectors 127 and lower robot-assembled intersectors 131.
7) Dog-run-adaptable anti-wobbling foldable lower posts 107
   is (or are each)
   slidably inserted within dog-run-adaptable anti-wobbling foldable upper posts 106.
8) Dog-run-adaptable anti-wobbling arthritic-assisting feet 108
   is (or are each)
   robotically welded to dog-run-adaptable anti-wobbling foldable lower posts 107.
9) Dog-run-adaptable anti-wobbling arthritic-assisting foot holes 109
   is (or are each)
   robotically drilled into dog-run-adaptable anti-wobbling arthritic-assisting feet 108.
10) Truss holes 110
   is (or are each)
   robotically drilled into foldable top trusses 103, foldable corner trusses 104, and foldable side trusses 105.
11) Robot-assembled automatically-making-rivet-tail-flare noise-canceling injury-preventing top-connector system 111 is (or are each) connected by the combined connections of its components.
12) Top robot-assembled connectors 112
   is (or are each) foldably
   robotically heated up to expand and robotically heat-riveted to dog-run-adaptable anti-wobbling foldable top trusses 103.
13) Top robot-assembled heat-expandable cold-contractable holes 113
   is (or are each)
   robotically heated up to expand and robotically molded in top robot-assembled connectors 112.
14) Top robot-assembled automatically-flaring-and-shielding-rivet-tail injury-preventing hammer-shields 114
   is (or are each)
   robotically heated up to expand and robotically molded on top robot-assembled connectors 112 to cover at least one of top robot-assembled heat-expandable cold-contractable holes 113.
15) Top robot-assembled heat-expandable cold-contractable double-tail rivets 115 is (or are each)
   robotically heated up to expand and robotically heat-hammered through top robot-assembled heat-expandable cold-contractable holes 113 against top robot-assembled automatically-flaring-and-shielding-rivet-tail injury-preventing hammer-shields 114 such that hammer-shields 114 automatically bend the tails of top double-tail rivets 115 to secure top robot-assembled connectors 112 to top trusses 103, and automatically shield the tails of top double-tail rivets 115 to prevent user injury.
16) Robot-assembled heat-expandable cold-contractable interlocking anti-wobbling spiral-saw screw system 116 is (or are each) connected by the combined connections of its components.
17) Robot-assembled heat-expandable cold-contractable anti-wobbling screws 117
   is (or are each)
   robotically heated up to expand and inserted into top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132.
18) Robot-assembled heat-expandable cold-contractable spirally-threading spiral saws 118
   is (or are each)
   formed to robot-assembled heat-expandable cold-contractable anti-wobbling screws 117.
19) Robot-assembled heat-expandable cold-contractable spiral-teeth 119
   is (or are each)
   formed to robot-assembled heat-expandable cold-contractable spirally-threading spiral saws 118.
20) Robot-assembled heat-expandable cold-contractable interlocking cones 120
   is (or are each)
   formed to robot-assembled heat-expandable cold-contractable anti-wobbling screws 117.
21) Robot-assembled heat-expandable cold-contractable interlocking spiral locks 121
   is (or are each)
   formed to robot-assembled heat-expandable cold-contractable interlocking cones 120.
22) Robot-assembled injury-preventing cone-shielding central intersector system 122 is (or are each) connected by the combined connections of its components.
23) Central robot-assembled intersectors 123
   is (or are each)
   robotically heated up to expand and robotically heat-screwed to dog-run-adaptable anti-wobbling foldable top trusses 103.
24) Central robot-assembled heat-expandable cold-contractable holes 124
   is (or are each)
   robotically heated up to expand and robotically molded in central robot-assembled intersectors 123.
25) Central robot-assembled automatically-flaring-and-shielding-cone-head injury-preventing hammer-shields 125
   is (or are each)
   robotically heated up to expand and robotically molded on central robot-assembled intersectors 123 to cover at least one of central robot-assembled heat-expandable cold-contractable holes 124.
26) Robot-assembled injury-preventing cone-shielding upper intersector system 126 is (or are each) connected by the combined connections of its components.
27) Upper robot-assembled intersectors 127
   is (or are each)
   robotically heated up to expand and robotically heat-screwed to dog-run-adaptable anti-wobbling foldable top trusses 103 and robotically assembled to dog-run-adaptable anti-wobbling foldable upper posts 106.
28) Upper robot-assembled heat-expandable cold-contractable holes 128
   is (or are each)
   robotically heated up to expand and robotically molded in upper robot-assembled intersectors 127.
29) Upper robot-assembled automatically-flaring-and-shielding-cone-head injury-preventing hammer-shields 129
   is (or are each)
   robotically heated up to expand and robotically molded on upper robot-assembled intersectors 127 to cover at least one of upper robot-assembled heat-expandable cold-contractable holes 128.
30) Robot-assembled arthritic-assisting injury-preventing cone-shielding lower intersector system 130 is (or are each) connected by the combined connections of its components.
31) Lower robot-assembled intersectors 131
   is (or are each)
   robotically heated up to expand and robotically heat-screwed to dog-run-adaptable anti-wobbling foldable corner trusses 104, dog-run-adaptable anti-wobbling foldable side trusses 105, and robotically and slidably attached to dog-run-adaptable anti-wobbling foldable upper posts 106.
32) Lower robot-assembled heat-expandable cold-contractable holes 132
   is (or are each)
   robotically heated up to expand and robotically molded in lower robot-assembled intersectors 131.
33) Lower robot-assembled cone-shielding injury-preventing hammer-shields 133
   is (or are each)
   robotically heated up to expand and robotically molded on lower robot-assembled intersectors 131 to cover at least one of lower robot-assembled heat-expandable cold-contractable holes 128.
34) Lower robot-assembled arthritic-assisting height-adjusting dog-run-panel-rope hooks 134
   is (or are each)
   robotically and pivotably secured to lower robot-assembled intersectors 131 by robot-assembled self-securing hook-securing pins 138.
35) Lower robot-assembled noise-canceling friction-reducing height-adjusting nipples 135
   is (or are each)
   robotically and pivotably secured to lower robot-assembled arthritic-assisting height-adjusting dog-run-panel-rope hooks 134 by lower robot-assembled self-securing nipple-securing pins 137.
36) Lower robot-assembled noise-canceling friction-reducing lead-in nipple tips 136
   is (or are each)
   robotically inserted within lower robot-assembled noise-canceling friction-reducing height-adjusting nipples 135.
37) Lower robot-assembled self-securing nipple-securing pins 137
   is (or are each)
   robotically heated up to expand and robotically heat-pressed through lower robot-assembled arthritic-assisting height-adjusting dog-run-panel-rope hooks 134 and through lower robot-assembled noise-canceling friction-reducing height-adjusting nipples 135.
38) Lower robot-assembled self-securing hook-securing pins 138
   is (or are each)
   robotically heated up to expand and robotically heat-pressed into lower robot-assembled intersectors 131 and through lower robot-assembled arthritic-assisting height-adjusting dog-run-panel-rope hooks 134.
39) Lower robot-assembled hook spring 139
   is (or are each)
   robotically springingly inserted between lower robot-assembled intersectors 131 and lower robot-assembled arthritic-assisting height-adjusting dog-run-panel-rope hooks 134.
40) Lower robot-assembled noise-canceling friction-reducing nipple-centering tunnels 140
   is (or are each)
   robotically molded into lower robot-assembled intersectors 131.
41) Robot-assembled arthritic-assisting injury-preventing post-centering tick-preventing water-discharging sleeve system 141 is (or are each) connected by the combined connections of its components.
42) Robot-assembled sleeves 142
   is (or are each)
   robotically assembled to dog-run-adaptable anti-wobbling foldable upper posts 106.
43) Sleeve robot-assembled post-centering clamps 143
   is (or are each)
   robotically molded to robot-assembled sleeves 142.
44) Sleeve robot-assembled tick-preventing downward teeth 144
   is (or are each)
   robotically molded to sleeve robot-assembled post-centering clamps 143.
45) Sleeve robot-assembled water-discharging grooves 145
   is (or are each)
   robotically molded into sleeve robot-assembled post-centering clamps 143.
46) Sleeve robot-assembled arthritic-assisting height-adjusting dog-run-panel-rope hooks 146
   is (or are each)
   robotically and pivotably secured to robot-assembled sleeves 142 by sleeve robot-assembled self-securing hook-securing pins 150.
47) Sleeve robot-assembled noise-canceling friction-reducing post-height-adjusting grooved nipples 147
   is (or are each)
   robotically formed to sleeve robot-assembled noise-canceling friction-reducing hook-jacking jacks 148.
48) Sleeve robot-assembled noise-canceling friction-reducing hook-jacking jacks 148
   is (or are each)
   robotically assembled to sleeve robot-assembled arthritic-assisting height-adjusting dog-run-panel-rope hooks 146 by sleeve robot-assembled self-securing jack-securing pins 149.
49) Sleeve robot-assembled self-securing jack-securing pins 149
   is (or are each)
   robotically heated up to expand and robotically heat-pressed through sleeve robot-assembled arthritic-assisting height-adjusting dog-run-panel-rope hooks 146 and through sleeve robot-assembled noise-canceling friction-reducing hook-jacking jacks 148.
50) Sleeve robot-assembled self-securing hook-securing pins 150
   is (or are each)
   robotically heated up to expand and robotically heat-pressed into robot-assembled sleeves 142 and through sleeve robot-assembled arthritic-assisting height-adjusting dog-run-panel-rope hooks 146.
51) Sleeve robot-assembled hook spring 151
   is (or are each)
   robotically springingly inserted between robot-assembled sleeves 142 and robot-assembled arthritic-assisting height-adjusting dog-run-panel-rope hooks 146.
52) Sleeve robot-assembled noise-canceling friction-reducing flower-shaped nipple-centering holes 152
   is (or are each)
   robotically molded into robot-assembled sleeves 142.
53) Robot-assembled noise-canceling injury-preventing rust-preventing truss-centering cover-cushion system 153 is (or are each) connected by the combined connections of its components.
54) Robot-assembled rust-preventing truss-end covers 154
   is (or are each)
   robotically assembled to dog-run-adaptable anti-wobbling foldable corner trusses 104.
55) Robot-assembled noise-canceling cover-cushion 155
   is (or are each)
   robotically formed to robot-assembled rust-preventing truss-end covers 154.
56) Robot-assembled injury-preventing inward-curved cover-cushion edges 156
   is (or are each)
   robotically formed to robot-assembled noise-canceling cover-cushion 155.
57) Robot-assembled heat-expandable cold-contractable double-tail cover-cushion rivets 157
   is (or are each)
   robotically heated up to expand and robotically heat-hammered through robot-assembled rust-preventing truss-end covers 154 automatically bend the tails of robot-assembled heat-expandable cold-contractable double-tail cover-cushion rivets 157
   to secure robot-assembled heat-expandable cold-contractable double-tail cover-cushion rivets 157 to dog-run-adaptable anti-wobbling foldable corner trusses 104, and automatically shield the tails of robot-assembled heat-expandable cold-contractable double-tail cover-cushion rivets 157
   to prevent user injury.
58) Robot-assembled arthritic-assisting noise-canceling injury-preventing rust-preventing truss-centering cup-cushion system 158 is (or are each) connected by the combined connections of its components.
59) Robot-assembled noise-canceling cup-cushion 159
   is (or are each)
   robotically assembled to dog-run-adaptable anti-wobbling foldable side trusses 105.
60) Robot-assembled injury-preventing inward-curved cup-cushion edges 160
   is (or are each)
   robotically formed into robot-assembled noise-canceling cup-cushion 159.
61) Robot-assembled arthritic-assisting noise-canceling circular-cushion system 161 is (or are each) connected by the combined connections of its components.
62) Robot-assembled noise-canceling circular-cushion 162
   is (or are each)
   robotically assembled to dog-run-adaptable anti-wobbling foldable side trusses 105.
63) Robot-assembled double-tail built-in circular-cushion rivets 163
   is (or are each)
   robotically formed into robot-assembled noise-canceling circular-cushion 162.

### Function

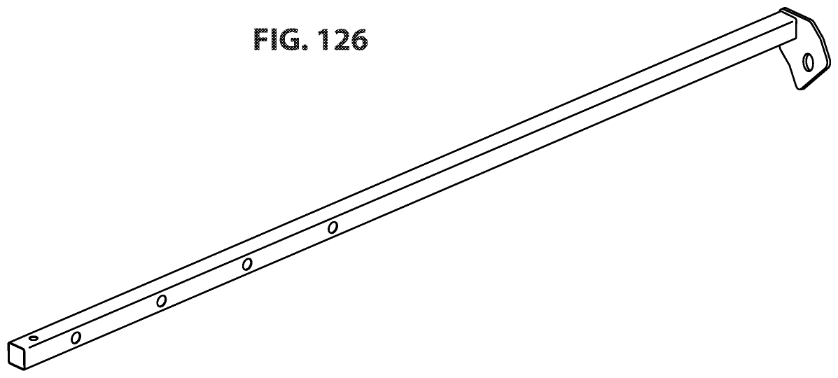

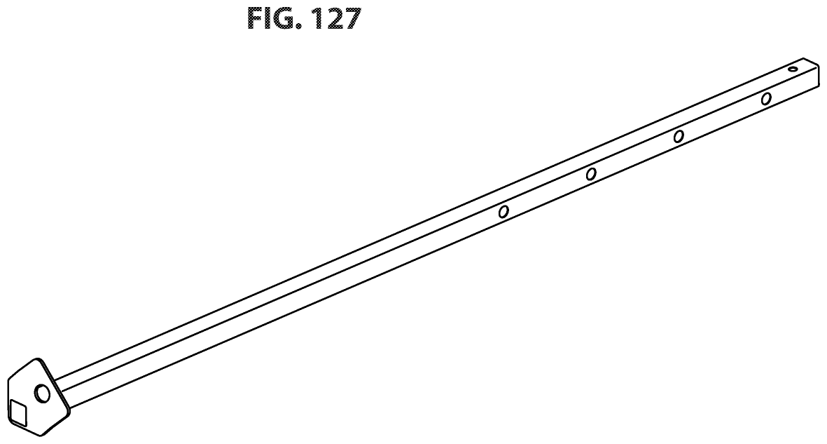

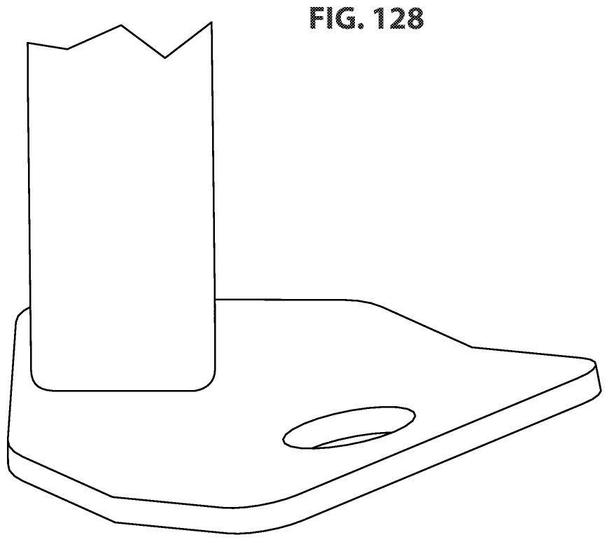

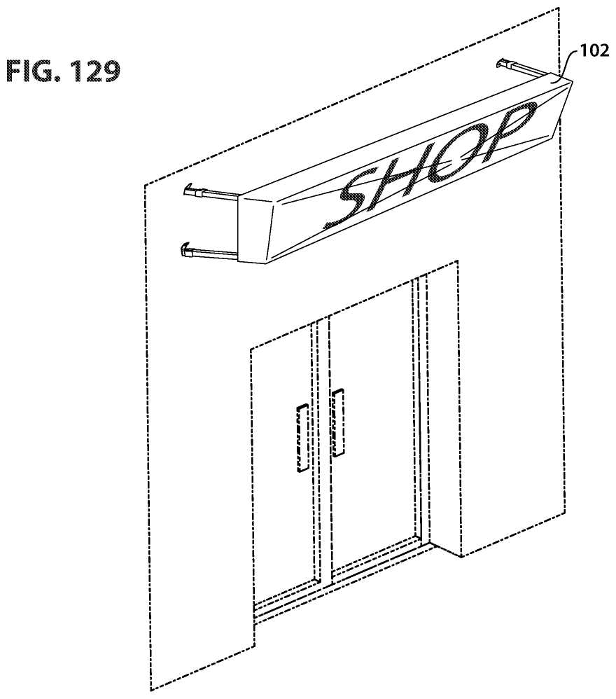

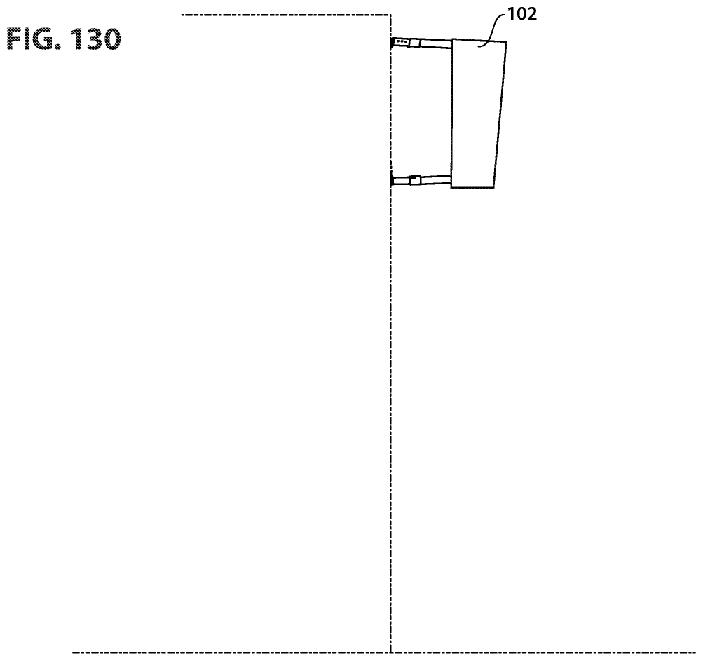

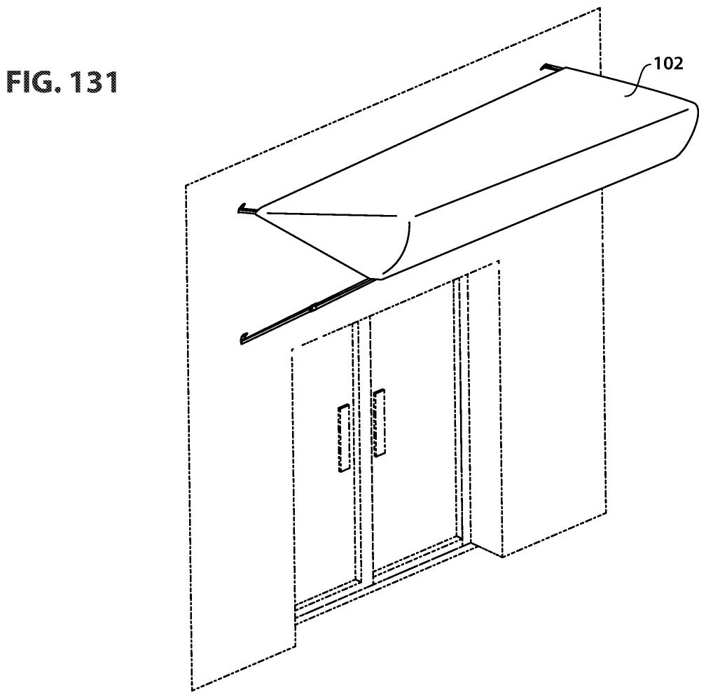

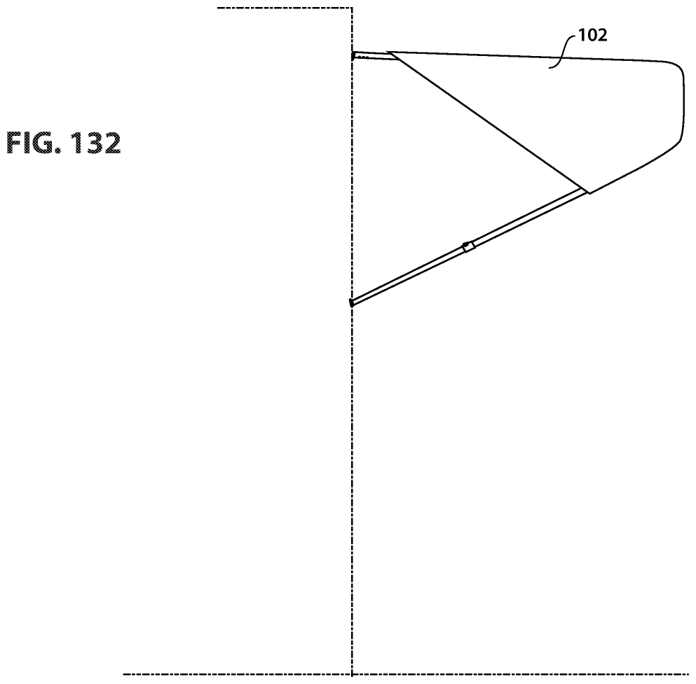

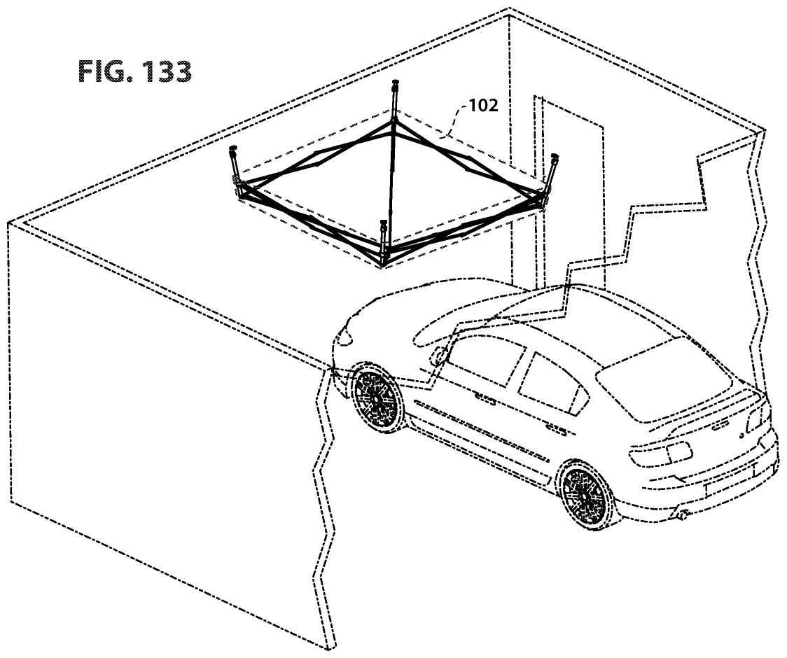

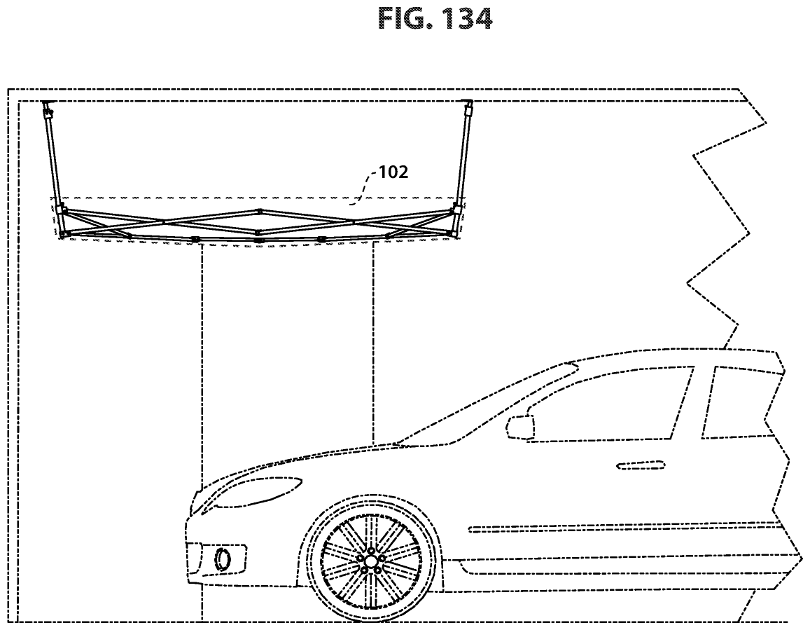

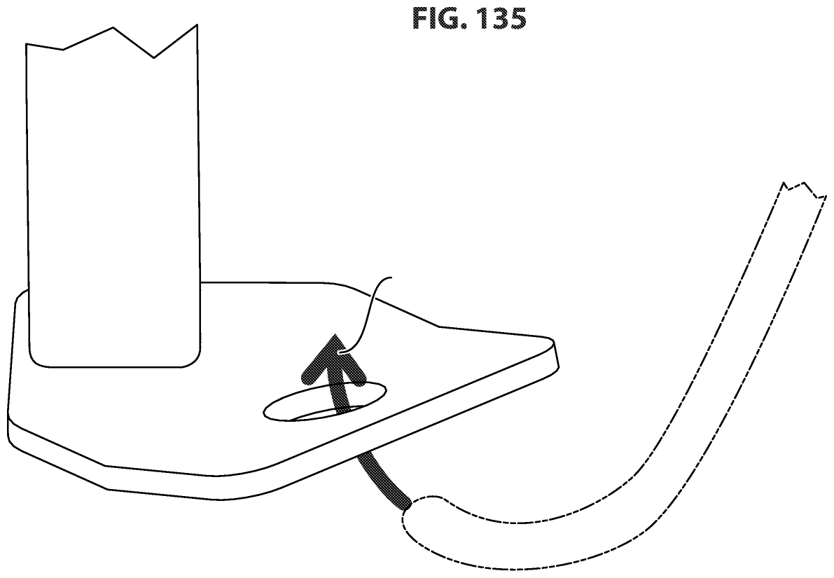

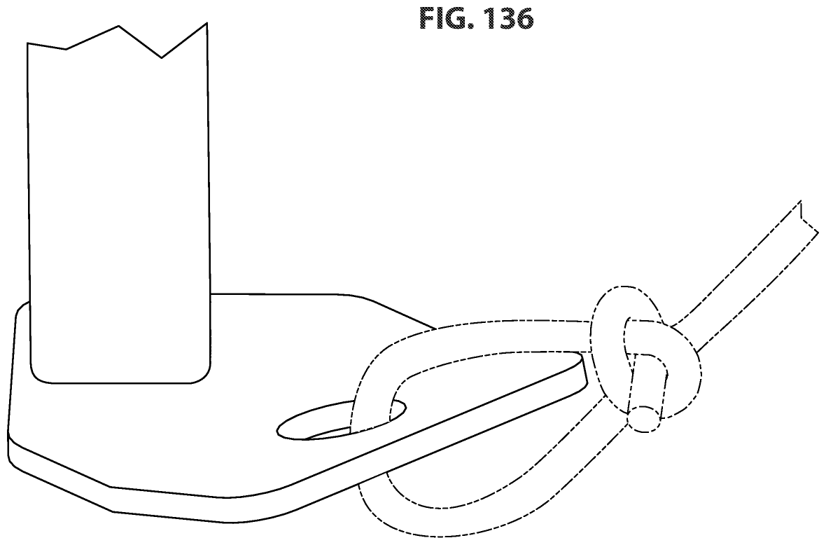

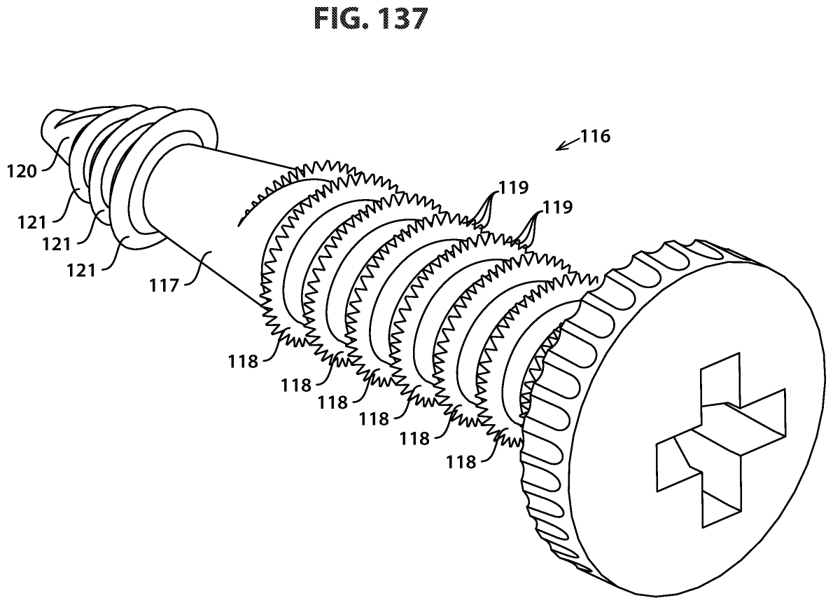

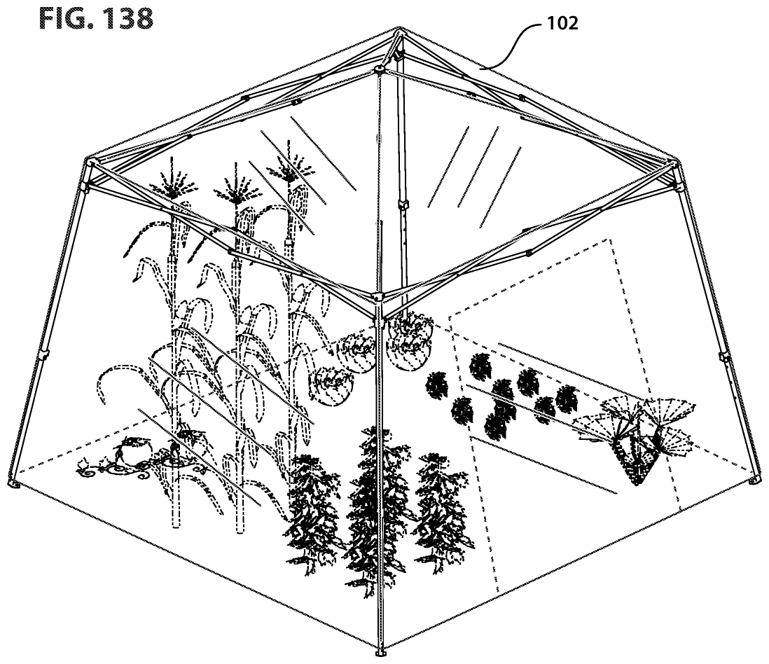

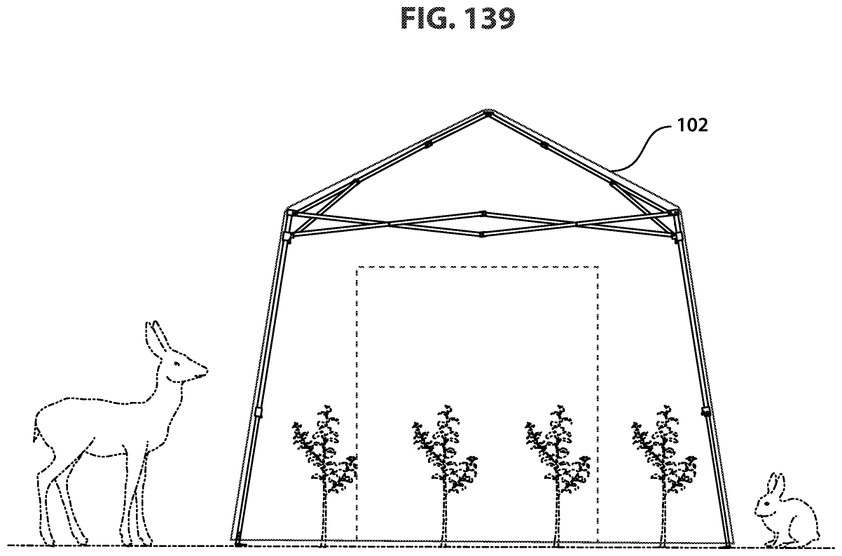

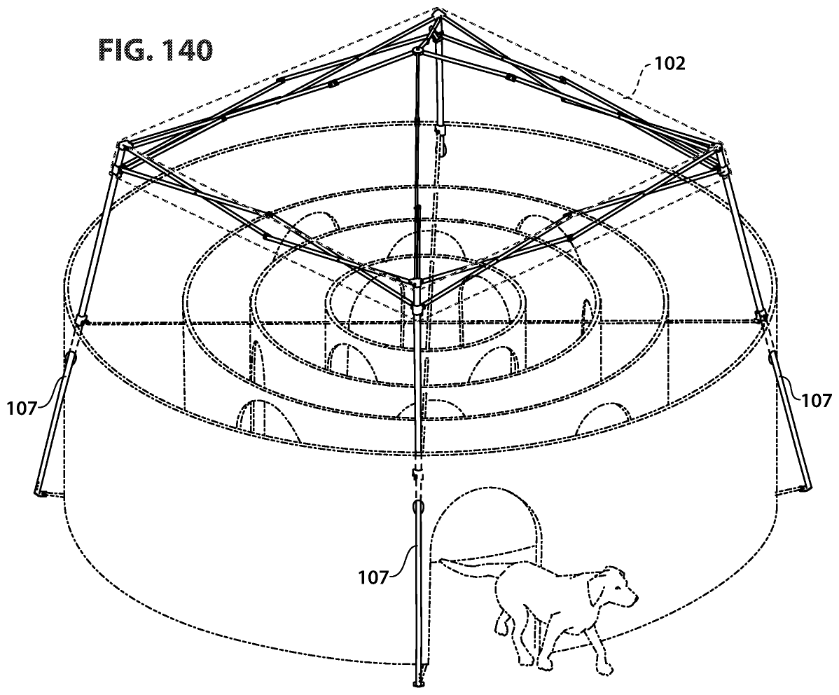

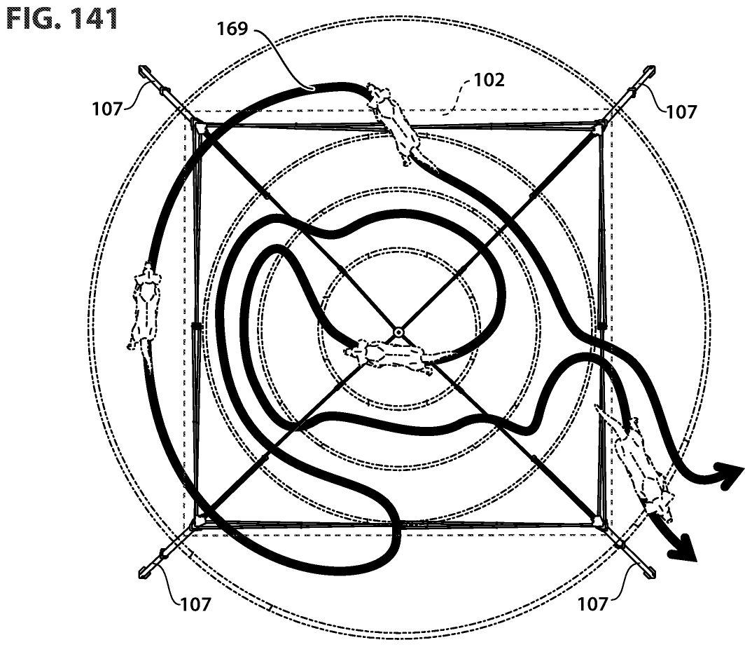

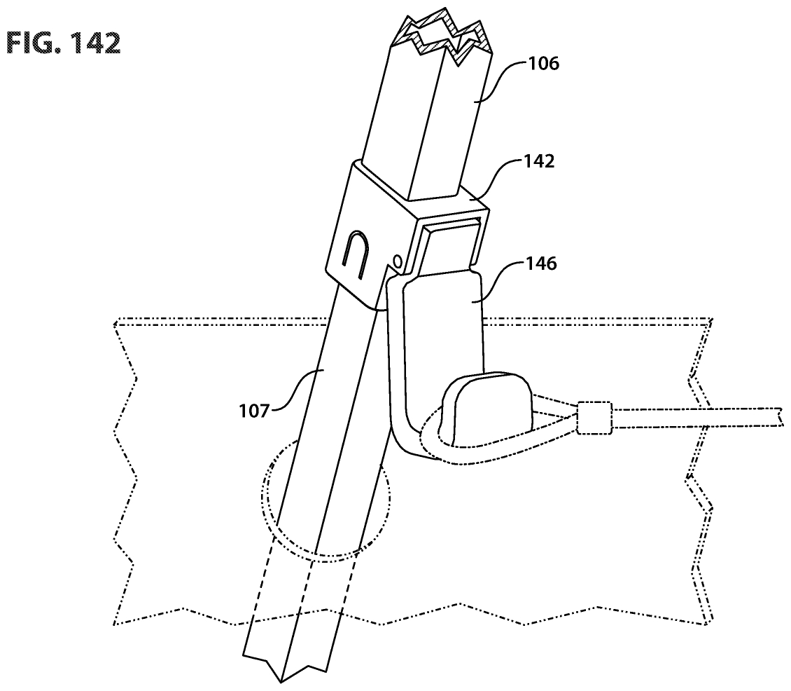

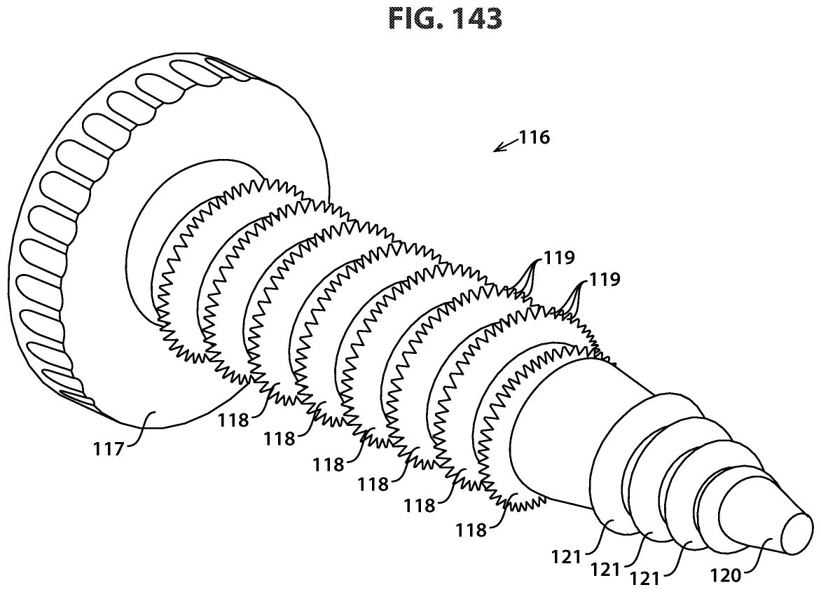

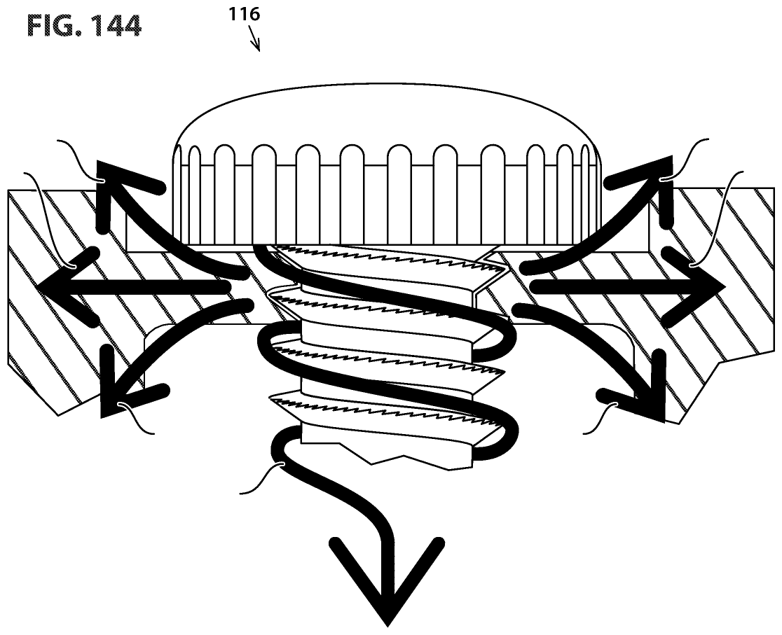

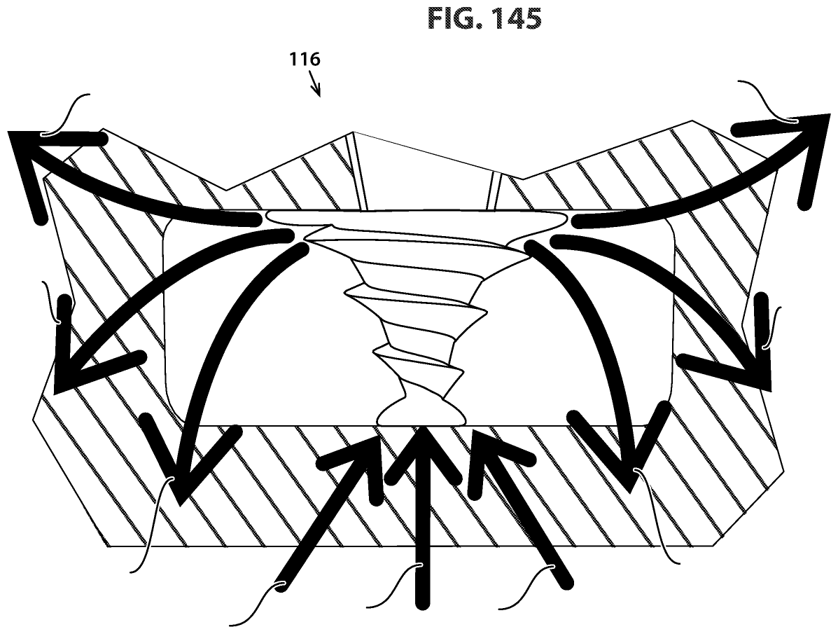

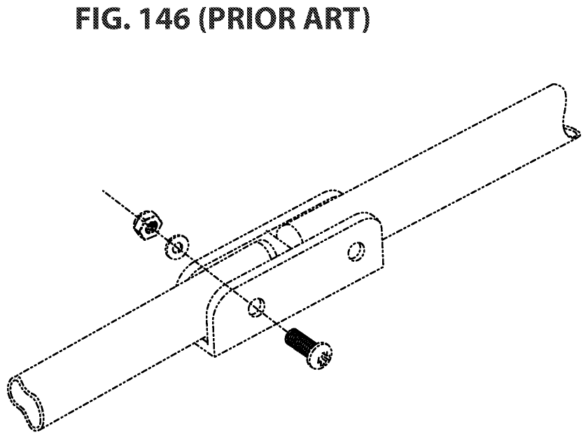

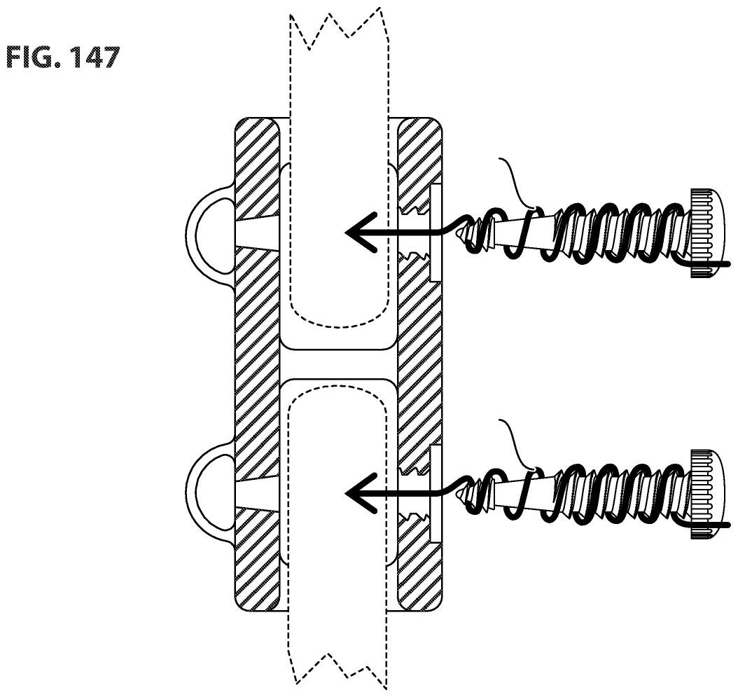

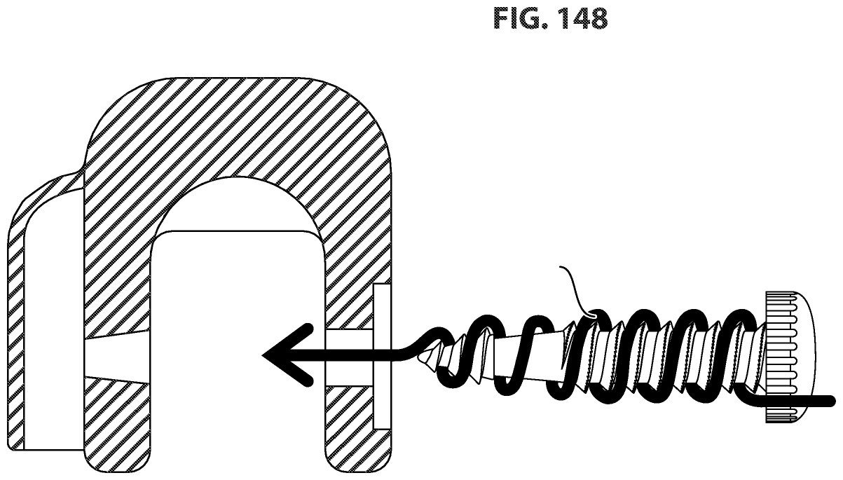

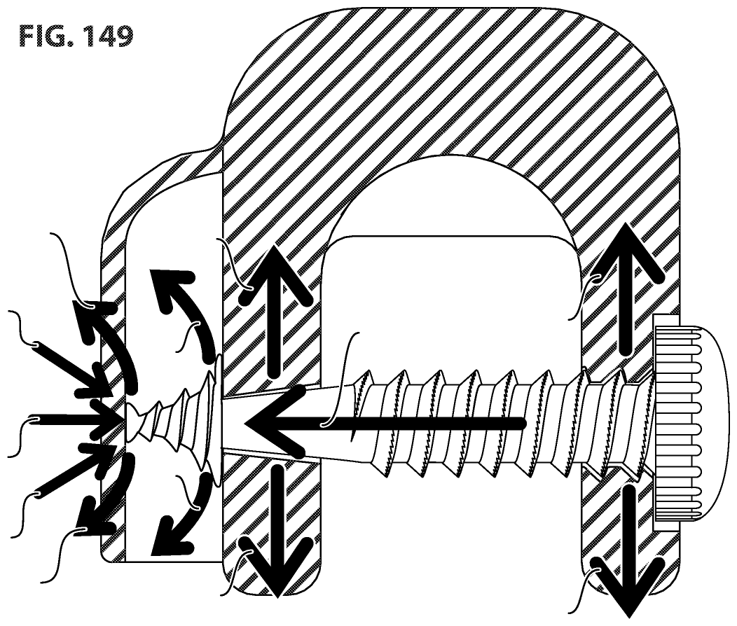

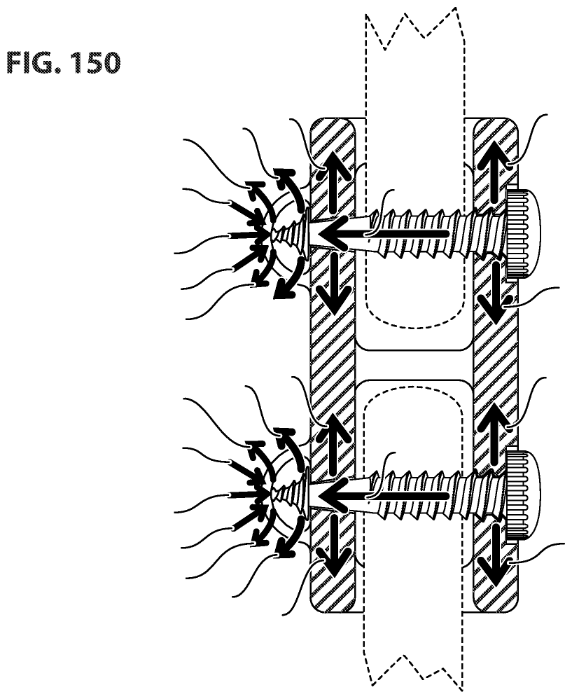

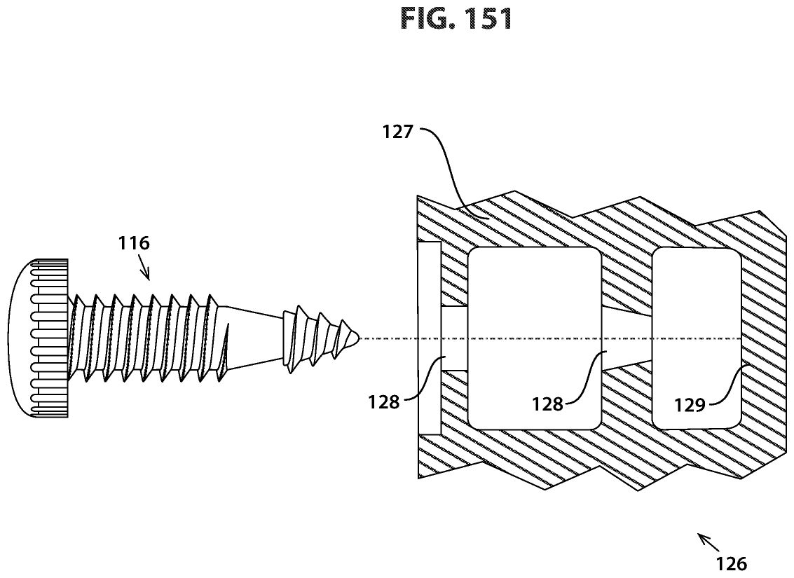

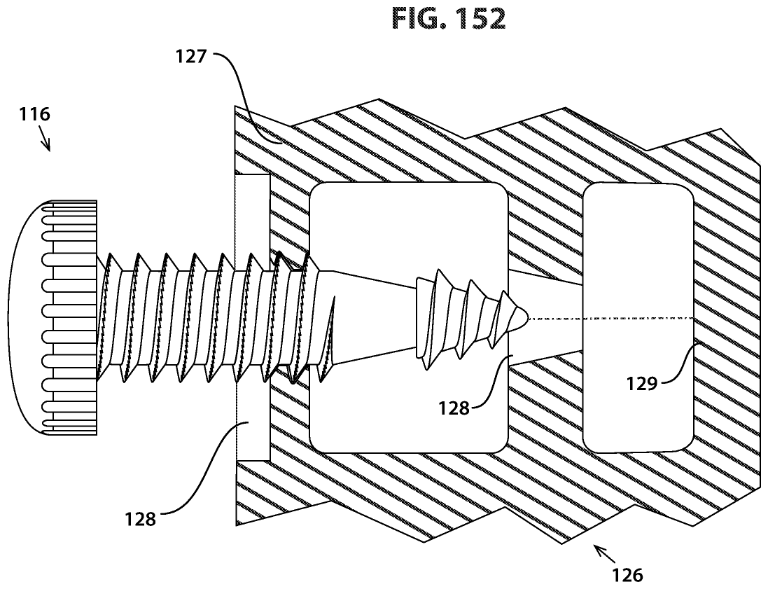

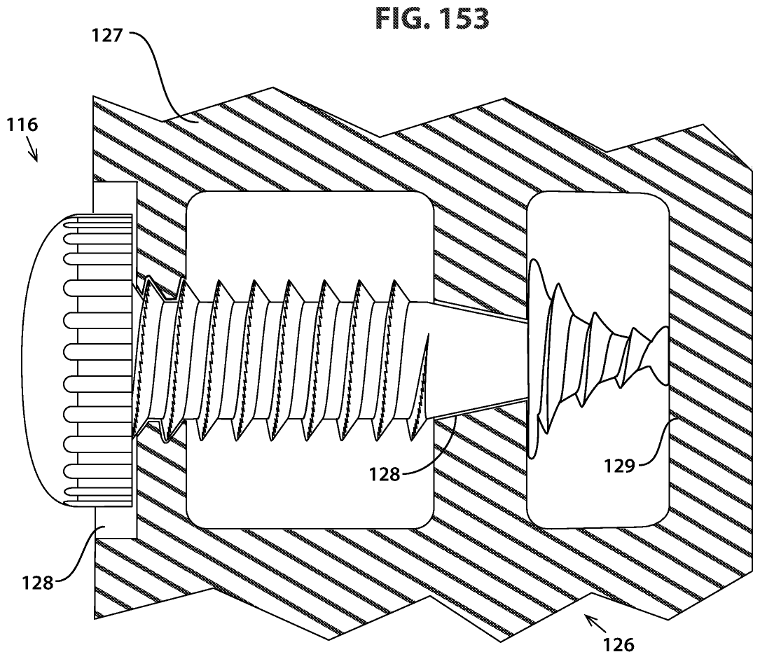

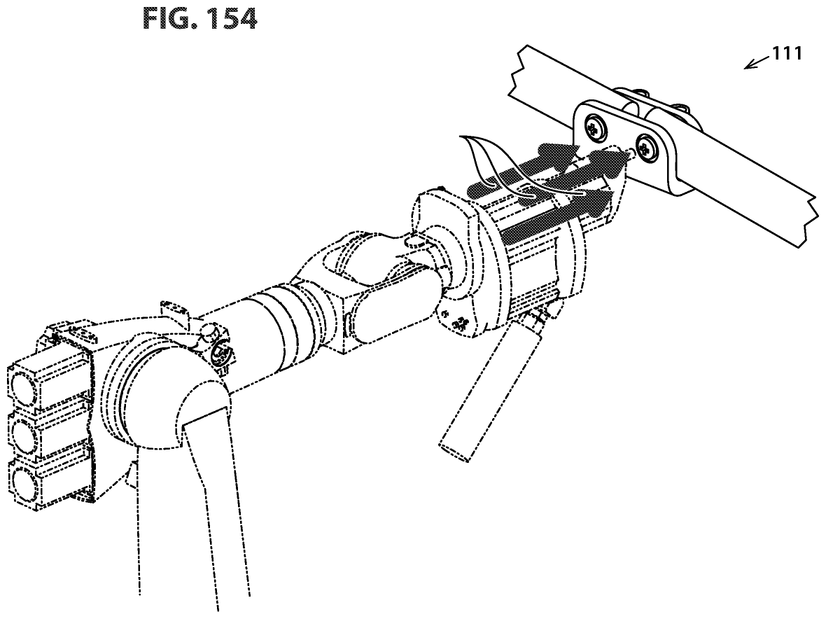

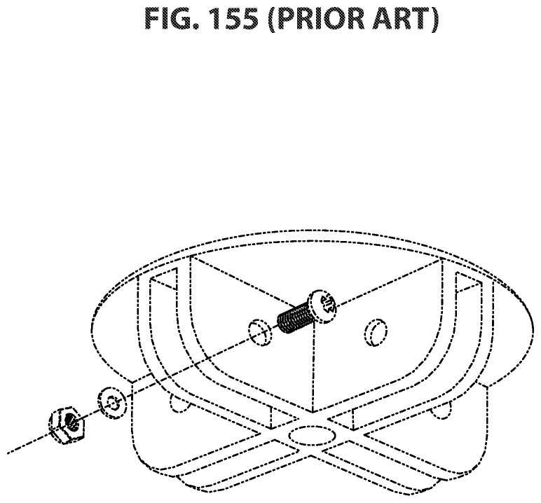

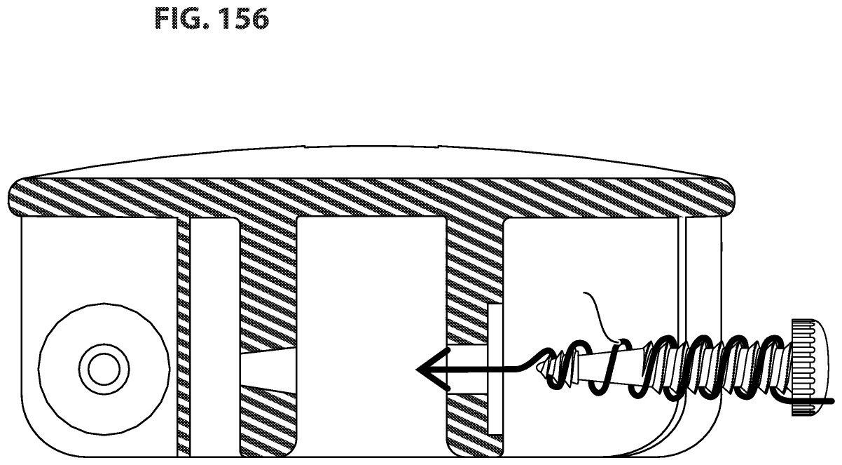

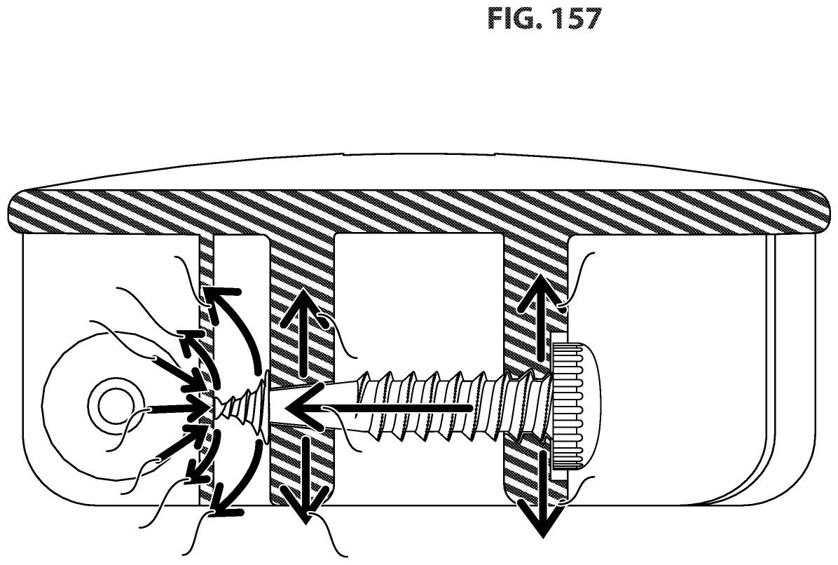

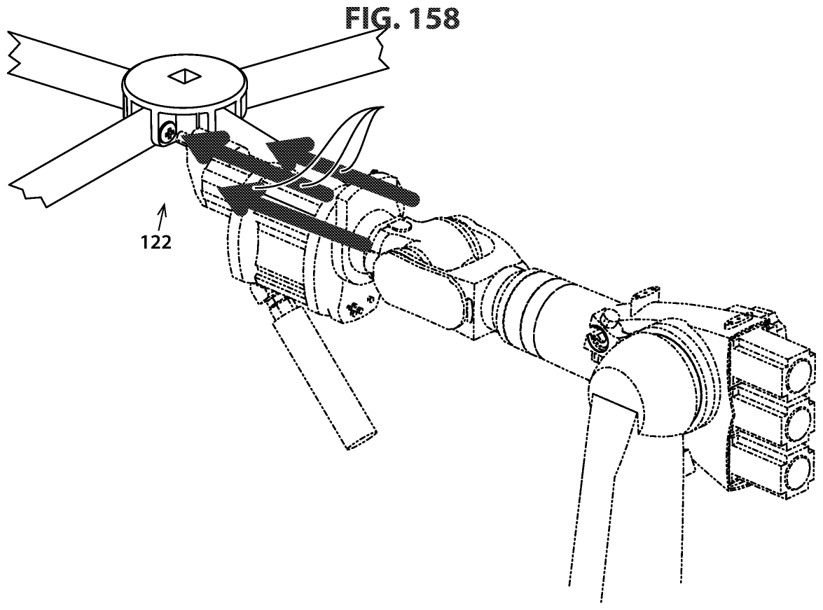

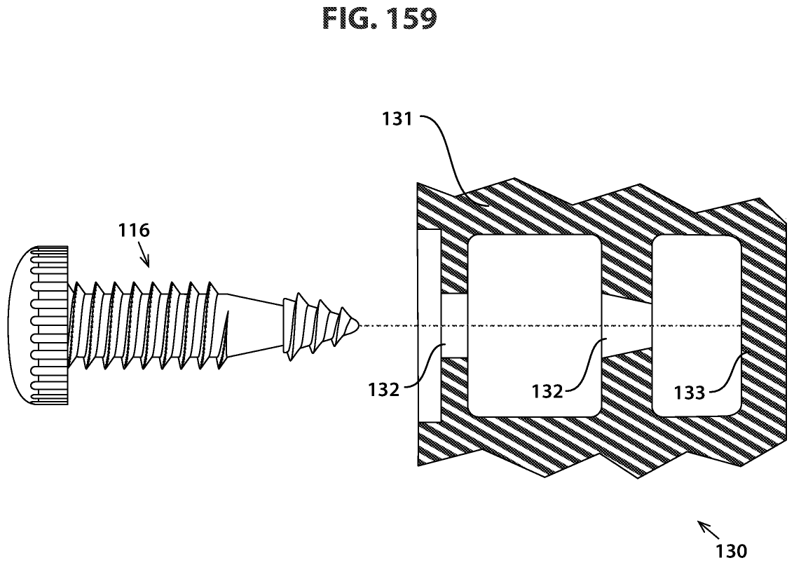

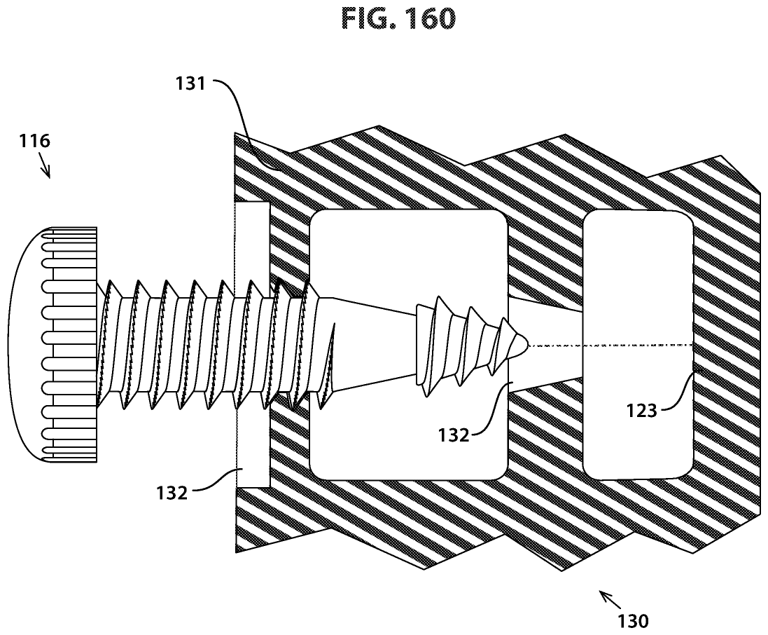

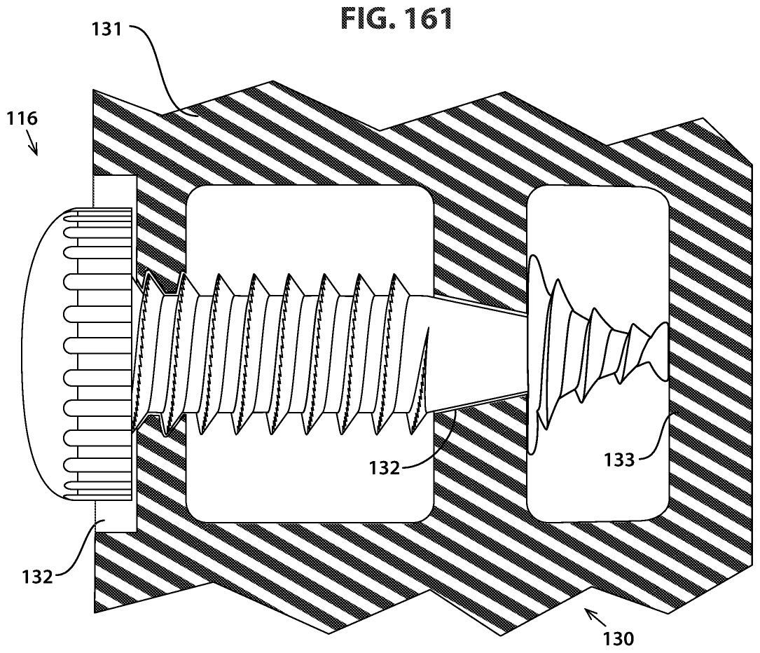

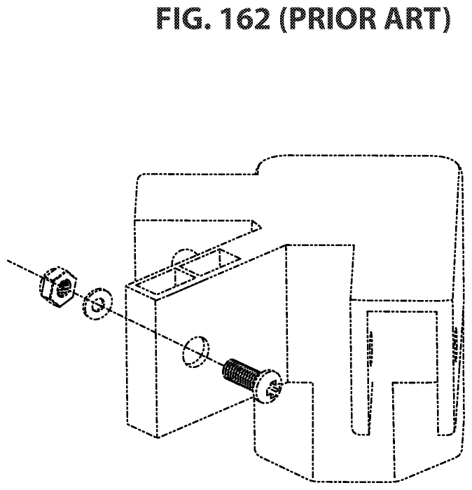

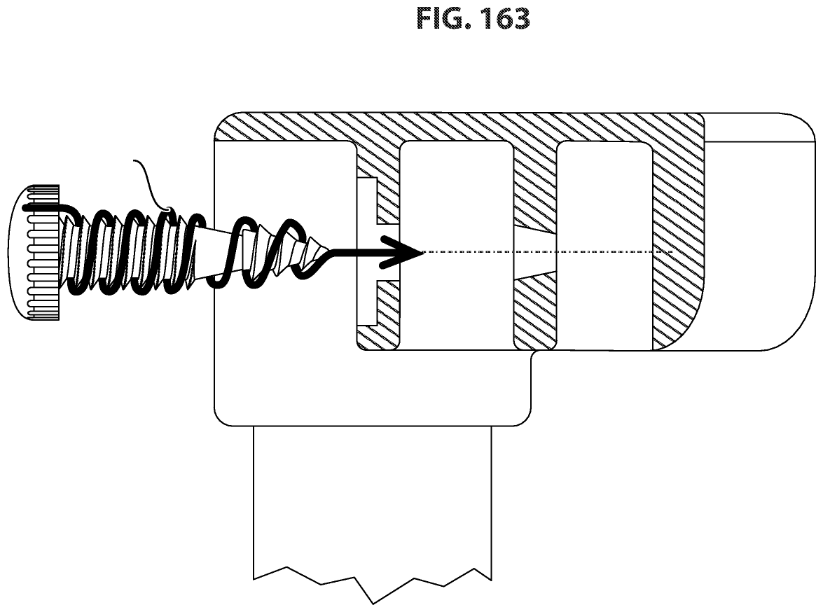

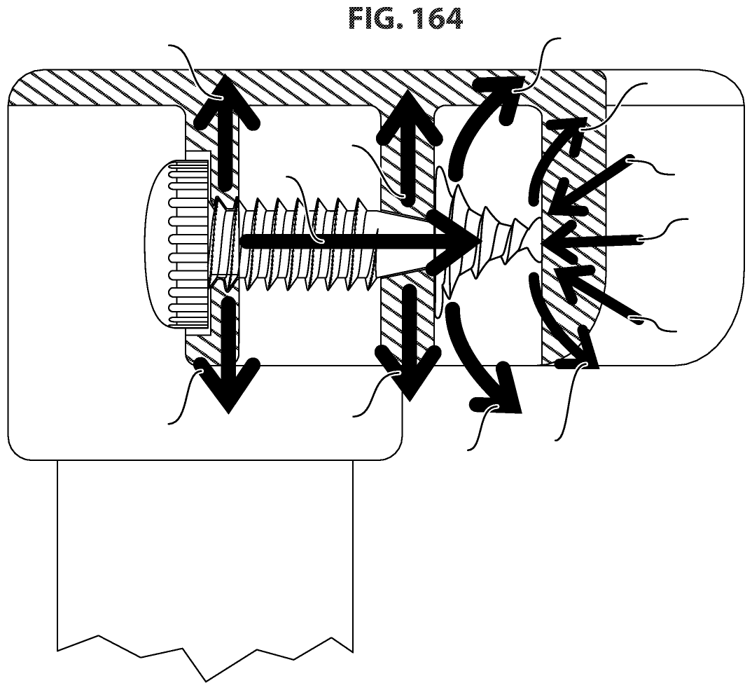

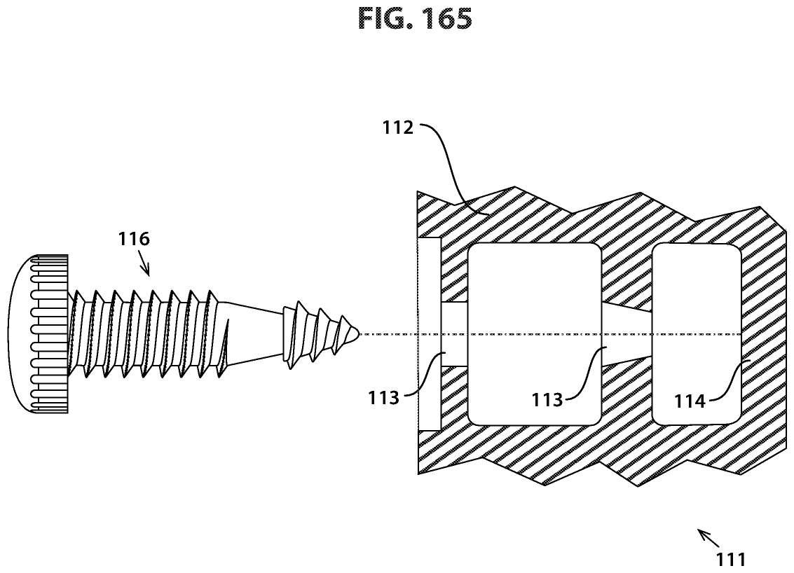

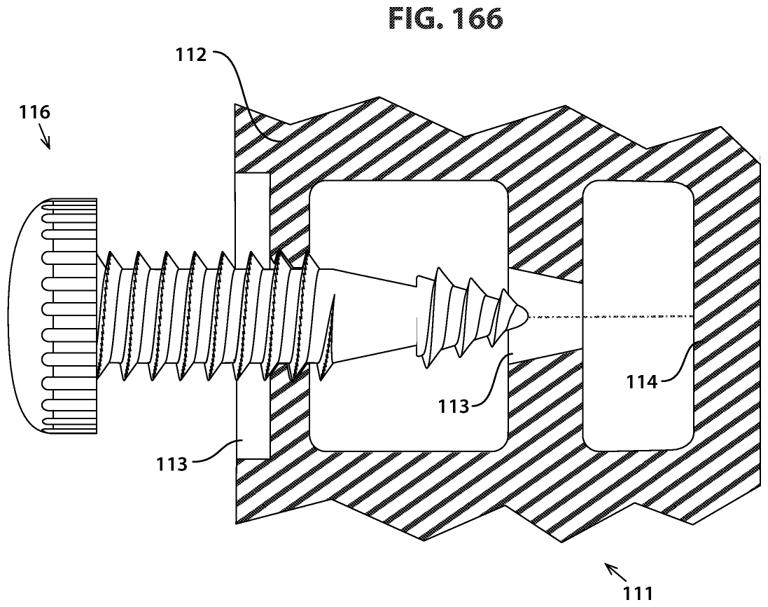

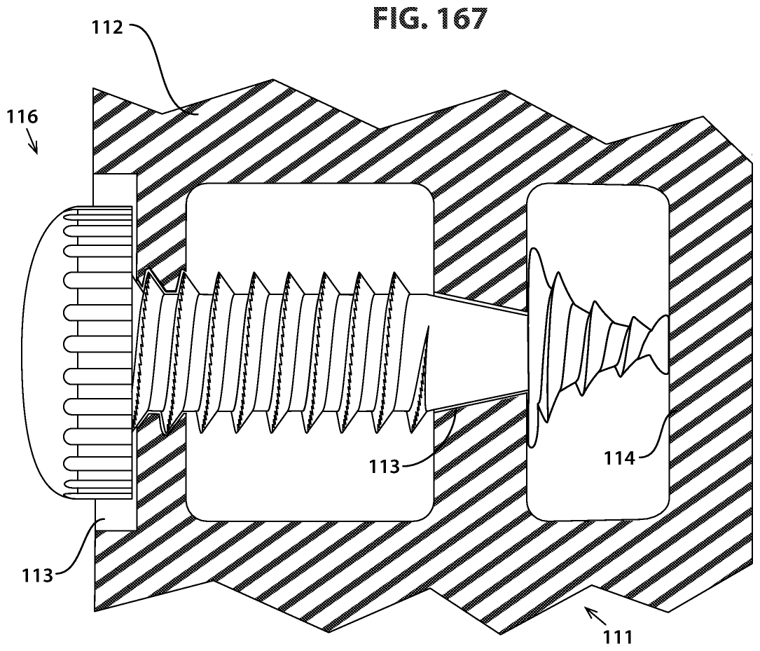

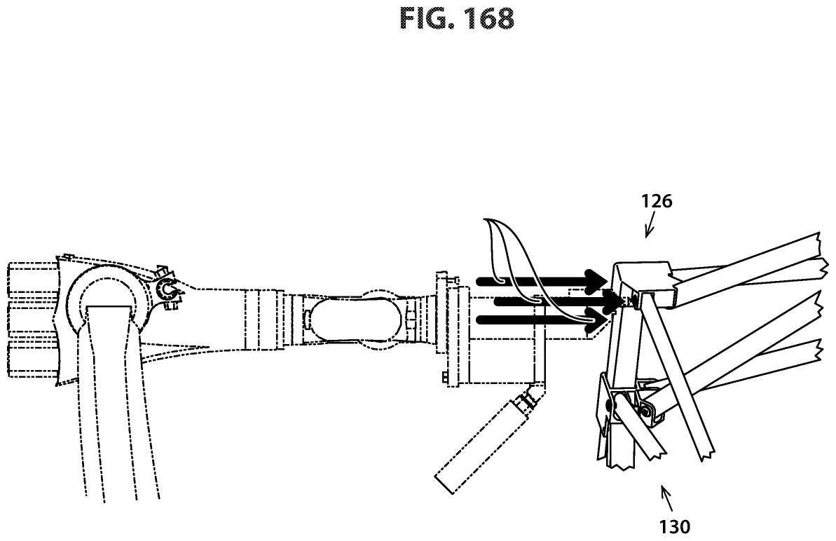

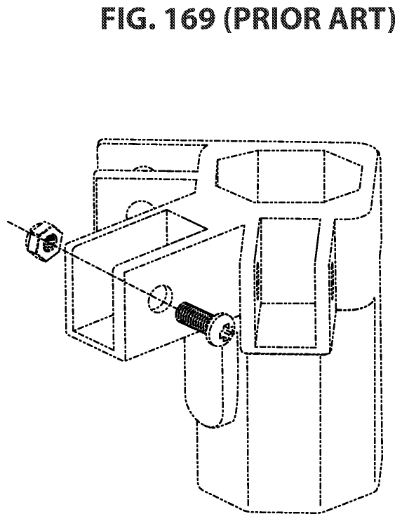

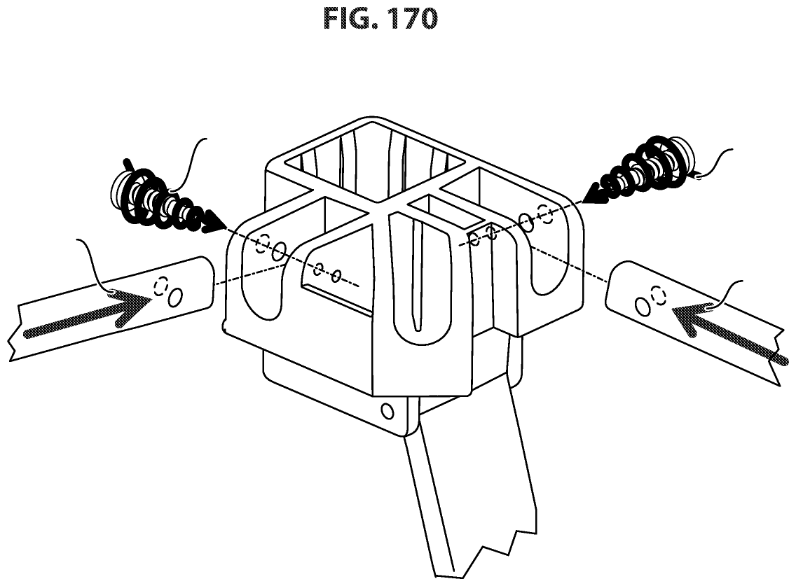

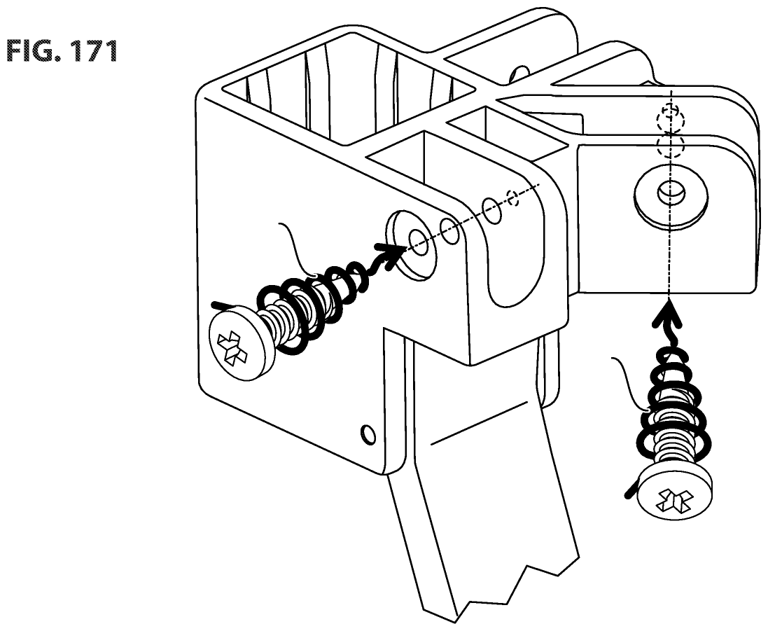

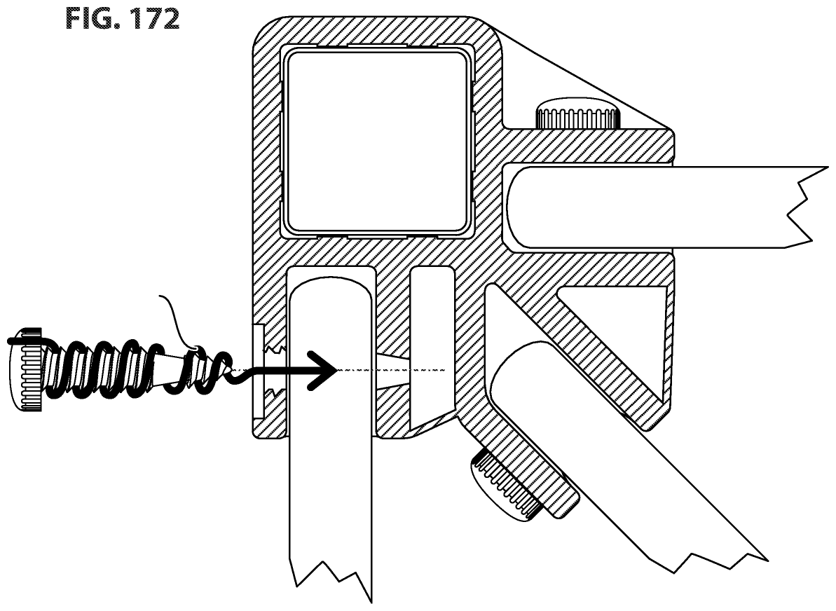

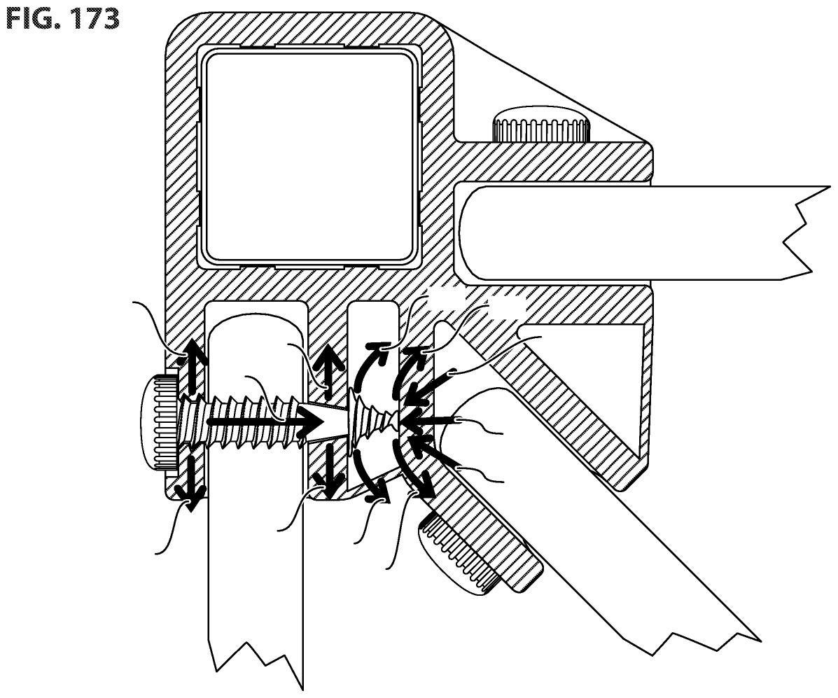

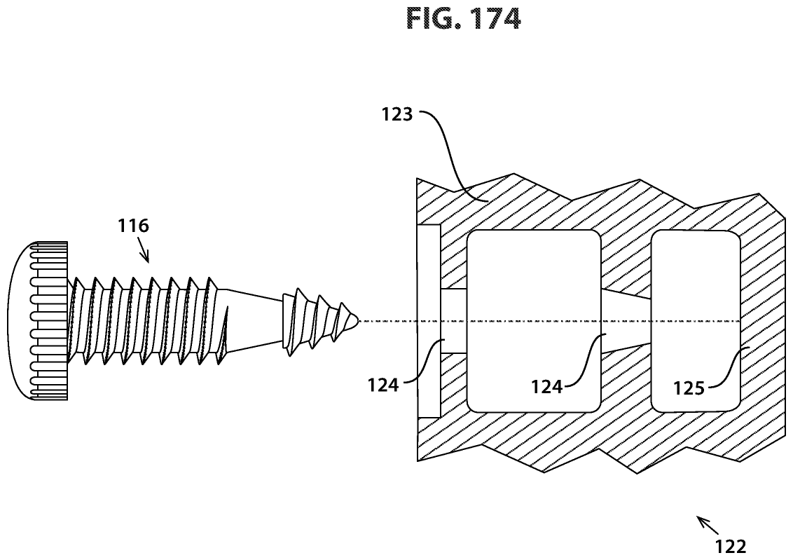

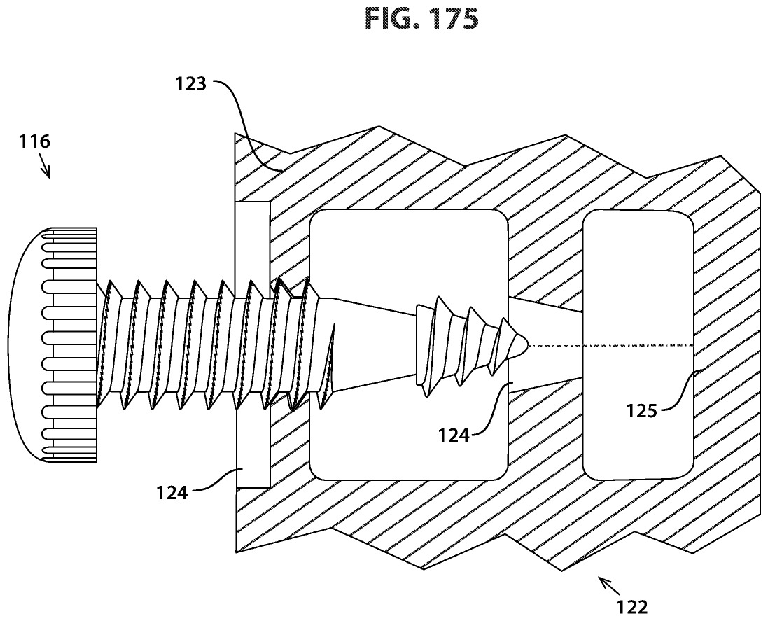

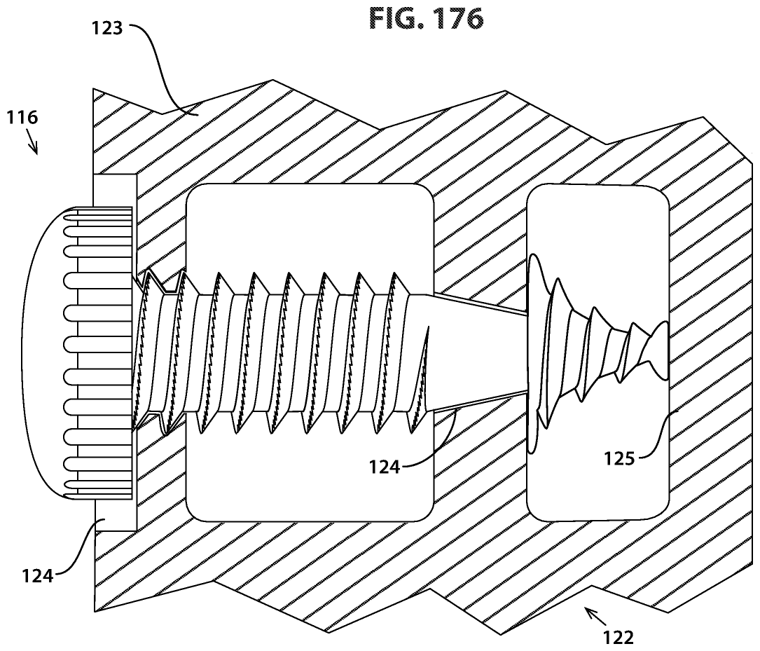

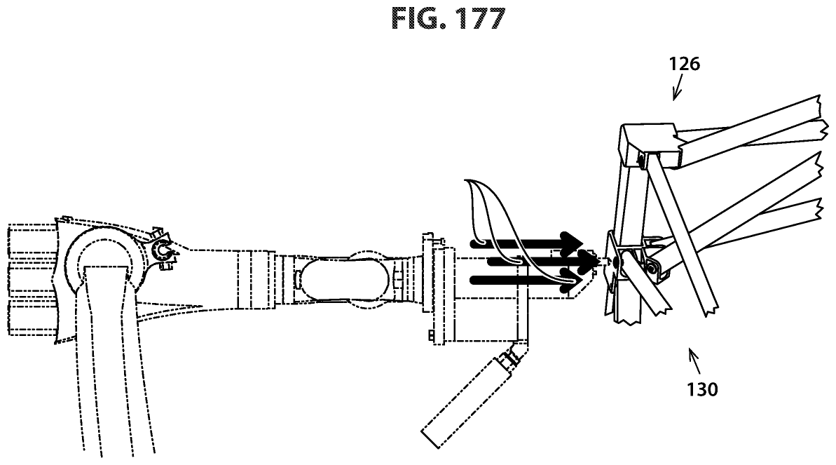

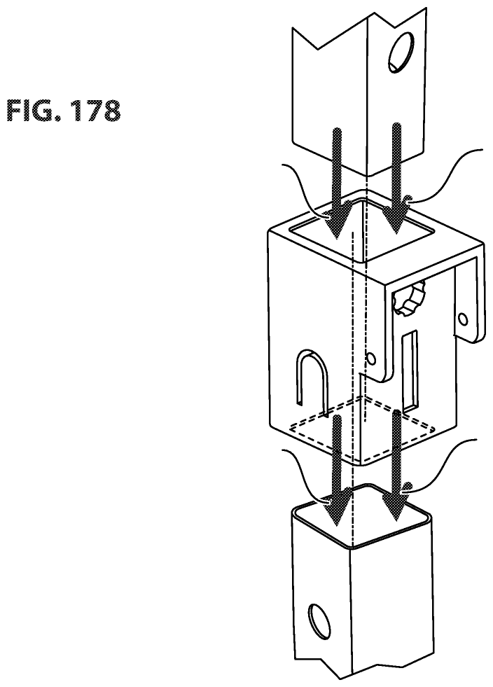

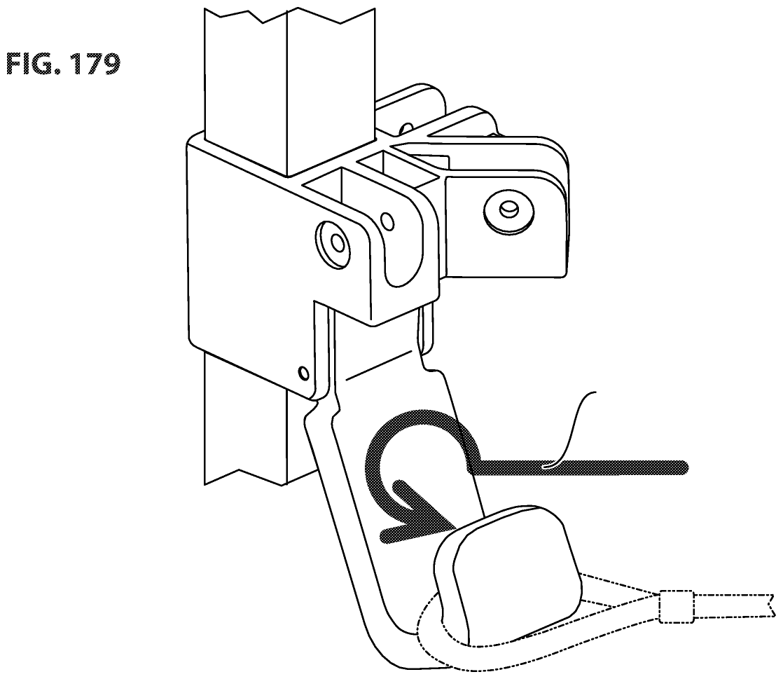

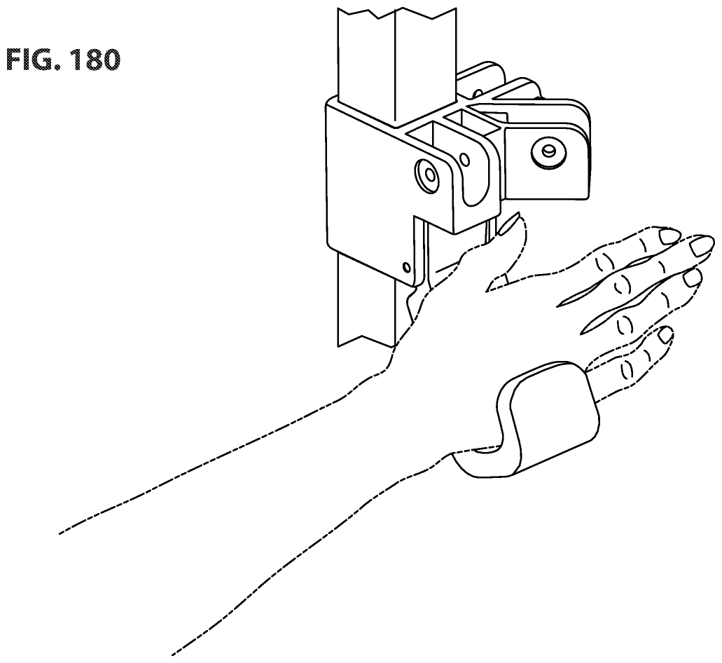

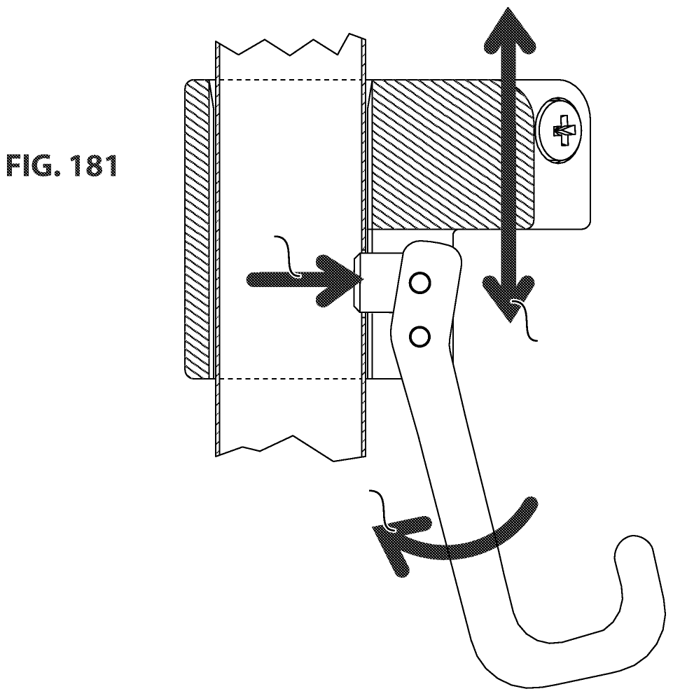

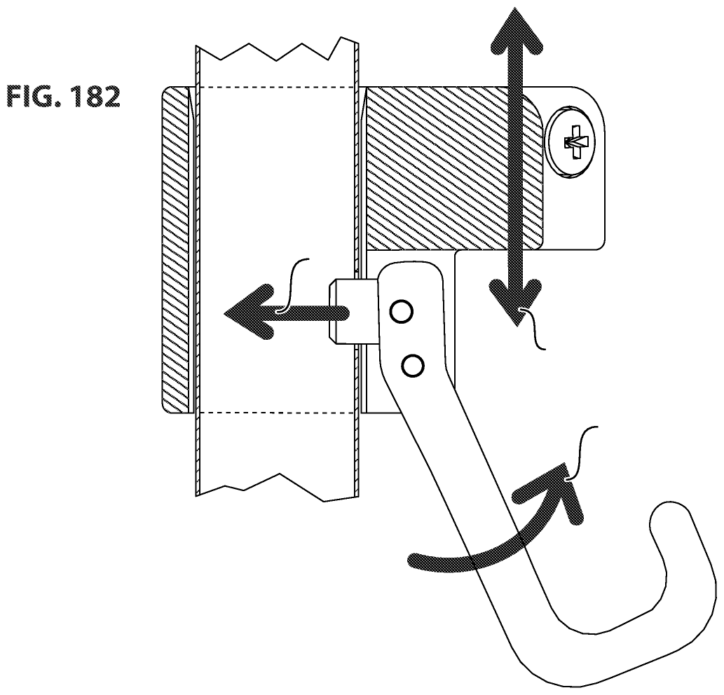

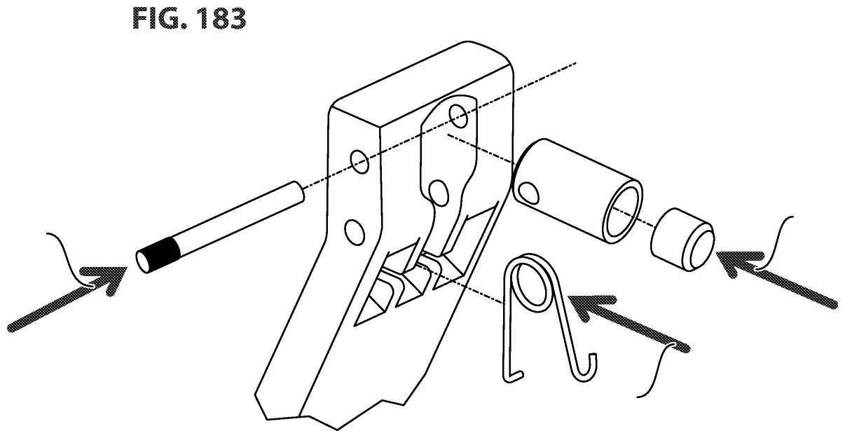

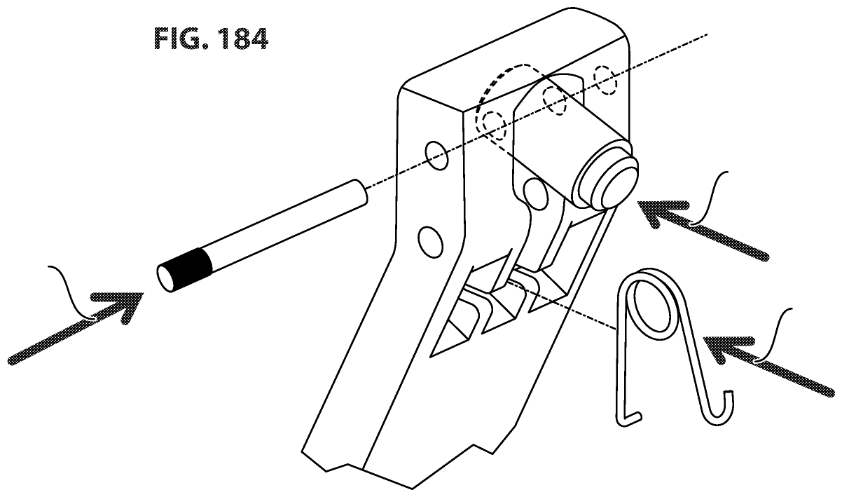

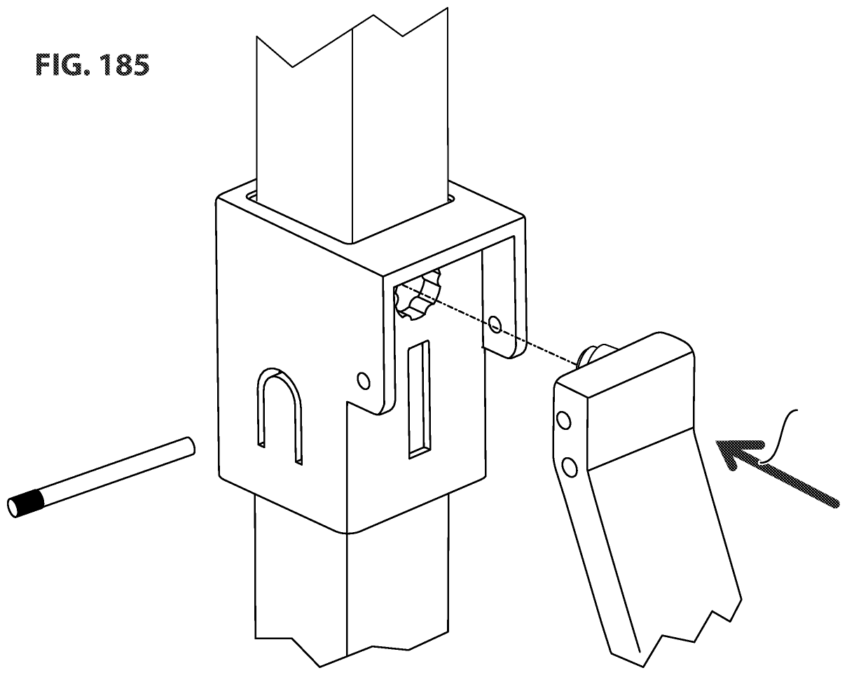

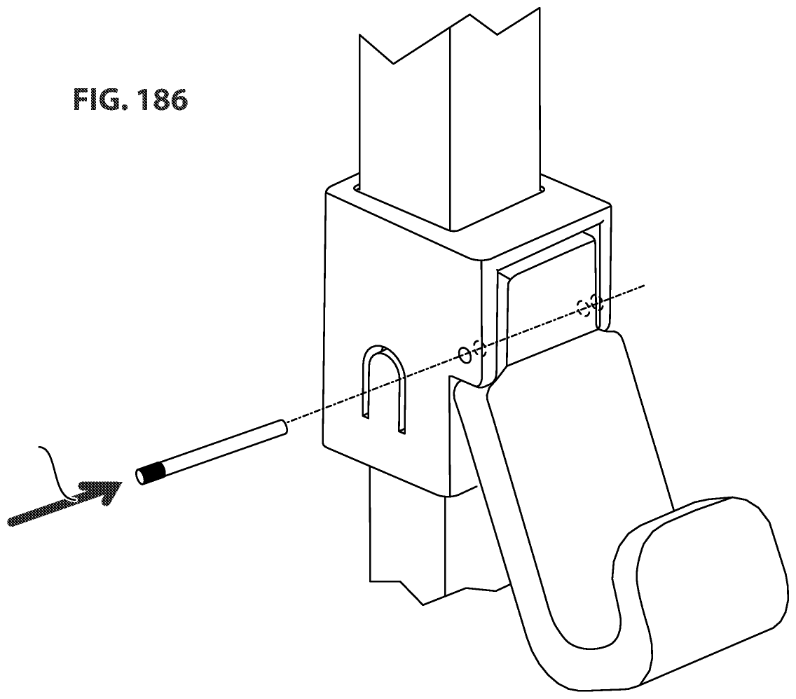

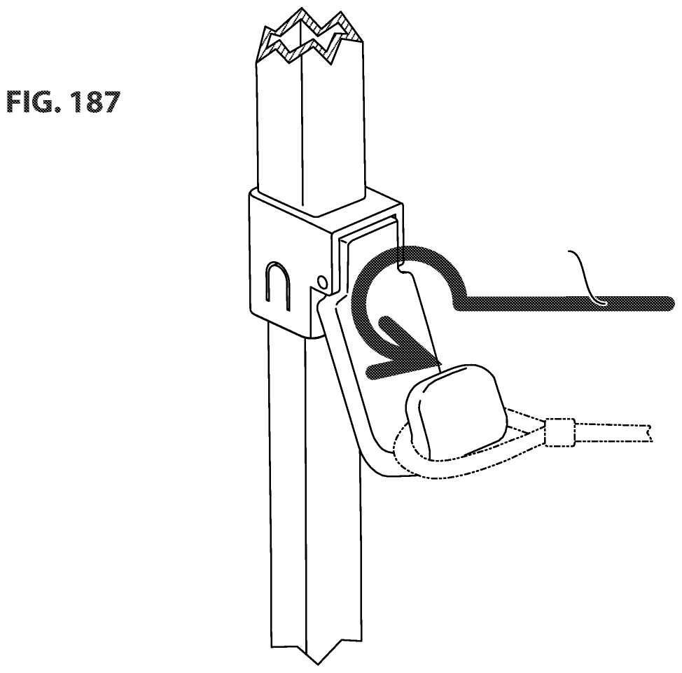

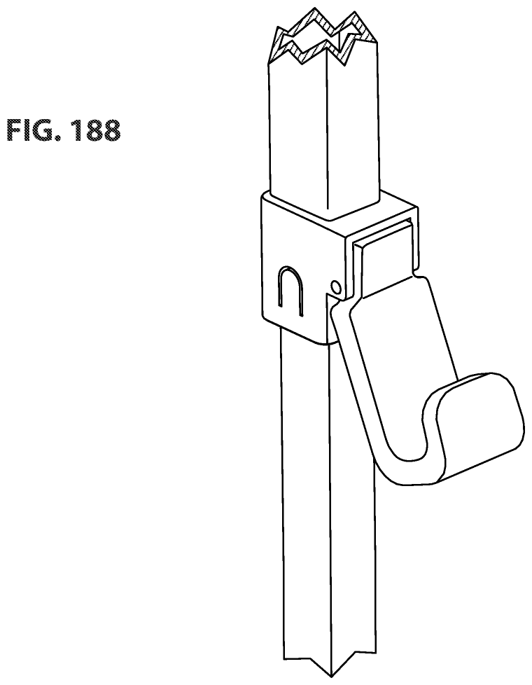

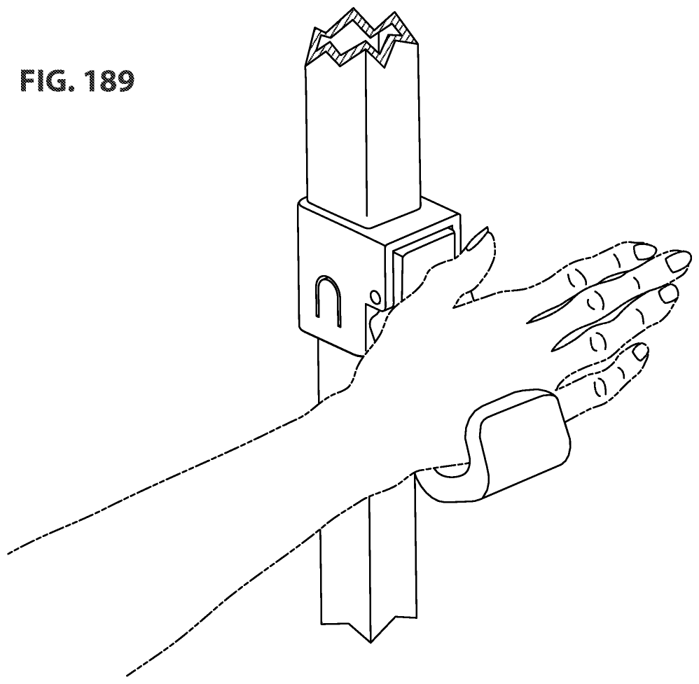

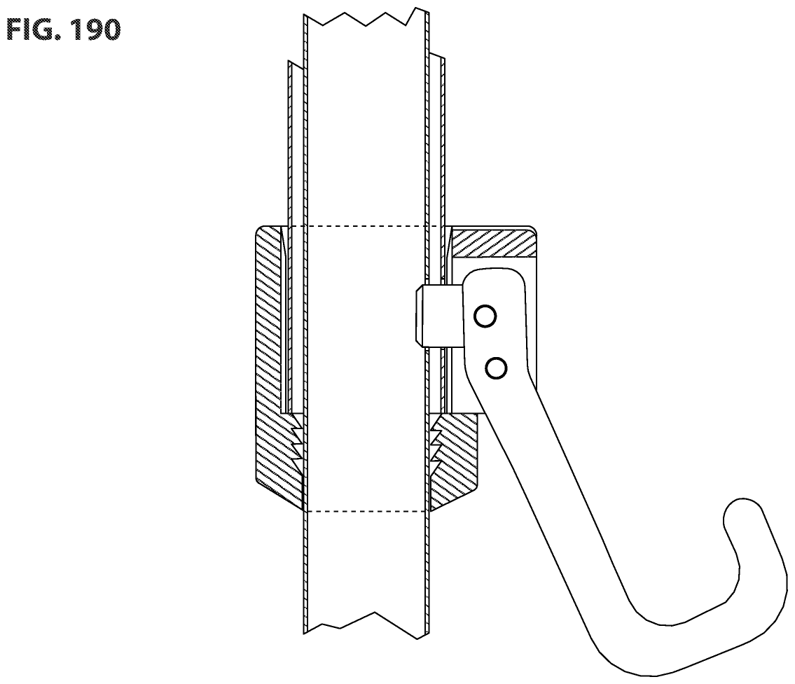

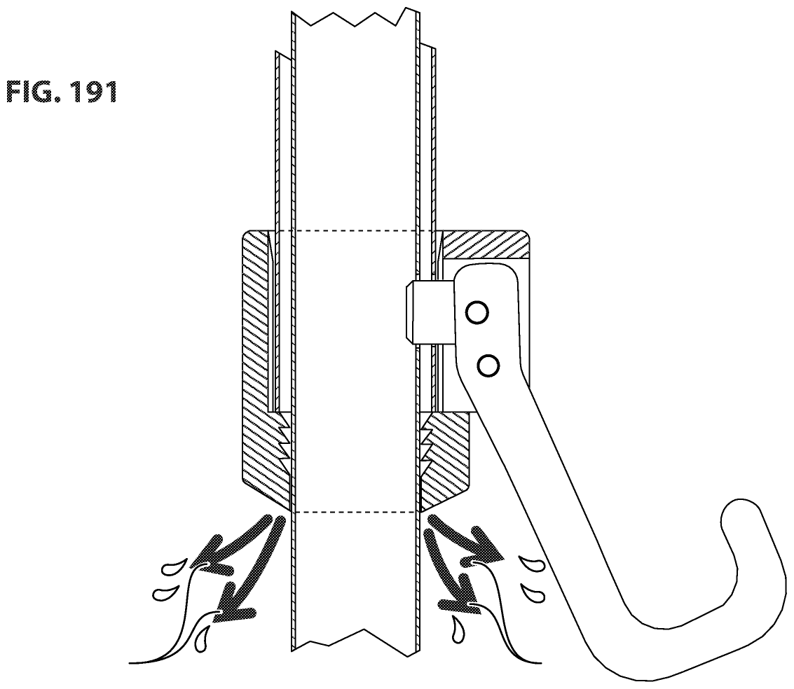

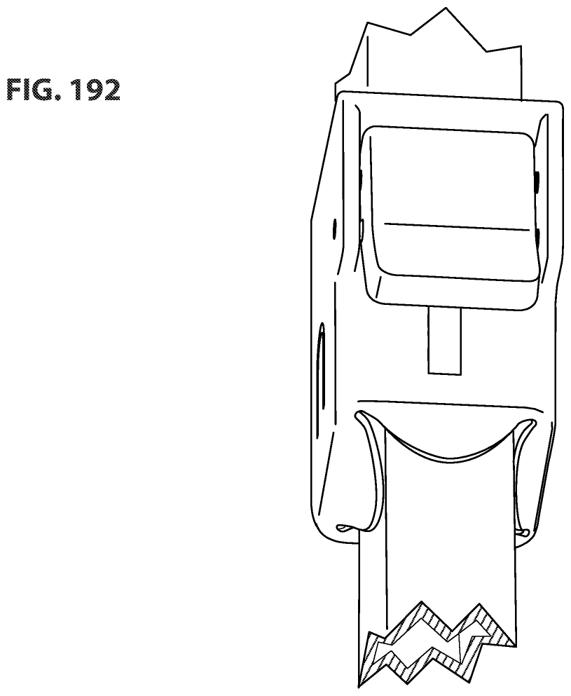

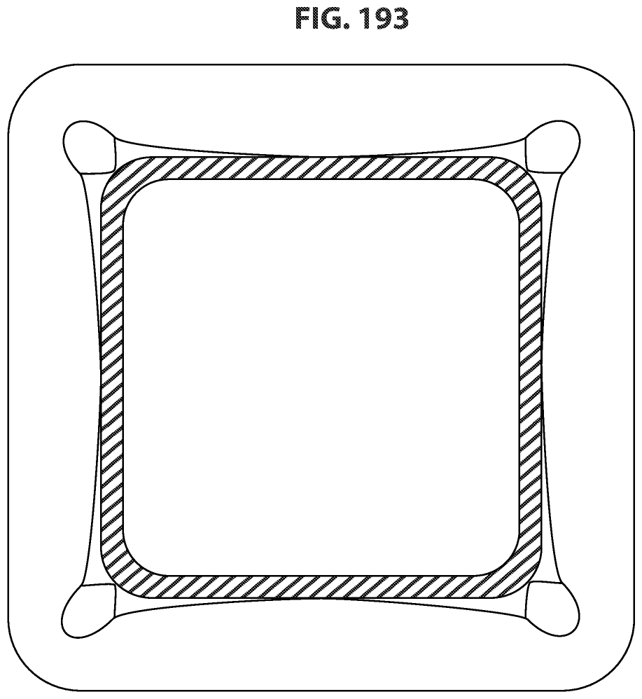

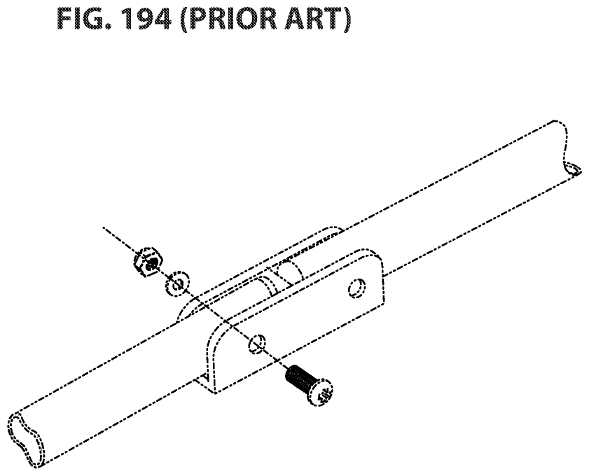

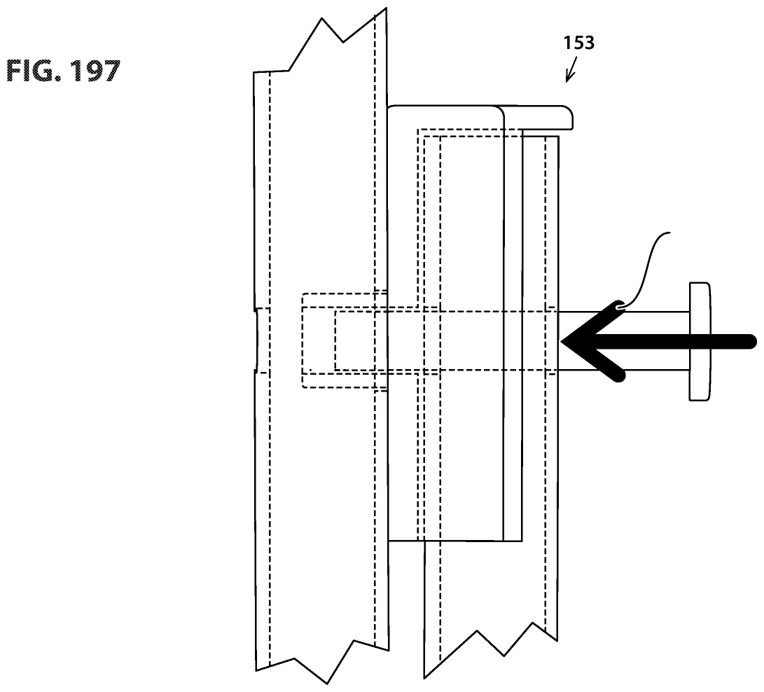

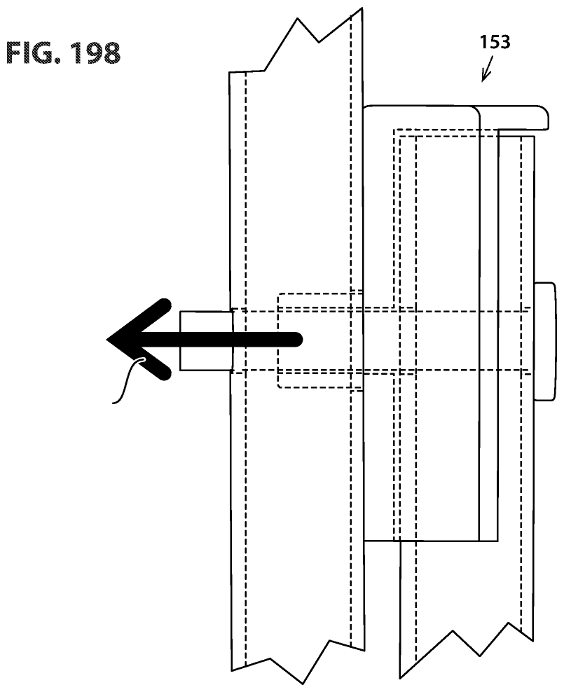

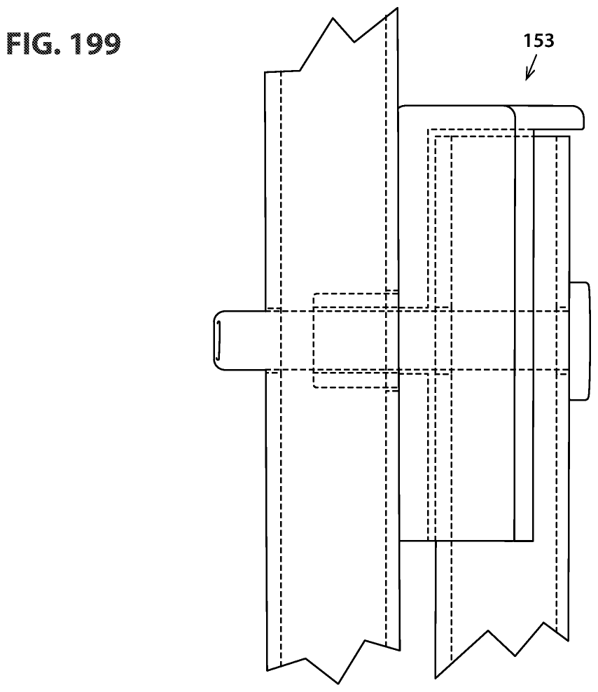

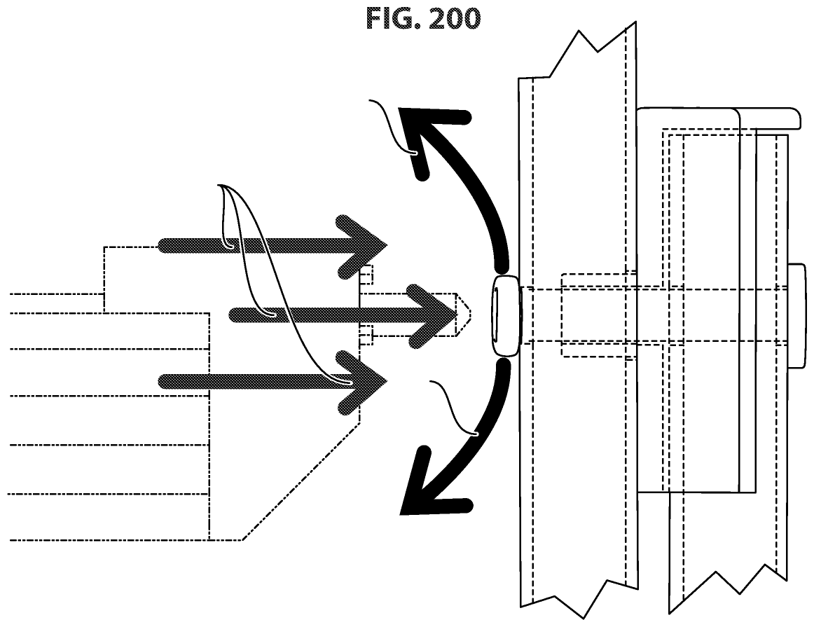

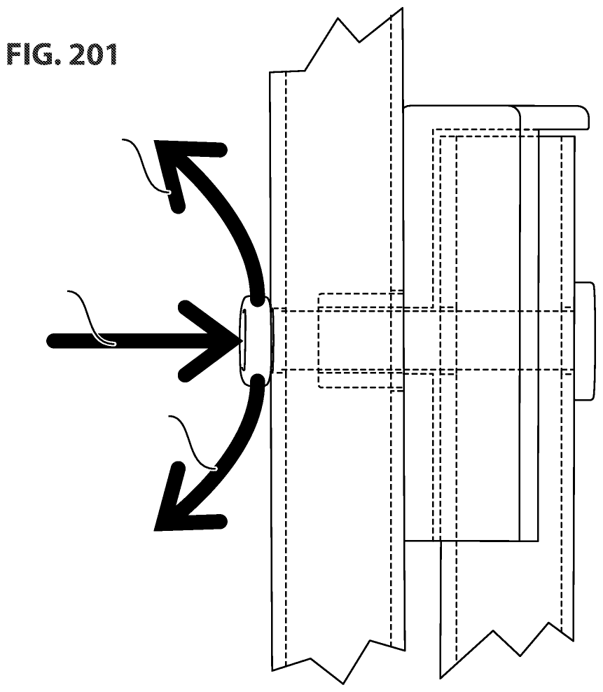

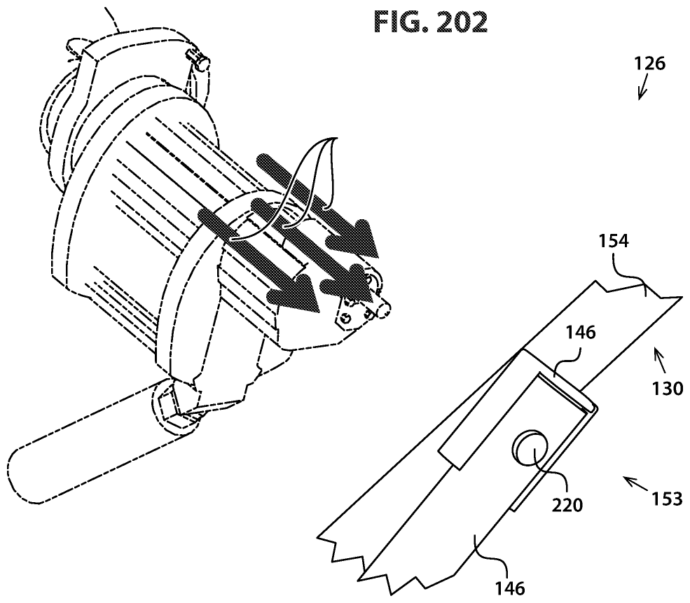

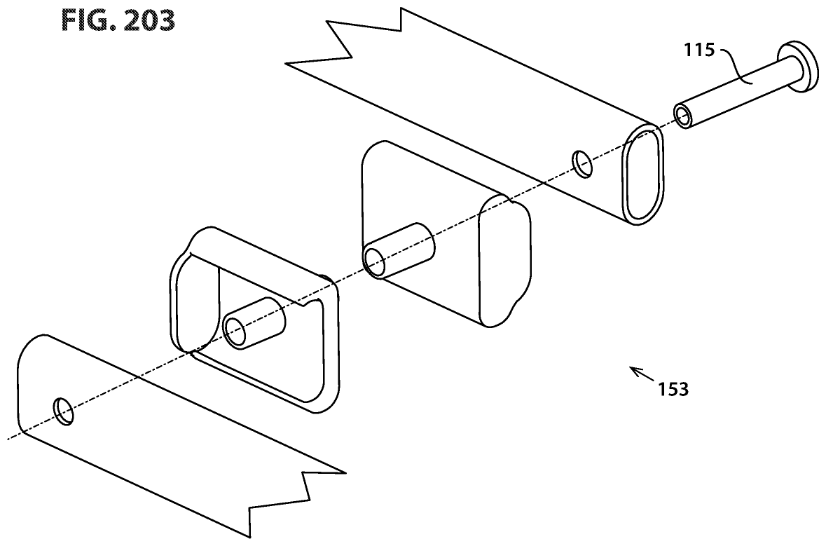

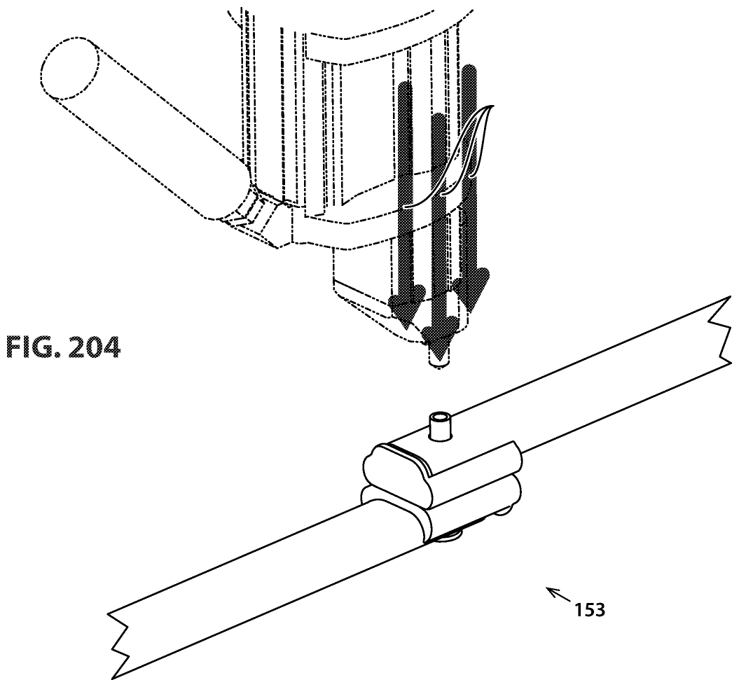

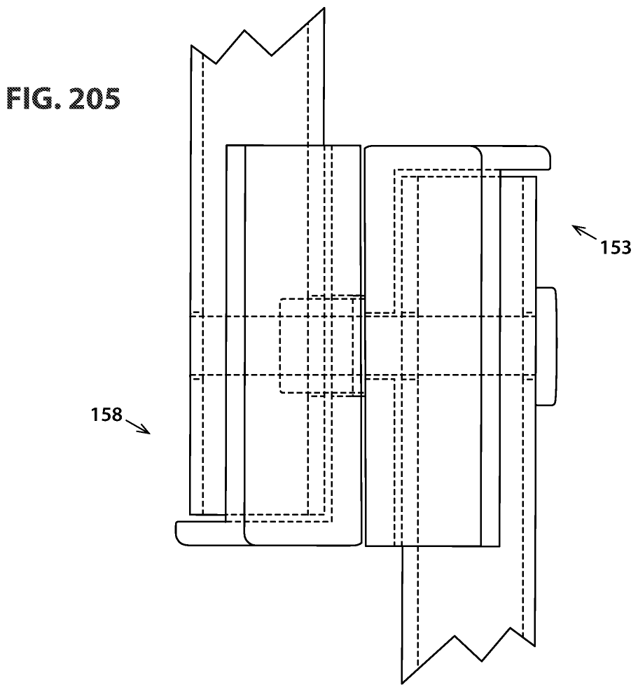

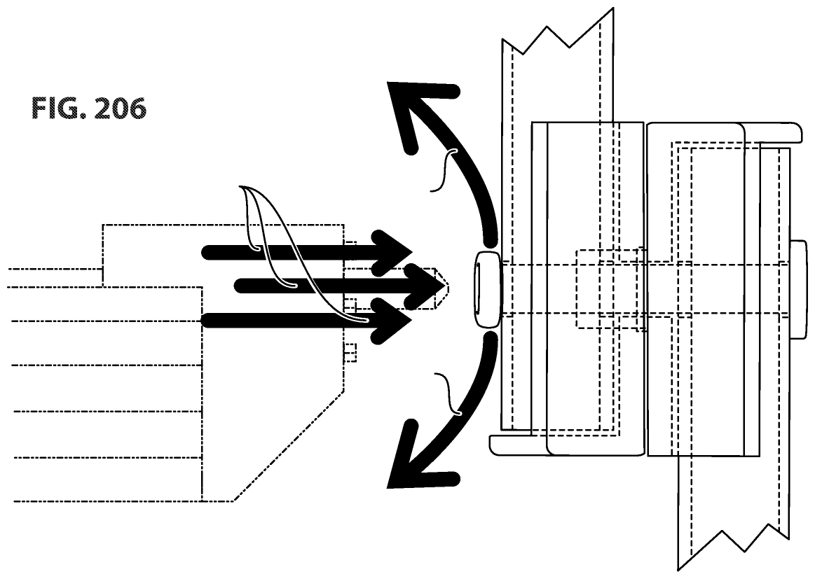

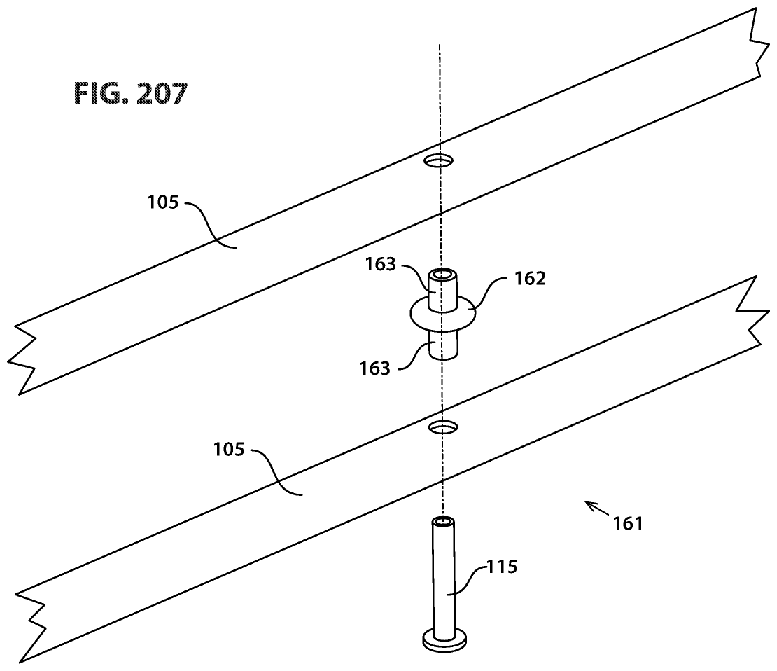

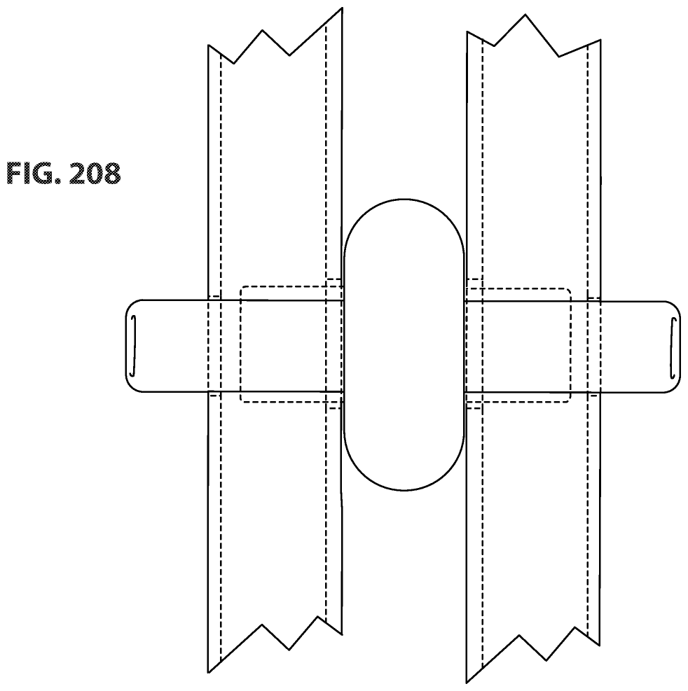

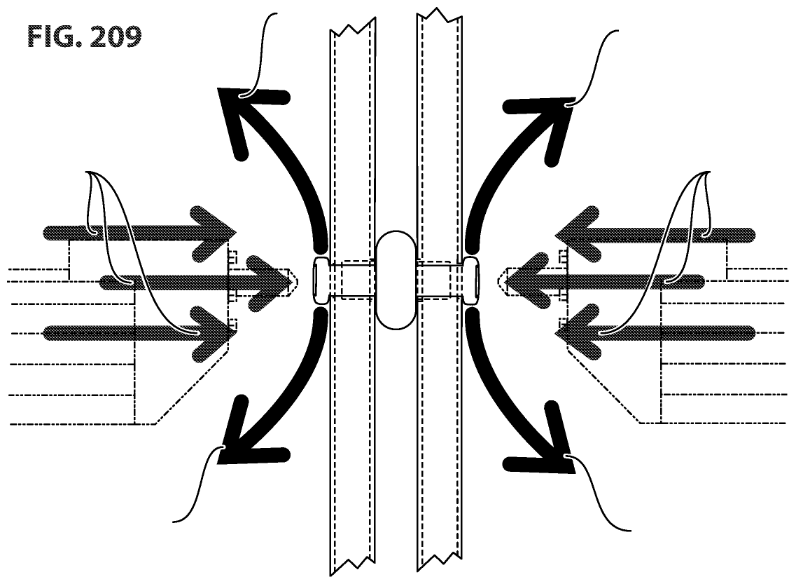

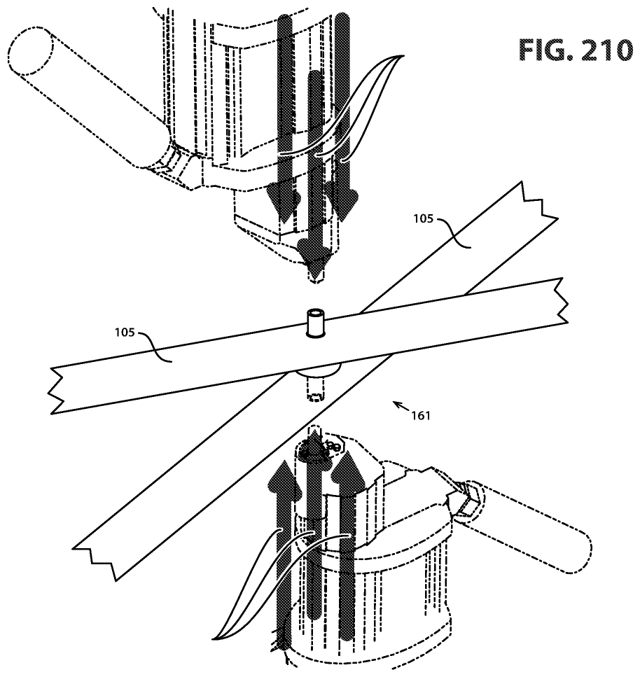

Referring to FIG. 129, FIG. 130, FIG. 131, FIG. 132, FIG. 133, FIG. 134, FIG. 135, FIG. 136, FIG. 137, FIG. 138, FIG. 139, FIG. 140, FIG. 141, FIG. 142, FIG. 143, FIG. 144, FIG. 145, FIG. 146, FIG. 147, FIG. 148, FIG. 149, FIG. 150, FIG. 151, FIG. 152, FIG. 153, FIG. 154, FIG. 155, FIG. 156, FIG. 157, FIG. 158, FIG. 159, FIG. 160, FIG. 161, FIG. 162, FIG. 163, FIG. 164, FIG. 165, FIG. 166, FIG. 167, FIG. 168, FIG. 169, FIG. 170, FIG. 171, FIG. 172, FIG. 173, FIG. 174, FIG. 175, FIG. 176, FIG. 177, FIG. 178, FIG. 179, FIG. 180, FIG. 181, FIG. 182, FIG. 183, FIG. 184, FIG. 185, FIG. 186, FIG. 187, FIG. 188, FIG. 189, FIG. 190, FIG. 191, FIG. 192, FIG. 193, FIG. 194, FIG. 195, FIG. 196, FIG. 197, FIG. 198, FIG. 199, FIG. 200, FIG. 201, FIG. 202, FIG. 203, FIG. 204, FIG. 205, FIG. 206, FIG. 207, FIG. 208, FIG. 209, and FIG. 210:
1) Robot-assembled arthritic-assisting noise-canceling friction-reducing dog-run-adaptable anti-wobbling gazebo system 101 is (or are respectively) for performing the combined functions of its components.
2) Adjustable canopy 102 is (or are respectively) for:
   a) Protecting occupants and property users from weather elements;
   b) Functioning as a greenhouse (see FIG. 3, FIG. 4, FIG. 138, and FIG. 139);
   c) Functioning as a cover for a dog-run in the direction of arrow 169 (see FIG. 5, FIG. 6, FIG. 140, and FIG. 141);
   d) Functioning as a surface for an advertisement sign (see FIG. 7, FIG. 8, FIG. 129, and FIG. 130);
   e) Functioning as an awning cover (see FIG. 9, FIG. 10, FIG. 131, and FIG. 132); and
   f) Functioning as ceiling-mounted overhead storage (see FIG. 11, FIG. 12, FIG. 133, and FIG. 134).
3) Dog-run-adaptable anti-wobbling foldable top trusses 103 is (or are respectively) for: Foldably supporting central robot-assembled intersectors 123.
4) Dog-run-adaptable anti-wobbling foldable corner trusses 104 is (or are respectively) for: Foldably supporting dog-run-adaptable anti-wobbling foldable top trusses 103.
5) Dog-run-adaptable anti-wobbling foldable side trusses 105 is (or are respectively) for: Foldably supporting dog-run-adaptable anti-wobbling foldable top trusses 103.
6) Dog-run-adaptable anti-wobbling foldable upper posts 106 is (or are respectively) for: Foldably and adjustably supporting dog-run-adaptable anti-wobbling foldable lower posts 107.
7) Dog-run-adaptable anti-wobbling foldable lower posts 107 is (or are respectively) for:
   a) Foldably and slidably raising and lowering to increase and decrease the height of the six-device-in-one robot-assembled arthritic-assisting noise-canceling friction-reducing dog-run-adaptable anti-wobbling gazebo; and
   b) Supporting sidewalls of dog-run.
8) Dog-run-adaptable anti-wobbling arthritic-assisting feet 108 is (or are respectively) for: Supporting dog-run-adaptable anti-wobbling foldable lower posts 107.
9) Dog-run-adaptable anti-wobbling arthritic-assisting foot holes 109 is (or are respectively) for:
   a) Securing a rope or cord for supporting a dog-run in the direction of arrow 170 (see FIG. 135, and FIG. 136); and
   b) Securing the six-device-in-one robot-assembled arthritic-assisting noise-canceling friction-reducing dog-run-adaptable anti-wobbling gazebo to the ground with a spike.
10) Truss holes 110 is (or are respectively) for: Providing openings for secure and foldable attachment and operation.
11) Robot-assembled automatically-making-rivet-tail-flare noise-canceling injury-preventing top-connector system 111 is (or are respectively) for performing the combined functions of its components.
12) Top robot-assembled connectors 112 is (or are respectively) for:
   Robotically and foldably attaching two dog-run-adaptable anti-wobbling foldable top trusses 103 together in the direction of arrow 171a (see FIG. 154).
13) Top robot-assembled heat-expandable cold-contractable holes 113 is (or are respectively) for:
   a) Providing openings for robot-assembled heat-expandable cold-contractable anti-wobbling screws 117 to be robotically inserted
      to reduce end-user assembly time,
      to reduce human-involved manufacturing assembly hours,
      to decrease overall production assembly time, and
      to increase total per-unit production output (see FIG. 146 (Prior Art));
   b) Locking robot-assembled heat-expandable cold-contractable anti-wobbling screws 117 by expanding from friction-heat during insertion, forming threads, and then contracting inward when cooled in the directions of arrows 171a, 171b, 171c, and 171d (see FIG. 145, FIG. 149, FIG. 150, and FIG. 153).
14) Top robot-assembled automatically-flaring-and-shielding-rivet-tail injury-preventing hammer-shields 114 is (or are respectively) for:
   a) Providing a limiting surface for robot-assembled heat-expandable cold-contractable anti-wobbling screws 117 to stop in the directions of arrows 171a, 171f, 171g, 171h, 171i, and 171j (see FIG. 145, FIG. 149, FIG. 150, and FIG. 153); and
   b) Preventing injury by covering the robot-assembled heat-expandable cold-contractable interlocking cones 120.
15) Top robot-assembled heat-expandable cold-contractable double-tail rivets 115 is (or are respectively) for:
   Pivotably and robotically-assembling dog-run-adaptable anti-wobbling foldable top trusses 103 to top robot-assembled connectors 112 in the direction of arrow 172a, (see FIG. 154).
16) Robot-assembled heat-expandable cold-contractable interlocking anti-wobbling spiral-saw screw system 116 is (or are respectively) for performing the combined functions of its components.
17) Robot-assembled heat-expandable cold-contractable anti-wobbling screws 117 is (or are respectively) for:
   a) Saving manufacturing time by eliminating the need for nuts and bolts (see FIG. 146 (Prior Art), FIG. 155 (Prior Art), FIG. 162 (Prior Art), and FIG. 169 (Prior Art));
   b) Saving manufacturing man-hours by robotically manufacturing in the directions of arrows 172a, 172b, 172c, and 172d (see FIG. 154, FIG. 158, FIG. 168, and FIG. 177);
   c) Saving end-consumer assembly time by robotically pre-installing robot-assembled heat-expandable cold-contractable anti-wobbling screws 117, at the factory in the directions of arrows 172a, 172b, 172c, and 172d (see FIG. 154, FIG. 158, FIG. 168, and FIG. 177); and
   d) Increasing overall production output of the six-device-in-one robot-assembled arthritic-assisting noise-canceling friction-reducing dog-run-adaptable anti-wobbling gazebo by robotically decreasing per-unit production time.
18) Robot-assembled heat-expandable cold-contractable spirally-threading spiral saws 118 is (or are respectively) for:
   Robotically and heatingly expanding and tapping threads into top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144).
19) Robot-assembled heat-expandable cold-contractable spiral-teeth 119 is (or are respectively) for:
   Robotically and speedily cutting through plastic connector material
      to decrease production time, and
      to increase production output
   in the directions of arrows 171a, 173a, and 173b (see FIG. 144).
20) Robot-assembled heat-expandable cold-contractable interlocking cones 120 is (or are respectively) for:
   a) Robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132
      in the directions of arrows 171a, 173a, and 173b (see FIG. 144);
   b) Expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133
      in the directions of arrows 171a, 173c, 173d, and 173e (see FIG. 145); and
   c) Eliminating the need for the usage of nuts and bolts
      to robotically lessen the assembly time, and
      to robotically lessen assembly cost (see FIG. 146 (Prior Art), FIG. 155 (Prior Art), FIG. 162 (Prior Art), and FIG. 169 (Prior Art)).
21) Robot-assembled heat-expandable cold-contractable interlocking spiral locks 121 is (or are respectively) for:
   a) Robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144); and
   b) Expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133
      in the directions of arrows 171a, 173c, 173d, and 173e (see FIG. 145).
22) Robot-assembled injury-preventing cone-shielding central intersector system 122 is (or are respectively) for performing the combined functions of its components.
23) Central robot-assembled intersectors 123 is (or are respectively) for:
   Robotically securely attaching at least one dog-run-adaptable anti-wobbling foldable top trusses 103
   in the direction of arrow 172b (see FIG. 158).
24) Central robot-assembled heat-expandable cold-contractable holes 124 is (or are respectively) for:
   a) Providing openings for robot-assembled heat-expandable cold-contractable anti-wobbling screws 117 to be robotically installed in the direction of arrow 172b (see FIG. 158); and
   b) Locking robot-assembled heat-expandable cold-contractable anti-wobbling screws 117 by expanding from friction-heat during insertion, forming threads, and then contracting inward when cooled in the directions of arrows 174a, 174b, 174c, 174d, and 174e (see FIG. 156, FIG. 157, FIG. 159, FIG. 160, and FIG. 161).
25) Central robot-assembled automatically-flaring-and-shielding-cone-head injury-preventing hammer-shields 125 is (or are respectively) for:
   a) Automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place
      in the directions of arrows 174a, 174f, 174g, 174h, 174i, and 174j (see FIG. 156, FIG. 157, FIG. 159, FIG. 160, and FIG. 161); and
   b) Preventing injury by coving the robot-assembled heat-expandable cold-contractable interlocking cones 120.
26) Robot-assembled injury-preventing cone-shielding upper intersector system 126 is (or are respectively) for performing the combined functions of its components.
27) Upper robot-assembled intersectors 127 is (or are respectively) for:
   Pivotably and foldably attaching dog-run-adaptable anti-wobbling foldable top trusses 103, dog-run-adaptable anti-wobbling foldable corner trusses 104, dog-run-adaptable anti-wobbling foldable side trusses 105, and dog-run-adaptable anti-wobbling foldable upper posts 106 together.
28) Upper robot-assembled heat-expandable cold-contractable holes 128 is (or are respectively) for:
   a) Providing openings for robot-assembled heat-expandable cold-contractable anti-wobbling screws 11 to be robotically installed; and
   b) Locking robot-assembled heat-expandable cold-contractable anti-wobbling screws 117 by expanding from friction-heat during insertion, forming threads, and then contracting inward when cooled in the directions of arrows 175a, 175b, 175c, 175d, and 175e (see FIG. 163, FIG. 164, FIG. 165, FIG. 166, and FIG. 167).
29) Upper robot-assembled automatically-flaring-and-shielding-cone-head injury-preventing hammer-shields 129 is (or are respectively) for:
   a) Automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place; and
   b) Preventing injury by coving the robot-assembled heat-expandable cold-contractable interlocking cones 120
      in the directions of arrows 175a, 175f, 175g, 175h, 175i, and 175j (see FIG. 163, FIG. 164, FIG. 165, FIG. 166, and FIG. 167).
30) Robot-assembled arthritic-assisting injury-preventing cone-shielding lower intersector system 130 is (or are respectively) for performing the combined functions of its components.
31) Lower robot-assembled intersectors 131 is (or are respectively) for: Slidably attaching to dog-run-adaptable anti-wobbling foldable upper posts 106.
32) Lower robot-assembled heat-expandable cold-contractable holes 132 is (or are respectively) for:
   Providing openings for robot-assembled heat-expandable cold-contractable anti-wobbling screws 11 to be robotically installed in the directions of arrows 176a, 176b, 176c, 176d, and 176e (see FIG. 170, FIG. 171, FIG. 172, FIG. 173, FIG. 174, FIG. 175, and FIG. 176).
33) Lower robot-assembled cone-shielding injury-preventing hammer-shields 133 is (or are respectively) for:
   a) Automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place; and
   b) Preventing injury by coving the robot-assembled heat-expandable cold-contractable interlocking cones 120
      in the directions of arrows 176a, 176f, 176g, 176h, 176i, and 176j (see FIG. 170, FIG. 171, FIG. 172, FIG. 173, FIG. 174, FIG. 175, and FIG. 176).
34) Lower robot-assembled arthritic-assisting height-adjusting dog-run-panel-rope hooks 134 is (or are respectively) for:
   a) Allowing an arthritic to deploy and retract the six-device-in-one robot-assembled arthritic-assisting noise-canceling friction-reducing dog-run-adaptable anti-wobbling gazebo without the need to close the hand in the directions of arrows 177a, 177b, 177c, 177d, 177e, and 177f (see FIG. 178, FIG. 179, and FIG. 180); and
   b) Attaching a rope or strap to support a dog run
      in the direction of arrow 178 (see FIG. 181).
35) Lower robot-assembled noise-canceling friction-reducing height-adjusting nipples 135 is (or are respectively) for:
   a) Securingly and pivotingly locking lower robot-assembled arthritic-assisting height-adjusting dog-run-panel-rope hooks 134; and
   b) Securingly snap-locking the six-device-in-one robot-assembled arthritic-assisting noise-canceling friction-reducing dog-run-adaptable anti-wobbling gazebo from collapsing to prevent injury
      in the directions of arrows 177a, 177b, 177c, 177d, 177e, and 177f (see FIG. 179 and FIG. 180).
36) Lower robot-assembled noise-canceling friction-reducing lead-in nipple tips 136 is (or are respectively) for:
   Easily allowing lower robot-assembled noise-canceling friction-reducing height-adjusting nipples 135 to be inserted into lower robot-assembled noise-canceling friction-reducing nipple-centering tunnels 140
      in the direction of arrow 179a (see FIG. 182, and FIG. 183).
37) Lower robot-assembled self-securing nipple-securing pins 137 is (or are respectively) for:
   Hingedly securing lower robot-assembled noise-canceling friction-reducing height-adjusting nipples 135 to lower robot-assembled arthritic-assisting height-adjusting dog-run-panel-rope hooks 134
   in the direction of arrow 179b (see FIG. 182 and FIG. 183).
38) Lower robot-assembled self-securing hook-securing pins 138 is (or are respectively) for:
   Hingedly securing lower robot-assembled arthritic-assisting height-adjusting dog-run-panel-rope hooks 134 to lower robot-assembled intersectors 131.
39) Lower robot-assembled hook spring 139 is (or are respectively) for:
   Springingly providing opposing force for lower robot-assembled arthritic-assisting height-adjusting dog-run-panel-rope hooks 134 to return to its original position once depressed
   in the direction of arrow 179c (see FIG. 182 and FIG. 183).
40) Lower robot-assembled noise-canceling friction-reducing nipple-centering tunnels 140 is (or are respectively) for:
   Securely centeringly snap-locking lower robot-assembled noise-canceling friction-reducing height-adjusting nipples 135 to securely snap-lock the deployed six-device-in-one robot-assembled arthritic-assisting noise-canceling friction-reducing dog-run-adaptable anti-wobbling gazebo from collapsing.
41) Robot-assembled arthritic-assisting injury-preventing post-centering tick-preventing water-discharging sleeve system 141 is (or are respectively) for performing the combined functions of its components.
42) Robot-assembled sleeves 142 is (or are respectively) for:
   Providing easy-slide surface for dog-run-adaptable anti-wobbling foldable lower posts 107 to slide up and down within dog-run-adaptable anti-wobbling foldable upper posts 106 to prevent scratching
   in the directions of arrows 180a and 180b (see FIG. 184).
43) Sleeve robot-assembled post-centering clamps 143 is (or are respectively) for:
   Centering dog-run-adaptable anti-wobbling foldable lower posts 107
   within dog-run-adaptable anti-wobbling foldable upper posts 106.
44) Sleeve robot-assembled tick-preventing downward teeth 144 is (or are respectively) for:
   Preventing ticks from getting inside dog-run-adaptable anti-wobbling foldable upper posts 106.
45) Sleeve robot-assembled water-discharging grooves 145 is (or are respectively) for:
   Allowing water to discharge out of dog-run-adaptable anti-wobbling foldable upper posts 106
   in the directions of arrows 181a and 181b (see FIG. 188).
46) Sleeve robot-assembled arthritic-assisting height-adjusting dog-run-panel-rope hooks 146 is (or are respectively) for:
   a) Allowing an arthritic to deploy and retract the six-device-in-one robot-assembled arthritic-assisting noise-canceling friction-reducing dog-run-adaptable anti-wobbling gazebo without bending the fingers (see FIG. 191); and
   b) Attaching a rope or strap to support a dog run in the direction of arrow 182 (see FIG. 193).
47) Sleeve robot-assembled noise-canceling friction-reducing post-height-adjusting grooved nipples 147 is (or are respectively) for:
   Securely snap-locking the deployed six-device-in-one robot-assembled arthritic-assisting noise-canceling friction-reducing dog-run-adaptable anti-wobbling gazebo to prevent collapsing.
48) Sleeve robot-assembled noise-canceling friction-reducing hook-jacking jacks 148 is (or are respectively) for:
   Securely snap-locking sleeve robot-assembled arthritic-assisting height-adjusting dog-run-panel-rope hooks 146
   in the direction of arrow 183 (see FIG. 185).
49) Sleeve robot-assembled self-securing jack-securing pins 149 is (or are respectively) for:
   Securing sleeve robot-assembled noise-canceling friction-reducing hook-jacking jacks 148 to sleeve robot-assembled arthritic-assisting height-adjusting dog-run-panel-rope hooks 146.
50) Sleeve robot-assembled self-securing hook-securing pins 150 is (or are respectively) for:
   Hingedly securing sleeve robot-assembled arthritic-assisting height-adjusting dog-run-panel-rope hooks 146 to robot-assembled sleeves 142 in the direction of arrow 184 (see FIG. 186).
51) Sleeve robot-assembled hook spring 151 is (or are respectively) for:
   Springingly providing opposing force for sleeve robot-assembled arthritic-assisting height-adjusting dog-run-panel-rope hooks 146 to return to its original position once depressed.
52) Sleeve robot-assembled noise-canceling friction-reducing flower-shaped nipple-centering holes 152 is (or are respectively) for:
   Securely centeringly snapping sleeve robot-assembled noise-canceling friction-reducing hook-jacking jacks 148 to securely snap-lock the deployed six-device-in-one robot-assembled arthritic-assisting noise-canceling friction-reducing dog-run-adaptable anti-wobbling gazebo to prevent collapsing.
53) Robot-assembled noise-canceling injury-preventing rust-preventing truss-centering cover-cushion system 153 is (or are respectively) for performing the combined functions of its components.
54) Robot-assembled rust-preventing truss-end covers 154 is (or are respectively) for:
   a) Eliminating the need for nuts and bolts
      to save manufacturing cost,
      to save manufacturing time,
      to save end-user assembly time, and
      to increase overall production output;
   b) Eliminating the need for washers
      to save manufacturing cost,
      to save manufacturing time,
      to save end-user assembly time, and
      to increase overall production output;
   c) Eliminating the need for 50 truss-end-plugs, from prior art
      to save manufacturing cost,
      to save manufacturing time,
      to save end-user assembly time, and
      to increase overall production output;
   d) Preventing water and insects from entering into dog-run-adaptable anti-wobbling foldable corner trusses 104; and
   e) Preventing injury by covering sharp metal edges.
55) Robot-assembled noise-canceling cover-cushion 155 is (or are respectively) for:
   Providing a washer to assist in easy motion and to prevent metal-to-metal contact.
56) Robot-assembled injury-preventing inward-curved cover-cushion edges 156 is (or are respectively) for:
   Securely snap-locking in place eliminating the need for nuts and bolts.
57) Robot-assembled heat-expandable cold-contractable double-tail cover-cushion rivets 157 is (or are respectively) for:
   a) Decreasing assembly man hours by being robotically factory-installed;
   b) Decreasing end-user assembly time by being robotically factory-installed;
   c) Eliminating need for washers;
   d) Creating a locking ridge when robotically heat-stamped eliminating need for nuts and bolts
      in the directions of arrows 185a, 185b, 185c, and 185d (see FIG. 197, FIG. 198, and FIG. 199); and
   e) Creating a locking ridge when robotically heat-stamped securely and pivotably locking two dog-run-adaptable anti-wobbling foldable side trusses 105 together
      in the directions of arrows 185a, 185b, 185c, and 185d (see FIG. 197, FIG. 198, and FIG. 199).
58) Robot-assembled arthritic-assisting noise-canceling injury-preventing rust-preventing truss-centering cup-cushion system 158 is (or are respectively) for performing the combined functions of its components.
59) Robot-assembled noise-canceling cup-cushion 159 is (or are respectively) for:
   a) Eliminating the need for nuts and bolts
      to save manufacturing cost,
      to save manufacturing time,
      to save end-user assembly time, and
      to increase overall production output
      in the directions of arrows 186a, 186b, and 186c (see FIG. 203, FIG. 204, FIG. 205, and FIG. 206);
   b) Eliminating the need for washers
      to save manufacturing cost,
      to save manufacturing time,
      to save end-user assembly time, and
      to increase overall production output
      in the directions of arrows 186a, 186b, and 186c (see FIG. 203, FIG. 204, FIG. 205, and FIG. 206);
   c) Eliminating the need for 50 truss-end-plugs, from prior art
      to save manufacturing cost,
      to save manufacturing time,
      to save end-user assembly time, and
      to increase overall production output
      in the directions of arrows 186a, 186b, and 186c (see FIG. 203, FIG. 204, FIG. 205, and FIG. 206);
   d) Preventing water and insects from entering into dog-run-adaptable anti-wobbling foldable corner trusses 104; and
   e) Preventing injury by covering sharp metal edges.
60) Robot-assembled injury-preventing inward-curved cup-cushion edges 160 is (or are respectively) for:
   Securely snap-locking in place eliminating the need for securing nuts, bolts, and washers.
61) Robot-assembled arthritic-assisting noise-canceling circular-cushion system 161 is (or are respectively) for performing the combined functions of its components.
62) Robot-assembled noise-canceling circular-cushion 162 is (or are respectively) for:
   a) Providing a washer between two dog-run-adaptable anti-wobbling foldable side trusses 105;
   b) Pivotably connecting two dog-run-adaptable anti-wobbling foldable side trusses 105 together;
   c) Eliminating the need for nuts and bolts
      to save manufacturing cost,
      to save manufacturing time,
      to save end-user assembly time, and
      to increase overall production output
      in the directions of arrows 187a, 187b, 187c, 187d, 187e, and 186f (see FIG. 207, FIG. 208, FIG. 209, and FIG. 210); and
   d) Eliminating the need for washers
      to save manufacturing cost,
      to save manufacturing time,
      to save end-user assembly time, and
      to increase overall production output
      in the directions of arrows 187a, 187b, 187c, 187d, 187e, and 186f (see FIG. 207, FIG. 208, FIG. 209, and FIG. 210).
63) Robot-assembled double-tail built-in circular-cushion rivets 163 is (or are respectively) for:
   a) Pivotably connecting two dog-run-adaptable anti-wobbling foldable side trusses 105 together;
   b) Being robotically installed to lessen the assembly man hours in the directions of arrows 187a, 187b, 187c, 187d, 187e, and 186f (see FIG. 207, FIG. 208, FIG. 209, and FIG. 210);
   c) Being robotically installed to lessen end-user assembly time in the directions of arrows 187a, 187b, 187c, 187d, 187e, and 186f (see FIG. 207, FIG. 208, FIG. 209, and FIG. 210); and
   d) Being robotically heat-stamped automatically creating a locking ridge eliminating the need for nuts in the directions of arrows 187a, 187b, 187c, 187d, 187e, and 186f (see FIG. 207, FIG. 208, FIG. 209, and FIG. 210).

### Variation

Any component of the six-device-in-one robot-assembled arthritic-assisting noise-canceling friction-reducing dog-run-adaptable anti-wobbling gazebo can have any shape and size.

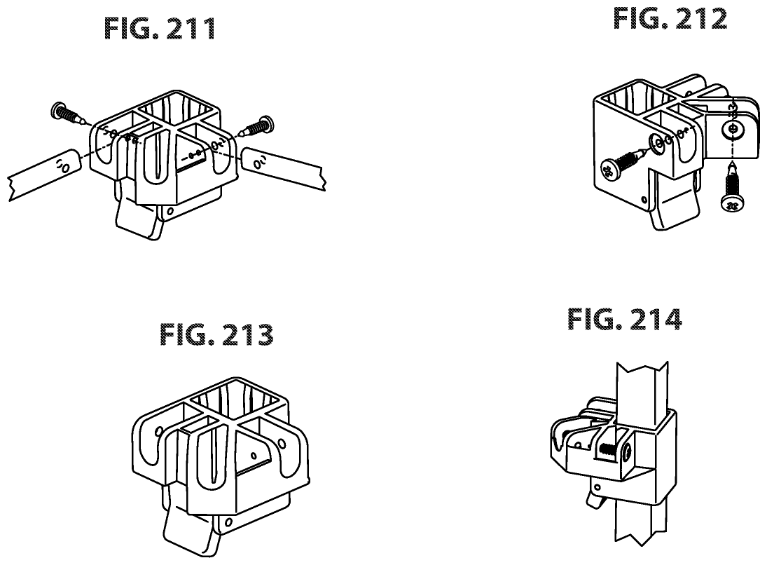

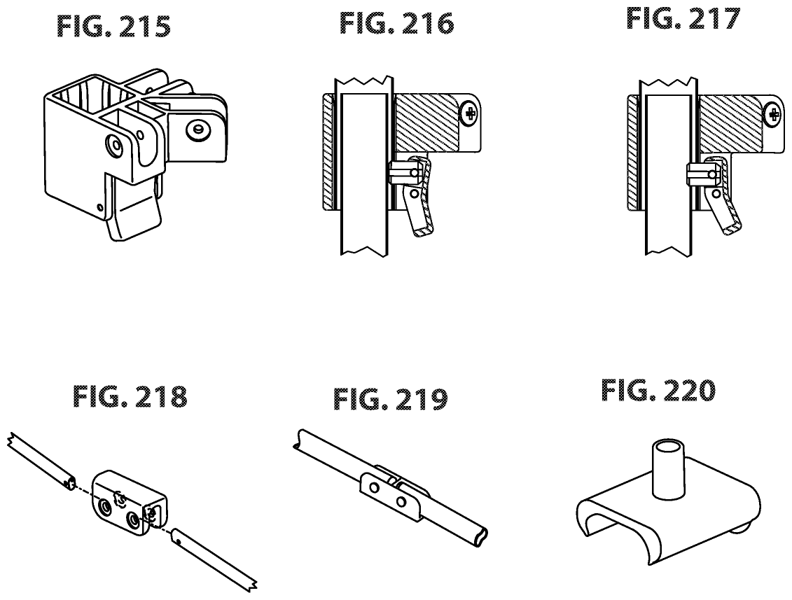

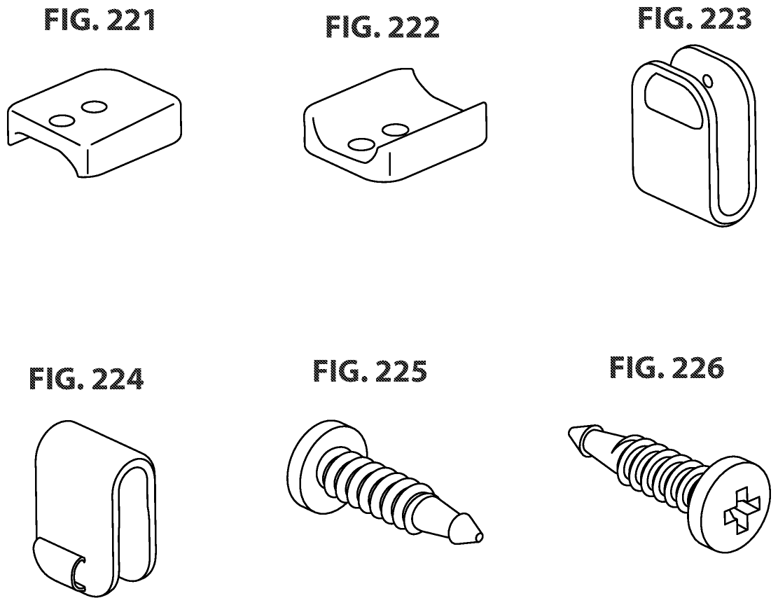

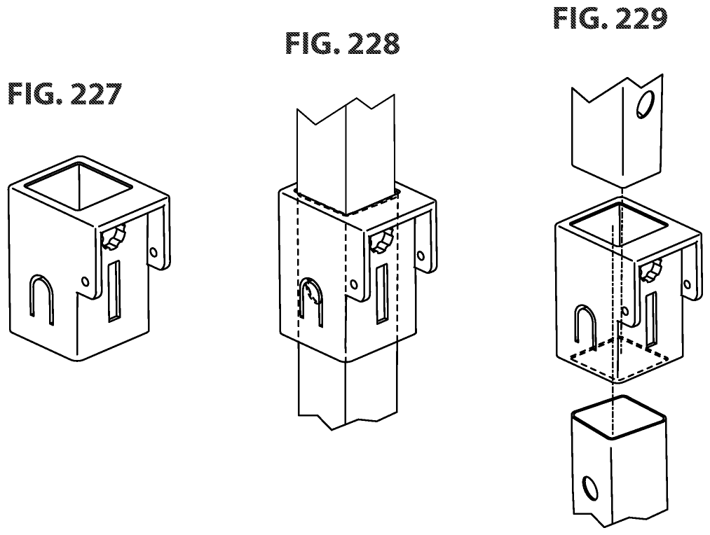

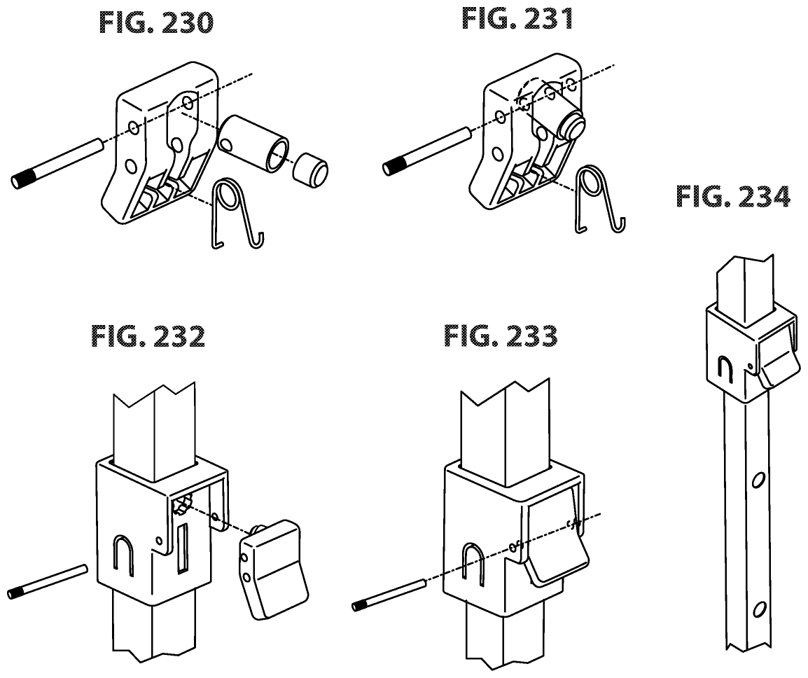

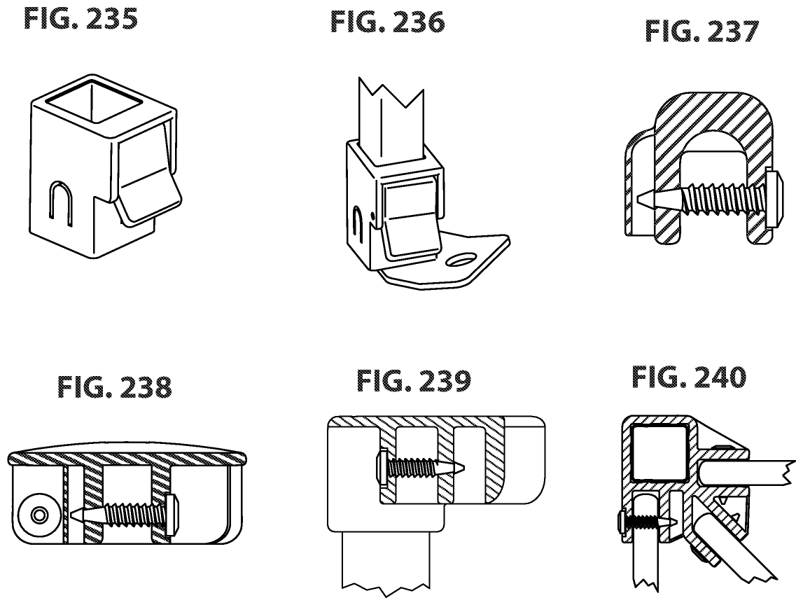

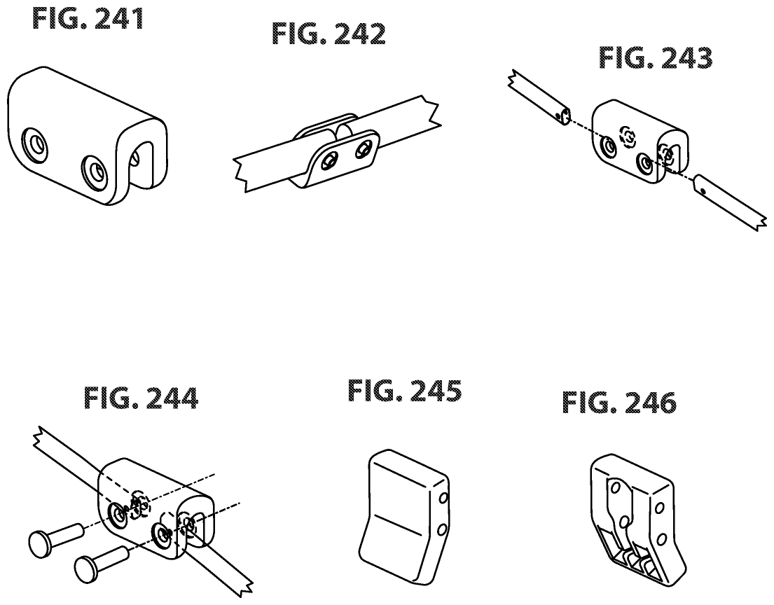

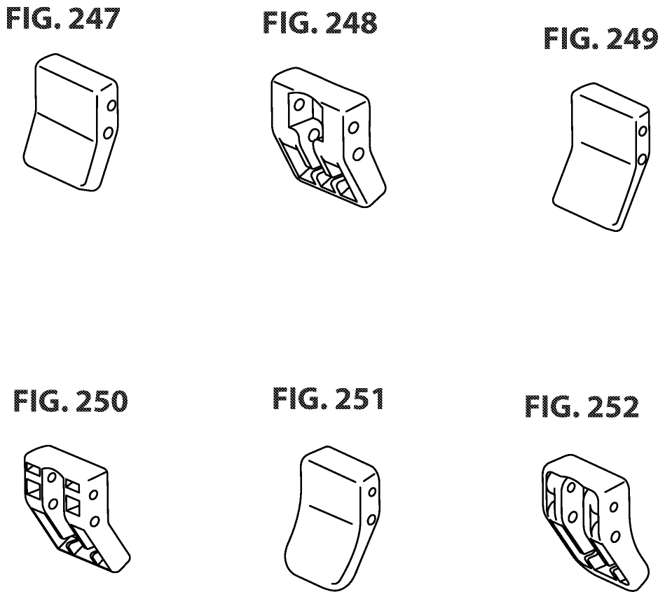

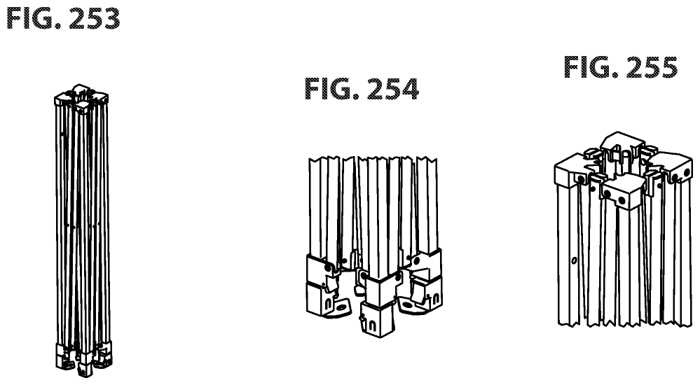

Any component of the six-device-in-one robot-assembled arthritic-assisting noise-canceling friction-reducing dog-run-adaptable anti-wobbling gazebo can be replaced with an equivalent component. Any component of six-device-in-one robot-assembled arthritic-assisting noise-canceling friction-reducing dog-run-adaptable anti-wobbling gazebo can be made of any material(s) or any combination of any materials. Any component of the six-device-in-one robot-assembled arthritic-assisting noise-canceling friction-reducing dog-run-adaptable anti-wobbling gazebo can be made of any flexible, semi-flexible, bendable, semi-bendable, stretchable, semi-stretchable, rigid, or semi-rigid material(s). Any component-attaching method of the six-device-in-one robot-assembled arthritic-assisting noise-canceling friction-reducing dog-run-adaptable anti-wobbling gazebo can be replaced with an equivalent method. For example, FIG. 211, FIG. 212, FIG. 213, FIG. 214, FIG. 215, FIG. 216, and FIG. 217 illustrate perspective and cross-sectional views of equivalent variations of robot-assembled arthritic-assisting injury-preventing cone-shielding lower intersector system. For example, FIG. 218 and FIG. 219 illustrate perspective views of equivalent variations of robot-assembled automatically-making-rivet-tail-flare noise-canceling injury-preventing top-connector system. For example, FIG. 220, FIG. 221, FIG. 222, FIG. 223, and FIG. 224 illustrate perspective views of equivalent variations of robot-assembled noise-canceling injury-preventing rust-preventing truss-centering cover-cushion system. For example, FIG. 225 and FIG. 226 illustrate perspective views of equivalent variations of robot-assembled heat-expandable cold-contractable anti-wobbling screws. For example, FIG. 227, FIG. 228, FIG. 229, FIG. 230, FIG. 231, FIG. 232, FIG. 233, FIG. 234, FIG. 235, and FIG. 236 illustrate perspective views of equivalent variations of various components of robot-assembled arthritic-assisting injury-preventing post-centering tick-preventing water-discharging sleeve system. For example, FIG. 237, FIG. 238, FIG. 239, and FIG. 240 illustrate cross-section views of equivalent variations of robot-assembled automatically-making-rivet-tail-flare noise-canceling injury-preventing top-connector system, robot-assembled injury-preventing cone-shielding central intersector system, robot-assembled injury-preventing cone-shielding upper intersector system, and robot-assembled arthritic-assisting injury-preventing cone-shielding lower intersector system and the installation of robot-assembled heat-expandable cold-contractable interlocking anti-wobbling spiral-saw screw system, respectively, therein. For example, FIG. 241, FIG. 242, FIG. 243, and FIG. 244 illustrate perspective views of equivalent variations of robot-assembled automatically-making-rivet-tail-flare noise-canceling injury-preventing top-connector system. For example, FIG. 245, FIG. 246, FIG. 247, FIG. 248, FIG. 249, FIG. 250, FIG. 251, and FIG. 252 illustrate perspective views of equivalent variations of lower robot-assembled arthritic-assisting height-adjusting dog-run-panel-rope hooks and sleeve robot-assembled arthritic-assisting height-adjusting dog-run-panel-rope hooks. For example, FIG. 253, FIG. 254, and FIG. 255 illustrate perspective views of equivalent variations of the six-device-in-one robot-assembled arthritic-assisting noise-canceling friction-reducing dog-run-adaptable anti-wobbling gazebo in its folded position.

### MAJOR ADVANTAGES OF THE INVENTION

The present invention substantially departs from the conventional concepts and designs of the prior art. In doing so, the present invention provides the six-device-in-one robot-assembled arthritic-assisting noise-canceling friction-reducing dog-run-adaptable anti-wobbling gazebo, having many unique and significant features, functions, and advantages, which overcome all the disadvantages of the prior art, as follows:
1) It is an object of the new invention to provide a six-device-in-one robot-assembled arthritic-assisting noise-canceling friction-reducing dog-run-adaptable anti-wobbling gazebo, having adjustable canopy 102.
   Therefore, the six-device-in-one robot-assembled arthritic-assisting noise-canceling friction-reducing dog-run-adaptable anti-wobbling gazebo:
      a) Is capable of protecting occupants and property users from weather elements;
      b) Is capable of functioning as a greenhouse (see FIG. 3, FIG. 4, FIG. 138, and FIG. 139);
      c) Is capable of functioning as a cover for a dog-run in the direction of arrow 169 (see FIG. 5, FIG. 6, FIG. 140, and FIG. 141);
      d) Is capable of functioning as a surface for an advertisement sign (see FIG. 7, FIG. 8, FIG. 129, and FIG. 130);
      e) Is capable of functioning as an awning cover (see FIG. 9, FIG. 10, FIG. 131, and FIG. 132); and
      f) Is capable of functioning as ceiling-mounted overhead storage (see FIG. 11, FIG. 12, FIG. 133, and FIG. 134).
2) It is another object of the new invention to provide a six-device-in-one robot-assembled arthritic-assisting noise-canceling friction-reducing dog-run-adaptable anti-wobbling gazebo, having
   dog-run-adaptable anti-wobbling foldable lower posts 107.
   Therefore, the six-device-in-one robot-assembled arthritic-assisting noise-canceling friction-reducing dog-run-adaptable anti-wobbling gazebo:
      a) Is capable of foldably and slidably raising and lowering to increase and decrease the height of the six-device-in-one robot-assembled arthritic-assisting noise-canceling friction-reducing dog-run-adaptable anti-wobbling gazebo; and
      b) Is capable of supporting sidewalls of dog-run.
3) It is another object of the new invention to provide a six-device-in-one robot-assembled arthritic-assisting noise-canceling friction-reducing dog-run-adaptable anti-wobbling gazebo, having
   top robot-assembled automatically-flaring-and-shielding-rivet-tail injury-preventing hammer-shields 114.
   Therefore, the six-device-in-one robot-assembled arthritic-assisting noise-canceling friction-reducing dog-run-adaptable anti-wobbling gazebo:
      a) Is capable of providing a limiting surface for robot-assembled heat-expandable cold-contractable anti-wobbling screws 117 to stop in the directions of arrows 171a, 171f, 171g, 171h, 171i, and 171j (see FIG. 145, FIG. 149, FIG. 150, and FIG. 153); and
      b) Is capable of preventing injury by covering the robot-assembled heat-expandable cold-contractable interlocking cones 120.
4) It is a further object of the new invention to provide a six-device-in-one robot-assembled arthritic-assisting noise-canceling friction-reducing dog-run-adaptable anti-wobbling gazebo, having
   robot-assembled heat-expandable cold-contractable anti-wobbling screws 117.
   Therefore, the six-device-in-one robot-assembled arthritic-assisting noise-canceling friction-reducing dog-run-adaptable anti-wobbling gazebo:
      a) Is capable of saving manufacturing time by eliminating the need for nuts and bolts (see FIG. 146 (Prior Art), FIG. 155 (Prior Art), FIG. 162 (Prior Art), and FIG. 169 (Prior Art));
      b) Is capable of saving manufacturing man-hours by robotically manufacturing in the directions of arrows 172a, 172b, 172c, and 172d (see FIG. 154, FIG. 158, FIG. 168, and FIG. 177);
      c) Is capable of saving end-consumer assembly time by robotically pre-installing robot-assembled heat-expandable cold-contractable anti-wobbling screws 117, at the factory in the directions of arrows 172a, 172b, 172c, and 172d (see FIG. 154, FIG. 158, FIG. 168, and FIG. 177); and
      d) Is capable of increasing overall production output of the six-device-in-one robot-assembled arthritic-assisting noise-canceling friction-reducing dog-run-adaptable anti-wobbling gazebo by robotically decreasing per-unit production time.
5) It is an even further object of the new invention to provide a six-device-in-one robot-assembled arthritic-assisting noise-canceling friction-reducing dog-run-adaptable anti-wobbling gazebo, having
   robot-assembled heat-expandable cold-contractable spirally-threading spiral saws 118.
   Therefore, the six-device-in-one robot-assembled arthritic-assisting noise-canceling friction-reducing dog-run-adaptable anti-wobbling gazebo:
      Is capable of robotically and heatingly expanding and tapping threads into top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132 in the directions of arrows 171a, 173a, and 173b (see FIG. 144).
6) It is another object of the new invention to provide a six-device-in-one robot-assembled arthritic-assisting noise-canceling friction-reducing dog-run-adaptable anti-wobbling gazebo, having
   robot-assembled heat-expandable cold-contractable spiral-teeth 119.
   Therefore, the six-device-in-one robot-assembled arthritic-assisting noise-canceling friction-reducing dog-run-adaptable anti-wobbling gazebo:
      Is capable of robotically and speedily cutting through plastic connector material
         to decrease production time, and
         to increase production output
      in the directions of arrows 171a, 173a, and 173b (see FIG. 144).
7) It is yet another object of the new invention to provide a six-device-in-one robot-assembled arthritic-assisting noise-canceling friction-reducing dog-run-adaptable anti-wobbling gazebo, having
   robot-assembled heat-expandable cold-contractable interlocking cones 120.
   Therefore, the six-device-in-one robot-assembled arthritic-assisting noise-canceling friction-reducing dog-run-adaptable anti-wobbling gazebo:
      a) Is capable of robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132
         in the directions of arrows 171a, 173a, and 173b (see FIG. 144);
      b) Is capable of expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133
         in the directions of arrows 171a, 173c, 173d, and 173e (see FIG. 145); and
      c) Is capable of eliminating the need for the usage of nuts and bolts
         to robotically lessen the assembly time, and
         to robotically lessen assembly cost (see FIG. 146 (Prior Art), FIG. 155 (Prior Art), FIG. 162 (Prior Art), and FIG. 169 (Prior Art)).
8) It is still yet another object of the new invention to provide a six-device-in-one robot-assembled arthritic-assisting noise-canceling friction-reducing dog-run-adaptable anti-wobbling gazebo, having
   robot-assembled heat-expandable cold-contractable interlocking spiral locks 121.
   Therefore, the six-device-in-one robot-assembled arthritic-assisting noise-canceling friction-reducing dog-run-adaptable anti-wobbling gazebo:
      a) Is capable of robotically and heatingly boring through top robot-assembled heat-expandable cold-contractable holes 113, central robot-assembled heat-expandable cold-contractable holes 124, upper robot-assembled heat-expandable cold-contractable holes 128, and lower robot-assembled heat-expandable cold-contractable holes 132
         in the directions of arrows 171a, 173a, and 173b (see FIG. 144); and
      b) Is capable of expanding and locking when impacted by top robot-assembled automatically-flaring-and-shielding-rivet-tail injury-preventing hammer-shields 114, central robot-assembled automatically-flaring-and-shielding-cone-head injury-preventing hammer-shields 125, upper robot-assembled automatically-flaring-and-shielding-cone-head injury-preventing hammer-shields 129, and lower robot-assembled cone-shielding injury-preventing hammer-shields 133 in the directions of arrows 171a, 173c, 173d, and 173e (see FIG. 145).
9) It is still yet an even further object of the new invention to provide a six-device-in-one robot-assembled arthritic-assisting noise-canceling friction-reducing dog-run-adaptable anti-wobbling gazebo, having
   central robot-assembled automatically-flaring-and-shielding-cone-head injury-preventing hammer-shields 125.
   Therefore, the six-device-in-one robot-assembled arthritic-assisting noise-canceling friction-reducing dog-run-adaptable anti-wobbling gazebo:
      a) Is capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place
         in the directions of arrows 174a, 174f, 174g, 174h, 174i, and 174j (see FIG. 156, FIG. 157, FIG. 159, FIG. 160, and FIG. 161); and
      b) Is capable of preventing injury by coving the robot-assembled heat-expandable cold-contractable interlocking cones 120.
10) It is still yet an even further object of the new invention to provide a six-device-in-one robot-assembled arthritic-assisting noise-canceling friction-reducing dog-run-adaptable anti-wobbling gazebo, having
   upper robot-assembled automatically-flaring-and-shielding-cone-head injury-preventing hammer-shields 129.
   Therefore, the six-device-in-one robot-assembled arthritic-assisting noise-canceling friction-reducing dog-run-adaptable anti-wobbling gazebo:
      a) Is capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place; and
      b) Is capable of preventing injury by coving the robot-assembled heat-expandable cold-contractable interlocking cones 120
         in the directions of arrows 175a, 175f, 175g, 175h, 175i, and 175j (see FIG. 163, FIG. 164, FIG. 165, FIG. 166, and FIG. 167).
11) It is still yet an even further object of the new invention to provide a six-device-in-one robot-assembled arthritic-assisting noise-canceling friction-reducing dog-run-adaptable anti-wobbling gazebo, having
   lower robot-assembled cone-shielding injury-preventing hammer-shields 133.
   Therefore, the six-device-in-one robot-assembled arthritic-assisting noise-canceling friction-reducing dog-run-adaptable anti-wobbling gazebo:
      a) Is capable of automatically stopping robot-assembled heat-expandable cold-contractable anti-wobbling screws 117 allowing robot-assembled heat-expandable cold-contractable interlocking cones 120 and robot-assembled heat-expandable cold-contractable interlocking spiral locks 121 to expand and lock into place, and
      b) Is capable of preventing injury by coving the robot-assembled heat-expandable cold-contractable interlocking cones 120
         in the directions of arrows 176a, 176f, 176g, 176h, 176i, and 176j (see FIG. 170, FIG. 171, FIG. 172, FIG. 173, FIG. 174, FIG. 175, and FIG. 176).
12) It is still yet an even further object of the new invention to provide a six-device-in-one robot-assembled arthritic-assisting noise-canceling friction-reducing dog-run-adaptable anti-wobbling gazebo, having
   lower robot-assembled arthritic-assisting height-adjusting dog-run-panel-rope hooks 134.
   Therefore, the six-device-in-one robot-assembled arthritic-assisting noise-canceling friction-reducing dog-run-adaptable anti-wobbling gazebo:
      a) Is capable of allowing an arthritic to deploy and retract the six-device-in-one robot-assembled arthritic-assisting noise-canceling friction-reducing dog-run-adaptable anti-wobbling gazebo without the need to close the hand
         in the directions of arrows 177a, 177b, 177c, 177d, 177e, and 177f (see FIG. 178, FIG. 179, and FIG. 180); and
      b) Is capable of attaching a rope or strap to support a dog run
         in the direction of arrow 178 (see FIG. 181).
13) It is still yet an even further object of the new invention to provide a six-device-in-one robot-assembled arthritic-assisting noise-canceling friction-reducing dog-run-adaptable anti-wobbling gazebo, having
   sleeve robot-assembled post-centering clamps 143.
   Therefore, the six-device-in-one robot-assembled arthritic-assisting noise-canceling friction-reducing dog-run-adaptable anti-wobbling gazebo:
      Is capable of centering dog-run-adaptable anti-wobbling foldable lower posts 107 within dog-run-adaptable anti-wobbling foldable upper posts 106.
14) It is still yet an even further object of the new invention to provide a six-device-in-one robot-assembled arthritic-assisting noise-canceling friction-reducing dog-run-adaptable anti-wobbling gazebo, having
   sleeve robot-assembled tick-preventing downward teeth 144.
   Therefore, the six-device-in-one robot-assembled arthritic-assisting noise-canceling friction-reducing dog-run-adaptable anti-wobbling gazebo:
      Is capable of preventing ticks from getting inside dog-run-adaptable anti-wobbling foldable upper posts 106.
15) It is still yet an even further object of the new invention to provide a six-device-in-one robot-assembled arthritic-assisting noise-canceling friction-reducing dog-run-adaptable anti-wobbling gazebo, having
   sleeve robot-assembled water-discharging grooves 145.
   Therefore, the six-device-in-one robot-assembled arthritic-assisting noise-canceling friction-reducing dog-run-adaptable anti-wobbling gazebo:
      Is capable of allowing water to discharge out of dog-run-adaptable anti-wobbling foldable upper posts 106
      in the directions of arrows 181a and 181b (see FIG. 188).
16) It is still yet an even further object of the new invention to provide a six-device-in-one robot-assembled arthritic-assisting noise-canceling friction-reducing dog-run-adaptable anti-wobbling gazebo, having
   sleeve robot-assembled arthritic-assisting height-adjusting dog-run-panel-rope hooks 146.
   Therefore, the six-device-in-one robot-assembled arthritic-assisting noise-canceling friction-reducing dog-run-adaptable anti-wobbling gazebo:
      a) Is capable of allowing an arthritic to deploy and retract the six-device-in-one robot-assembled arthritic-assisting noise-canceling friction-reducing dog-run-adaptable anti-wobbling gazebo without bending the fingers (see FIG. 191); and
      b) Is capable of attaching a rope or strap to support a dog run
         in the direction of arrow 182 (see FIG. 193).
17) It is still yet an even further object of the new invention to provide a six-device-in-one robot-assembled arthritic-assisting noise-canceling friction-reducing dog-run-adaptable anti-wobbling gazebo, having
   robot-assembled rust-preventing truss-end covers 154.
   Therefore, the six-device-in-one robot-assembled arthritic-assisting noise-canceling friction-reducing dog-run-adaptable anti-wobbling gazebo:
      a) Is capable of eliminating the need for nuts and bolts
         to save manufacturing cost,
         to save manufacturing time,
         to save end-user assembly time, and
         to increase overall production output;
      b) Is capable of eliminating the need for washers
         to save manufacturing cost,
         to save manufacturing time,
         to save end-user assembly time, and
         to increase overall production output;
      c) Is capable of eliminating the need for 50 truss-end-plugs, from prior art
         to save manufacturing cost,
         to save manufacturing time,
         to save end-user assembly time, and
         to increase overall production output;
      d) Is capable of preventing water and insects from entering into dog-run-adaptable anti-wobbling foldable corner trusses 104; and
      e) Is capable of preventing injury by covering sharp metal edges.
18) It is still yet an even further object of the new invention to provide a six-device-in-one robot-assembled arthritic-assisting noise-canceling friction-reducing dog-run-adaptable anti-wobbling gazebo, having
   robot-assembled heat-expandable cold-contractable double-tail cover-cushion rivets 157.
   Therefore, the six-device-in-one robot-assembled arthritic-assisting noise-canceling friction-reducing dog-run-adaptable anti-wobbling gazebo:
      a) Is capable of decreasing assembly man hours by being robotically factory-installed;
      b) Is capable of decreasing end-user assembly time by being robotically factory-installed;
      c) Is capable of eliminating need for washers;
      d) Is capable of creating a locking ridge when robotically heat-stamped eliminating need for nuts and bolts
         in the directions of arrows 185a, 185b, 185c, and 185d (see FIG. 197, FIG. 198, and FIG. 199); and
      e) Is capable of creating a locking ridge when robotically heat-stamped securely and pivotably locking two dog-run-adaptable anti-wobbling foldable side trusses 105 together
         in the directions of arrows 185a, 185b, 185c, and 185d (see FIG. 197, FIG. 198, and FIG. 199).
19) It is still yet an even further object of the new invention to provide a six-device-in-one robot-assembled arthritic-assisting noise-canceling friction-reducing dog-run-adaptable anti-wobbling gazebo, having
   robot-assembled noise-canceling cup-cushion 159.
   Therefore, the six-device-in-one robot-assembled arthritic-assisting noise-canceling friction-reducing dog-run-adaptable anti-wobbling gazebo:
      a) Is capable of eliminating the need for nuts and bolts
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      b) Is capable of eliminating the need for washers
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      c) Is capable of eliminating the need for 50 truss-end-plugs, from prior art
         to save manufacturing cost,
         to save manufacturing time,
         to save end-user assembly time, and
         to increase overall production output
         in the directions of arrows 186a, 186b, and 186c (see FIG. 203, FIG. 204, FIG. 205, and FIG. 206);
      d) Is capable of preventing water and insects from entering into dog-run-adaptable anti-wobbling foldable corner trusses 104; and
      e) Is capable of preventing injury by covering sharp metal edges.
20) It is still yet an even further object of the new invention to provide a six-device-in-one robot-assembled arthritic-assisting noise-canceling friction-reducing dog-run-adaptable anti-wobbling gazebo, having
   robot-assembled noise-canceling circular-cushion 162.
   Therefore, the six-device-in-one robot-assembled arthritic-assisting noise-canceling friction-reducing dog-run-adaptable anti-wobbling gazebo:
      a) Is capable of providing a washer between two dog-run-adaptable anti-wobbling foldable side trusses 105;
      b) Is not capable of pivotably connecting two dog-run-adaptable anti-wobbling foldable side trusses 105 together;
      c) Is capable of eliminating the need for nuts and bolts
         to save manufacturing cost,
         to save manufacturing time,
         to save end-user assembly time, and
         to increase overall production output
         in the directions of arrows 187a, 187b, 187c, 187d, 187e, and 186f (see FIG. 207, FIG. 208, FIG. 209, and FIG. 210); and
      d) Is capable of eliminating the need for washers
         to save manufacturing cost,
         to save manufacturing time,
         to save end-user assembly time, and
         to increase overall production output
         in the directions of arrows 187a, 187b, 187c, 187d, 187e, and 186f (see FIG. 207, FIG. 208, FIG. 209, and FIG. 210).
21) It is still yet an even further object of the new invention to provide a six-device-in-one robot-assembled arthritic-assisting noise-canceling friction-reducing dog-run-adaptable anti-wobbling gazebo, having
   robot-assembled double-tail built-in circular-cushion rivets 163.
   Therefore, the six-device-in-one robot-assembled arthritic-assisting noise-canceling friction-reducing dog-run-adaptable anti-wobbling gazebo:
      a) Is capable of pivotably connecting two dog-run-adaptable anti-wobbling foldable side trusses 105 together;
      b) Is capable of being robotically installed to lessen the assembly man hours in the directions of arrows 187a, 187b, 187c, 187d, 187e, and 186f (see FIG. 207, FIG. 208, FIG. 209, and FIG. 210);
      c) Is capable of being robotically installed to lessen end-user assembly time in the directions of arrows 187a, 187b, 187c, 187d, 187e, and 186f (see FIG. 207, FIG. 208, FIG. 209, and FIG. 210); and
      d) Is capable of being robotically heat-stamped automatically creating a locking ridge eliminating the need for nuts in the directions of arrows 187a, 187b, 187c, 187d, 187e, and 186f (see FIG. 207, FIG. 208, FIG. 209, and FIG. 210).

What is claimed is:

1. A multifunctional gazebo comprising:
an adjustable canopy;
a foldable truss, including at least one of a top truss, a corner truss, and a side truss, and the foldable truss supporting the adjustable canopy; and
a plurality of posts, including an upper post and a lower post, wherein the lower post and the upper post are configured to be slidably coupled to allow for height adjustment, the lower post and the upper post coupled to the foldable truss.

2. The multifunctional gazebo of claim 1, further comprising a spiral-saw screw system including at least one spiral-saw screw.

3. The system of claim 2, wherein the spiral-saw screw includes an anti-wobbling feature.

4. The system of claim 2, wherein the spiral-saw screw includes a spiral saw feature.

5. The system of claim 2, wherein the spiral-saw screw includes spiral-teeth.

6. The system of claim 2, wherein the spiral-saw screw includes interlocking cones.

7. The system of claim 2, wherein the spiral-saw screw includes interlocking spiral locks.

8. The multifunctional gazebo of claim 1, further comprising a plurality of connectors and expandable cold-contractable screws for assembling the multifunctional gazebo, wherein the expandable cold-contractable screws expand upon heating and contract upon cooling to lock into place.

9. The multifunctional gazebo of claim 1, further comprising a cover cushion system.

10. The multifunctional gazebo of claim 9, wherein the cover cushion system includes truss-end covers.

11. The multifunctional gazebo of claim 9, wherein the cover cushion system includes a cover-cushion.

12. The multifunctional gazebo of claim 9, wherein the cover cushion system includes inward-curved cover-cushion edges.

13. The multifunctional gazebo of claim 9, wherein the cover cushion system includes double-tail cover-cushion rivets.

14. The multifunctional gazebo of claim 1, further comprising a foot attached to the lower post, the foot having at least one hole for securing the multifunctional gazebo.

15. The multifunctional gazebo of claim 1, wherein the foldable truss is made of a material selected from the group consisting of metal and plastic.

16. The multifunctional gazebo of claim 1, further comprising a plurality of height-adjusting hooks, nipples, and securing pins attached to the posts for adjusting a height of the multifunctional gazebo.

17. The multifunctional gazebo of claim 1, wherein the adjustable canopy is further configurable to function as a privacy screen.

18. The multifunctional gazebo of claim 1, further comprising a modular sidewall system attachable to the foldable truss, allowing for customizable enclosure configurations.

19. The multifunctional gazebo of claim 1, further comprising a foot coupled to the lower post, the foot including at least one hole configured to accommodate different types of ground anchors.

20. The multifunctional gazebo of claim 1, wherein the different types of ground anchors include at least one of spikes, stakes, and screws, for versatile ground securing options.
